(19) United States
(12) Patent Application Publication
(10) Pub. No.: US 2026/0193279 A1
(43) Pub. Date: Jul. 9, 2026

(54) BORYL THIANTHRENIUM SALTS, PROCESS FOR THEIR PREPARATION AND USE FOR THE SYNTHESIS OF ORGANOBORON COMPOUNDS

(71) Applicant: THE TEXAS A&M UNIVERSITY SYSTEM, College Station, TX (US)

(72) Inventors: Shiqing XU, College Station, TX (US); Veerabhadra Reddy VULUPALA, College Station, TX (US); Nagarjun Reddy MALLAMPUDI, College Station, TX (US); Disni GUNASEKERA, College Station, TX (US); Satyanarayana NYALATA, College Station, TX (US); Yusif GYASI, College Station, TX (US)

(21) Appl. No.: 19/442,613

(22) Filed: Jan. 7, 2026

Related U.S. Application Data
(60) Provisional application No. 63/742,596, filed on Jan. 7, 2025.

(51) Int. Cl. C07F 5/02

(52) U.S. Cl. CPC C07F 5/027

(57) ABSTRACT

The present disclosure relates to boryl thianthrenium salts of formula (I),

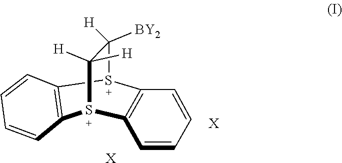

their preparation, and use in the synthesis of organoboron compounds.

### RELATED APPLICATIONS

This application claims the benefit of U.S. Provisional Application No. 63/742,596, filed Jan. 7, 2025, the contents of which are fully incorporated by reference herein.

### TECHNICAL FIELD

The present disclosure relates to boryl thianthrenium salts, process for their preparation, and their use for the synthesis of organoboron compounds.

### BACKGROUND

Organoboron compounds are highly versatile building blocks for a wide range of synthetic transformations in modern organic synthesis. Beyond their synthetic utility, boron-containing compounds are gaining recognition as a new frontier in biomedical research, exhibiting potential as imaging agents and therapeutic agents with anti-cancer, antiviral, antibacterial, and other disease-specific activities. Boronic esters, including N-methyliminodiacetic acid (MIDA) boronates, have been successfully employed as prodrug strategies to improve the solubility, stability, and permeability of boronic acids, further demonstrating their versatility and importance in advancing medicinal chemistry. MIDA boronates are particularly useful in synthetic chemistry and automated iterative small-molecule synthesis due to their enhanced stability, which arises from the steric protection and reduced Lewis acidity of the boron center conferred by the strongly coordinating MIDA group.

Aziridines, on the other hand, represent valuable structural motifs prevalent in natural products and bioactive molecules, and serve as versatile precursors of amine compounds via aziridine ring-opening reactions. Aziridinyl boronates, which integrate the distinct scaffold features of aziridines and α-amino-boronates, offer significant promise for both synthetic chemistry and drug discovery. However, methods to synthesize aziridinyl boronates remain very limited and are constrained by substrate scope, functional group tolerance, and synthetic accessibility. As a consequence, there is a lack of synthetic methods for direct transformation of widely available and diverse nitrogen nucleophiles into aziridinyl boronates.

### SUMMARY

The present disclosure is directed to boryl thianthrenium salt compounds, process for their preparation, and use for the synthesis of organoboron compounds.

In one embodiment, the present compounds may be represented by formula (I)

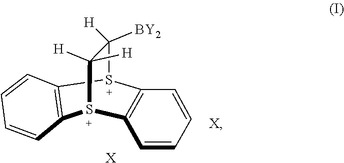

where X and Y are defined herein.

In another embodiment, the present disclosure provides compositions useful in the synthesis of organoboron compounds. In one aspect, the composition comprises a compound of formula (I) and a solvent.

In another embodiment, the present disclosure provides a method of preparing a boryl thianthrenium salt. The method comprises treating thianthrene 5-oxide or thianthrene with an alkenyl boronate 1:

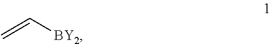

where Y is as defined herein.

In some aspects of alkenyl boronate 1, Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-NR³—C₁₋₁₂ alkylenyl-C(O)O—; R² is C₁₋₈ alkyl, C(O)—C₁₋₈ alkyl, or C(O)—C₁₋₈ alkyl-N(R³)₂; and R³ is hydrogen or C₁₋₄ alkyl.

In one aspect of the method of preparing a boryl thianthrenium salt, the boryl thianthrenium salt is a compound of formula (I).

In another aspect, the present disclosure provides for the synthesis of organoboron compounds using a boryl thianthrenium salt. In some aspects, the boryl thianthrenium salt is

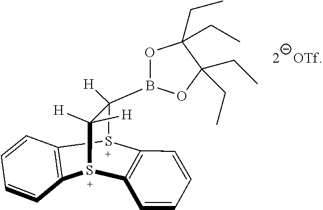

In one embodiment, a method of synthesizing an organoboron compound is provided. The method comprises contacting 3c with a compound comprising —NH₂.

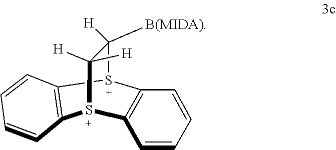

In some aspects, the compound comprising —NH₂ is an amine, a sulfonamide, or a sulfamide.

In other aspects, the method of synthesizing an organoboron compound comprises forming an aziridinyl borate.

In other aspects, the method of synthesizing an organoboron compound comprises opening and aziridine ring of the aziridinyl borate with a nucleophile.

### BRIEF DESCRIPTION OF THE FIGURES

FIG. 1 is an X-ray structure of boryl thianthrenium dication 3c.

FIG. 2 is an X-ray structure of compound 45.

FIG. 3 is an X-ray structure of compound 30.

FIG. 4 is a comparative ¹H NMR analysis of 1-octene, vinyl Bpin, and vinyl MIDA boronate.

FIG. 5 is cyclic voltammograms (CVs) of 1a, 1c, and 1-octene.

FIG. 6 is an X-ray structure of compound 60.

### DETAILED DESCRIPTION

The present disclosure describes boryl thianthrenium dicationic intermediates derived from vinyl boronates that serve as versatile building blocks for the synthesis of aziridinyl boronates with diverse nitrogen nucleophiles. The inherent susceptibility of boryl intermediates to deborylation presents a significant synthetic challenge. Importantly, boryl substituents provide new opportunities on tuning the reactivity and selectivity via their electric and steric effects.

The present disclosure describes the first synthesis of bench-stable boryl thianthrenium dication intermediates via chemical or electrochemical thianthrenation of vinyl boronates. The boryl thianthrenium dication unlocks a general, metal-free approach for the efficient and diastereoselective synthesis of aziridinyl boronates with diverse nitrogen nucleophiles. Key features of this strategy include: (i) exceptional selectivity for the mono-thianthrenium formation; (ii) broad substrate compatibility of nitrogen nucleophiles, including sulfonamides, sulfamates, alkyl amines, amino esters, and hydrazides; (ii) late-stage functionalization of drug molecules with excellent chemoselectivity and functional group tolerance; and (iv) high diasteroselectivity of boryl thianthrenium dication-enabled transition metal-free aziridination. This novel approach significantly broadens the range of aziridinyl boronates that are otherwise very challenging to access.

The N-methyliminodiacetic acid (MIDA) boryl group is very effective in suppressing undesired deborylation and promoting exclusive mono-adduct formation via a plausible [4+2]cycloaddition pathway. The unique boryl thianthrenium dication enables a transition-metal-free, chemo- and diastereoselective synthesis of aziridinyl boronates, utilizing a broad range of nitrogen nucleophiles. The method demonstrates remarkable generality, practicality, and functional group tolerance, as evidenced by its application to diverse substrates, including the late-stage modification of drug molecules. The strategic significance of this approach is further highlighted through multiple downstream transformations of aziridinyl boronates, offering new opportunities to synthesize synthetically challenging boron containing drug-like scaffolds.

### Definitions

Certain terms as used in the specification are intended to refer to the following definitions, as detailed below.

As used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used in the specification and the appended claims, unless specified to the contrary, the following terms have the meaning indicated:

The term “alkyl,” as used herein, refers to a saturated, straight or branched hydrocarbon chain radical. Representative examples of alkyl include, but are not limited to, methyl, ethyl, n-propyl, isopropyl, n-butyl, sec-butyl, isobutyl, tert-butyl, and the like.

In some instances, the number of carbon atoms in a moiety is indicated by the prefix “Cₓ-C_{y}” or “C_{x-y}” wherein x is the minimum and y is the maximum number of carbon atoms in the substituent. Thus, for example, “C₁-C₆ alkyl” or “C₁₋₆ alkyl” means an alkyl substituent containing from 1 to 6 carbon atoms and “C₁-C₃ alkyl” or “C₁₋₃ alkyl” means an alkyl substituent containing from 1 to 3 carbon atoms.

The term “alkylene” or “alkylenyl” means a divalent radical derived from a straight or branched, saturated hydrocarbon chain, for example, of 1 to 10 carbon atoms or of 1 to 6 carbon atoms (C₁₋₆ alkylenyl) or of 1 to 4 carbon atoms or of 1 to 3 carbon atoms (C₁₋₃ alkylenyl). Examples of C₁₋₆ alkylenyl include, but are not limited to, —CH₂—, —CH₂CH₂—, —C(CH₃)₂—CH₂CH₂CH₂—, —C(CH₃)₂—CH₂CH₂—, —CH₂CH₂CH₂CH₂—, and —CH₂CH(CH₃)CH₂—.

The term “aziridinyl borate” refers to an aziridine to which a boron atom is attached. The boron atom is attached to one or more oxygen atoms.

The term “borate” refers to a compound comprising a boron atom which is attached to one or more oxygen atoms.

The term “halide” refers to the negatively charged anion of Cl, Br, I, and F.

The term “ligand” refers to an ion or molecule with a functional group that can donate a pair of electrons, such as a Lewis base, to bind to another atom, forming a coordination complex. For example, a ligand which coordinates to a boron atom forms a boron complex. The ligand may be mono-dentate meaning that it donates on electron pair, or it may be bidentate meaning that it donates two electron pairs, the electron pairs belonging to two functional groups.

The term “mesylate” refers to the negatively charged anion of CH₃SO₂O⁻.

The term “organoboron compound” refers to a compound comprising at least one boron atom and at least one carbon atom.

The term “tosylate” refers to the negatively charged anion of CH₃C₄H₄SO₂O⁻.

The term “triflate” refers to the negatively charged anion of CF₃SO₂O⁻.

As used herein, the terms “including,” “containing,” and “comprising” are used in their open, non-limiting sense.

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

Except as otherwise noted, the methods and techniques of the present embodiments are generally performed according to conventional methods well known in the art and as described in various general and more specific references that are cited and discussed throughout the present specification. See, e.g., Loudon, Organic Chemistry, Fourth Edition, New York: Oxford University Press, 2002, pp. 360-361, 1084-1085; Smith and March, March's Advanced Organic Chemistry: Reactions, Mechanisms, and Structure, Fifth Edition, Wiley-Interscience, 2001.

Chemical nomenclature for compounds described herein has generally been derived using the commercially available ACD/Name 2014 (ACD/Labs) or ChemBioDraw Ultra 13.0 (Perkin Elmer).

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination. All combinations of the embodiments pertaining to the chemical groups represented by the variables are specifically embraced by the present disclosure and are disclosed herein just as if each and every combination was individually and explicitly disclosed, to the extent that such combinations embrace compounds that are stable compounds (i.e., compounds that can be isolated, characterized, and tested for biological activity). In addition, all subcombinations of the chemical groups listed in the embodiments describing such variables are also specifically embraced by the present disclosure and are disclosed herein just as if each and every such sub-combination of chemical groups was individually and explicitly disclosed herein.

### Compounds

In one embodiment, compounds of the present disclosure are represented by formula (I),

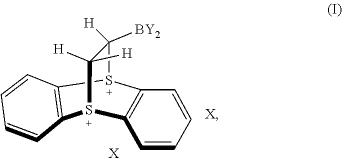

where each Y is a ligand; or wherein two Y combine to form a bidentate ligand; and each X is independently a negatively charged ion.

In some aspects of compounds of formula (I), Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-NR³—C₁₋₁₂ alkylenyl-C(O)O—; R² is C₁₋₈ alkyl, C(O)—C₁₋₈ alkyl, or C(O)—C₁₋₈ alkylenyl-N(R³)₂; and R³ is hydrogen or C₁₋₄ alkyl.

In other aspects of compounds of formula (I), two Y are combined to form

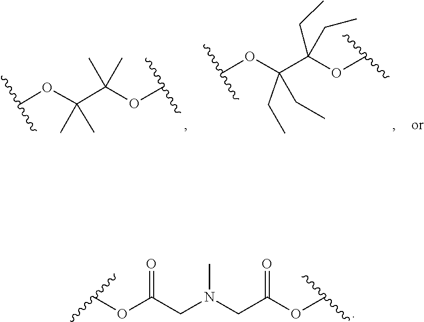

In other aspects of compounds of formula (I), BY₂ is:

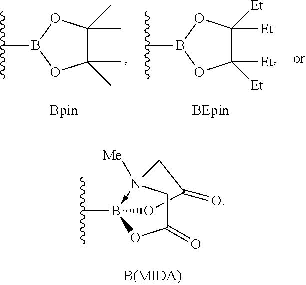

In some aspects of compounds of formula (I), each X is independently halide, triflate, mesylate, tosylate, [PF₆]⁻, [BF₄]⁻, [B(C₆F₅)₄]⁻, [ClO₄]⁻, or [SbF₆]⁻.

In some aspects of compounds of formula (I), each X is independently triflate, [PF₆]⁻, [BF₄]⁻, [B(C₆F₅)₄]⁻, [ClO₄]⁻, or [SbF₆]⁻.

In some aspects of compounds of formula (I), each X is independently triflate.

In some aspects of compounds of formula (I), each X is independently [PF₆]⁻.

In some aspects of compounds of formula (I), each X is independently [BF₄]⁻.

In some aspects of compounds of formula (I), each X is independently [B(C₆F₅)₄]⁻.

In some aspects of compounds of formula (I), each X is independently [ClO₄]⁻.

In some aspects of compounds of formula (I), each X is independently [SbF₆]⁻.

In other aspects of compounds of formula (I), two Y are combined to form

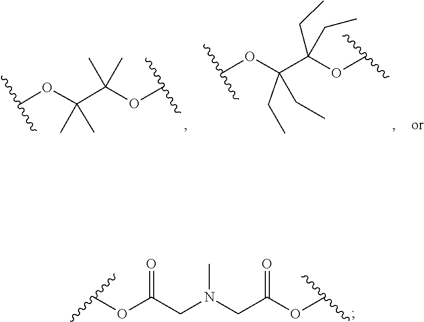

and
each X is independently halide, triflate, mesylate, tosylate, [PF₆]⁻, [BF₄]⁻, [B(C₆F₅)₄]⁻, [ClO₄]⁻, or [SbF₆]⁻.

In other aspects of compounds of formula (I), two Y are combined to form

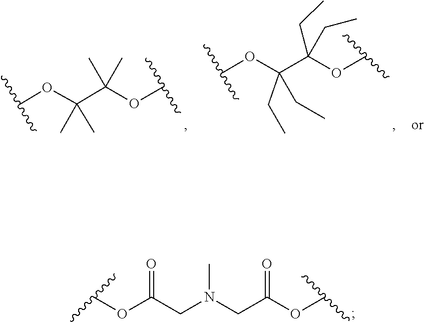

and
each X is independently triflate, [PF₆]⁻, [BF₄]⁻, [B(C₆F₅)₄]⁻, [ClO₄]⁻, or [SbF₆]⁻.

In other aspects of compounds of formula (I), two Y are combined to form

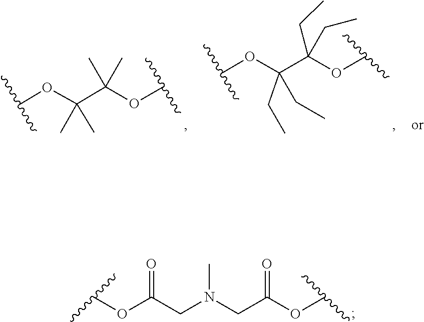

and
each X is triflate.

In some aspects of compounds of formula (I), two Y combine to form —O—C₁₋₁₂ alkylenyl-O—.

In one embodiment, compounds of the present disclosure are represented by formula (II),

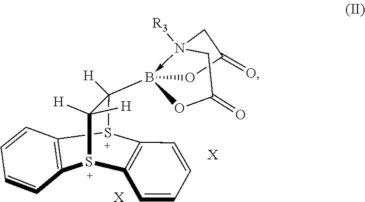

where R³ is C₁₋₄ alkyl, and each X is independently a negatively charged ion.

In some aspects of compounds of formula (II), R³ is methyl.

In some aspects of compounds of formula (II), each X is independently halide, triflate, mesylate, tosylate, [PF₆]⁻, [BF₄]⁻, [B(C₆F₅)₄]⁻, [ClO₄]⁻, or [SbF₆]⁻.

In some aspects of compounds of formula (II), each X is independently triflate, [PF₆]⁻, [BF₄]⁻, [B(C₆F₅)₄]⁻, [ClO₄]⁻, or [SbF₆]⁻.

In some aspects of compounds of formula (II), X is triflate.

In some aspects of compounds of formula (II), the compound is

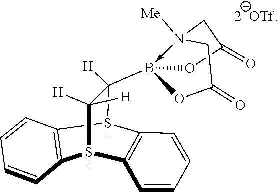

In one embodiment, compounds of the present disclosure are represented by formula (III),

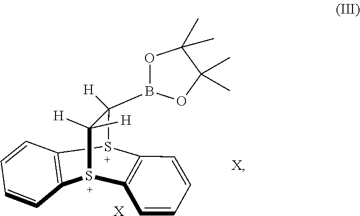

where each X is independently a negatively charged ion.

In some aspects of compounds of formula (III), each X is independently halide, triflate, mesylate, tosylate, [PF₆]⁻, [BF₄]⁻, [B(C₆F₅)₄]⁻, [ClO₄]⁻, or [SbF₆]⁻.

In some aspects of compounds of formula (III), each X is independently triflate, [PF₆]⁻, [BF₄]⁻, [B(C₆F₅)₄]⁻, [ClO₄]⁻, or [SbF₆]⁻.

In some aspects of compounds of formula (III), X is triflate.

In some aspects of compounds of formula (III), the compound is

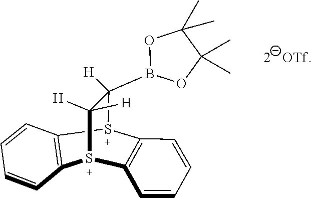

In one embodiment, compounds of the present disclosure are represented by formula (IV),

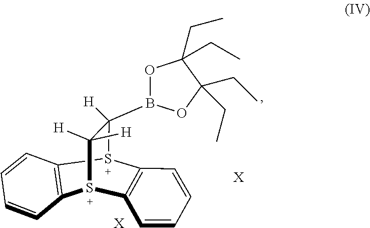

where each X is independently a negatively charged ion.

In some aspects of compounds of formula (IV), each X is independently halide, triflate, mesylate, tosylate, [PF₆]⁻, [BF₄]⁻, [B(C₆F₅)₄]⁻, [ClO₄]⁻, or [SbF₆]⁻.

In some aspects of compounds of formula (IV), each X is independently triflate, [PF₆]⁻, [BF₄]⁻, [B(C₆F₅)₄]⁻, [ClO₄]⁻, or [SbF₆]⁻.

In some aspects of compounds of formula (IV), X is triflate.

In some aspects of compounds of formula (IV), the compound is

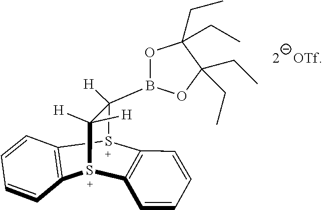

### Methods of Preparation

In one embodiment, a method of preparing a boryl thianthrenium salt is provided. The method comprises treating a thianthrene 5-oxide 2 or thianthrene (TT) with an alkenyl boronate 1 to form a boryl thianthrenium dication 3 as shown in Scheme 1. The reaction may be effected under chemical thianthrenation methods using thianthrene 5-oxide 2 or electrochemical thianthrenation methods using thianthrene (TT).

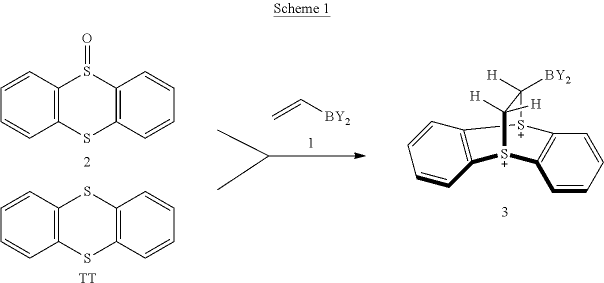

In the chemical thianthrenation method, any suitable ratio of alkenyl boronate 1 to thianthrene 5-oxide 2 may be used, including, for example a ratio of thianthrene 5-oxide 2 to alkenyl boronate 1 of about 5 to about 1 to 1; preferably about 4 to about 2 to 1; more preferably about 4 to about 3 to 1; even more preferably about 3.7 to about 3.2 to 1. In one embodiment, the ratio of thianthrene 5-oxide 2 to alkenyl boronate 1 is 0.3:1.

For the chemical thianthrenation methods using thianthrene 5-oxide 2, an acid is used in the reaction of thianthrene 5-oxide 2 and alkenyl boronate 1. Any suitable acids may be used. In some the acid is a Bronsted acid. Preferably the acid is triflic acid.

In addition, the chemical thianthrenation methods using thianthrene 5-oxide 2, also uses an acylating agent. Any suitable acylating agent may be used including acyl halides and acyl anhydrides. Preferably the acylating agent is triflic anhydride.

The reaction of thianthrene 5-oxide 2 and alkenyl boronate 1 in the presence of an acid and an acylating agent may take place in a suitable solvent at a suitable temperature. The reaction may be performed at or below ambient temperature, preferably below ambient temperature, more preferably between about −10 to about 10° C., even more preferably between about −5 to about 5° C., still more preferably at about 0° C. Any suitable solvent may be used, including, but not limited to acetonitrile.

The reaction of thianthrene 5-oxide 2 and alkenyl boronate 1 in the presence of an acid and an acylating agent may be performed for a suitable amount of time as indicted by reaction monitoring methods known to one skilled in the art including but not limited to thin layer chromatography, nuclear magnetic resonance (NMR), or other chromatography methods. In some instances, the reaction may be monitored to maximize the formation of the boryl thianthrenium dication 3 or a salt thereof. The reaction may also be monitored to minimize formation of undesired side products including but not limited to the deborylated vinyl thianthrenium product 4 or the bis-adduct 50a (Scheme 2).

### Scheme 2

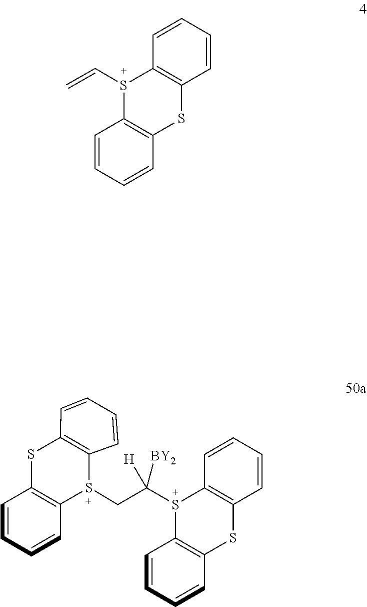

In addition to the chemical thianthrenation of alkenyl boronate 1 under acidic conditions, a sustainable and acid-free electrochemical thianthrenation approach was investigated. Electrochemistry has emerged as a cornerstone of sustainable organic synthesis, offering an environmentally friendly alternative to traditional chemical methods for oxidizing or reducing organic compounds. By leveraging electrons from a power supply to drive redox reactions, electrochemical methods reduce the need for stoichiometric chemical reagents, lower production costs, and promote sustainability by minimizing waste and energy consumption.

The utility of anodic oxidation of inexpensive thianthrene (TT) to form dicationic thianthrene adducts with alkenes, enabling diverse in situ transformations has been studied (Holst et al., Nature 2021, 596 (7870), 74-79; Wang et al. J. Am. Chem. Soc. 2021, 143 (51), 21503-21510; Holst et al. J. Am. Chem. Soc. 2023, 145 (15), 8299-8307; Kim et al., Angew. Chem. Int. Ed. 2023, 62 (21), e202303032). However, these methods generate a mixture of mono- and bis-adducts through two reactive species, thianthrene radical cation (TT⁺·), and thianthrene dication (TT²⁺) (Scheme 3), and have been primarily limited to alkyl-substituted alkenes. The present invention minimizes formation of the deborylated vinyl thianthrenium product 4 or the bis-adduct 50a (Scheme 2).

### Scheme 3

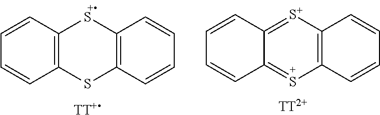

The electrochemical thianthrenation of TT with alkenyl boronate 1 was conducted using a divided cell setup with RVC electrodes RVC(+)/RVC(−) with a current from about 2 mA to about 15 mA; preferably about 4 mA to about 12 mA.

In the electrochemical thianthrenation method, any suitable ratio of alkenyl boronate 1 to thianthrene may be used, including, for example a ratio of thianthrene to alkenyl boronate 1 of about 2 to about 1 to 1; preferably about 1.7 to about 1.3 to 1; more preferably about 1.6 to about 1.4 to 1. In one embodiment, the ratio of thianthrene to alkenyl boronate 1 is 1.5:1.

In the electrochemical thianthrenation method, may take place in a suitable solvent at a suitable temperature. The reaction may be performed between about 0 to about 80° C., preferably between about 10 to about 40° C., even more preferably between about 20 to about 55° C., still more preferably at about 23° C. Any suitable solvent may be used, including, but not limited to acetonitrile.

The electrochemical reaction of thianthrene and alkenyl boronate 1 may be performed for a suitable amount of time as indicted by reaction monitoring methods known to one skilled in the art including but not limited to thin layer chromatography, nuclear magnetic resonance (NMR), or other chromatography methods. In some instances, the reaction may be monitored to maximize the formation of the boryl thianthrenium dication 3 or a salt thereof. The reaction may also be monitored to minimize formation of undesired side products including but not limited to the deborylated vinyl thianthrenium product 4 or the bis-adduct 50a (Scheme 2).

In some aspects of the method of preparing a boryl thianthrenium salt, the boryl thianthrenium salt is of formula (I),

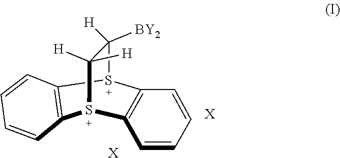

where each Y is a ligand; or wherein two Y combine to form a bidentate ligand; and each X is independently a negatively charged ion.

In some aspects, of the method of preparing a boryl thianthrenium salt of formula (I), Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-NR³—C₁₋₁₂ alkylenyl-C(O)O—; R² is C₁₋₈ alkyl, C(O)—C₁₋₈ alkyl, or C(O)—C₁₋₈ alkyl-N(R³)₂; and R³ is hydrogen or C₁₋₄ alkyl.

In some aspects of the method of preparing a boryl thianthrenium salt of formula (I), two Y are combined to form:

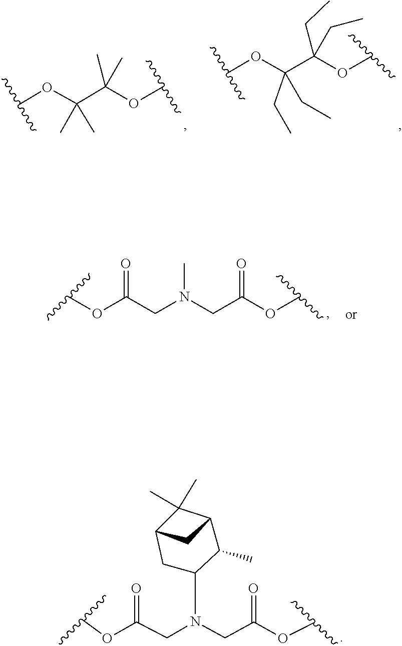

In some aspects of the method of preparing a boryl thianthrenium salt of formula (I), two Y are combined to form:

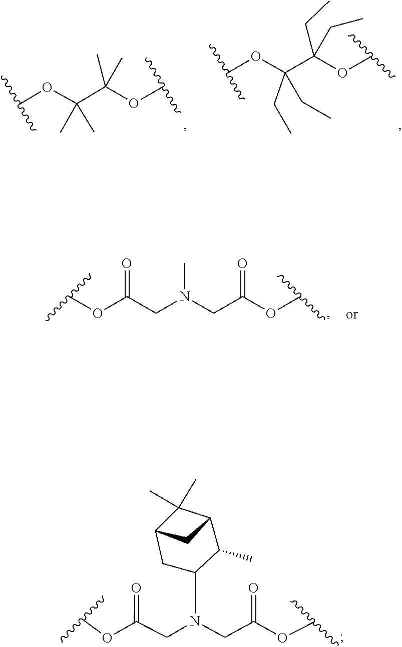

and each X is independently halide, triflate, mesylate, tosylate, [PF₆]⁻, [BF₄]⁻, [B(C₆F₅)₄]⁻, [ClO₄]⁻, or [SbF₆]⁻.

In some aspects of the method of preparing a boryl thianthrenium salt of formula (I), two Y are combined to form:

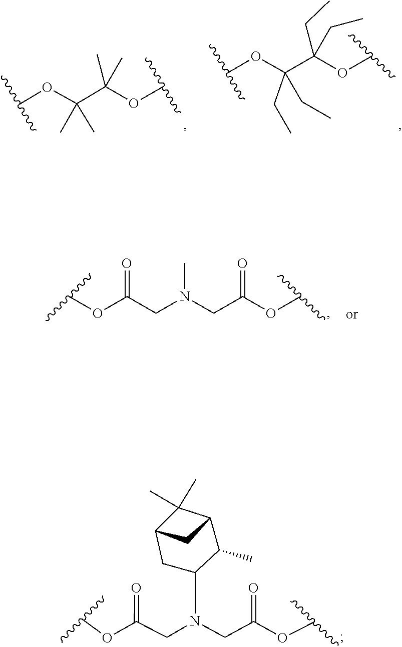

and each X is independently triflate, [PF₆]⁻, [BF₄]⁻, [B(C₆F₅)₄]⁻, [ClO₄]⁻, or [SbF₆]⁻.

In some aspects of the method of preparing a boryl thianthrenium salt, the boryl thianthrenium salt is of formula (I), BY₂ is:

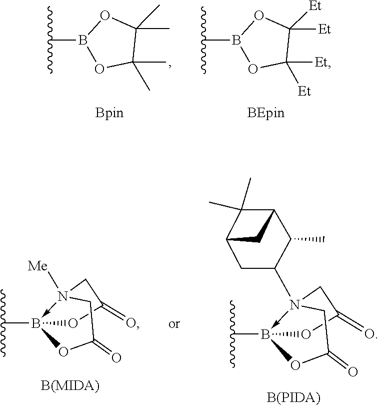

In some aspects of the method of preparing a boryl thianthrenium salt, the boryl thianthrenium salt of formula (I) is:

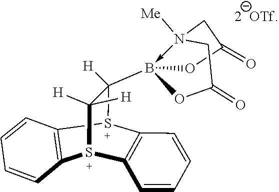

In some aspects of the method of preparing a boryl thianthrenium salt, the boryl thianthrenium salt of formula (I) is:

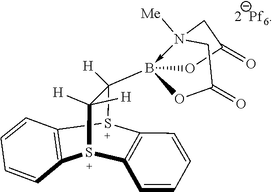

In some aspects of the method of preparing a boryl thianthrenium salt, the alkenyl boronate is alkenyl boronate 1:

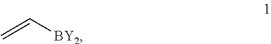

where each Y is a ligand; or wherein two Y combine to form a bidentate ligand.

In some aspects of the method of preparing a boryl thianthrenium salt, in alkenyl boronate of 1, Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-NR³—C₁₋₁₂ alkylenyl-C(O)O—; R² is C₁₋₈ alkyl, C(O)—C₁₋₈ alkyl, or C(O)—C₁₋₈ alkyl-N(R³)₂; and R³ is hydrogen or C₁₋₄ alkyl.

In some aspects of the method of preparing a boryl thianthrenium salt, in alkenyl boronate 1, two Y of alkenyl boronate 1 are combined to form

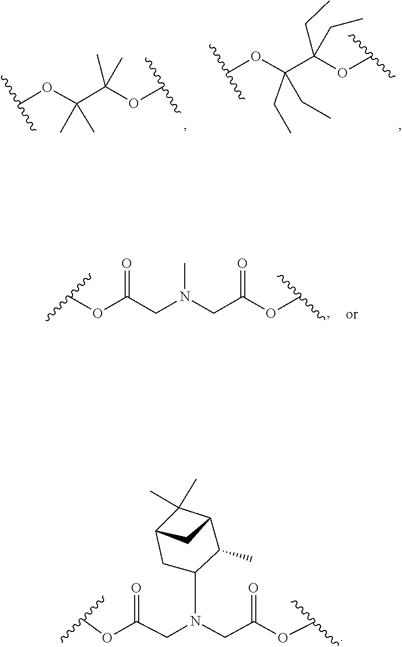

In some aspects of the method of preparing a boryl thianthrenium salt, in alkenyl boronate of formula 1, BY₂ is

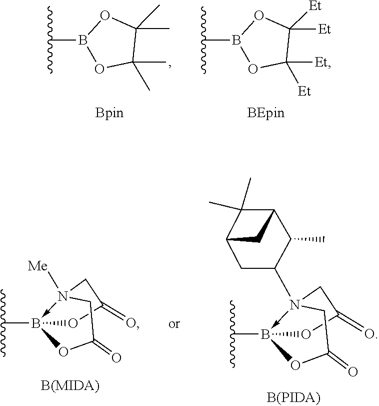

In some aspects of the method of preparing a boryl thianthrenium salt, the alkenyl boronate reacts with thianthrene 5-oxide or thianthrene via a [4+2] cycloaddition.

In some aspects of the method of preparing a boryl thianthrenium salt, the alkenyl boronate reacts with thianthrene 5-oxide via a [4+2] cycloaddition.

In some aspects of the method of preparing a boryl thianthrenium salt, the alkenyl boronate reacts with thianthrene via a [4+2] cycloaddition.

In some aspects of the method of preparing a boryl thianthrenium salt, method comprises treating a thianthrene 5-oxide with an alkenyl boronate in the presence of an acid.

In some aspects of the method of preparing a boryl thianthrenium salt, method comprises treating a thianthrene 5-oxide with an alkenyl boronate in the presence of triflic acid.

Boryl thianthrenium salts 4c and 5c may also be synthesized as shown in Scheme 4.

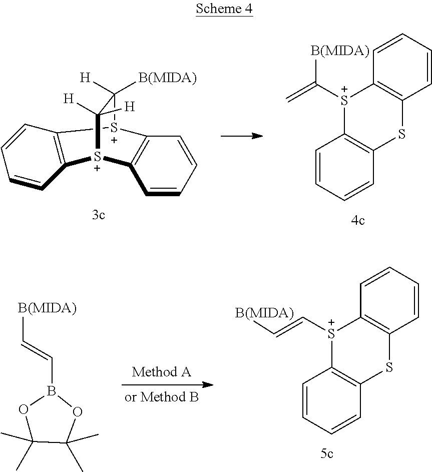

As shown in Scheme 4, boryl thianthrenium salt 4c may be prepared from 3c using a base in yields up to 80%. In some aspects, the counterion of 4c may be halide, triflate, mesylate, tosylate, [PF₆]⁻, [BF₄]⁻, [B(C₆F₅)₄]⁻, [ClO₄]⁻, or [SbF₆]⁻; preferably triflate, [PF₆]⁻, [BF₄]⁻, [B(C₆F₅)₄]⁻, [ClO₄]⁻, or [SbF₆]⁻.

As shown in Scheme 4, boryl thianthrenium salt 5c may be prepared from the pinacol boronate using either Method A or Method B. In some aspects, the counterion of 5c may be halide, triflate, mesylate, tosylate, [PF₆]⁻, [BF₄]⁻, [B(C₆F₅)₄]⁻, [ClO₄]⁻, or [SbF₆]⁻; preferably triflate, [PF₆]⁻, [BF₄]⁻, [B(C₆F₅)₄]⁻, [ClO₄]⁻, or [SbF₆]⁻.

Additionally, chiral boryl thianthrenium salts 3d, ent-3d, 5d, and ent-5d may be prepared for use in asymmetric synthesis of chiral boron-containing compounds as shown in Scheme 5.

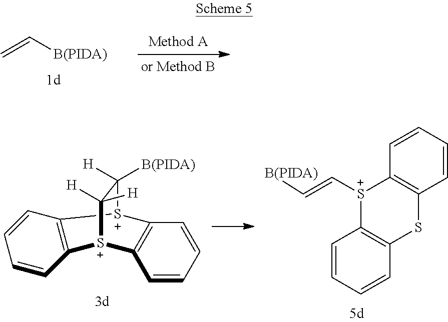

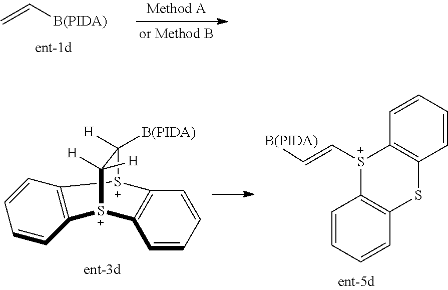

Boryl dication 3d may be prepared from 1d using Method A or B in yields up to 80%. Treatment with a base affords chiral boryl thianthrenium salt 5d. In some aspects, the counterion of 3d may be halide, triflate, mesylate, tosylate, [PF₆]⁻, [BF₄]⁻, [B(C₆F₅)₄]⁻, [ClO₄]⁻, or [SbF₆]; preferably triflate, [PF₆]⁻, [BF₄]⁻, [B(C₆F₅)₄]⁻, [ClO₄]⁻, or [SbF₆]⁻. In some aspects, the counterion of 5d may be halide, triflate, mesylate, tosylate, [PF₆]⁻, [BF₄]⁻, [B(C₆F₅)₄]⁻, [ClO₄]⁻, or [SbF₆]; preferably triflate, [PF₆]⁻, [BF₄]⁻, [B(C₆F₅)₄]⁻, [ClO₄]⁻, or [SbF₆]⁻. In a similar manner the enantiomer ent-3d may be prepared by starting with ent-1d.

In one embodiment, thianthrene 5-oxide 2 or thianthrene (TT) with an alkenyl boronate 1e (where R¹⁰ is C₁₋₈ alkyl; and each Y is a ligand; or wherein two Y combine to form a bidentate ligand) to form a boryl thianthrenium dication 4d as shown in Scheme 6. The reaction may be effected under chemical thianthrenation methods using thianthrene 5-oxide 2 or electrochemical thianthrenation methods using thianthrene (TT).

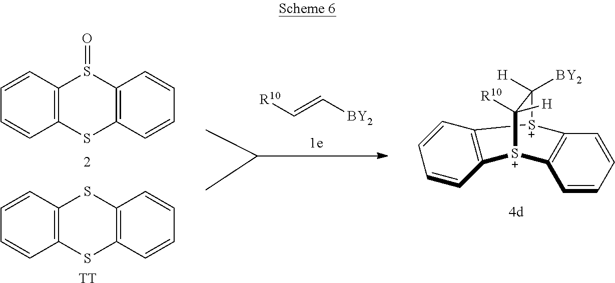

In one aspect of compound 4d, R10 is C₁₋₈ alkyl; Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-NR³—C₁₋₁₂ alkylenyl-C(O)O—; R² is C₁₋₈ alkyl, C(O)—C₁₋₈ alkyl, or C(O)—C₁₋₈ alkyl-N(R³)₂; and R³ is hydrogen or C₁₋₄ alkyl.

In one aspect of compound 4d, two Y are combined to form:

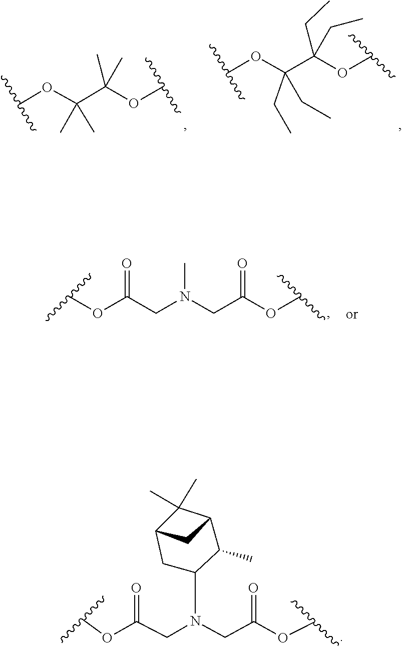

In one aspect of compound 4d, BY₂ is:

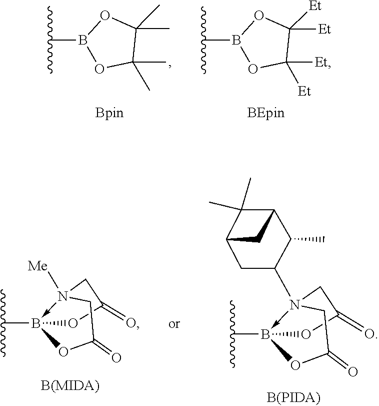

In one aspect of compound 4d, BY₂ is:

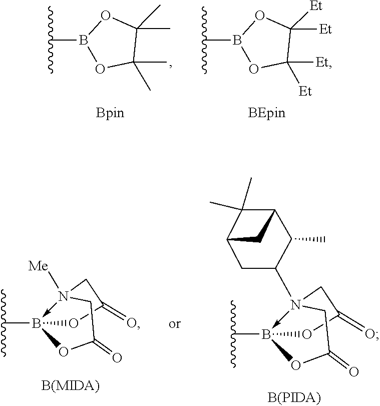

and Compound 4d has a counterion which is halide, triflate, mesylate, tosylate, [PF₆]⁻, [BF₄]⁻, [B(C₆F₅)₄]⁻, [ClO₄]⁻, or [SbF₆]⁻; preferably triflate, [PF₆]⁻, [BF₄]⁻, [B(C₆F₅)₄]⁻, [ClO₄]⁻, or [SbF₆]⁻.

### Compositions

In another aspect, the present disclosure provides compositions that are useful in the chemical synthesis comprising a solvent and a compound of formula (I),

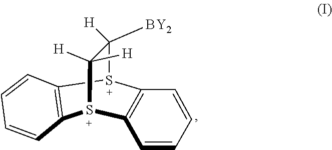

where each Y is a ligand; or wherein two Y combine to form a bidentate ligand; and each X is independently a negatively charged ion.

The term “composition” as used herein is intended to encompass a product comprising the specified ingredients in the specified amounts, as well as any product which results, directly or indirectly, from combination of the specified ingredients in the specified amounts.

In some aspects, the solvent of the composition is any suitable solvent that dissolves, partially dissolves, slurries, suspends, or otherwise allows the composition of formula (I) to react in a chemical reaction. In some aspects the solvent is acetonitrile, tetrahydrofuran, dimethyl sulfoxide, methyl tert-butyl ether, and the like. Preferably, the solvent is acetonitrile.

In some aspects, the composition comprises a solvent and a compound of formula (II),

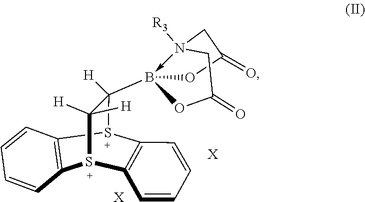

where R³ is C₁₋₄ alkyl, and each X is independently a negatively charged ion.

In some aspects of the composition comprising formula (II), each X is independently halide, triflate, mesylate, tosylate, [PF₆]⁻, [BF₄]⁻, [B(C₆F₅)₄]⁻, [ClO₄]⁻, or [SbF₆]⁻.

In some aspects of the composition comprising formula (II), each X is independently triflate, [PF₆]⁻, [BF₄]⁻, [B(C₆F₅)₄]⁻, [ClO₄]⁻, or [SbF₆]⁻.

In some aspects, the composition comprises a solvent and the compound:

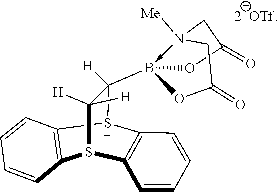

In some aspects, the composition comprises a solvent and the compound:

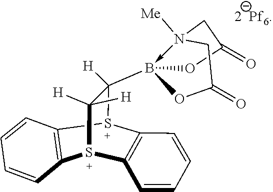

### METHODS OF USE

In one embodiment, a method of synthesizing an organoboron compound using a boryl thianthrenium salt is provided. In particular, the boryl thianthrenium dication 3c or 3d is used in the synthesis of the organoboron compound.

The boryl thianthrenium dication 3d may be the triflate salt:

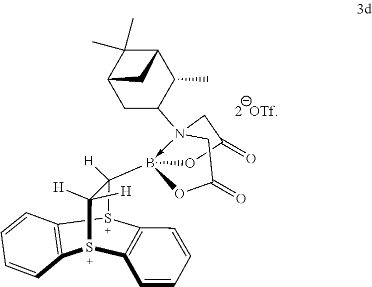

The boryl thianthrenium dication 3d may be the PF₆⁻ salt:

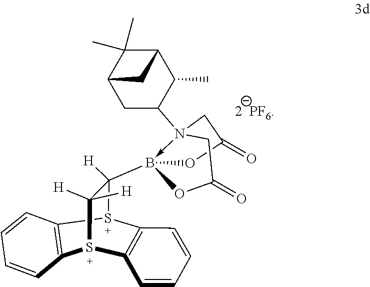

The boryl thianthrenium dication 3c may be the triflate salt:

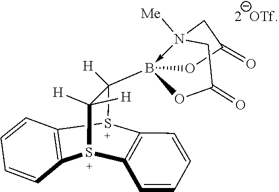

The boryl thianthrenium dication 3c may be the PF₆⁻ salt:

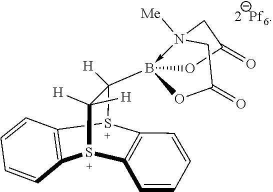

The triflate of boryl thianthrenium dication 3c

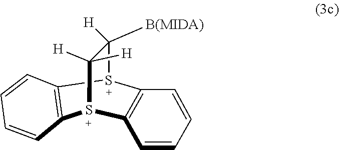

was obtained as the triflate salt, as a solid, is bench-stable, and can be stored for at least several months without obvious decomposition. This high stability, combined with its straightforward preparation and handling, highlights the practicality of this compound for broader synthetic applications, marking a significant milestone in boryl cation chemistry and organothianthrenium chemistry.

In one aspect of the method of synthesizing an organoboron compound, the method comprises contacting 3c,

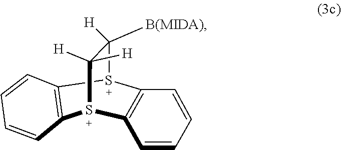

with a compound comprising —NH₂.

In one aspect of the method of synthesizing an organoboron compound, the method comprises contacting 3d,

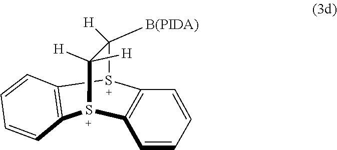

with a compound comprising —NH₂.

To evaluate the synthetic utility of boryl thianthrenium dication 3c, celecoxib and 3c were investigated as model substrates (Scheme 7). The desired N-tosyl aziridinyl MIDA boronate 5 was formed in excellent yield (94%) using potassium carbonate (5.0 eq.) as the base in dichloromethane (DCM, 0.1 M) at ambient temperature (Table 1, entry 1). Substituting potassium carbonate with cesium carbonate or potassium phosphate yielded 5 with comparable yields of 93% and 90%, respectively (entries 2 and 3). Employing a weaker base such as sodium bicarbonate resulted in a significantly reduced yield of 23% (entry 4). Using a stronger base like sodium tert-butoxide afforded 5 in only 18% (entry 5). The effect of solvents on the reaction were evaluated. The transformation proceeded smoothly in acetonitrile, THF, and DMF, delivering the desired product 5 in yields ranging from 75-90% (entries 6-8). However, when DMSO was used as the solvent, the yield dropped to 33%. To demonstrate the scalability, a gram-scale synthesis of 5 was conducted under the optimized conditions (potassium carbonate as base in DCM), affording 3.62 g of 5 in 92% isolated yield (entry 10). The ease of scaling up further underscores the practicality and robustness of this methodology.

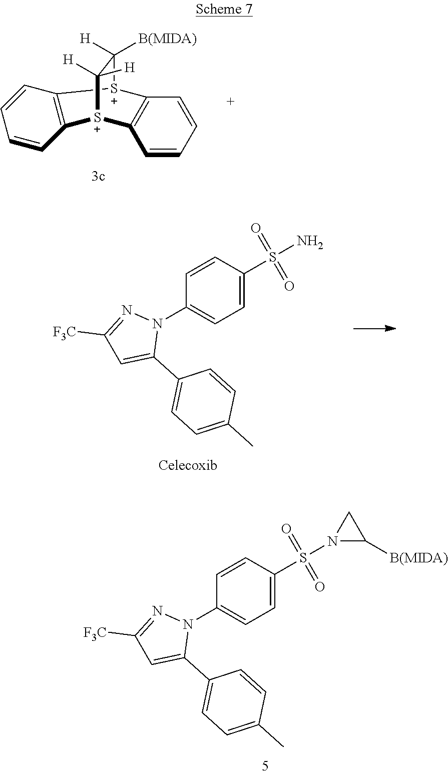

TABLE 1
Optimization of reaction conditions of 3c and Celecoxib

| | | | 5 (% |
|---|---|---|---|
| Entry | Base | Solvent | Yield)^{a} |
| 1 | K₂CO₃ | DCM | 94 |
| | | | (90^{b}) |
| 2 | Cs₂CO₃ | DCM | 93 |
| 3 | K₃PO₄ | DCM | 90 |
| 4 | NaHCO₃ | DCM | 23 |
| 5 | NaOtBu | DCM | 18 |
| 6 | K₂CO₃ | MeCN | 90 |
| 7 | K₂CO₃ | THF | 81 |
| 8 | K₂CO₃ | DMF | 75 |
| 9 | K₂CO₃ | DMSO | 33 |
| 10 | K₂CO₃ | DCM | 32^{c} |
| | | | (3.62 g) |

The reaction was conducted using 3c (0.2 mmol, 1.0 eq.), celecoxib (1.2 eq.), and base (5 eq.) in solvent (2 mL) at 23° C. for 14 h.
^{a}NMR yield;
^{b}isolated yield;
^{c}gram-scale synthesis using 7 mmol of 3c.

In some aspects, the method of synthesizing an organoboron compound comprises contacting 3c with a compound comprising —NH₂ in the presence of a base. In some aspects, the base is potassium carbonate, cesium carbonate, sodium bicarbonate, potassium phosphate, or sodium tert-butoxide; preferably the base is potassium carbonate, cesium carbonate, or potassium phosphate; more preferably, the base is potassium carbonate.

In some aspects, the method of synthesizing an organoboron compound comprises contacting 3c with a compound comprising —NH₂ in the presence of a base and a solvent. In some aspects, the solvent is dichloromethane, acetonitrile, tetrahydrofuran, N,N-dimethylformamide, or dimethyl sulfoxide; preferably dichloromethane, acetonitrile, tetrahydrofuran, or N,N-dimethylformamide; more preferably dichloromethane.

In some aspects, the method of synthesizing an organoboron compound comprises contacting 3c with a compound comprising —NH₂ in the presence of a base and a solvent. In some aspects, the base is potassium carbonate, cesium carbonate, sodium bicarbonate, potassium phosphate, or sodium tert-butoxide; and the solvent is dichloromethane, acetonitrile, tetrahydrofuran, N,N-dimethylformamide, or dimethyl sulfoxide; preferably the base is potassium carbonate, cesium carbonate, or potassium phosphate; and the solvent is dichloromethane, acetonitrile, tetrahydrofuran, or N,N-dimethylformamide; more preferably the base is potassium carbonate and the solvent is dichloromethane.

The versatility and robustness of the metal-free aziridination protocol was evaluated by synthesizing aziridinyl boronates using a variety of nitrogen nucleophiles. The reactivity of a broad range of sulfonamides was examined as both sulfonamides and sulfonamide boronic acids constitute important classes of drugs and bioactive molecules. As shown in Table 2, aryl sulfonamides bearing electron-donating groups, such as acetamide 6, amino 7, and methyl 8, as well as electron-withdrawing groups, including ester 9, nitro (10 and 11), bromide 12, and chloride 13, were all compatible with the transformation, affording the corresponding aziridinyl boronates in good to excellent yields. Heteroaryl sulfonamides, such as 14 and 15, as well as aliphatic sulfonamides (16 and 17), were similarly well-suited to this transformation, delivering aziridinyl boronates. Sulfamides, including 18, 19, and doripenem sidechain 20, underwent aziridination to afford aziridinyl boronates in good yields, demonstrating the broad applicability of the reaction.

Additional nitrogen nucleophiles were investigated including amines and amino acids as shown in Table 2. N-Alkyl aziridinyl boronates were readily synthesized from a wide range of amine nucleophiles by using Cs₂CO₃ as a base in acetonitrile at room temperature. Benzyl amines, heterobenzylic amines, and propargyl amine underwent efficient aziridination, furnishing desired aziridines 21-32. Remarkably, enantioenriched aziridines were readily obtained by the aziridination reaction of commercially available chiral amines, affording 31 and 32 in 61% yield with excellent (>20:1) diastereomeric ratio (dr) values. The absolute configuration of 31 was unambiguously confirmed via X-ray crystallographic analysis. Notably, tryptamine, containing a potentially competing unprotected indole group, underwent successful aziridination to yield 33. Sterically congested bicyclo[1.1.1]pentane (BCP) amine, a bioisostere of para-substituted benzene with growing relevance in medicinal chemistry, proceeded smoothly to produce the corresponding BCP aziridine 34 in 71% yield. BCP aziridines offer a novel scaffold and building blocks for BCP-based drug discovery. Furthermore, amino acid derivatives, including α-amino esters and p-amino esters, were also well tolerated under these conditions, delivering aziridinyl boronates 35-38 with excellent diastereoselectivity. Notably, substrates with acidic protons, such as aniline (7), unprotected indole (33), NH-amides (6, 37), NH-sulfamides (19), and terminal alkynes (32), were efficiently converted into aziridinyl boronates, underscoring the mildness of the reaction conditions. This metal-free aziridination exhibited exceptional functional group tolerance and high chemo-/stereo-selectivity, enabling access to aziridinyl boronates that were previously inaccessible.

TABLE 2
Aziridination with boryl thianthrenium dication 3c.

| No. | Structure | Y^{a} |
|---|---|---|
| 6 | 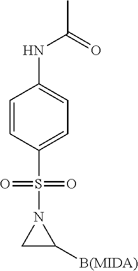 | 60^{b} |
| 7 | 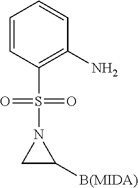 | 55^{b} |
| 8 | 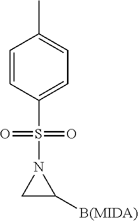 | 72^{b} |
| 9 | 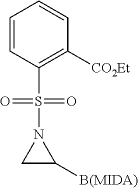 | 69^{b} |
| 10 | 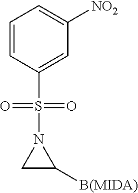 | 88^{b} |
| 11 | 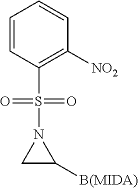 | 75^{b} |
| 12 | 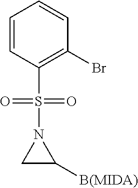 | 70^{b} |
| 13 | 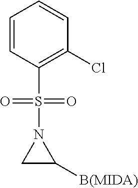 | 78^{b} |
| 14 | 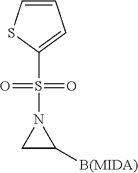 | 70^{b} |
| 15 | 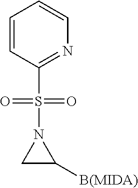 | 45^{b} |
| 16 | 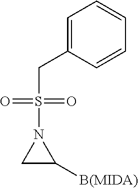 | 61^{b} |
| 17 | 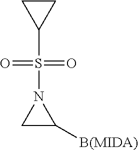 | 75^{b} |
| 18 | 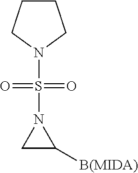 | 75^{b} |
| 19 | 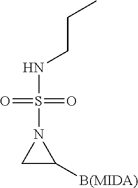 | 67^{b} |
| 20 | 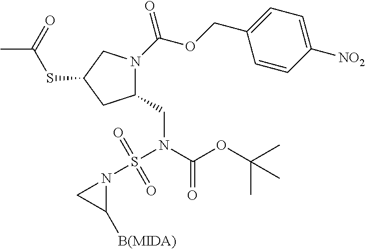 | 68^{b} |
| 21 | 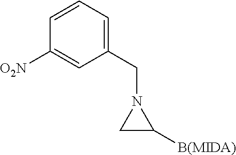 | 73^{c} |
| 22 | 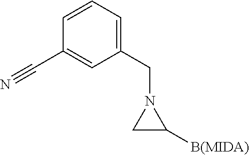 | 45^{c} |
| 23 | 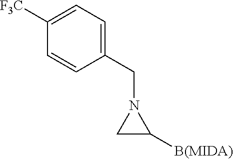 | 68^{c} |
| 24 | 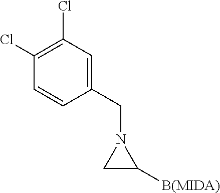 | 61^{c} |
| 25 | 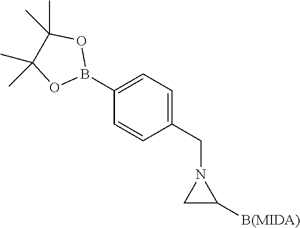 | 61^{c} |
| 26 | 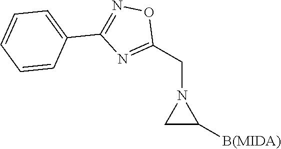 | 55^{c} |
| 27 | 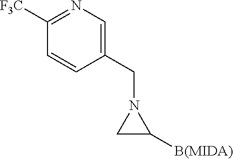 | 62^{c} |
| 28 | 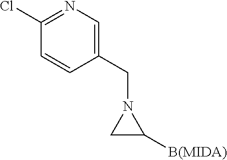 | 75^{c} |
| 29 | 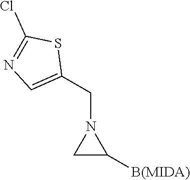 | 78^{c} |
| 30 | 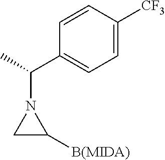 | 61^{c} (>20) |
| 31 | 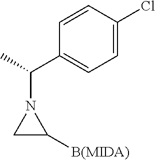 | 61^{c} (>20) |
| 32 | 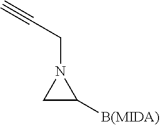 | 58^{c} |
| 33 | 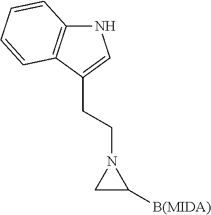 | 54^{c} |
| 34 | 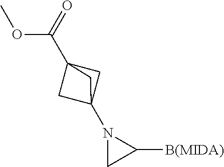 | 71^{c} |
| 35 | 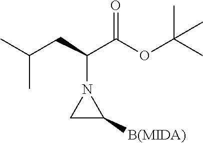 | 72^{c} (>20) |
| 36 | 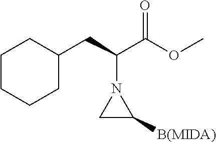 | 60^{c} (>20) |
| 37 | 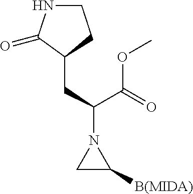 | 69^{c} (>20) |
| 38 | 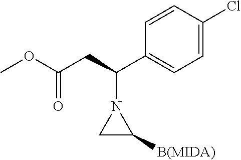 | 68^{c} 85:15 |

^{a}Y = yield of isolated aziridinyl boronate product (diasteromeric ratio);
^{b}reaction, unless otherwise noted, was conducted using 3c (0.3 mmol, 1.0 eq.), RNH₂ (1.2 eq.), and K₂CO₃ (5 eq.) in DCM 3 mL at 23° C. for 14 h;
^{c}The reaction was conducted using 3c (0.3 mmol, 1.0 eq.), RNH₂ (1.2 eq.), and Cs₂CO₃ (3 eq.) in MeCN 3 mL at 23° C. for 14 h.

In some aspects of the method of synthesizing an organoboron compound, the method comprises contacting 3c with a compound comprising −NH₂, where the compound comprising —NH₂ is an amine, a sulfonamide, or a sulfamide. In some aspects the compound comprising —NH₂ is an amine. In other aspects the compound comprising —NH₂ is a sulfonamide. In yet other aspects, the compound comprising —NH₂ is a sulfamide.

In some aspects of the method of synthesizing an organoboron compound, the method comprises contacting 3c with a compound comprising —NH₂; and forming an aziridine; preferably forming an aziridinyl borate.

In some aspects of the method of synthesizing an organoboron compound, the method comprises forming an aziridine by contacting 3c with a compound comprising —NH₂.

In some aspects of the method of synthesizing an organoboron compound, the method comprises forming an aziridine by contacting 3c with a compound comprising —NH₂ in the presence of a base. Preferably the base is potassium carbonate, cesium carbonate, sodium bicarbonate, potassium phosphate, or sodium tert-butoxide; more preferably the base is potassium carbonate, cesium carbonate, or potassium phosphate; even more preferably, the base is potassium carbonate.

In other aspects of the method of synthesizing an organoboron compound, the method comprises forming an aziridinyl borate by contacting 3c with a compound comprising —NH₂.

In some aspects of the method of synthesizing an organoboron compound, the method comprises forming an aziridinyl borate by contacting 3c with a compound comprising —NH₂ in the presence of a base. Preferably the base is potassium carbonate, cesium carbonate, sodium bicarbonate, potassium phosphate, or sodium tert-butoxide; more preferably the base is potassium carbonate, cesium carbonate, or potassium phosphate; even more preferably, the base is potassium carbonate.

The synthetic utility of this method is further demonstrated through the late-stage functionalization of various drug molecules. The mild conditions, coupled with excellent functional group tolerance, allowed the successful modification of a wide range of sulfonamide and sulfamate drugs, including celecoxib, hydrochlorothiazide, pritelivir, valdecoxib, indapamide, sulpiride, zonisamide, and topiramate, affording corresponding boryl aziridine derivatives 5, and 39-45 in yields ranging from 60% to 92% (Table 3). Notably, the aziridination of topiramate, a widely used anti-convulsant and nerve pain drug, yielded 45 with a >20:1 dr, and its absolute configuration was confirmed via X-ray crystallography (CCDC 2414411).

In addition to sulfonamide-based drugs, this method also proved effective for aliphatic primary amine drugs. For example, linagliptin and tranylcypromine were readily converted to their boryl aziridine analogs 46-48. Interestingly, isoniazid, a first-line tuberculosis treatment containing a hydrazide motif, underwent successful aziridination to yield 49. It should be noted that heterocyclic compounds are ubiquitous in biologically active molecules, but their susceptibility to oxidation and potential to poison transition-metal catalysts often complicate their functionalization in traditional aziridination reactions. In contrast, this boryl thianthrenium dication-enabled methodology offers several distinct advantages: i) transition metal-free conditions, ii) oxidant-free in the aziridination step, iii) broad functional group tolerance, and iv) excellent chemo- and diastereoselectivity. This robustness enabled the selective conversion of commercially available diverse nitrogen nucleophiles bearing heteroaromatic or saturated heterocyclic groups into aziridinyl boronates in a single step, providing an attractive strategy for late-stage functionalization and the development of potential boron-containing therapeutic candidates.

TABLE 3
Late-stage functionalization of drug molecules from 3c.

| No. | Structure | Y^{a} |
|---|---|---|
| 5 | 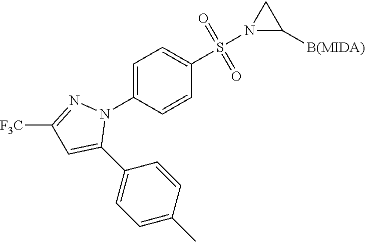 | 92^{c} |
| 39 | 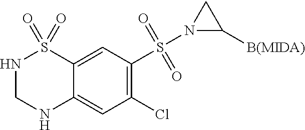 | 60^{c} |
| 40 | 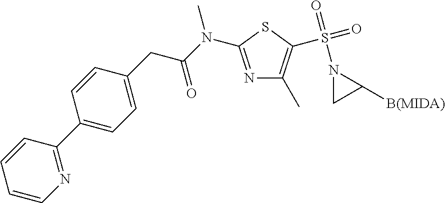 | 72^{c} |
| 41 | 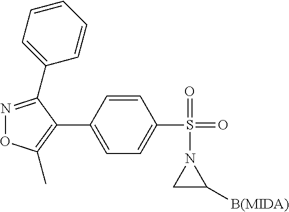 | 76^{c} |
| 42 | 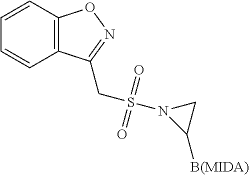 | 73^{c} |
| 43 | 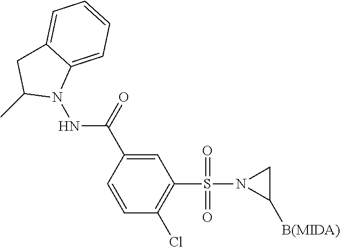 | 76^{c} |
| 44 | 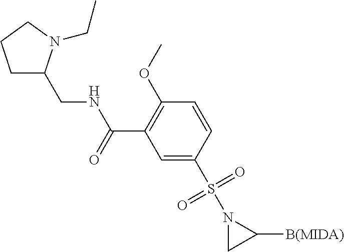 | 71^{c} |
| 45 | 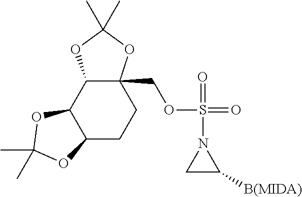 | 66^{c} |
| 46 | 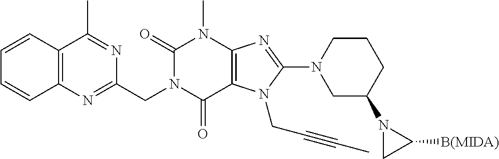 | 66 (9:1)^{c} |
| 47 | 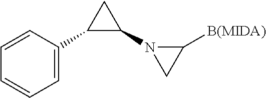 | 60 (1:1)^{c} |
| 48 | 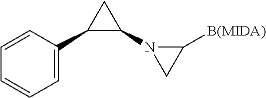 | 62 (>20)^{c} |
| 49 | 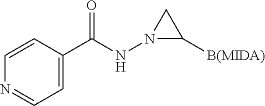 | 40 |

^{a}Y = % yield (diastereomeric ratio);
^{b}reaction was conducted using 3c (0.3 mmol, 1.0 eq.), RNH₂ (1.2 eq.), and K₂CO₃ (5 eq.) in DCM 3 mL at 23° C. for 14 h;
^{c}reaction was conducted using 3c (0.3 mmol, 1.0 eq.), RNH₂ (1.2 eq.), and Cs₂CO₃ (3 eq.) in MeCN 3 mL at 23° C. for 14 h.

TABLE 4
Asymmetric late-stage aziridination of drug molecules from 3d, ent-3d, 5d and ent-
5d.

| No. | Structure | Yield (%) |
|---|---|---|
| 50 | 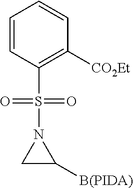 | 74 dr >20 |
| 51 | 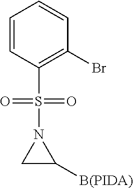 | 69 dr >20 |
| 52 | 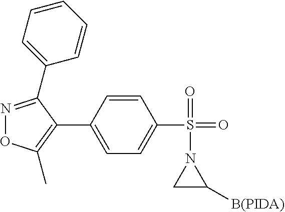 | 68 dr >20 |
| 53 | 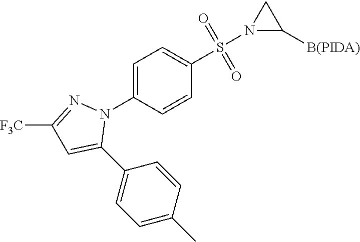 | 64 dr >20 |
| ent-53 | 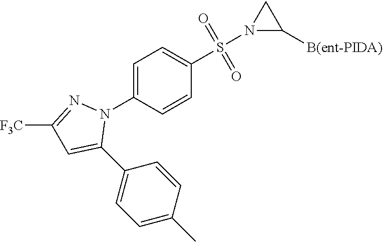 | 62 dr >20 |
| 54 | 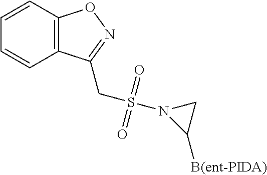 | 68 dr >20 |
| 55 | 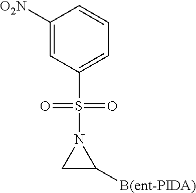 | 60 dr >20 |
| 56 | 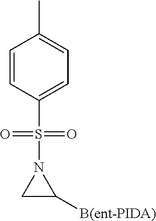 | 62 dr >20 |

Scheme 8. Representative examples for synthesis of boron-containing cyclopropanes and dihydrofurans, and late-stage functionalization of drug molecules from 3 and 4e.

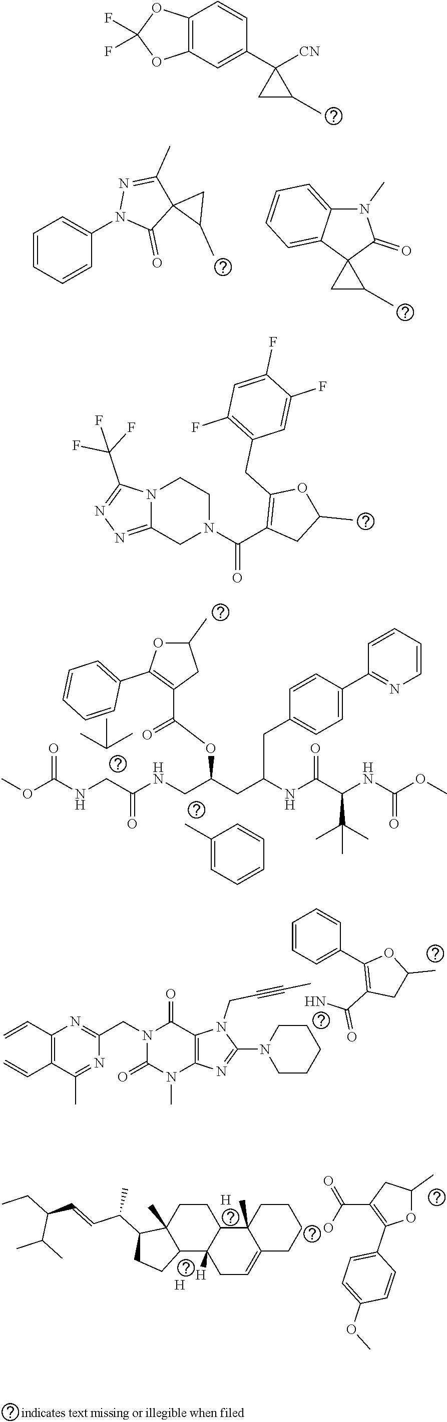

Scheme 9. Representative examples of the boron-containing products, and late-stage functionalization of drug molecules from 3 and 4e.

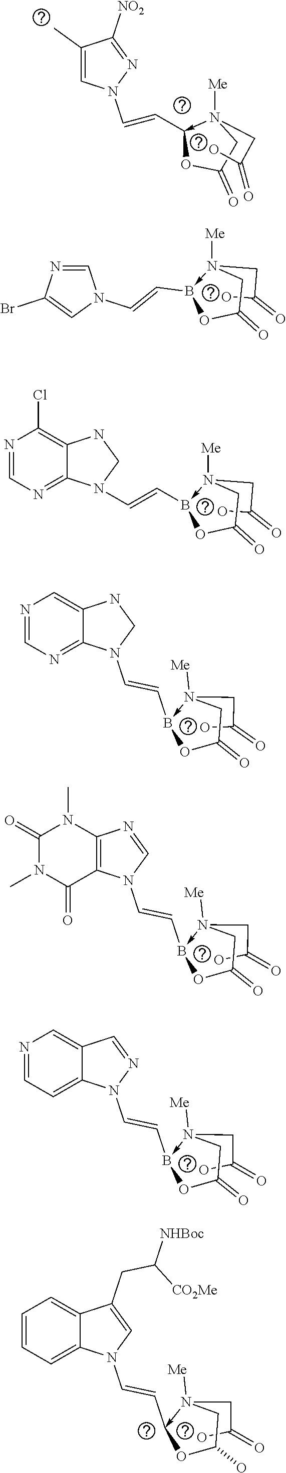

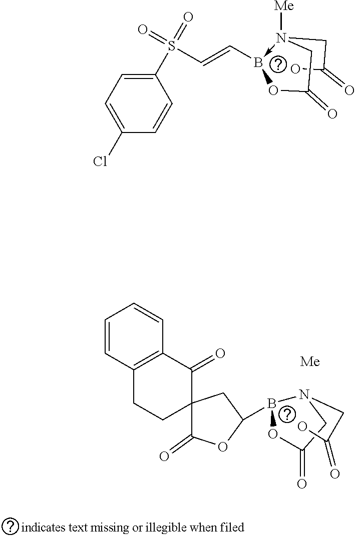

Scheme 10. Representative examples of the boron-containing products from 5a.

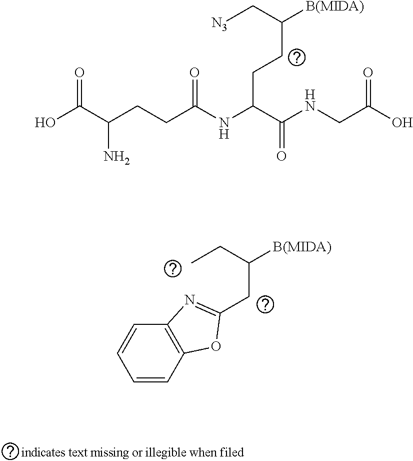

Scheme 11. Representative examples of the boron-containing products from 4d and 4f.

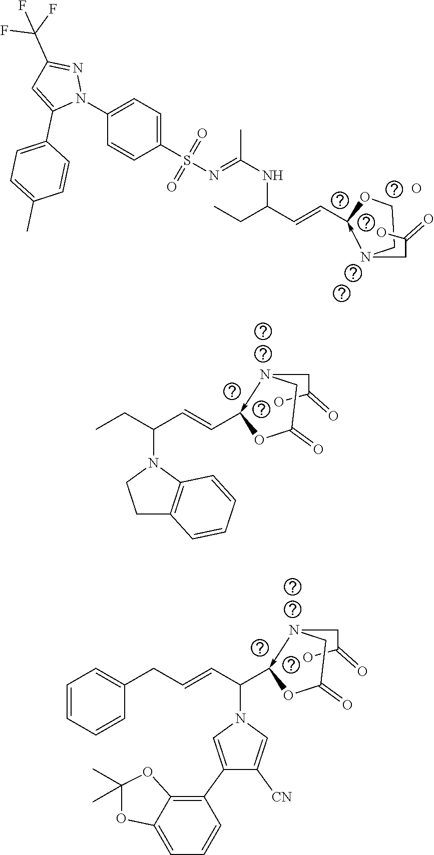

The acid-free nature of the electrochemical synthesis of 3c is particularly advantageous for a one-pot aziridination protocol under basic conditions, eliminating the need for intermediate workup or purification. To showcase the feasibility of this one-pot process and its applicability, the late-stage aziridination of drug molecules containing amine groups was evaluated (Scheme 12). In this protocol, the boryl thianthrenium dicationic salt 3c was generated from 1c in the divided cell. Subsequently, amine-containing substrates and Cs₂CO₃ were added directly to the anode compartment to afford the desired aziridinyl boronates (Table 5). Compound 5 was derived from Celecoxob, compound 41 from Valdecoxib, and 45 from Topiramate. A pinene-derived iminodiacetic acid (PIDA) ligand has previously been shown to function as an effective chiral auxiliary, enabling highly diastereoselective epoxidation of alkenylboronates to furnish chiral oxiranyl PIDA boronates. The reactivity of vinyl B(PIDA) 1d in thiathrenation and aziridination transformation was investigated. The one-pot electrochemical process proceeded with high levels of stereocontrol, providing access to chiral aziridinyl boronate 5-1 in 55% yield with excellent diastereoselectivity (Table 5). The acid-free conditions and high selectivity make this strategy particularly attractive for the sustainable synthesis of boron-containing compounds with pharmaceutical relevance.

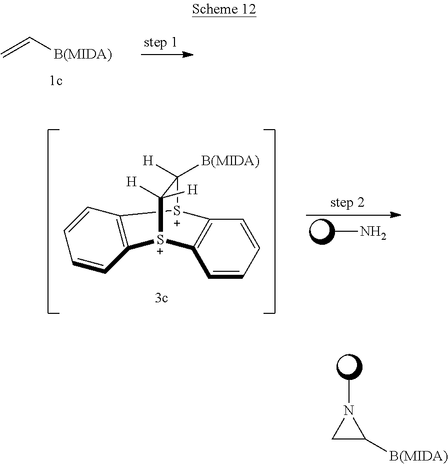

TABLE 5
One-pot aziridination.

| No. | Structure | Yield (%) |
|---|---|---|
| 5 | 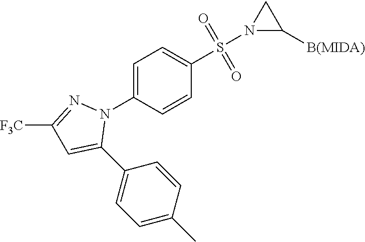 | 66 |
| 28 | 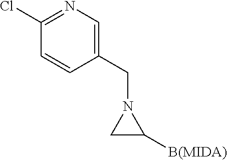 | 72 |
| 41 | 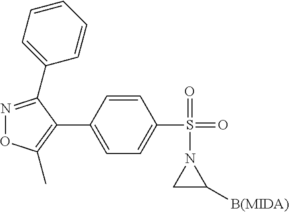 | 60 |
| 45 | 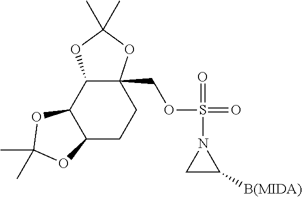 | 55 |
| 5-1 | 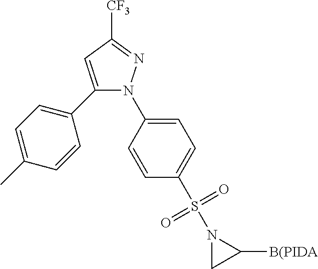 | 55ª Dr >20 |

Step 1: 1c (0.3 mmol), constant current RVC (+)/RVC (−), n-Bu₄NPF₄, MeCN, 23° C. Step 2: RNH2 (0.2 mmol), CsCO₃ (1.0 mmol), 23° C., 16 h.
^{a}0.3 mmol of vinyl PIDA boronate 1d instead of 1c.

With the two readily scalable methods for preparing boryl thianthrenium dication 3c by either chemical or electrochemical thianthrenation and the subsequent transition metal-free aziridination method, the downstream derivatization of aziridinyl boronates was explored to demonstrate their versatility in accessing a broad range of α- and β-aminoboronic esters, important classes of bioactive molecules with significant medicinal and synthetic applications. Aziridinyl MIDA boronate 5, derived from a nonsteroidal anti-inflammatory drug celecoxib, was chosen as a representative substrate. Initial investigations focused on regioselective aziridine ring-opening reactions using various nucleophiles to generate α-aminoboronic esters (Table 6). For instance, the treatment of aziridine 5 with p-anisidine and t-butylamine resulted in the formation of regioselective ring-opening products 51 and 52 in excellent yields of 88% and 85%, respectively. Ring-opening reactions were evaluated using benzyl triethylammonium halides (Cl and Br) in combination with BF₃·Et₂O at 0° C., which successfully afforded halogenated derivatives 53 and 56 in 76% and 81% yields, respectively. Additionally, the reaction of aziridine 5 with sodium azide in DMF at 75° C. produced the azido sulfonamide 54 with a regioselectivity ratio of 4:1. Beyond traditional ring-opening reactions, aziridine 5 displayed the reactivity in cycloaddition chemistry. Treatment of 5 with BF₃·Et₂O and benzonitrile enabled a [3+2] cycloaddition to form the dihydroimidazole derivative 55 in 76% yield with 4:1 regioselectivity. This transformation highlights the potential of aziridinyl boronates to access nitrogen-containing heterocycles in a straightforward manner. Nucleophilic substitution of the bromo derivative 56, which was prepared via regioselective aziridine ring-opening reaction was explored. The bromo intermediate 56 was treated with various nucleophiles, including sodium benzoate, sodium benzenethiolate, and potassium ethanethioate in the presence of NaI, affording derivatives 57, 58, and 59 in good yields. The B(MIDA) group can be further converted into the corresponding B(OH)₂ and BF₃K derivatives, affording compounds 62 from 51 and 63 from 52 in good yields (Table 6).

TABLE 6
Diverse transformations of aziridinyl boronate 5.

| No. | Structure | Yield (%) |
|---|---|---|
| 51 | 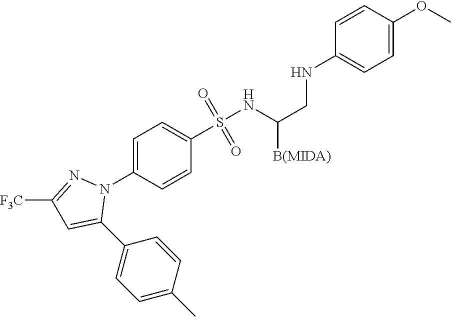 | 88^{a} |
| 52 | 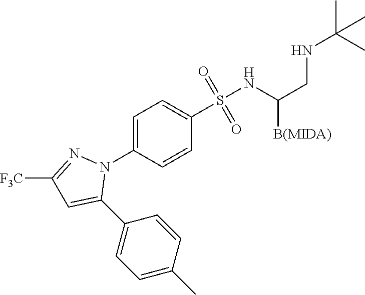 | 85^{b} |
| 53 | 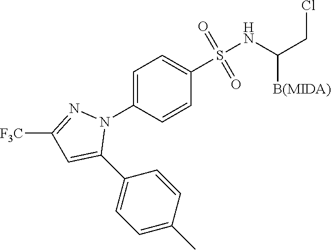 | 76^{c} |
| 54 | 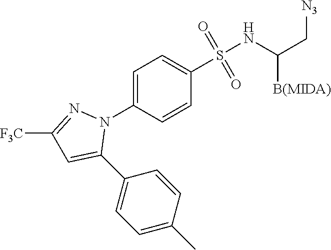 | 74^{d} |
| 55 | 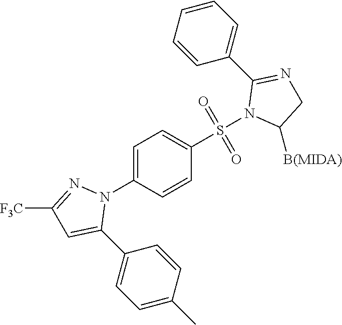 | 76^{e} |
| 56 | 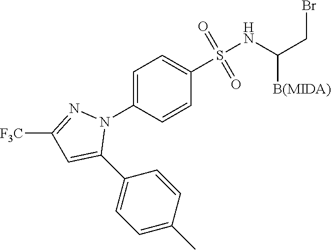 | 81^{f} |
| 57 | 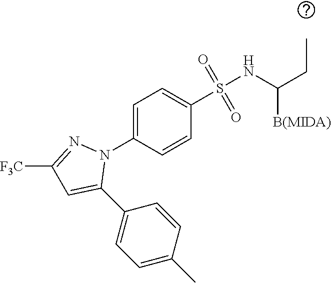 | 77^{g} |
| 58 | 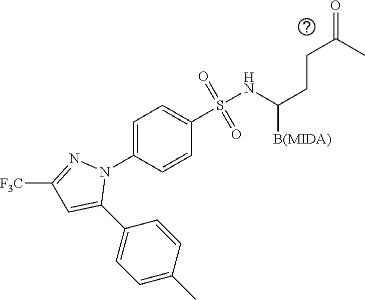 | 71^{h} |
| 59 | 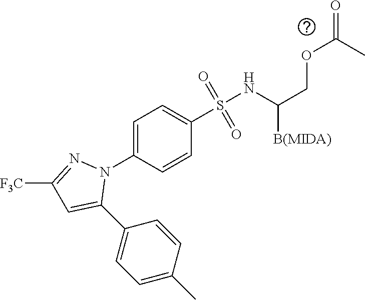 | 61ⁱ |
| 62 | 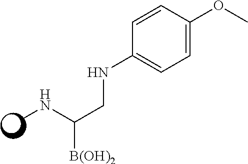 | 70^{j} |
| 63 | 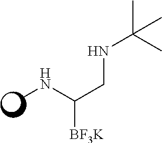 | 71^{k} |
| 64 | 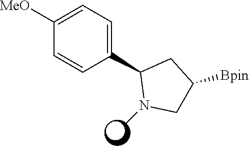 | 30^{1,m} |
| 65 | 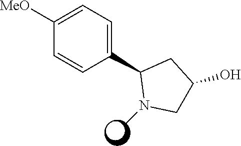 | 80ⁿ dr 7:3 |
| 66 | 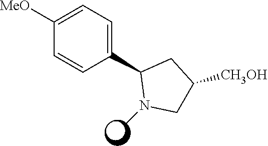 | 64^{o} dr 7:3 |
| 67 | 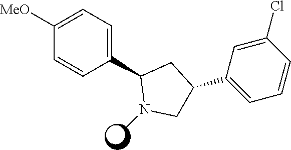 | 72^{p} dr 7:3 |
| 68 | 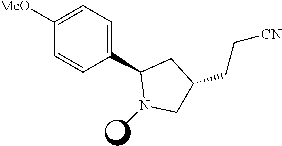 | 81^{q} dr 7:3 |

Reaction conditions: (a) 5 (1.0 eq.), p-anisidine (3.0 eq.), DMF, 60° C., 14 h; (b) 5 (1.0 eq.), tert-butylamine, MeCN, 1 h; (c) 5 (1.0 eq.), benzyltriethylammonium chloride (1.5 eq.), BF3•Et2O (1.2 eq.), DCM, 0° C., 5 h; (d) 5 (1.0 eq.), NaN₃ (3.0 eq.), DMF, 75° C., 10 h; (e) 5 (1.0 eq.), BF3•Et2O (1.2 eq.), PhCN, 1 h; (f)(5 (1.0 eq.), benzyltriethylammonium bromide (1.5 eq.), BF3•Et2O (1.2 eq.), DCM, 0° C., 1 h; (g) 56 (1.0 eq.), PhSNa (1.5 eq.), NaI (1.5 eq.), acetone, 55° C., 12 h; (h) 56 (1.0 eq.), potassium ethanethioate (1.5 eq.), NaI (1.5 eq.), DMF, 60° C., 12 h; (i) 56 (1.0 eq.), sodium benzoate (1.5 eq.), NaI (1.5 eq.), DMF, 60° C., 12 h.; (j) 51 (1.0 eq.), 3N HCl (2.5 eq.), MeOH, 4 h; (k) 52 (1.0 eq.), KHF₂ (5 eq.), MeCN/MeOH = 4:1, 16 h; (l) 5 (1.0 eq.), 4-vinylanisole (1.5 eq.); 4-CzlPN (4 mol%), (4,4′-dtbbpy)NiCl₂ (8 mol%), NaI (2.0 eq.), Et₃N (3.0 eq.), blue LEDs (456 nm), THF, 70° C., 48 h; (m) pinacol (1.2 eq.), DCM/MeOH = 1:1, 45° C., 12 h; (n) 64 (1.0 eq.), NaBO₃ (5.0 eq.), THF/H₂O = 4:1, 3 h; (o) 64 (1.0 eq.), CH₂Br₂ (4 eq.), nBuLi (3.9 eq.), THF, −78~23° C., 21 h; H₂O₂, NaOH; (p) 64 (1.3 eq.), 1-bromo-3-chlorobenzene (1.0 eq.), morpholine (1.5 eq.), [Ir(dF(CF₃)ppy)₂(dtbbpy)]PF₆ (1 mol%), NiCl₂•glyme (5 mol%), dtbbpy (5 mol%), DMF, blue LEDs (456 nm), 2 h; (q) 64 (1.3 eq.), acrylonitrile (4.0 eq.), DMAP (1.5 eq.), [Ir(dF(CF₃)ppy)₂(dtbbpy)]PF₆ (2 mol%), acetone/MeOH 1:1, blue LEDs (456 nm); and

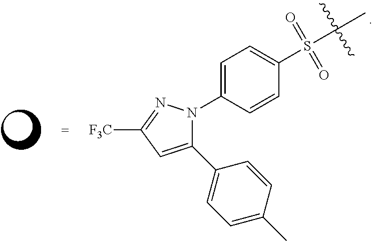 [SMILES: *S(=O)(=O)c1ccc(-n2nc(C(F)(F)F)cc2-c2ccc(C)cc2)cc1]

After synthesizing various α-aminoboronic esters, efforts were directed toward the preparation of cyclic β-aminoboronic ester 64 via a photoredox [3+2] cycloaddition reaction of aziridine 5 and 4-vinylanisole. This reaction afforded a disubstituted sulfonyl pyrrolidine MIDA boronate, which was subsequently converted to the corresponding pinacol ester 64 in 50% overall yield (Table 6). To further showcase the synthetic utility of organoboron, 64 was oxidized to afford alcohol 65 in 80% yield. Boron homologation of 64 via a 1,2-boronate rearrangement followed by in situ oxidation provided 66 in 64% yield. In addition, C(sp²)-C(sp³) coupling reaction enabled by dual photoredox/nickel catalysis afforded 67 in 72% yield. Furthermore, Ir photocatalyst was used to oxidize C-Bpin bond of 64 in the presence of dimethylaminopyridine (DMAP) to generate a stabilized alkyl radical intermediate, which underwent radical addition to acrylonitrile to furnish 68 in 81% yield. Collectively, these results highlight aziridinyl boronates as versatile and robust intermediates for constructing a wide array of functionalized molecules containing the α- and β-aminoboronic ester moiety. The ability to perform late-stage modifications with excellent functional group tolerance and broad reactivity of organoboron compounds further underscores their potential as valuable building blocks in medicinal chemistry and complex molecule synthesis.

In some aspects, selected synthetic applications of boryl thianthrenium salts 3, 4d, 4e, 4f, and 5a, are as shown in Scheme 13 for synthesis of diverse boron-containing compounds with drug-like scaffolds.

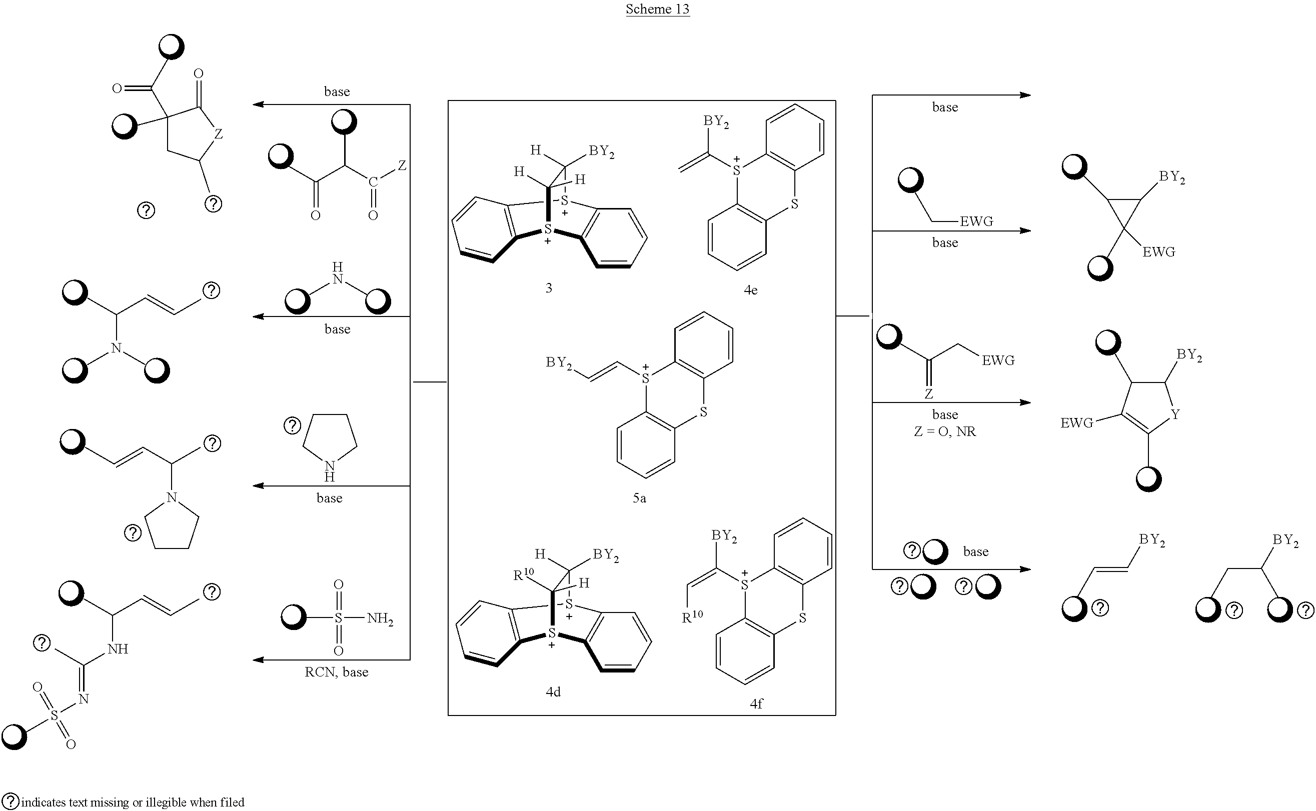

Without wishing to bound by theory, the mechanism for thianthrenation of vinyl MIDA boronate 1c using thianthrene 5-oxide (TTO), trifluoroacetic anhydride (TFAA) and triflic acid (TfOH), the thianthrene dication TT²⁺ is proposed as the reactive species based on the experimental results of exclusive formation of mono-adduct 3c and literature precedent. Activation of TTO with TFAA and Brönsted acid TfOH generates trifluoroacetylated derivative TT⁺-TFA, which undergoes further electron transfer under acidic conditions to form TT²⁺. This highly reactive species TT²⁺ facilitates a fast inverse-electron demand [4+2] cycloaddition with vinyl MIDA boronate 1c, leading exclusively to mono-thianthrenium diatonic adduct 3c. In contrast, the mechanism of electrochemical thianthrenation, involves two distinct reactive species thianthrene radical cation TT⁺· and dication TT²⁺. Anodic oxidation of TT generates TT⁺·, which reacts with olefins to initially form bis-adducts through radical addition followed by sequential radical trapping. At lower TT concentrations, TT⁺· undergoes disproportionation to yield TT²⁺, leading to mono-adduct via the rapid [4+2] cycloaddition. This dual-species mechanism results in a mixture of mono- and bis-adducts, each formed with high selectivity at different stages of the reaction due to the involvement of two distinct reactive species TT⁺· and TT²⁺ (Scheme 14).

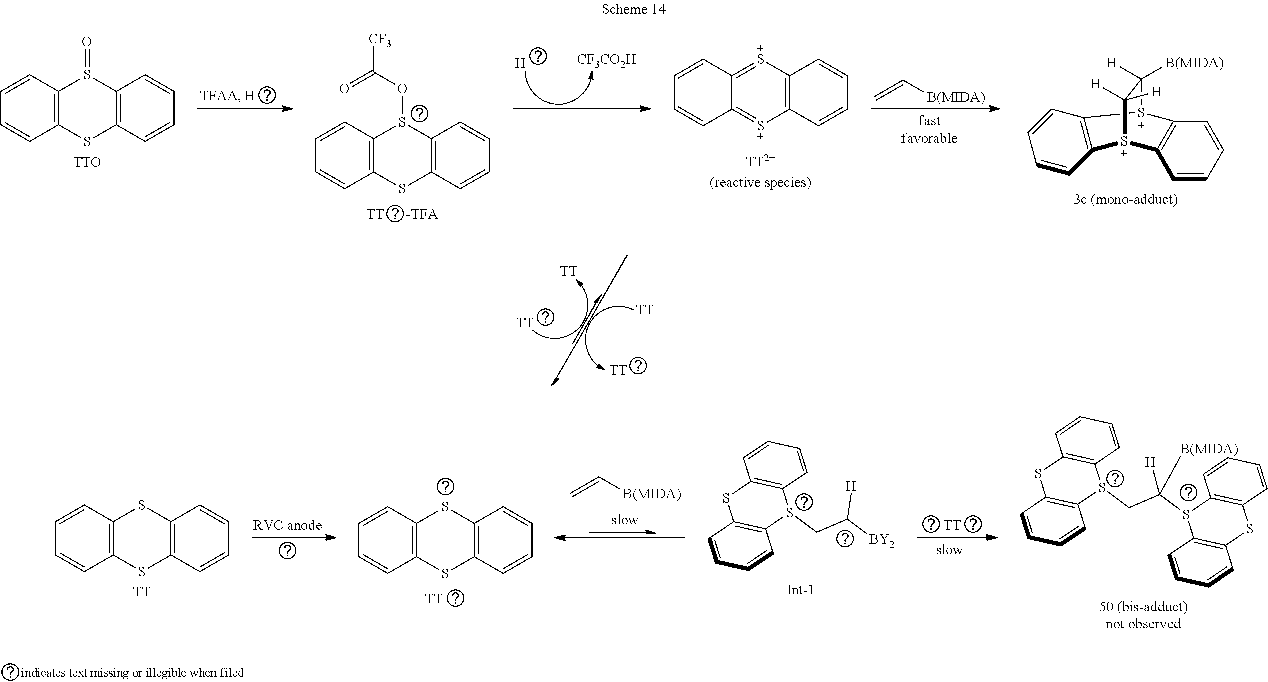

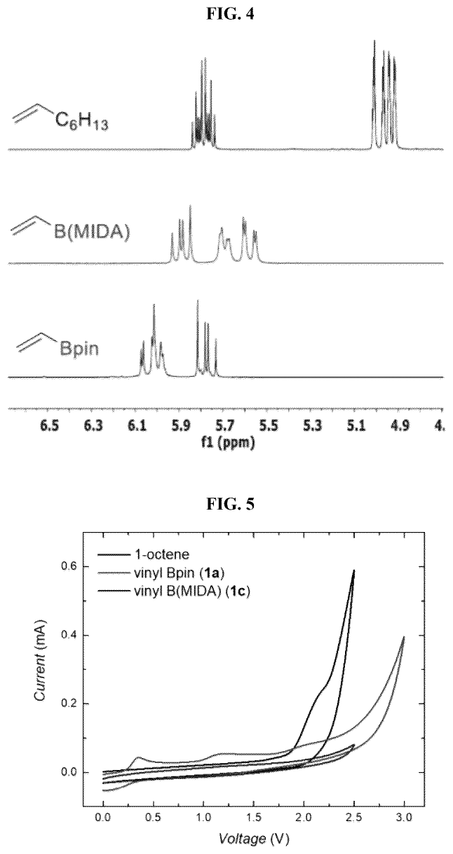

In the electrochemical thianthrenation of vinyl MIDA boronate 1c, the mono-adduct 3c is produced exclusively, with no bis-adduct 50 observed by ¹H NMR and FIRMS analysis. This selectivity likely arises from the unique electronic and steric effects of the MIDA boryl group compared to carbon-based substituents. Unlike the tricoordinate pinacol boryl (Bpin) group, which is known for its electron-withdrawing characteristics due to a partially vacant boron orbital, the electronic nature of the MIDA boryl group whether electron-withdrawing or electron-donating, is less clearly defined. The stable sp³-hybridized tetracoordinate boron complex in B(MIDA), featuring intramolecular B—N coordination, moderates its electron-withdrawing nature. To assess these electronic effects, comparative ¹H NMR analysis was conducted of 1-octene, vinyl Bpin, and vinyl MIDA boronate (FIG. 4). The results indicate that both Bpin and B(MIDA) are electron-withdrawing, with Bpin exerting a stronger effect as evidenced by the downfield chemical shifts of the C═C protons. Vinyl MIDA boronate exhibited no distinct oxidation peak in cyclic voltammetry (FIG. 5). In radical cation addition, electron-poor alkenes like vinyl MIDA boronate 1c are less reactive toward electrophilic TT⁺·, slowing the radical addition pathway. Steric effects further contribute to this selectivity. The sp³-hybridized boron center in B(MIDA) introduces steric hindrance, suppressing radical trapping of the intermediate radical cation Int-1 by the highly bulky TT⁺·. Collectively, these electronic and steric factors disfavor the TT⁺· pathway and promote exclusive formation of the mono-thianthrenium adduct 3c via TT²⁺ under electrochemical conditions.

Without wishing to be bound by theory, to gain insight into the reaction mechanism of boryl thianthrenium dication 3c-enabled transition metal-free aziridination, several control experiments were conducted (Scheme 15). When 3c was reacted with celecoxib in the presence of the radical scavenger TEMPO under standard conditions, the desired aziridine 5 was obtained in 90% yield, with no observable impact on the reaction efficiency. This finding suggests that the aziridination does not proceed through a radical pathway.

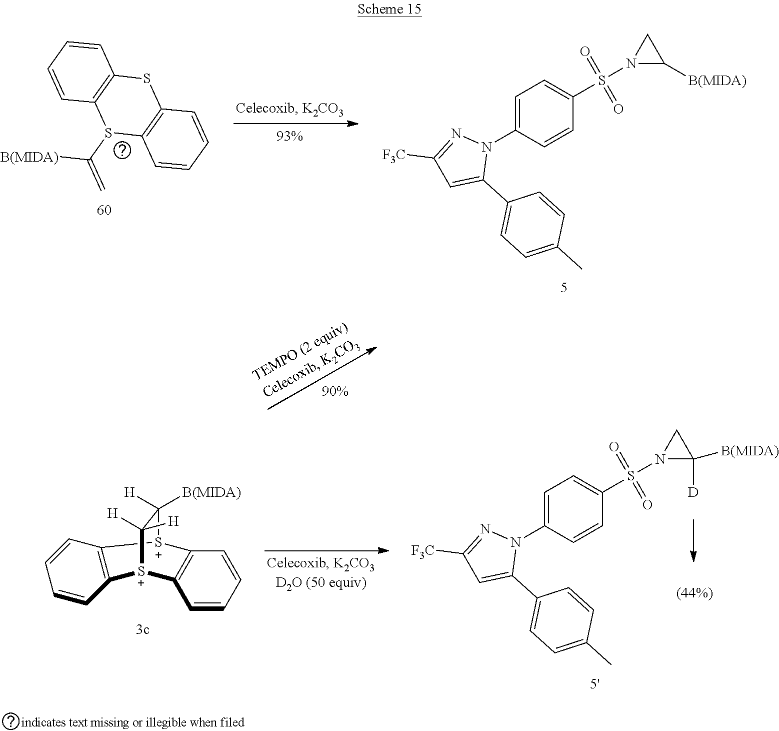

During the aziridination process, the rapid consumption of 3c was observed, leading to the formation of an alkenyl thianthrenium salt intermediate 60. This intermediate was isolated and structurally characterized as compound 60 using NMR and X-ray crystallography (CCDC 2414414) (Scheme 16). The distinct regioselectivity of 60 is likely due to the electron-withdrawing effect of boron outweighing steric influences which would preferentially facilitate the deprotonation of the α-proton of 3c adjacent to B(MIDA). To confirm the role of compound 60 in the aziridination pathway, the isolated intermediate was subjected to standard aziridination conditions. The reaction yielded the desired aziridinyl boronate 5 in 93% yield, providing compelling evidence that 60 serves as a key intermediate in the reaction pathway. Additionally, a deuterium-labeling experiment was performed using D₂O as the deuterium source under standard conditions. The resulting formation of the α-deuterated aziridine 5′ suggests the involvement of a protonation step in the mechanism. Based on these experimental findings the mechanism depicted in Scheme 16 is proposed: (1) dicationic adduct 3c rapidly transforms into alkenyl thianthrenium salt 60 via B(MIDA)-directed selective deprotonation; (2) a nitrogen nucleophile undergoes nucleophilic conjugate addition to alkenylthianthrenium salt 60, generating a stabilized thianthrenium ylide int-2; (3) protonation of ylide int-2 produces cationic int-3 where the proton originates from the amine nucleophile itself, similar to a Michael-type addition; and (4) int-3 which subsequently undergoes intramolecular nucleophilic substitution to form the desired aziridine product, releasing the thianthrene.

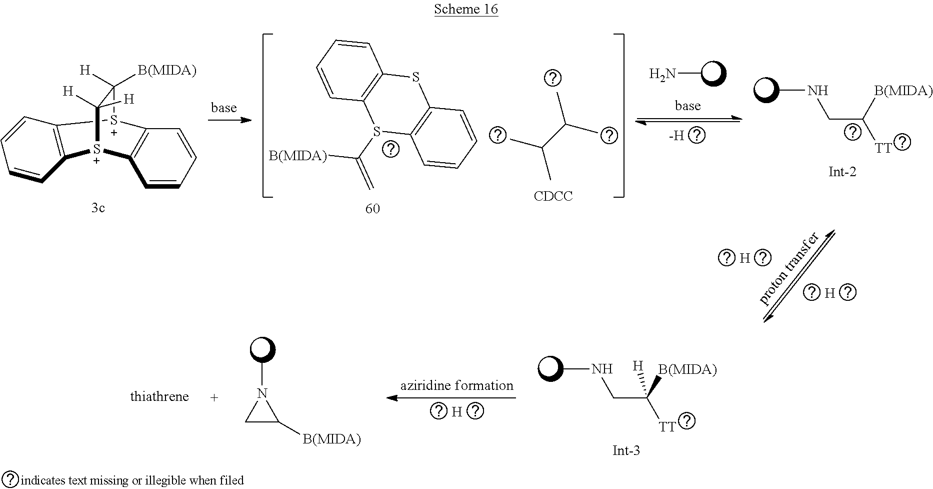

Two readily scalable methods for preparing bench-stable boryl thianthrenium dication 3c have been developed by either chemical or electrochemical thianthrenation of vinyl MIDA boronate. This unique boryl thianthrenium dication serves a versatile building block to enable a transition-metal-free, chemo- and diastereoselective synthesis of aziridinyl boronates, utilizing a broad range of nitrogen nucleophiles. Notably, the MIDA boryl group plays crucial roles in this approach including i) suppressing undesired deborylation, ii) promoting exclusive mono-adduct formation via a formal [4+2] cycloaddition pathway with thianthrene dication TT2+, iii) directing regioselective vinyl boryl thianthrenium formation via selective deprotonation of 3c; and iv) enabling diastereoselective aziridination. The approach demonstrates remarkable generality, practicality, and functional group tolerance, as evidenced by its application to diverse substrates, including the late-stage modification of over ten drug molecules. The strategic significance of this approach is further highlighted through an electrochemical one-pot protocol, asymmetric synthesis using vinyl B(PIDA), and diverse downstream transformations of aziridinyl boronates. This approach significantly enhances the synthetic accessibility of aziridinyl boronates that were previously inaccessible, offering new opportunities for synthetically challenging boron-containing drug-like scaffolds. The broad applications of these novel boryl thianthrenium salts has been demonstrated for the synthesis of a wide range of boron-containing compounds, including α-boryl aziridines, boryl cyclopropanes, boryl dihydrofurans, boryl dihydropyrrole, alkenyl boronates, allylic boronates, and boryl spiro-heterocycles by reacting with various nucleophiles.

### Examples

In order that the invention described herein may be more fully understood, the following examples are set forth. The synthetic examples described in this application are offered to illustrate the compounds, polymorphs, pharmaceutical compositions, and processes provided herein and are not to be construed in any way as limiting their scope.

Common abbreviations well known to those with ordinary skills in the synthetic art which are used throughout: ACN or MeCN is acetonitrile; Bpin is pinacol boronate; BEpin is 1,1,2,2-tetraethylethylene glycol boronate; B(MIDA) is N-methyliminodiacetic acid boronate; B(PIDA) is N-pinenyl iminodiacetic acid boronate; DCM is dichloromethane; DMF is N,N-dimethylformamide; DMSO is dimethyl sulfoxide; HRMS is high resolution mass spectrometry; TFA is trifluoroacetic acid; TFAA is trifluoroacetic anhydride; TfOH or HOTf is triflic acid; THF is tetrahydrofuran; and TTO is thianthrene 5-oxide.

Other abbreviations well known to those with ordinary skills in the art which are used throughout: eq. is equivalents; min is minutes; h is hour.

Analytical thin layer chromatography (TLC) was carried out using silica gel 60 F254 pre-coated plates. Visualization was accomplished with UV lamp or 12 stain. Silica gel 230-400 mesh size was used for flash column chromatography using the combination of ethyl acetate and petroleum ether as eluent. Unless noted, all reactions were carried out in oven-dried glassware under an atmosphere of nitrogen/argon using anhydrous solvents. All commercial reagents were used as received. ¹H NMR, ¹³C NMR, ¹¹B NMR, and ¹⁹F NMR spectra were recorded on Varian-Inova-400, Bruker-ARX-400 or Bruker Avance-III-800 spectrometer at ambient temperature. Multiplicities are indicated as s (singlet), d (doublet), t (triplet), m (multiplet) and br (broad). Mass spectra (MS) were obtained using ESI mass spectrometers.

All experiments with divided cell were carried out using a DC power supply (HM305P), and RVC electrodes (35 mm×5 mm×3 mm) was purchased from IKA and (6.0″×6.0″×0.25″) was purchased from ERG Aerospace Corporation. Undivided cell experiments were carried out using IKA ElectraSyn 2.0. Divided H-cells were fabricated in-house. A glass frit (Chemglass, catalog no. 202-05) was used to separate the anodic and cathodic chambers. The anode and cathode (RVC, electrodes) were assembled by affixing them using 2B graphite rods (JuneGold, 2 mm) to ensure good electrical contact.

### General Procedure for Boryl Thianthrenium Dication 3c Formation

Under nitrogen atmosphere a 50 mL Schlenk vial equipped with a magnetic stir bar was charged with 1c (1.0 mmol, 1.0 eq.), thianthrene 5-oxide (1.03 eq.), and MeCN (10.0 mL, c=0.10 M). After cooling to 0° C., trifluoroacetic anhydride (630 mg, 3.0 mmol, 3.0 eq.) was added dropwise, followed by dropwise addition of TfOH (180 mg, 1.2 mmol, 1.2 eq.). After stirring the mixture at 0° C. for 1 h, ether (35 mL) was added. The resulting slurry was filtered, and the solid was washed with Et₂O (10 mL) and then dried in a vacuum at 23° C. The solid was 3c used without further purification.

### Thianthrenation of Vinyl Boronates to Boryl Thianthrenium Dications.

Vinylboronic acid pinacol ester 1a (0.3 mmol, 1.0 eq.) was reacted with thianthrene oxide (TTO) 2 (1.03 eq.), trifluoroacetic anhydride (TFAA) (3 eq.), triflic acid (TfOH) (1.2 eq.) in acetonitrile (3 mL) at 0° C. for 1 h (Scheme 17). The reaction afforded the boryl thianthrenium dication 3a as a minor product with the deborylated vinyl thianthrenium product 4 as the major product in 90% NMR yield and 80% isolated yield (Table 7, entry 1). The same reaction conditions were applied to the more sterically hindered vinyl boronic ester, 1,1,2,2-tetraethylethylene glycol ester (BEpin), 1b, but this substrate similarly led to the formation of the deborylated byproduct 4 in 80% yield (entry 2). The deborylation process likely proceeds through a pathway similar to 1,2-dehaloboration, wherein nucleophilic attack at the boron center facilitates alkene formation. To address deborylation issues, sp³-hybridized MIDA boronates were investigated, which are known for their enhanced stability due a strong coordination B—N dative bond of the N-methyl of MIDA group to the boron center. This coordination effectively attenuates susceptibility toward nucleophilic attack and underlies the broad utility of MIDA boronates in organic synthesis and medicinal chemistry. The thianthrenation of vinyl MIDA boronate 1c under similar reaction conditions was investigated. Remarkably, substrate 1c completely suppressed the deborylation, furnishing the desired boryl thianthrenium dicationic adduct 3c in an excellent 90% isolated yield (entry 3). 3c was synthesized on a preparative scale, yielding over 60 grams of product in a single step through simple precipitation, without requiring column chromatography (entry 4). The boryl thianthrenium dication 3c was obtained as a white solid, which is bench-stable and can be stored for several months without decomposition.

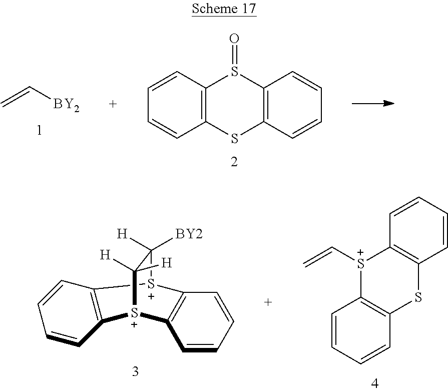

TABLE 7
Thianthrenation of vinyl boronates 1
to boryl thianthrenium dication 3.

| | | 3 (% | 4 (% |
|---|---|---|---|
| Entry | 1 (BY₂) | yield)^{a} | yield)^{a} |
| 1 | 1a (Bpin) | <2 | 90 |
| | | | (80^{b}) |
| 2 | 1b (BEpin) | <2 | 80 |
| 3 | 1c (B(MIDA)) | 95 | <2 |
| | | (90^{b}) | |
| 4 | 1c (B(MIDA)) | 91^{c} | <2 |
| | | (62.2 g) | |

The reaction was conducted using 1 (0.3 mmol, 1.0 eq.), TTO 2 (1.03 eq.), TFAA (3 eq.), and TfOH (1.2 eq.) in MeCN (3 mL) at 0° C. for 1 h.
^{a}NMR yield;
^{b}isolated yield;
^{c}multiple gram-scale synthesis.

### Thianthrenation of Vinyl Boronates to Boryl Thianthrenium Dications Via Electrochemistry.

To study electrochemical thianthrenation, the reactivity of vinyl B(MIDA) 1c was investigated using a divided cell setup with RVC electrodes RVC(+)/RVC(−) (Scheme 19), using Anode (RVC): 0.3 mmol of 1c (1 eq.), 0.45 mmol of TT (1.5 eq.) in 4 mL MeCN (0.2 M n-Bu₄NPF₆); Cathode (RVC): TFA (0.8 mmol) in 4 mL MeCN (0.2 M n-Bu₄NPF₆). Applying a current of 4 mA afforded desired product 3c with [PF₆]⁻ as anions in a good yield of 82% in 12 hours (Table 7, entry 1). Mono-adduct 3c was formed, with no detectable bis-adduct 50 or deborylation by-product 4. Increasing the current to 12 mA further improved the yield of 3c to 96% and reduced the reaction time to 5 hours, with no bis-adduct formation (entry 2). Substituting the cathode with a nickel form electrode resulted in a reduced yield of 78% (entry 3), while changing the connection from pencil/RVC to stainless steel wire/RVC led to no product formation (entry 5), highlighting the importance of a proper connection to the RVC for successful reaction progression. When the reaction was performed in an undivided cell using an ElectraSyn apparatus (entry 4), the yield dropped to 42%, likely due to potential competing reduction process of 3c at the cathode. Similar to chemical thianthrenation, electrochemical thianthrenation of vinyl Bpin 1a and vinyl BEpin 1b led to deborylated vinyl thianthrenium product 4 in 70% and 65% NMR yield, respectively (Scheme 18).

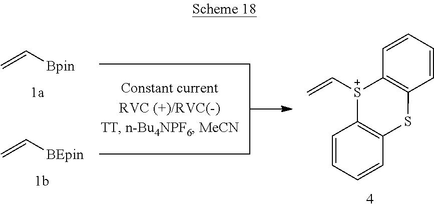

The scalability of the electrochemical process employing Anode (RVC): 5.5 mmol of vinyl B(MIDS) 1c (1 eq.), 8.25 mmol of TT (1.5 eq.) in 20 mL MeCN (2.2 eq. n-Bu₄NPF₆); Cathode (RVC): TFA (2.5 eq.) in 20 mL MeCN (2.2 eq. n-Bu₄NPF₆) resulted in the successful synthesis of 3c (3.2 g) in an 84% yield (Table 8, entry 6). This result demonstrates the practicality and efficiency of this electrochemical method.

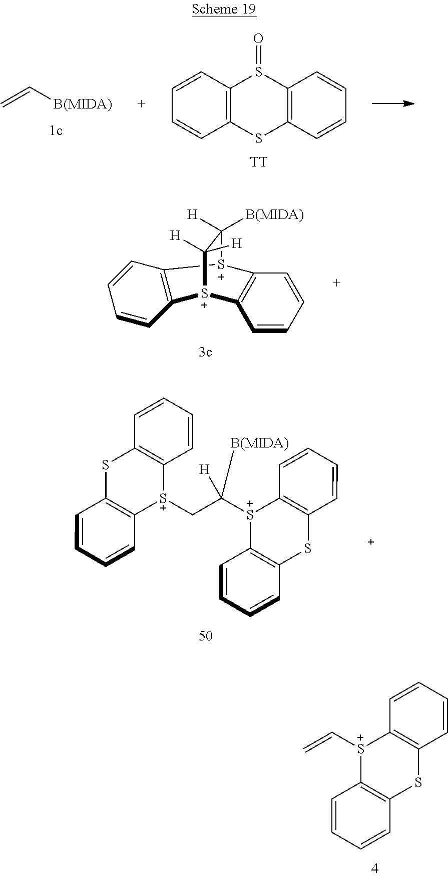

TABLE 8
Optimization of electrochemical thianthrenation
of vinyl MIDA boronate

| | | | 3c (% | 50 (% | 4 (% |
|---|---|---|---|---|---|
| Entry | i (mA) | Time (h) | Yield)^{d} | Yield) | Yield) |
| 1 | 4.0 | 12 | 82 | <2 | <2 |
| 2 | 12.0 | 5 | 96 | <2 | <2 |
| | | | (90)^{e} | | |
| 3^{a} | 12.0 | 5 | 78 | <2 | <2 |
| 4^{b} | 12.0 | 12 | 42 | <2 | <2 |
| 5^{c} | 12.0 | 5 | <2 | <2 | <2 |
| 6^{f} | 100 | 5 | 84 | <2 | <2 |
| | | | (3.2 g) | | |

^{a}Ni form as the cathode;
^{b}ElectraSyn as the electrochemical cell;
^{c}RVC electrode connected by a wire on the anode side;
^{d}NMR yield;
^{e}isolated yield;
^{f}Reaction scale: Anode (RVC): 5.5 mmol of 1c (1 eq.), 8.25 mmol of TT (1.5 eq.) in 20 mL MeCN (2.2 eq. n-Bu₄NPF₆); Cathode (RVC): TFA (2.5 eq.) in 20 mL MeCN (2.2 eq. n-Bu₄NPF₆).

### 12-(6-methyl-4,8-dioxo-1,3,6,2-dioxazaborocan-2-yl)-5,10-ethanothianthrene-5,10-diium triflate (3c)

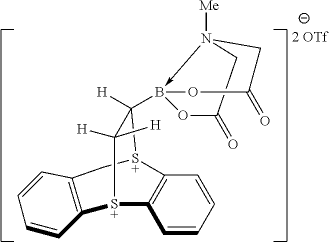

Under nitrogen atmosphere a 1000 mL three neck equipped with a magnetic stir bar was charged with 1c (100 mmol, 1.0 eq.), thianthrene 5-oxide (1.03 eq.), and MeCN (200 mL, c=0.5 M). After cooling to 0° C., trifluoroacetic anhydride (63 g, 3.0 mmol, 3.0 eq.) was added dropwise, followed by dropwise addition of TfOH (18 g, 1.2 mmol, 1.2 eq.). After stirring the mixture at 0° C. for 1 h an additional 600 mL of ether was added. The resulting slurry was filtered, and the solid was washed with Et₂O (100 mL) and then dried in a vacuum at 20° C. The solid was 3c obtained in 62.2 g and was used without further purification. ¹H NMR (400 MHz, DMSO) δ 8.62-8.42 (m, 4H), 8.24-8.09 (m, 4H), 4.50-4.28 (m, 4H), 4.18-4.00 (m, 3H), 2.97 (s, 3H). ¹⁹F NMR (377 MHz, DMSO) δ −77.73. ¹¹B NMR (128 MHz, DMSO) δ 9.93. ¹³C NMR (101 MHz, DMSO) δ 166.14, 165.36, 133.97, 133.79, 133.44, 133.29, 133.09, 132.74, 132.53, 126.43, 126.21, 125.16, 124.29, 120.63, 117.43, 116.44, 61.24, 60.84, 45.24.

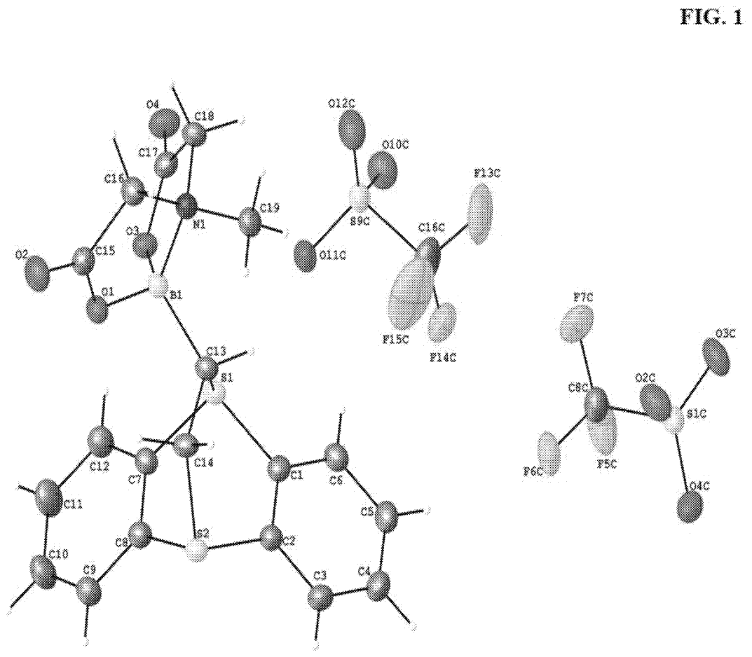

The structure of 3c was unambiguously confirmed via X-ray crystallography (CCDC 2414383). Boryl thianthrenium dication 3c was crystallized from acetonitrile. The atoms are depicted in FIG. 1 with 50% probability ellipsoids. The crystallographic data are summarized in the following tables.

Representative procedure for boryl thianthrenium salt 4e demonstrated for compound 60

To an oven-dried 100 mL Schlenk vial equipped with a magnetic stir bar was charged 3c (1.0 mmol, 1.0 eq.) and Cs₂CO₃ (0.52 eq.), followed by the solvent acetonitrile (0.1 M) and the mixture was stirred at ambient temperature for 14 h. The reaction mixture was filtered through celite and washed with MeCN. The volatiles were removed in vacuo. Dichloromethane was added to the crude reaction product. The resulting slurry was filtered, and the solid was washed with DCM (10 mL) and then dried to afford the product 60 as a white solid.

Representative Synthetic Procedure for Boryl Thianthrenium salt 5c

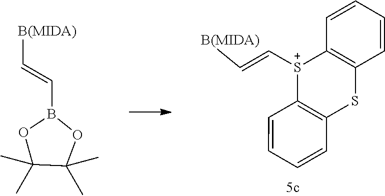

Under nitrogen atmosphere a 50 mL Schlenk vial equipped with a magnetic stir bar was charged with the starting boronate (1.0 mmol, 1.0 eq.), thianthrene 5-oxide (1.03 eq.), and MeCN (10.0 mL, c=0.10 M). After cooling to 0° C., trifluoroacetic anhydride (631.7 mg, 3.0 mmol, 3.0 eq.) was added dropwise, followed by dropwise addition of TfOH (180.0 mg, 1.2 mmol, 1.2 eq.). After stirring the mixture at 0° C. for 1 h, ether (35 mL) was added. The resulting slurry was filtered, and the solid was washed with Et₂O (10 mL) and then dried to afford the product 5c as a white solid.

### Representative Synthetic Procedure for Boryl Thianthrenium Salts 4d

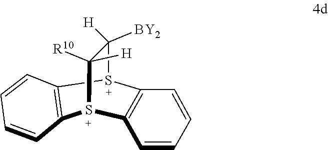

Under nitrogen atmosphere, a 50 mL Schlenk vial equipped with a magnetic stir bar was charged with an alkenyl BMIDA boronate (1.0 mmol, 1.0 eq.), thianthrene 5-oxide (1.03 eq.), and MeCN (10.0 mL, c=0.10 M). After cooling to 0° C., trifluoroacetic anhydride (630.1 mg, 3.0 mmol, 3.0 eq.) was added dropwise, followed by dropwise addition of TfOH (180.0 mg, 1.2 mmol, 1.2 eq.). After stirring the mixture at 0° C. for 1 h, ether (35 mL) was added. The resulting slurry was filtered, and the solid was washed with Et₂O (10 mL) and then dried in a vacuum at 20° C. The solid 4d was used without further purification.

### Representative Synthetic Procedure for Boryl Thianthrenium Salts 4f

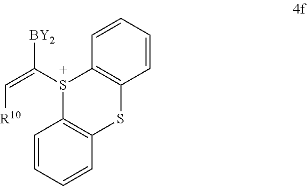

To the crude 4d (1.0 mmol, 1.0 eq.) and Cs₂CO₃ (0.52 eq.), was added acetonitrile (0.1 M) and the mixture was stirred at ambient temperature for 14 h. The reaction mixture was filtered through celite and washed with MeCN. The volatiles were removed in vacuo. Dichloromethane/ether (1:9, 100 mL) was added to the crude reaction product, the resulting slurry was filtered. The solid was washed with DCM (10 mL) and then dried to afford 4f.

### General Procedures for the Aziridination of Vinyl MIDA Boronate Ester:

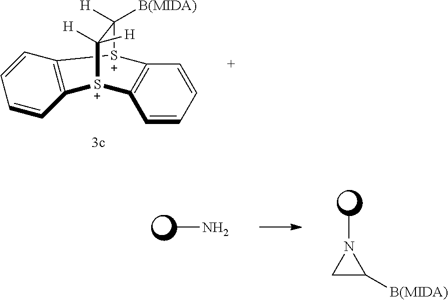

General Procedure A: Sulfonamide (1.2 eq.), K₂CO₃ (5.0 eq.), and 3c (1.0 eq.) were placed in a 10.0 mL Schlenk tube which was equipped with a magnetic stir bar. After back-filling with nitrogen (this process was repeated three times), DCM (0.1 M) was added. The vial was sealed and stirred at room temperature until TLC indicated (typically 14-16 h). The mixture was filtered, and the filter cake was washed with dichloromethane (2×10 mL). The filtrates were combined and concentrated and purified directly by column chromatography to afford the product.

General Procedure B: Amine (or HCl salt) (1.2 eq.), Cs₂CO₃ (3-5.0 eq.), and 3c (1.0 eq.) were placed in a 10.0 mL Schlenk tube which equipped with a magnetic stir bar. After back-filling with nitrogen (this process was repeated three times), acetonitrile (0.1 M) was added. The vial was sealed and stirred at room temperature until TLC indicated (typically 14-16 h). The mixture was filtered, and the filter cake was washed with dichloromethane (2×10 mL). The filtrates were combined and concentrated and purified directly by column chromatography to afford the product.

### General Experimental Procedures for Electrolysis:

### 3A. General Procedure and Experimental Setup for Boryl Thianthrenium Dication Formation (Divided Cell)

To an oven dried H-cell (divided cell) containing magnetic stir bars was charged with 1c (0.3 mmol, 1 eq.), TT (0.45 mmol, 1.5 eq.) in 4 mL anhydrous acetonitrile (0.2 M n-Bu₄NPF₆) to the anode compartment and trifluoroacitic acid (0.8 mmol) in 4 mL anhydrous acetonitrile (0.1 M n-Bu₄NPF₆) to the cathode compartment under argon atmosphere. Using stainless steel wire/RVC (12 mm×5 mm×3 mm) cathode and pencil/RVC (10 mm×5 mm×3 mm) anode, the reaction mixture was electrolyzed under constant current (12 mA) for 5 hours. After the reaction 50 μL of the reaction mixture was transferred to an NMR tube and diluted with DMSO-d6. The conversion was determined via ¹H NMR using 1,3,5-trimethoxylbenzene as the internal standard. Then, the electrodes were removed, and the reaction mixture was concentrated under reduced pressure. The precipitate was formed by adding diethyl ether to the rection mixture and filtered the precipitate and washed the precipitate with DCM to afford the 3c′.

### 3B. General Procedure and Experimental Setup for Boryl Thianthrenium Dication Formation (Undivided Cell)

To an oven-dried ElectraSyn reaction vial (5 mL) containing magnetic stir bar was charged with 1c (0.3 mmol, 1 eq.), TT (0.45 mmol, 1.5 eq.) and trifluoroacetic acid (0.5 mmol) in 4 mL anhydrous acetonitrile (0.2 M n-Bu₄NPF₆) under argon atmosphere. Using a RVC anode and cathode, the reaction mixture was electrolyzed under a constant current of 12 mA for 12 hours. After the reaction 50 μL of the reaction mixture was transferred to an NMR tube and diluted with DMSO-d6. The conversion was determined via ¹H NMR using 1,3,5-trimethoxylbenzene as the internal standard.

### 3C. General Procedure and Experimental Setup for Gram Scale Boryl Thianthrenium Dication Formation (Divided Cell)

To an oven dried H-cell (divided cell) containing magnetic stir bars was charged with 1c (5.5 mmol, 1 eq.), TT (8.25 mmol, 1.5 eq.) in 20 mL anhydrous acetonitrile (12.1 mmol, 2.2 eq., n-Bu₄NPF₆) to the anode compartment and trifluoroacitic acid (13.75 mmol, 2.5 eq.) in 20 mL anhydrous acetonitrile (12.1 mmol, 2.2 equiv, n-Bu₄NPF₆) to the cathode compartment under argon atmosphere. Using pencil/RVC (3 cm×5 cm×6 mm) cathode and pencil/RVC (3.5 cm×5 cm×6 mm) anode, the reaction mixture was electrolyzed under constant current (100 mA) for 5 hours. After the reaction 50 μL of the reaction mixture was transferred to an NMR tube and diluted with DMSO-d6. The conversion was determined via ¹H NMR using 1,3,5-trimethoxylbenzene as the internal standard. Then, the electrodes were removed, and the reaction mixture was concentrated under reduced pressure. The precipitate was formed by adding diethyl ether to the rection mixture and filtered the precipitate and washed the precipitate with DCM to afford the 3c′.

### 3D. General Procedure for Electrochemical One-Pot Aziridination Reaction

To an oven dried H-cell (divided cell) containing magnetic stir bars was charged with 1c (0.3 mmol, 1 eq., TT (0.45 mmol, 1.5 eq.) in 4 mL anhydrous acetonitrile (0.2 M n-Bu₄NPF₆) to the anode compartment and trifluoroacitic acid (0.8 mmol) in 4 mL anhydrous acetonitrile (0.2 M n-Bu₄NPF₆) to the cathode compartment under argon atmosphere. Using stainless steel wire/RVC (12 mm×5 mm×3 mm) cathode and pencil/RVC (10 mm×5 mm×3 mm) anode, the reaction mixture was electrolyzed under constant current (12 mA) for 5 hours. At the completion of the electrolysis, the electrode on the anode side was removed and Cs₂CO₃ (1 mmol), amine (0.2 mmol) was added to the anode compartment. The anodic compartment was equipped with septa with a needle to prevent pressurizing and after pressure equilibrium, the needle was removed, and cathode solution was removed from the cell using a pipette. The anodic solution was stirred in the cell for 16 hours. The mixture was filtered, the filter cake was washed with dichloromethane (2×10 mL), and then the filtrates were combined and concentrated and purified directly by column chromatography to afford the product.

### 3E. General Procedures for Cyclic Voltammetry

All cyclic voltammograms (CVs) were collected using an electrochemical cell fitted with a 3-mm-diameter glassy carbon disk electrode as the working electrode, a glassy carbon plate as the counter electrode, and an Ag/Ag+ electrode as the reference electrode. Following the general procedure, cyclic voltammetry was performed with 1a (5 mM), 1c (5 mM), and 1-octene (5 mM) with TBAPF₆ (0.1M) in anhydrous ACN. The scan rate used here was 0.2 V/s.

### 12-(6-methyl-4,8-dioxo-1,3,6,2-dioxazaborocan-2-yl)-5,10-ethanothianthrene-5,10-diium (3c′)

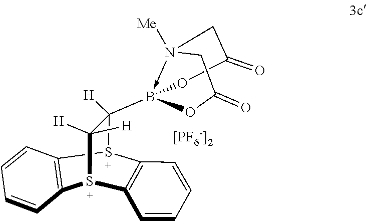

¹H NMR (400 MHz, DMSO) δ 8.56-8.44 (m, 4H), 8.19-8.11 (m, 4H), 4.46-4.33 (m, 4H), 4.13-4.02 (m, 3H), 2.96 (s, 3H). ¹⁹F NMR (377 MHz, DMSO) δ −69.32, −71.48. ¹¹B NMR (128 MHz, DMSO) δ 9.04. HRMS-ESI (m/z) [M]2+ calc'd for C₁₉H₁₈BNO₄S₂²⁺, 199.5380, found 199.5380.

### 6-Methyl-2-(1-((4-(4-(p-tolyl)-3-(trifluoromethyl)-1H-pyrazol-1-yl)phenyl)sulfonyl)aziridin-2-yl)-1,3,6,2-dioxazaborocane-4,8-dione (5)

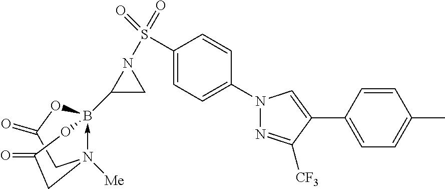

General procedure A with 3c (210 mg, 0.3 mmol), Celecoxib (137.8 mg, 0.36 mmol, 1.2 eq.) and K₂CO₃ (207 mg, 1.5 mmol, 5.0 eq.) to afford a white solid (155 mg, 0.162 mmol, 92% yield). Rf=0.4 (hexanes:ethyl acetate=4:6). ¹H NMR (400 MHz, DMSO) δ 8.09-8.00 (m, 2H), 7.70-7.61 (m, 2H), 7.33-7.22 (m, 5H), 4.36 (dd, J=24.9, 17.1 Hz, 2H), 4.16 (d, J=17.1 Hz, 1H), 3.98 (d, J=17.0 Hz, 1H), 3.11 (s, 3H), 2.48 (d, J=8.4 Hz, 1H), 2.37 (s, 3H), 2.31 (dd, J=8.3, 5.5 Hz, 1H), 2.17-2.11 (m, 1H). ¹⁹F NMR (377 MHz, DMSO) δ −60.96. ¹¹B NMR (128 MHz, DMSO) δ 12.91. ¹³C NMR (101 MHz, DMSO) δ 169.38, 168.73, 145.90, 143.23, 143.16, 142.78, 139.73, 137.12, 129.99, 129.66, 129.29, 126.61, 125.72, 123.05, 120.38, 106.94, 62.54, 62.49, 46.71, 30.80, 21.30. HRMS-ESI (m/z) [M+H]+ calc'd for C₂₄H₂₃BF₃N₄O₆S+, 563.1383, found 563.1395.

### N-(4-((2-(6-Methyl-4,8-dioxo-1,3,6,2-dioxazaborocan-2-yl)aziridin-1-yl)sulfonyl)phenyl)acetamide (6)

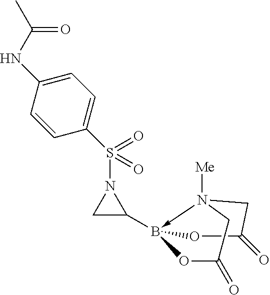

General procedure A with 3c (210 mg, 0.3 mmol), N-(4-sulfamoylphenyl)acetamide (77.3 mg, 0.36 mmol, 1.2 eq.) and K₂CO₃ (207 mg, 1.5 mmol, 5.0 eq.) to afford a white solid (71 mg, 60% yield). Rf=0.3 (hexanes:acetone 1:1). ¹H NMR (400 MHz, DMSO) δ 7.82 (d, J=1.2 Hz, 4H), 4.30 (dd, J=28.2, 17.0 Hz, 2H), 4.09 (d, J=17.1 Hz, 1H), 3.88 (d, J=17.0 Hz, 1H), 3.05 (s, 3H), 2.28 (d, J=8.3 Hz, 1H), 2.12-2.07 (m, 4H), 2.00 (d, J=5.3 Hz, 1H). ¹¹B NMR (128 MHz, DMSO) δ 2.12. ¹³C NMR (101 MHz, DMSO) δ 169.69, 169.46, 168.68, 144.61, 130.02, 129.84, 122.75, 119.55, 119.04, 62.46, 62.41, 46.63, 30.10, 24.66. HRMS-ESI (m/z) [M+H]+ calc'd for C₁₅H₁₉BN₃O₇S+, 396.1037, found 396.1019.

### 2-(1-((2-Aminophenyl)sulfonyl)aziridin-2-yl)-6-methyl-1,3,6,2-dioxazaborocane-4,8-dione (7)

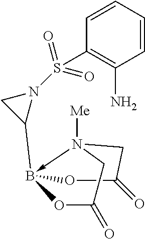

General procedure A with 3c (210 mg, 0.3 mmol), 2-aminobenzenesulfonamide (62 mg, 0.36 mmol, 1.2 eq.) and K₂CO₃ (207 mg, 1.5 mmol, 5.0 eq.) to afford a white solid (58 mg, 55% yield). Rf=0.2 (hexanes:ethyl acetate=1:9). ¹H NMR (400 MHz, DMSO) δ 7.48 (dd, J=8.1, 1.6 Hz, 1H), 7.39 (ddd, J=8.5, 7.1, 1.6 Hz, 1H), 6.90 (dd, J=8.4, 1.1 Hz, 1H), 6.67 (ddd, J=8.2, 7.0, 1.1 Hz, 1H), 6.15 (s, 2H), 4.37 (d, J=17.3 Hz, 1H), 4.26 (d, J=16.9 Hz, 1H), 4.09 (d, J=17.3 Hz, 1H), 3.90 (d, J=16.9 Hz, 1H), 3.02 (s, 3H), 2.34 (d, J=8.3 Hz, 1H), 2.11-1.99 (m, 2H). ¹¹B NMR (128 MHz, DMSO) δ 9.21. ¹³C NMR (101 MHz, DMSO) δ 169.65, 169.54, 168.53, 148.42, 135.51, 130.16, 122.74, 119.54, 117.64, 116.12, 115.71, 62.37, 62.32, 46.46, 29.62. HRMS-ESI (m/z) [M+H]+ calc'd for C₁₃H₁₇BN₃O₆S+, 354.0931, found 354.0928.

### 6-Methyl-2-(1-tosylaziridin-2-yl)-1,3,6,2-dioxazaborocane-4,8-dione (8)

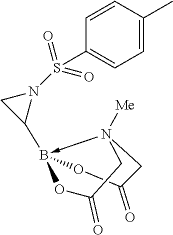

General procedure A with 3c (210 mg, 0.3 mmol), 4-methylbenzenesulfonamide (62 mg, 0.36 mmol, 1.2 eq.) and K₂CO₃ (207 mg, 1.5 mmol, 5.0 eq.) to afford a white solid (76 mg, 72% yield). Rf=0.4 (hexanes:ethyl acetate=3:7). ¹H NMR (400 MHz, DMSO) δ 7.90-7.76 (m, 2H), 7.51 (d, J=8.1 Hz, 2H), 4.36 (dd, J=30.4, Hz, 2H), 4.15 (d, J=17.2 Hz, 1H), 3.94 (d, J=16.9 Hz, 1H), 3.12 (s, 3H), 2.47 (s, 3H), 2.37 (d, J=8.3 Hz, 1H), 2.20 (dd, J=8.3, 5.4 Hz, 1H), 2.06 (d, J=5.3 Hz, 1H). ¹¹B NMR (128 MHz, DMSO) δ 8.45. ¹³C NMR (101 MHz, DMSO) δ 167.33, 166.54, 142.93, 132.06, 128.23, 126.33, 60.34, 60.30, 44.50, 28.20, 19.44. HRMS-ESI (m/z) [M+H]+ calc'd for C₁₄H₁₈BN₂O₆S+, 353.0979, found 353.0972.

### Ethyl 2-((2-(6-methyl-4,8-dioxo-1,3,6,2-dioxazaborocan-2-yl)aziridin-1-yl)sulfonyl)benzoate (9)

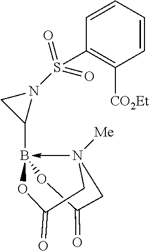

General procedure A with 3c (210 mg, 0.3 mmol), ethyl 2-sulfamoylbenzoate (83 mg, 0.36 mmol, 1.2 eq.) and K₂CO₃ (207 mg, 1.5 mmol, 5.0 eq.) to afford a white solid (85 mg, 69% yield). Rf=0.4 (hexanes:ethyl acetate=4:6). ¹H NMR (400 MHz, DMSO) δ 8.02 (dd, J=7.9, 1.4 Hz, 1H), 7.82 (td, J=7.5, 1.4 Hz, 1H), 7.76 (td, J=7.7, 1.5 Hz, 1H), 7.66 (dd, J=7.5, 1.4 Hz, 1H), 4.39-4.23 (m, 4H), 4.08 (d, J=17.1 Hz, 1H), 3.92 (d, J=16.9 Hz, 1H), 3.06 (s, 3H), 2.29 (dd, J=8.3, 5.5 Hz, 1H), 2.10 (d, J=5.5 Hz, 1H), 1.28 (t, J=7.1 Hz, 3H). ¹¹B NMR (128 MHz, DMSO) δ 8.45. ¹³C NMR (101 MHz, DMSO) δ 169.44, 168.60, 167.24, 134.56, 134.50, 133.89, 131.42, 130.20, 129.02, 62.37, 62.34, 62.32, 46.49, 31.64, 14.24. HRMS-ESI (m/z) [M+H]+ calc'd for C₁₆H₂₀BN₂O₈S+, 411.1033, found 411.1030.

### 6-Methyl-2-(1-((3-nitrophenyl)sulfonyl)aziridin-2-yl)-1,3,6,2-dioxazaborocane-4,8-dione (10)

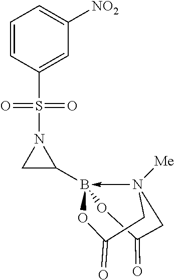

General procedure A with 3c (210 mg, 0.3 mmol), 3-nitrobenzenesulfonamide (73 mg, 0.36 mmol, 1.2 eq.) and K₂CO₃ (207 mg, 1.5 mmol, 5.0 eq.) to afford a white solid (100 mg, 88% yield). Rf=0.4 (hexanes:ethyl acetate=4:6). ¹H NMR (400 MHz, DMSO) δ 8.59 (ddd, J=8.2, 2.3, 1.0 Hz, 1H), 8.55 (t, J=2.0 Hz, 1H), 8.36 (dt, J=8.0, 1.3 Hz, 1H), 7.97 (t, J=8.0 Hz, 1H), 4.30 (dd, J=22.7, 17.1 Hz, 2H), 4.11 (d, J=Hz, 1H), 3.99 (d, J=17.0 Hz, 1H), 3.08 (s, 3H), 2.54 (d, J=8.4 Hz, 1H), 2.35 (dd, J=8.4, 5.6 Hz, 1H), 2.13 (d, J=5.6 Hz, 1H). ¹³C NMR (101 MHz, DMSO) δ 168.99, 168.37, 148.07, 138.54, 133.96, 131.74, 128.67, 122.63, 122.33, 119.13, 62.19, 62.17, 46.36, 38.89, 30.83. ¹¹B NMR (128 MHz, DMSO-d6). HRMS-ESI (m/z) [M+H]+ calc'd for C₁₃H₁₅O₈N₃BS 384.0667; found 384.0666.

### 6-Methyl-2-(1-((2-nitrophenyl)sulfonyl)aziridin-2-yl)-1,3,6,2-dioxazaborocane-4,8-dione (11)

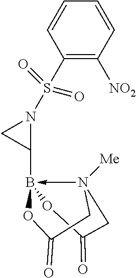

General procedure A with 3c (210 mg, 0.3 mmol), 2-nitrobenzenesulfonamide (73 mg, 0.36 mmol, 1.2 eq.) and K₂CO₃ (207 mg, 1.5 mmol, 5.0 eq.) to afford a white solid (87 mg, 75% yield). Rf=0.4 (hexanes:ethyl acetate=3:7). ¹H NMR (400 MHz, DMSO) δ 8.16 (dd, J=7.8, 1.4 Hz, 1H), 8.06 (dd, J=8.0, 1.4 Hz, 1H), 8.00 (td, J=7.7, 1.4 Hz, 1H), 7.92 (td, J=7.7, 1.4 Hz, 1H), 4.34 (dd, J=30.2, 17.0 Hz, 2H), 4.11 (d, J=17.2 Hz, 1H), 3.89 (d, J=16.9 Hz, 1H), 3.10 (s, 3H), 2.60 (d, J=8.4 Hz, 1H), 2.46 (dd, J=8.4, 5.6 Hz, 1H), 2.23 (d, J=5.6 Hz, 1H). ¹³C NMR (101 MHz, DMSO) δ 168.98, 167.96, 148.01, 135.88, 132.74, 130.83, 129.23, 124.56, 61.89, 61.84, 46.06, 32.21. ¹¹B NMR (128 MHz, DMSO-d6). HRMS-ESI (m/z) [M+H]+ calc'd for C₁₃H₁₅O₈N₃BS 384.0667; found 384.0674.

### 2-(1-((2-Bromophenyl)sulfonyl)aziridin-2-yl)-6-methyl-1,3,6,2-dioxazaborocane-4,8-dione (12)

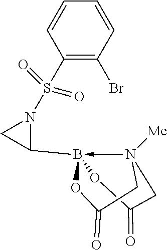

General procedure A with 3c (210 mg, 0.3 mmol), 2-bromobenzenesulfonamide (85 mg, 0.36 mmol, 1.2 eq.) and K₂CO₃ (207 mg, 1.5 mmol, 5.0 eq.) to afford a white solid (87 mg, 70% yield). Rf=0.4 (hexanes:ethyl acetate=4:6). ¹H NMR (400 MHz, DMSO) δ 8.04 (dd, J=6.0, 3.5 Hz, 1H), 7.95-7.90 (m, 1H), 7.69-7.59 (m, 2H), 4.32 (dd, J=45.9, 17.1 Hz, 2H), 4.10 (d, J=17.2 Hz, 1H), 3.90 (d, J=16.9 Hz, 1H), 3.11 (s, 3H), 2.52 (s, 1H), 2.39 (dd, J=8.3, 5.5 Hz, 1H), 2.10 (d, J=5.4 Hz, 1H). ¹³C NMR (101 MHz, DMSO) δ 169.09, 167.93, 137.10, 135.84, 135.38, 131.19, 128.43, 120.56, 61.98, 61.87, 46.12, 31.56. ¹¹B NMR (128 MHz, DMSO-d6). HRMS-ESI (m/z) [M+H]+ calc'd for C₁₃H₁₅O₆N₂BBrS 416.9922; found 416.9922.

### 2-(1-((2-Chlorophenyl)sulfonyl)aziridin-2-yl)-6-methyl-1,3,6,2-dioxazaborocane-4,8-dione (13)

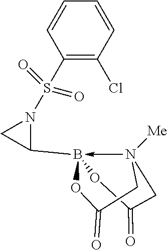

General procedure A with 2 (210 mg, 0.3 mmol), 2-chlorobenzenesulfonamide (70 mg, 0.36 mmol, 1.2 eq.) and K₂CO₃ (207 mg, 1.5 mmol, 5.0 eq.) to afford a white solid (87 mg, 78% yield). Rf=0.4 (hexanes:ethyl acetate=4:6). ¹H NMR (400 MHz, DMSO) δ 8.03 (dt, J=7.9, 1.1 Hz, 1H), 7.79-7.71 (m, 2H), 7.65-7.54 (m, 1H), 4.32 (dd, J=41.5, 17.0 Hz, 2H), 4.10 (d, J=17.2 Hz, 1H), 3.85 (d, J=16.9 Hz, 1H), 3.09 (s, 3H), 2.53 (d, J=8.4 Hz, 1H), 2.39 (dd, J=8.4, 5.6 Hz, 1H), 2.13 (d, J=5.5 Hz, 1H). ¹³C NMR (101 MHz, DMSO) δ 169.06, 167.95, 135.47, 135.37, 132.34, 131.96, 130.99, 127.96, 61.85, 61.81, 46.05, 31.57. ¹¹B NMR (128 MHz, DMSO-d6). HRMS-ESI (m/z) [M+H]+ calc'd for C₁₃H₁₅O₆N₂BClS 373.0427; found 373.0428.

### 6-Methyl-2-(1-(thiophen-2-ylsulfonyl)aziridin-2-yl)-1,3,6,2-dioxazaborocane-4,8-dione (14)

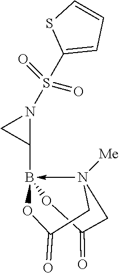

General procedure A with 3c (210 mg, 0.3 mmol), thiophene-2-sulfonamide (59 mg, 0.36 mmol, 1.2 eq.) and K₂CO₃ (207 mg, 1.5 mmol, 5.0 eq.) to afford a white solid (73 mg, 70% yield). Rf=0.4 (hexanes:ethyl acetate=4:6). ¹H NMR (400 MHz, DMSO) δ 8.14 (dd, J=5.0, 1.3 Hz, 1H), 7.79 (dd, J=3.8, 1.4 Hz, 1H), 7.29 (dd, J=5.0, 3.8 Hz, 1H), 4.31 (dd, J=24.2, 17.1 Hz, 2H), 4.10 (d, J=17.1 Hz, 1H), 3.90 (d, J=17.0 Hz, 1H), 3.05 (s, 3H), 2.34 (d, J=8.2 Hz, 1H), 2.21-2.09 (in, 2H). ¹³C NMR (101 MHz, DMSO) δ 169.40, 168.69, 136.12, 135.92, 135.30, 128.68, 62.55, 62.50, 55.38, 46.72, 30.64, 29.48. ¹¹B NMR (128 MHz, DMSO-d6). HRMS-ESI (m/z) [M+H]+ calc'd for C₁₁H₁₄O₆N₂BS₂ 345.0381; found 345.0382.

### 6-Methyl-2-(1-(pyridin-2-ylsulfonyl)aziridin-2-yl)-1,3,6,2-dioxazaborocane-4,8-dione (15)

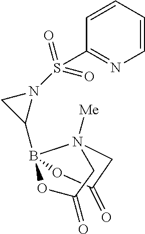

General procedure A with 3c (210 mg, 0.3 mmol), pyridine-2-sulfonamide (57.1 mg, 0.36 mmol, 1.2 eq.) and K₂CO₃ (207 mg, 1.5 mmol, 5.0 eq.) to afford a white solid (45 mg, 45% yield). Rf=0.4 (hexanes:Acetone 3:7). H NMR (400 MHz, DMSO) δ 8.86 (ddd, J=4.7, 1.7, 0.9 Hz, 1H), 8.22 (td, J=7.7, 1.7 Hz, 1H), 8.13 (dt, J=7.9, 1.1 Hz, 1H), 7.84 (ddd, J=7.6, 4.7, 1.2 Hz, 1H), 4.36 (dd, J=29.9, 17.1 Hz, 2H), 4.17 (d, J=17.1 Hz, 1H), 3.96 (d, J=17.0 Hz, 1H), 3.16 (s, 3H), 2.64 (d, J=8.3 Hz, 1H), 2.38 (dd, J=8.3, 5.6 Hz, 1H), 2.21 (d, J=5.5 Hz, 1H). ¹¹B NMR (128 MHz, DMSO) δ 8.44. ¹³C NMR (101 MHz, DMSO) δ 169.42, 168.69, 155.21, 150.87, 139.55, 128.69, 123.61, 62.47, 46.71, 31.31. HRMS-ESI (m/z) [M+H]+ calc'd for C₁₂H₁₅BN₃O₆S+, 340.0775, found 340.0772.

### 2-(1-(Benzylsulfonyl)aziridin-2-yl)-6-methyl-1,3,6,2-dioxazaborocane-4,8-dione (16)

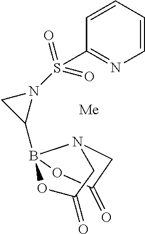

General procedure A with 3c (210 mg, 0.3 mmol), phenylmethanesulfonamide (62 mg, 0.36 mmol, 1.2 eq.) and K₂CO₃ (207 mg, 1.5 mmol, 5.0 eq.) to afford a white solid (120 mg, 61% yield). Rf=0.45 (hexanes:ethyl acetate=1:9). ¹H NMR (400 MHz, DMF) δ 7.65-7.51 (m, 5H), 4.81 (s, 2H), 4.50 (d, J=17.2 Hz, 1H), 4.39 (d, J=16.8 Hz, 1H), 4.24 (d, J=17.1 Hz, 1H), 3.95 (d, J=16.9 Hz, 1H), 3.22 (s, 3H), 2.42 (d, J=8.2 Hz, 1H), 2.30 (dd, J=8.2, 5.5 Hz, 1H), 2.20 (d, J=5.4 Hz, 1H). ¹¹B NMR (128 MHz, DMSO) δ 9.67. ¹³C NMR (101 MHz, DMF) δ 169.94, 169.07, 131.94, 129.83, 129.24, 129.22, 62.77, 57.83, 46.94, 31.82. HRMS-ESI (m/z) [M+H]+ calc'd for C₁₄H₁₈BN₂O₆S+, 353.0979, found 353.2078.

### 2-(1-(Cyclopropylsulfonyl)aziridin-2-yl)-6-methyl-1,3,6,2-dioxazaborocane-4,8-dione (17)

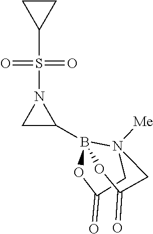

General procedure A with 3c (210 mg, 0.3 mmol), cyclopropanesulfonamide (40 mg, 0.36 mmol, 1.2 eq.) and K₂CO₃ (207 mg, 1.5 mmol, 5.0 eq.) to afford a white solid (68 mg, 75% yield). Rf=0.4 (hexanes:ethyl acetate=4:6). ¹H NMR (400 MHz, DMSO) δ 4.34 (dd, J=31.2, 17.1 Hz, 2H), 4.13 (d, J=17.1 Hz, 1H), 3.95 (d, J=16.9 Hz, 1H), 3.12 (s, 3H), 2.84 (tt, J=7.9, 4.9 Hz, 1H), 2.44-2.38 (m, 1H), 2.15-2.11 (m, 2H), 1.15-1.01 (m, 4H). ¹¹B NMR (128 MHz, DMSO) δ 8.19. ¹³C NMR (101 MHz, DMSO) δ 167.40, 166.66, 60.33, 60.28, 28.06, 26.27, 3.30, 3.07. HRMS-ESI (m/z) [M+H]+ calc'd for C₁₀H₁₅BN₂O₆S+, 303.0822, found 303.0808.

### 6-Methyl-2-(1-(pyrrolidin-1-ylsulfonyl)aziridin-2-yl)-1,3,6,2-dioxazaborocane-4,8-dione (18)

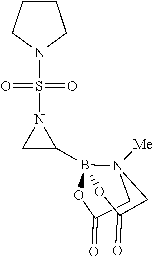

General procedure A with 3c (210 mg, 0.3 mmol), pyrrolidine-1-sulfonamide (54.2 mg, 0.36 mmol, 1.2 eq.) and K₂CO₃ (207 mg, 1.5 mmol, 5.0 eq.) to afford a white solid (74 mg, 75% yield). Rf=0.5 (hexanes:ethyl acetate=2:8). ¹H NMR (400 MHz, DMSO) δ 4.28 (d, J=17.2 Hz, 1H), 4.17 (d, J=16.8 Hz, 1H), 4.00 (d, J=Hz, 1H), 3.83 (d, J=16.9 Hz, 1H), 3.25-3.20 (m, 4H), 3.00 (s, 3H), 2.29 (d, J=8.4 Hz, 1H), 1.97 (d, J=5.3 Hz, 1H), 1.85-1.75 (m, 5H). ¹¹B NMR (128 MHz, DMSO) δ 8.77. ¹³C NMR (101 MHz, DMSO) δ 169.70, 168.57, 62.24, 62.20, 46.51, 45.52, 29.43, 23.27, 11.60. HRMS-ESI (m/z) [M+H]+ calc'd for C₁₁H₂₀BN₃O₆S+, 332.1088, found 332.1084.

### 2-(6-Methyl-4,8-dioxo-1,3,6,2-dioxazaborocan-2-yl)-N-propylaziridine-1-sulfonamide (19)

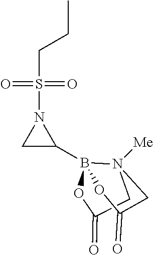

General procedure A with 3c (210 mg, 0.3 mmol), propane-1-sulfonamide (44 mg, 0.36 mmol, 1.2 eq.) and K₂CO₃ (207 mg, 1.5 mmol, 5.0 eq.) to afford a white solid (60 mg, 67% yield). Rf=0.4 (hexanes:ethyl acetate=4:6). ¹H NMR (400 MHz, DMSO) δ 7.32 (t, J=5.8 Hz, 1H), 4.29 (d, J=17.2 Hz, 1H), 4.17 (d, J=16.8 Hz, 1H), 4.00 (d, J=17.2 Hz, 1H), 3.75 (d, J=16.8 Hz, 1H), 3.02 (s, 3H), 2.90 (td, J=7.2, 5.9 Hz, 2H), 2.15 (d, J=8.3 Hz, 1H), 1.88 (d, J=5.1 Hz, 1H), 1.78 (dd, J=8.1, 5.2 Hz, 1H), 1.40 (h, J=7.3 Hz, 2H), 0.79 (t, J=7.4 Hz, 3H). ¹¹B NMR (128 MHz, DMSO) δ 9.21. ¹³C NMR (101 MHz, DMSO) δ 169.70, 168.57, 62.24, 62.20, 46.51, 45.52, 29.43, 23.27, 11.60. HRMS-ESI (m/z) [M+H]+ calc'd for C₁₀H₁₉BN₃O₆S+, 320.1088, found 320.1081.

### 4-Nitrobenzyl (2S,4S)-4-(acetylthio)-2-(((N-(tert-butoxycarbonyl)-2-(6-methyl-4,8-dioxo-1,3,6,2-dioxazaborocan-2-yl)aziridine)-1-sulfonamido)methyl)pyrrolidine-1-carboxylate (20)

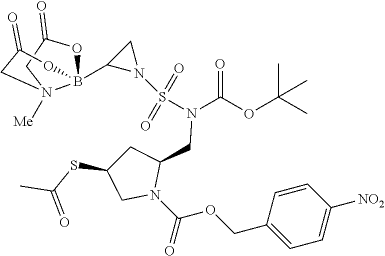

General procedure A with 3c (210 mg, 0.3 mmol), Doripenem side chain (192.3 mg, 0.36 mmol, 1.2 eq.) and K₂CO₃ (207 mg, 1.5 mmol, 5.0 eq.) to afford a white solid (145 mg, 68% yield). Rf=0.3 (dichloromethane:methanol=9:1). ¹H NMR (400 MHz, DMSO) δ 8.20 (d, J=8.2 Hz, 2H), 7.62 (d, J=8.5 Hz, 2H), 5.42-4.92 (m, 2H), 4.49-3.63 (m, 9H), 3.08 (s, 4H), 2.67 (d, J=8.0 Hz, 1H), 2.49-2.41 (m, 1H), 2.33 (d, J=1.5 Hz, 3H), 2.29-2.14 (m, 2H), 1.69 (s, 1H), 1.41 (t, J=10.6 Hz, 9H). ¹¹B NMR (128 MHz, DMSO) δ 9.21. ¹³C NMR (101 MHz, DMSO) δ 195.54, 195.51, 169.44, 168.57, 154.22, 151.00, 150.97, 147.41, 145.32, 128.66, 123.95, 84.58, 65.50, 62.40, 52.27, 46.67, 33.41, 30.95, 30.93, 27.90, 1.63. HRMS-ESI (m/z) [M+H]+ calc'd for C₂₇H₃₇BN₅O₁₃S₂+, 714.1922, found 714.1923.

### 6-Methyl-2-(1-(3-nitrobenzyl)aziridin-2-yl)-1,3,6,2-dioxazaborocane-4,8-dione (21)

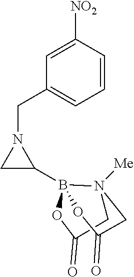

General procedure B with 3c (210 mg, 0.3 mmol), (3,4-dichlorophenyl)methanamine (63.2 mg, 0.36 mmol, 1.2 eq.) and Cs₂CO₃ (295 mg, 0.9 mmol, 3.0 eq.) to afford a white solid (77 mg, 73% yield). Rf=0.2 (dichloromethane:methanol=9:1). ¹H NMR (400 MHz, DMSO) δ 8.23 (t, J=2.0 Hz, 1H), 8.13 (ddd, J=8.2, 2.4, 1.1 Hz, 1H), 7.82 (dt, J=7.7, 1.4 Hz, 1H), 7.63 (t, J=7.9 Hz, 1H), 4.27 (d, J=17.2 Hz, 1H), 4.14 (d, J=16.8 Hz, 1H), 4.01 (d, J=17.2 Hz, 1H), 3.96 (d, J=13.6 Hz, 1H), 3.89 (d, J=16.8 Hz, 1H), 2.99 (d, J=13.6 Hz, 1H), 2.92 (s, 3H), 1.54 (dd, J=4.3, 1.6 Hz, 1H), 1.40 (dd, J=7.4, 1.7 Hz, 1H), 0.82 (dd, J=7.5, 4.3 Hz, 1H). ¹³C NMR (101 MHz, DMSO) δ 169.49, 168.49, 147.73, 142.39, 134.96, 129.64, 122.63, 121.83, 63.91, 61.90, 61.68, 48.59, 46.20, 30.67. ¹¹B NMR (128 MHz, DMSO) δ 13.26.). HRMS-ESI (m/z) [M+H]+ calc'd for C₁₄H₁₆O₆N₃B 334.1205; found 334.1207.

### 3-((2-(6-Methyl-4,8-dioxo-1,3,6,2-dioxazaborocan-2-yl)aziridin-1-yl)methyl)benzonitrile (22)

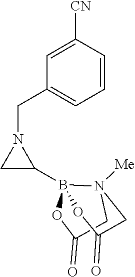

General procedure B with 3c (210 mg, 0.3 mmol), 3-(aminomethyl)benzonitrile (47.7 mg, 0.36 mmol, 1.2 eq.) and Cs₂CO₃ (295 mg, 0.9 mmol, 3.0 eq.) to afford a white solid (42 mg, 45% yield). Rf=0.5 (dichloromethane:methanol=9:1). ¹H NMR (400 MHz, DMSO) δ 7.74 (s, 1H), 7.65 (t, J=7.5 Hz, 2H), 7.48 (t, J=7.7 Hz, 1H), 4.20 (d, J=17.2 Hz, 1H), 4.07 (d, J=16.8 Hz, 1H), 3.94 (d, J=17.2 Hz, 1H), 3.85-3.73 (m, 2H), 2.86 (d, J=14.4 Hz, 4H), 1.46 (d, J=4.1 Hz, 1H), 1.35-1.28 (m, 1H), 0.73 (dd, J=7.4, 4.3 Hz, 1H). ¹³C NMR (101 MHz, DMSO) δ 169.51, 168.48, 141.67, 133.23, 131.73, 130.69, 129.39, 118.92, 111.11, 64.07, 61.90, 61.66, 54.91, 46.13, 30.73, 30.70. ¹¹B NMR (128 MHz, DMSO) δ 11.73. HRMS-ESI (m/z) [M+H]+ calc'd for C₁₅H₁₇O₄N₃B 314.1307; found 312.1297.

### 6-Methyl-2-(1-(4-(trifluoromethyl)benzyl)aziridin-2-yl)-1,3,6,2-dioxazaborocane-4,8-dione (23)

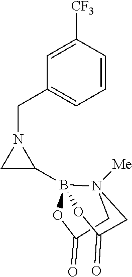

General procedure B with 3c (210 mg, 0.3 mmol), (4-(trifluoromethyl)phenyl)methanamine (63.3 mg, 0.36 mmol, 1.2 eq.) and Cs₂CO₃ (295 mg, 0.9 mmol, 3.0 eq.) to afford a white solid (73 mg, 68% yield). Rf=0.5 (dichloromethane:methanol=9:1). ¹H NMR (400 MHz, MeOD) δ 7.64 (d, J=8.2 Hz, 2H), 7.59 (d, J=8.2 Hz, 2H), 4.13 (dd, J=20.7, 17.0 Hz, 2H), 4.00 (d, J=17.1 Hz, 1H), 3.86 (d, J=16.8 Hz, 1H), 3.64 (d, J=13.6 Hz, 1H), 3.42 (d, J=13.7 Hz, 1H), 2.85 (s, 3H), 1.86 (d, J=4.5 Hz, 1H), 1.60 (d, J=7.6 Hz, 1H), 0.97 (dd, J=7.7, 4.5 Hz, 1H). ¹⁹F NMR (376 MHz, MeOD) δ −63.87. ¹¹B NMR (128 MHz, MeOD) δ10.34. ¹³C NMR (101 MHz, MeOD) δ 172.96, 172.66, 170.88, 170.42, 165.56, 162.65, 144.90, 138.01, 131.31, 130.18, 129.87, 127.07, 126.69, 126.66, 126.34, 126.31, 66.07, 59.91, 57.67, 54.81, 42.97, 42.46, 32.12. HRMS-ESI (m/z) [M+H]+ calc'd for C₁₅H₁₇O₄N₂BF₃ 357.1228; found 357.1222.

### 2-(1-(3,4-Dichlorobenzyl)aziridin-2-yl)-6-methyl-1,3,6,2-dioxazaborocane-4,8-dione (24)

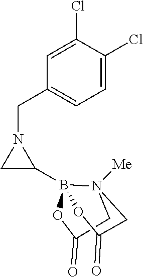

General procedure B with 3c (210 mg, 0.3 mmol), (3,4-dichlorophenyl)methanamine (63.2 mg, 0.36 mmol, 1.2 eq.) and Cs₂CO₃ (295 mg, 0.9 mmol, 3.0 eq.) to afford a white solid (65 mg, 61% yield). Rf=0.2 (dichloromethane:methanol=9:1). ¹H NMR (400 MHz, DMSO) δ 7.57-7.49 (m, 2H), 7.29 (dt, J=8.3, 1.7 Hz, 1H), 4.20 (dd, J=1.3 Hz, 1H), 4.07 (dd, J=16.8, 1.3 Hz, 1H), 3.99-3.93 (m, 1H), 3.86-3.69 (m, 2H), 2.85 (s, 3H), 2.79 (d, J=13.5 Hz, 1H), 1.49-1.43 (m, 1H), 1.28 (dd, J=7.4, 1.6 Hz, 1H), 0.71 (dd, J=7.5, 4.3 Hz, 1H). ¹¹B NMR (128 MHz, DMSO) δ 9.92. ¹³C NMR (101 MHz, DMSO) δ 169.97, 168.94, 141.75, 131.19, 130.76, 130.54, 129.76, 129.00, 64.06, 62.36, 62.13, 46.61, 31.12. HRMS-ESI (m/z) [M+H]+ calc'd for C₁₄H₁₆BCl₂N₂O₄+, 357.0580, found 357.0576.

### 6-Methyl-2-(1-(4-(4,4,5,5-tetramethyl-1,3,2-dioxaborolan-2-yl)benzyl)aziridin-2-yl)-1,3,6,2-dioxazaborocane-4,8-dione (25)

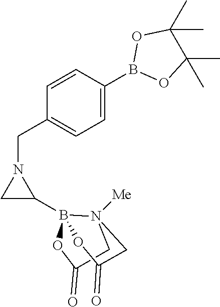

General procedure B with 3c (210 mg, 0.3 mmol), (4-(4,4,5,5-tetramethyl-1,3,2-dioxaborolan-2-yl)phenyl)methanamine (84.3 mg, 0.36 mmol, 1.2 eq.) and Cs₂CO₃ (295 mg, 0.9 mmol, 3.0 eq.) to afford a white solid (76 mg, 61% yield). Rf=0.5 (dichloromethane:methanol=9:1). ¹H NMR (400 MHz, DMSO) δ 7.56 (d, J=7.7 Hz, 2H), 7.29 (d, J=7.7 Hz, 2H), 4.18 (d, J=Hz, 1H), 4.04 (d, J=16.7 Hz, 1H), 3.91 (dd, J=17.1, 8.0 Hz, 1H), 3.70 (d, J=16.7 Hz, 1H), 3.61 (d, J=13.3 Hz, 1H), 2.96 (d, J=13.4 Hz, 1H), 2.73 (s, 3H), 1.50-1.42 (m, 1H), 1.22 (s, 13H), 0.67 (dd, J=7.5, 4.2 Hz, 1H). ¹¹B NMR (128 MHz, DMSO) δ 13.72, 1.14. ¹³C NMR (101 MHz, DMSO) δ 169.98, 169.64, 168.86, 143.83, 134.84, 128.27, 84.04, 65.79, 62.27, 62.06, 46.35, 31.13, 25.16, 25.14. HRMS-ESI (m/z) [M+H]+ calc'd for C₂₀H₂₉O₆N₂B₂ 415.2212; found 415.2174.

### 6-Methyl-2-(1-((3-phenyl-1,2,4-oxadiazol-5-yl)methyl)aziridin-2-yl)-1,3,6,2-dioxazaborocane-4,8-dione (26)

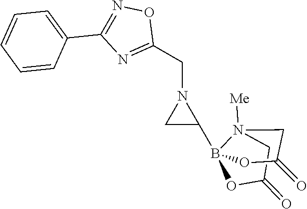

General procedure B with 3c (210 mg, 0.3 mmol), (3-phenyl-1,2,4-oxadiazol-5-yl)methanamine (63.3 mg, 0.36 mmol, 1.2 eq.) and Cs₂CO₃ (295 mg, 0.9 mmol, 3.0 eq.) to afford a white solid (59 mg, 55% yield). Rf=0.6 (dichloromethane:methanol=9:1). ¹H NMR (400 MHz, DMSO) δ 8.07-7.95 (m, 2H), 7.65-7.51 (m, 3H), 4.29 (d, J=17.2 Hz, 1H), 4.19 (d, J=16.7 Hz, 1H), 4.10 (d, J=15.2 Hz, 1H), 4.03 (d, J=12.5 Hz, 1H), 3.99 (d, J=12.0 Hz, 1H), 3.50 (d, J=15.3 Hz, 1H), 3.00 (s, 3H), 1.66 (dd, J=4.5, 1.3 Hz, 1H), 1.60 (dd, J=7, 1.2 Hz, 1H), 0.96 (dd, J=7.6, 4.4 Hz, 1H). ¹³C NMR (101 MHz, DMSO) δ 177.92, 169.46, 168.64, 168.48, 167.55, 131.65, 129.35, 127.05, 126.11, 61.72, 61.70, 61.40, 55.42, 48.62, 46.06, 30.58. ¹¹B NMR (128 MHz, DMSO) δ 5.20. HRMS-ESI (m/z) [M+H]+ calc'd for C₁₆H₁₈O₅N₄B 357.1365; found 357.1364.

### 6-Methyl-2-(1-((6-(trifluoromethyl)pyridin-3-yl)methyl)aziridin-2-yl)-1,3,6,2-dioxazaborocane-4,8-dione (27)

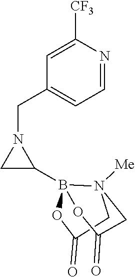

General procedure B with 3c (210 mg, 0.3 mmol), (6-(trifluoromethyl)pyridin-3-yl)methanamine (63.6 mg, 0.36 mmol, 1.2 eq.) and Cs₂CO₃ (295 mg, 0.9 mmol, 3.0 eq.) to afford a white solid (66 mg, 62% yield). Rf=0.2 (dichloromethane:methanol=9:1). ¹H NMR (400 MHz, DMSO) δ 8.66 (dd, J=5.3, 2.0 Hz, 1H), 8.00 (td, J=7.9, 2.1 Hz, 1H), 7.81 (d, J=8.2 Hz, 1H), 4.22 (d, J=17.3 Hz, 1H), 4.09 (d, J=16.8 Hz, 1H), 3.97 (d, J=17.2 Hz, 1H), 3.91-3.80 (m, 2H), 2.92 (d, J=20.3 Hz, 4H), 1.48 (dd, J=4.3, 1.6 Hz, 1H), 1.35 (dd, J=7.4, 1.6 Hz, 1H), 0.79 (dd, J=7.5, 4.3 Hz, 1H). ¹⁹F NMR (376 MHz, DMSO) δ −66.19. ¹¹B NMR (128 MHz, DMSO) δ 13.89. ¹³C NMR (101 MHz, DMSO) δ 169.94, 168.98, 150.30, 149.86, 145.72, 145.39, 140.01, 138.17, 137.25, 62.40, 62.14, 55.35, 46.68, 31.13. HRMS (ESI-MS) m/z: [M+H]+ Calcd for C₁₄H₁₆O₄N₃BF₃ 358.1186; found 358.1175.

### 2-(1-((6-Chloropyridin-3-yl)methyl)aziridin-2-yl)-6-methyl-1,3,6,2-dioxazaborocane-4,8-dione (28)

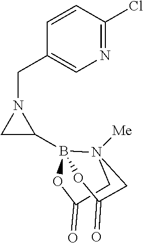

General procedure B with 3c (210 mg, 0.3 mmol), (6-chloropyridin-3-yl)methanamine (52 mg, 0.36 mmol, 1.2 eq.) and Cs₂CO₃ (295 mg, 0.9 mmol, 3.0 eq.) to afford a white solid (76 mg, 75% yield). Rf=0.2 (dichloromethane:methanol=9:1). ¹H NMR (400 MHz, DMSO) δ 7.98 (d, J=2.4 Hz, 1H), 7.47 (dd, J=8.2, 2.5 Hz, 1H), 7.09 (d, J=8.2 Hz, 1H), 3.81 (dd, J=49.9, 17.0 Hz, 2H), 3.63 (d, J=17.2 Hz, 1H), 3.55-3.36 (m, 2H), 2.54 (s, 3H), 1.12 (dd, J=4.2, 1.6 Hz, 1H), 0.99 (dd, J=7.5, 1.6 Hz, 1H), 0.42 (dd, J=7.4, 4.3 Hz, 1H). ¹¹B NMR (128 MHz, DMSO) δ 12.24. ¹³C NMR (101 MHz, DMSO) δ 169.95, 168.96, 149.93, 149.27, 140.22, 135.47, 124.37, 62.38, 62.14, 55.37, 46.65, 31.04. HRMS-ESI (m/z) [M+H]+ calc'd for C₁₃H₁₆O₄N₃BCl 324.0922; found 324.0891.

### 2-(1-((2-Chlorothiazol-5-yl)methyl)aziridin-2-yl)-6-methyl-1,3,6,2-dioxazaborocane-4,8-dione (29)

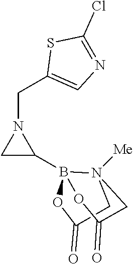

General procedure B with 3c (210 mg, 0.3 mmol), (2-chlorothiazol-5-yl)methanamine (54 mg, 0.36 mmol, 1.2 eq.) and Cs₂CO₃ (295 mg, 0.9 mmol, 3.0 eq.) to afford a white solid (77 mg, 78% yield). Rf=0.4 (dichloromethane:methanol=95:5). ¹H NMR (400 MHz, DMSO) δ 7.58 (s, 1H), 4.32 (d, J=17.2 Hz, 1H), 4.21 (d, J=16.8 Hz, 1H), 4.14-3.88 (m, 4H), 3.21-3.14 (m, 1H), 2.99 (s, 3H), 1.57 (dd, J=4.4, 1.4 Hz, 1H), 1.45 (dd, J=7.5, 1.5 Hz, 1H), 0.90 (dd, J=7.6, 4.4 Hz, 1H). ¹³C NMR (101 MHz, DMSO) δ 169.87, 168.93, 149.80, 141.33, 139.07, 62.34, 62.14, 57.25, 46.59, 30.98. HRMS-ESI (m/z) [M+H]+ calc'd for C₁₁H₁₄BClN₃O₄S, 330.0487, found 330.0482.

### 6-Methyl-2-((R)-1-((R)-1-(4-(trifluoromethyl)phenyl)ethyl)aziridin-2-yl)-1,3,6,2-dioxazaborocane-4,8-dione (30)

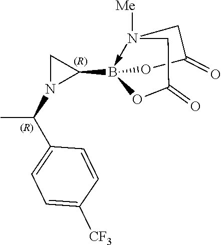

General procedure B with 3c (210 mg, 0.3 mmol), (R)-1-(4-(trifluoromethyl)phenyl)ethan-1-amine HCl salt (81.3 mg, 0.36 mmol, 1.2 eq.) and Cs₂CO₃ (490 mg, 1.5 mmol, 5.0 eq.) to afford a white solid (68 mg, 61% yield). Rf=0.45 (dichloromethane:methanol-=95:5). ¹H NMR (400 MHz, DMSO) δ 8.26 (d, J=8.2 Hz, 2H), 8.16 (d, J=8.0 Hz, 2H), 4.52 (d, J=33.9 Hz, 1H), 4.35 (s, 1H), 4.20 (d, J=17.1 Hz, 1H), 3.91 (d, J=16.5 Hz, 1H), 3.03 (q, J=6.5 Hz, 1H), 2.70 (s, 3H), 2.29 (dd, J=4.3, 1.3 Hz, 1H), 2.06-2.02 (m, 1H), 2.00 (d, J=6.5 Hz, 3H), 1.29 (dd, J=7.7, 4.2 Hz, 1H). ¹¹B NMR (128 MHz, DMSO) δ 10.82. ¹³C NMR (101 MHz, CD₃CN) δ 167.80, 166.84, 166.56, 149.40, 128.36, 128.04, 127.37, 126.31, 124.95, 124.67, 122.26, 70.29, 60.71, 60.61, 60.47, 46.95, 43.42, 28.83, 21.52. HRMS-ESI (m/z) [M+H]+ calc'd for C₁₆H₁₉BF₃N₂O₄, 371.1390, found 371.1383.

### 2-((R)-1-((R)-1-(4-Chlorophenyl)ethyl)aziridin-2-yl)-6-methyl-1,3,6,2-dioxazaborocane-4,8-dione (31)

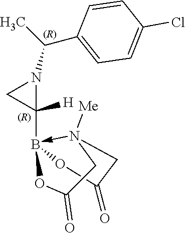

General procedure B with 3c (210 mg, 0.3 mmol), (R)-1-(4-chlorophenyl)ethan-1-amine HCl salt (56 mg, 0.36 mmol, 1.2 eq.) and Cs₂CO₃ (490 mg, 1.5 mmol, 5.0 eq.) to afford a white solid (61 mg, 61% yield). Rf=0.3 (dichloromethane:methanol=9:1). ¹H NMR (400 MHz, DMSO) δ 7.32 (s, 4H), 4.08 (d, J=17.3 Hz, 1H), 3.97-3.87 (m, 1H), 3.73 (d, J=17.2 Hz, 1H), 3.29 (d, J=16.5 Hz, 2H), 2.27 (q, J=6.5 Hz, 1H), 2.09 (s, 3H), 1.51 (dd, J=4.2, 1.5 Hz, 1H), 1.31 (dd, J=7.6, 1.5 Hz, 1H), 1.25 (d, J=6.5 Hz, 3H), 0.59 (dd, J=7.6, 4.2 Hz, 1H). ¹¹B NMR (128 MHz, DMSO) δ 5.20. ¹³C NMR (101 MHz, DMSO) δ 169.84, 168.48, 144.79, 132.12, 129.61, 128.85, 70.60, 61.90, 61.84, 61.66, 44.86, 30.10, 23.67. HRMS-ESI (m/z) [M+H]+ calc'd for C₁₅H₁₉BClN₂O₄, 337.1120, found 337.1116.

### 6-Methyl-2-(1-(prop-2-yn-1-yl)aziridin-2-yl)-1,3,6,2-dioxazaborocane-4,8-dione (32)

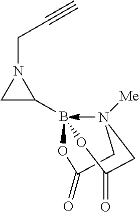

General procedure B with 3c (210 mg, 0.3 mmol), prop-2-yn-1-amine (20 mg, 0.36 mmol, 1.2 eq.) and Cs₂CO₃ (295 mg, 0.9 mmol, 3.0 eq.) to afford a white solid (41 mg, 58% yield). Rf=0.4 (dichloromethane:methanol=9:1). ¹H NMR (400 MHz, DMSO) δ 4.27 (d, J=17.3 Hz, 1H), 4.14 (d, J=16.7 Hz, 1H), 4.00 (d, J=Hz, 1H), 3.85 (d, J=16.6 Hz, 1H), 3.24 (dd, J=16.5, 2.5 Hz, 1H), 3.17 (t, J=2.5 Hz, 1H), 3.08 (d, J=2.5 Hz, 1H), 3.03 (s, 3H), 1.44 (dd, J=4.3, 1.5 Hz, 1H), 1.34 (dd, J=7.6, 1.5 Hz, 1H), 0.73 (dd, J=7.6, 4.3 Hz, 1H).) 6 ¹³C NMR (101 MHz, DMSO) δ 169.55, 168.32, 80.85, 75.09, 61.83, 61.59, 54.91, 48.11, 46.23, 28.88. ¹¹B NMR (128 MHz, DMSO) δ 8.49. HRMS-ESI (m/z) [M+H]+ calc'd for C₁₀H₁₄O₄N₂B 237.1041; found 237.1037.

### 2-(1-(2-(1H-Indol-3-yl)ethyl)aziridin-2-yl)-6-methyl-1,3,6,2-dioxazaborocane-4,8-dione (33)

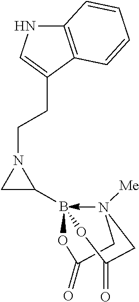

General procedure B with 3c (210 mg, 0.3 mmol), Tryptamine (58 mg, 0.36 mmol, 1.2 eq.) and Cs₂CO₃ (295 mg, 0.9 mmol, 3.0 eq.) to afford a white solid (56 mg, 54% yield). Rf=0.2 (dichloromethane:methanol=85:15). ¹H NMR (400 MHz, CD₃CN) δ 9.29 (s, 1H), 7.52 (d, J=8.0 Hz, 1H), 7.35 (d, J=8.1 Hz, 1H), 7.15-7.06 (m, 2H), 7.00 (ddd, J=8.0, 6.9, 1.1 Hz, 1H), 4.12-3.91 (m, 4H), 3.69 (s, 1H), 3.45-3.36 (m, 1H), 3.16-3.12 (m, 2H), 3.00 (s, 3H), 2.69-2.62 (m, 2H), 2.32 (dd, J=9.2, 8.2 Hz, 1H). ¹¹B NMR (128 MHz, CD₃CN) δ 8.94. ¹³C NMR (101 MHz, CD₃CN) δ 168.13, 167.76, 137.18, 127.43, 124.28, 122.39, 119.72, 118.77, 112.18, 109.76, 63.81, 63.58, 55.82, 47.80, 33.39, 23.12. HRMS-ESI (m/z) [M+H]+ calc'd for C₁₇H₂₁BN₃O₄ 342.1625; found 342.1619.

### Methyl 3-(2-(6-methyl-4,8-dioxo-1,3,6,2-dioxazaborocan-2-yl)aziridin-1-yl)bicyclo[1.1.1]pentane-1-carboxylate (34)

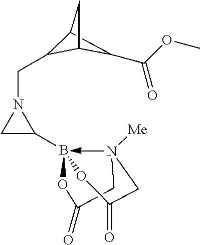

General procedure B with 3c (210 mg, 0.3 mmol), methyl 3-aminobicyclo[1.1.1]pentane-1-carboxylate hydrochloride (64 mg, 0.36 mmol, 1.2 eq.) and Cs₂CO₃ (295 mg, 0.9 mmol, 3.0 eq.) to afford a white solid (68 mg, 71% yield). Rf=0.3 (dichloromethane:methanol=95:5). ¹H NMR (400 MHz, DMSO) δ 4.20 (d, J=17.1 Hz, 1H), 4.10 (d, J=16.9 Hz, 1H), 3.98 (d, J=17.2 Hz, 1H), 3.77 (d, J=16.8 Hz, 1H), 3.52 (s, 3H), 2.91 (s, 3H), 1.81 (s, 6H), 1.35-1.31 (m, 2H), 0.84-0.63 (m, 1H). ¹¹B NMR (128 MHz, DMSO) δ 13.41. ¹³C NMR (101 MHz, DMSO) δ 170.59, 169.82, 168.94, 62.59, 62.19, 58.44, 51.97, 50.82, 46.84, 33.18, 27.30. HRMS-ESI (m/z) [M]+ calc'd for C₁₄H₂₀BN₂O₆, 323.1414, found 323.1408.

### tert-Butyl (S)-4-methyl-2-((S)-2-(6-methyl-4,8-dioxo-1,3,6,2-dioxazaborocan-2-yl)aziridin-1-yl)pentanoate (35)

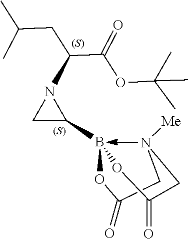

General procedure B with 3c (210 mg, 0.3 mmol), tert-butyl L-leucinate (67.6 mg, 0.36 mmol, 1.2 eq.) and Cs₂CO₃ (295 mg, 0.9 mmol, 3.0 eq.) to afford a white solid (79 mg, 72% yield). Rf=0.3 (dichloromethane:methanol=9:1). ¹H NMR (400 MHz, DMSO) δ 4.30-4.23 (m, 1H), 4.13 (d, J=16.2 Hz, 1H), 3.97 (dd, J=20.7, 16.8 Hz, 2H), 2.92 (s, 3H), 1.98 (dd, J=8.3, 4.8 Hz, 1H), 1.62 (ddt, J=18.9, 13.2, 6.0 Hz, 2H), 1.48 (dd, J=4.3, 1.4 Hz, 1H), 1.41 (s, 10H), 1.25 (dd, J=7.6, 1.5 Hz, 1H), 0.87 (dd, J=8.1, 6.3 Hz, 6H), 0.74 (dd, J=7.6, 4.2 Hz, 1H). ¹¹B NMR (128 MHz, DMSO) δ 10.15. ¹³C NMR (101 MHz, DMSO) δ 173.44, 170.06, 168.65, 81.03, 72.91, 61.85, 61.48, 45.42, 42.90, 28.84, 28.11, 25.12, 23.81, 22.60. HRMS-ESI (m/z) [M+H]+ calc'd for C₁₇H₃₀BN₂O₆, 369.2197, found 369.2192.

### Methyl (S)-3-cyclohexyl-2-((S)-2-(6-methyl-4,8-dioxo-1,3,6,2-dioxazaborocan-2-yl)aziridin-1-yl)propanoate (36)

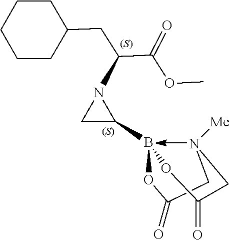

General procedure B with 3c (210 mg, 0.3 mmol), L-CHA-OMe-HCl salt (80 mg, 0.36 mmol, 1.2 eq.) and Cs₂CO₃ (490 mg, 1.5 mmol, 5.0 eq.) to afford a white solid (66 mg, 60% yield). Rf=0.6 (dichloromethane:methanol=9:1). ¹H NMR (400 MHz, DMSO) δ 4.14 (dd, J=17.0, 4.9 Hz, 2H), 3.92 (dd, J=17.0, 7.3 Hz, 2H), 3.57 (d, J=2.7 Hz, 3H), 2.89 (s, 3H), 2.19 (dd, J=8.9, 4.8 Hz, 1H), 1.60-1.51 (m, 6H), 1.41 (dt, J=10.2, 5.0 Hz, 1H), 1.36 (dd, J=7.5, 4.6 Hz, 1H), 1.28 (d, J=7.7 Hz, 2H), 1.07 (td, J=11.9, 5.2 Hz, 3H), 0.82-0.71 (m, 2H), 0.58 (dd, J=7.6, 4.5 Hz, 1H). ¹¹B NMR (128 MHz, DMSO) δ 14.71. ¹³C NMR (101 MHz, DMSO) δ 173.24, 169.58, 169.28, 71.20, 62.32, 51.89, 51.84, 46.46, 34.28, 33.76, 32.97, 29.25, 26.47, 26.13, 26.05. HRMS-ESI (m/z) [M+H]+ calc'd for C₁₇H₂₈BN₂O₆, 367.2040, found 367.2033.

### Methyl (S)-2-((S)-2-(6-methyl-4,8-dioxo-1,3,6,2-dioxazaborocan-2-yl)aziridin-1-yl)-3-((S)-2-oxopyrrolidin-3-yl)propanoate (37)

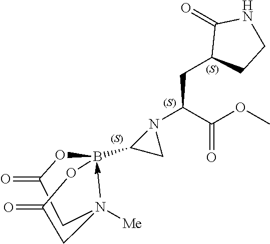

General procedure B with 3c (210 mg, 0.3 mmol), methyl (S)-2-amino-3-((S)-2-oxopyrrolidin-3-yl)propanoate HCl salt (67 mg, 0.36 mmol, 1.2 eq.) and Cs₂CO₃ (490 mg, 1.5 mmol, 5.0 eq.) to afford a white solid (76 mg, 69% yield). Rf=0.4 (dichloromethane:methanol=9:1). ¹H NMR (400 MHz, DMSO) δ 7.52 (s, 1H), 4.19 (d, J=17.2 Hz, 1H), 4.05 (d, J=16.3 Hz, 1H), 3.90 (dd, J=16.7, 11.8 Hz, 2H), 3.57 (s, 3H), 3.03 (dd, J=11.3, 7.8 Hz, 2H), 2.82 (s, 3H), 2.31 (dd, J=6.9, 4.5 Hz, 1H), 2.08 (ddt, J=17.8, 8.8, 4.6 Hz, 3H), 1.59-1.48 (m, 2H), 1.44 (dd, J=4.3, 1.4 Hz, 1H), 1.28 (dd, J=7.6, 1.5 Hz, 1H), 0.72 (dd, J=7.6, 4.3 Hz, 1H). ¹¹B NMR (128 MHz, DMSO) δ 8.19. ¹³C NMR (101 MHz, DMSO) δ 178.52, 174.14, 170.10, 168.66, 71.85, 61.89, 61.42, 55.36, 52.14, 45.22, 38.29, 35.08, 28.98, 28.89. HRMS-ESI (m/z) [M]+ calc'd for C₁₅H₂₃BN₃O₇, 368.1629, found 368.1632.

### Methyl(S)-3-(4-chlorophenyl)-3-((S)-2-(6-methyl-4,8-dioxo-1,3,6,2-dioxazaborocan-2-yl)aziridin-1-yl)propanoate (38)

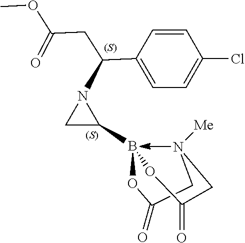

General procedure B with 3c (210 mg, 0.3 mmol), methyl (S)-3-amino-3-(4-chlorophenyl)propanoate HCl salt (77 mg, 0.36 mmol, 1.2 eq.) and Cs₂CO₃ (490 mg, 1.5 mmol, 5.0 eq.) to afford a white solid (80 mg, 68% yield). Rf=0.3 (dichloromethane:methanol=9:1). ¹H NMR (400 MHz, DMSO) δ 7.31 (d, J=6.0 Hz, 4H), 4.16 (dd, J=17.0, 5.1 Hz, 2H), 3.96 (dd, J=17.0, 11.6 Hz, 2H), 3.41 (s, 3H), 2.95 (d, J=9.1 Hz, 3H), 2.82 (dd, J=13.0, 3.3 Hz, 1H), 2.72-2.63 (m, 2H), 1.24 (dd, J=4.4, 1.4 Hz, 1H), 1.14 (dd, J=7.5, 1.4 Hz, 1H), 0.82 (dd, J=7.5, 4.4 Hz, 1H). ¹¹B NMR (128 MHz, DMSO) δ 15.65. ¹³C NMR (101 MHz, DMSO) δ 171.36, 169.63, 169.33, 141.60, 132.24, 129.94, 128.52, 71.15, 62.37, 62.33, 51.71, 46.50, 42.07, 29.62. HRMS-ESI (m/z) [M+H]+ calc'd for C₁₇H₂₁BClN₂O₆, 395.1181, found 395.1168.

### 2-(1-((7-Chloro-1,1-dioxido-3,4-dihydro-2H-benzo[e][1,2,4]thiadiazin-6-yl)sulfonyl)aziridin-2-yl)-6-methyl-1,3,6,2-dioxazaborocane-4,8-dione (39)

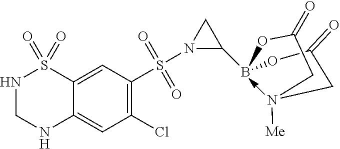

General procedure A with 3c (210 mg, 0.3 mmol), hydrochlorothiazide (107.3 mg, 0.36 mmol, 1.2 eq.) and K₂CO₃ (207 mg, 1.5 mmol, 5.0 eq.) to afford a white solid (86 mg, 60% yield). Rf=0.3 (hexanes:ethyl acetate=2:8). ¹H NMR (400 MHz, DMSO) δ 8.39 (t, J=2.7 Hz, 1H), 8.07 (t, J=7.9 Hz, 1H), 8.00 (s, 1H), 7.10 (s, 1H), 4.81 (dd, J=7.9, 2.7 Hz, 2H), 4.42 (d, J=17.2 Hz, 1H), 4.31 (d, J=16.8 Hz, 1H), 4.15 (d, J=17.2 Hz, 1H), 3.89 (d, J=16.8 Hz, 1H), 3.16 (s, 3H), 2.52 (d, J=8.3 Hz, 1H), 2.39 (dd, J=8.3, 5.4 Hz, 1H), 2.13 (d, J=5.4 Hz, 1H). ¹¹B NMR (128 MHz, DMSO) δ 8.58. ¹³C NMR (101 MHz, DMSO) δ 172.16, 169.58, 168.36, 151.31, 147.42, 139.36, 139.03, 129.08, 122.86, 62.30, 62.27, 46.77, 27.68. HRMS-ESI (m/z) [M+H]+ calc'd for C₁₄H₁₇BClN₄O₈S₂+, 479.0269, found 479.0249.

### N-Methyl-N-(4-methyl-5-((2-(6-methyl-4,8-dioxo-1,3,6,2-dioxazaborocan-2-yl)aziridin-1-yl)sulfonyl)thiazol-2-yl)-2-(4-(pyridin-2-yl)phenyl)acetamide (40)

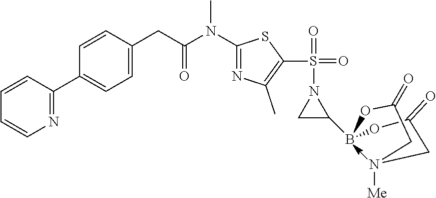

General procedure A with 3c (210 mg, 0.3 mmol), Pritelivir (145 mg, 0.36 mmol, 1.2 eq.) and K₂CO₃ (207 mg, 1.5 mmol, 5.0 eq.) to afford a white solid (126 mg, 72% yield). Rf=0.4 (100% ethyl acetate). ¹H NMR (400 MHz, DMSO) δ 8.60 (dd, J=4.9, 1.8 Hz, 1H), 8.00 (d, J=8.0 Hz, 2H), 7.94-7.76 (m, 2H), 7.39-7.22 (m, 3H), 4.36-4.14 (m, 4H), 4.03 (d, J=17.2 Hz, 1H), 3.82 (d, J=17.0 Hz, 1H), 3.68 (s, 3H), 3.03 (s, 3H), 2.47 (s, 3H), 2.28 (d, J=8.3 Hz, 1H), 2.12 (dd, J=8.2, 5.4 Hz, 1H), 2.05 (d, J=5.4 Hz, 1H). ¹³C NMR (101 MHz, DMSO) δ 172.84, 169.49, 168.58, 161.49, 156.27, 153.91, 150.01, 137.87, 137.70, 135.32, 130.68, 126.99, 123.02, 120.61, 119.98, 62.46, 62.43, 46.66, 34.93, 30.60, 16.96. HRMS-ESI (m/z) [M+H]+ calc'd for C₂₅H₂₇BN₅O₇S₂+, 584.1439, found 584.1439.

### 6-Methyl-2-(1-((4-(5-methyl-3-phenylisoxazol-4-yl)phenyl)sulfonyl)aziridin-2-yl)-1,3,6,2-dioxazaborocane-4,8-dione (41)

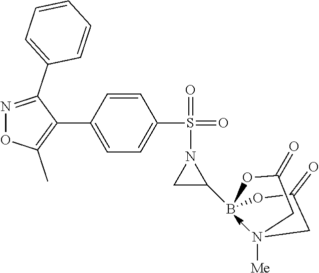

General procedure A with 3c (210 mg, 0.3 mmol), Valdecoxib (113.5 mg, 0.36 mmol, 1.2 eq.) and K₂CO₃ (207 mg, 1.5 mmol, 5.0 eq.) to afford a white solid (113 mg, 76% yield). Rf=0.5 (hexanes:ethyl acetate=4:6). ¹H NMR (400 MHz, DMSO) δ 7.93-7.80 (m, 2H), 7.48-7.34 (m, 5H), 7.29 (dq, J=6.6, 2.3 Hz, 2H), 4.24 (dd, J=27.7, 17.1 Hz, 2H), 4.04 (d, J=17.1 Hz, 1H), 3.84 (d, J=17.0 Hz, 1H), 2.98 (s, 3H), 2.44 (s, 3H), 2.38 (d, J=8.4 Hz, 1H), 2.18 (dd, J=8.3, 5.5 Hz, 1H), 2.02 (d, J=5.5 Hz, 1H). ¹¹B NMR (128 MHz, DMSO) δ 8.72. ¹³C NMR (101 MHz, DMSO) δ 167.29, 166.58, 166.35, 159.04, 134.53, 133.82, 128.74, 128.20, 127.26, 126.63, 126.60, 126.57, 112.31, 60.37, 60.33, 44.52, 28.60, 9.81. HRMS-ESI (m/z) [M+H]+ calc'd for C₂₃H₂₂BN₃O₇S+, 496.1350, found 496.1353.

### 2-(1-((Benzo[d]isoxazol-3-ylmethyl)sulfonyl)aziridin-2-yl)-6-methyl-1,3,6,2-dioxazaborocane-4,8-dione (42)

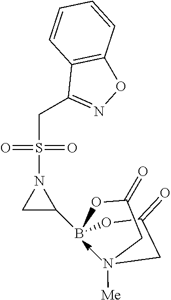

General procedure A with 3c (210 mg, 0.3 mmol), Zonisamide (76.6 mg, 0.36 mmol, 1.2 eq.) and K₂CO₃ (207 mg, 1.5 mmol, 5.0 eq.) to afford a white solid (86 mg, 73% yield). Rf=0.4 (hexanes:ethyl acetate=2:8). ¹H NMR (400 MHz, DMSO) δ 8.01 (dt, J=8.1, 1.1 Hz, 1H), 7.80 (t, J=9.4 Hz, 1H), 7.74-7.67 (m, 1H), 7.44 (t, J=7.5 Hz, 1H), 5.31 (d, J=1.6 Hz, 2H), 4.39-4.20 (m, 2H), 4.09 (d, J=17.1 Hz, 1H), 3.87 (d, J=16.9 Hz, 1H), 3.06 (s, 3H), 2.38 (d, J=8.4 Hz, 1H), 2.26 (dd, J=8.3, 5.6 Hz, 1H), 2.14-2.03 (m, 1H). ¹¹B NMR (128 MHz, DMSO) δ 9.06. ¹³C NMR (101 MHz, DMSO) δ 169.65, 169.43, 168.65, 163.28, 150.06, 131.23, 129.13, 124.60, 123.66, 121.23, 110.24, 62.45, 52.45, 48.41, 47.17, 46.67, 32.08. HRMS-ESI (m/z) [M+H]+ calc'd for C₁₅H₁₇BFN₃O₇S+, 394.0850, found 394.0858.

### 3-Chloro-4-((2-(6-methyl-4,8-dioxo-1,3,6,2-dioxazaborocan-2-yl)aziridin-1-yl)sulfonyl)-N-(2-methylindolin-1-yl)benzamide (43)

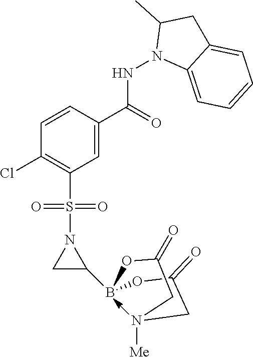

General procedure A with 3c (210 mg, 0.3 mmol), Indapamide (132 mg, 0.36 mmol, 1.2 eq.) and K₂CO₃ (207 mg, 1.5 mmol, 5.0 eq.) to afford a white solid (125 mg, 76% yield). Rf=0.4 (hexanes:ethyl acetate=1:9). ¹H NMR (400 MHz, DMSO) δ 10.52 (s, 1H), 8.43 (dd, J=4.0, 2.2 Hz, 1H), 8.16 (dt, J=8.3, 2.0 Hz, 1H), 7.85 (d, J=8.3 Hz, 1H), 7.13-6.89 (m, 2H), 6.80-6.62 (m, 1H), 6.48 (d, J=7.8 Hz, 1H), 4.27 (dd, J=38.0, 17.0 Hz, 2H), 4.05 (d, J=17.2 Hz, 1H), 3.85 (t, J=16.8 Hz, 2H), 3.16-2.94 (m, 5H), 2.54 (dd, J=9.7, 6.3 Hz, 2H), 2.43-2.37 (m, 1H), 2.09 (dd, J=5.6, 2.0 Hz, 1H), 1.24 (d, J=6.1 Hz, 3H). ¹¹B NMR (128 MHz, DMSO) δ 9.28. ¹³C NMR (101 MHz, DMSO) δ 167.41, 166.34, 162.01, 161.95, 149.76, 134.04, 133.64, 132.24, 131.08, 130.84, 130.80, 128.28, 125.43, 122.77, 118.42, 116.45, 60.25, 60.19, 44.47, 33.79, 30.26, 16.89. HRMS-ESI (m/z) [M+H]+ calc'd for C₂₃H₂₅BClN₄O₇S+, 547.1226, found 547.1234.

### N-((1-Ethylpyrrolidin-2-yl)methyl)-2-methoxy-5-((2-(6-methyl-4,8-dioxo-1,3,6,2-dioxazaborocan-2-yl)aziridin-1-yl)sulfonyl)benzamide (44)

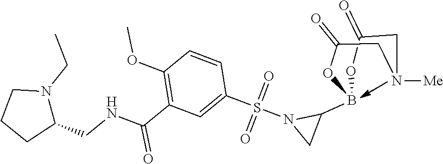

General procedure A with 3c (210 mg, 0.3 mmol), (S)-Sulpiride (123.3 mg, 0.36 mmol, 1.2 eq.) and K₂CO₃ (207 mg, 1.5 mmol, 5.0 eq.) to afford a white solid (134 mg, 71% yield). Rf=0.3 (hexanes:ethyl acetate=0:100). ¹H NMR (400 MHz, DMSO) δ 8.04 (dd, J=6.0, 3.5 Hz, 1H), 7.95-7.90 (m, 1H), 7.69-7.59 (m, 2H), 4.32 (dd, J=45.9, 17.1 Hz, 2H), 4.10 (d, J=17.2 Hz, 1H), 3.90 (d, J=16.9 Hz, 1H), 3.11 (s, 3H), 2.52 (s, 1H), 2.39 (dd, J=8.3, 5.5 Hz, 1H), 2.10 (d, J=5.4 Hz, 1H). ¹³C NMR (101 MHz, DMSO) δ 169.09, 167.93, 137.10, 135.84, 135.38, 131.19, 128.43, 120.56, 61.98, 61.87, 46.12, 31.56. ¹¹B NMR (128 MHz, DMSO-d6). HRMS-ESI (m/z) [M+H]+ calc'd for C₂₂H₃₂BN₄O₈S 523.2034; found 523.2007.

### ((3aS,5aR,8aR,8bS)-2,2,7,7-Tetramethyltetrahydro-3aH-bis([1,3]dioxolo)[4,5-b:4′,5′-d]pyran-3a-yl)methyl (R)-2-(6-methyl-4,8-dioxo-1,3,6,2-dioxazaborocan-2-yl)aziridine-1-sulfonate (45)

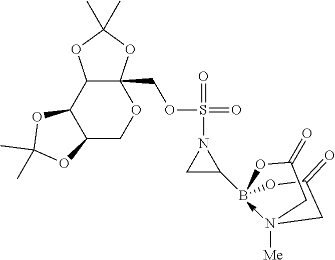

General procedure A with 3c (210 mg, 0.3 mmol), Topiramate (102.1 mg, 0.36 mmol, 1.2 eq.) and K₂CO₃ (207 mg, 1.5 mmol, 5.0 eq.) to afford a white solid (103 mg, 0.162 mmol, 66% yield). Rf=0.4 (hexanes:ethyl acetate=3:7). ¹H NMR (400 MHz, DMSO) δ 4.66 (dt, J=7.9, 2.4 Hz, 1H), 4.45-4.27 (m, 6H), 4.18 (dd, J=17.1, 1.6 Hz, 1H), 3.99 (dd, J=17.0, 8.5 Hz, 1H), 3.81 (dt, J=13.1, 2.1 Hz, 1H), 3.70 (dd, J=12.9, 2.7 Hz, 1H), 3.13 (s, 3H), 2.61-2.56 (m, 1H), 2.33-2.25 (m, 2H), 1.53 (s, 3H), 1.41 (dd, J=11.0, 2.4 Hz, 6H), 1.34 (s, 3H). ¹¹B NMR (128 MHz, DMSO) δ 8.96. ¹³C NMR (101 MHz, DMSO) δ 169.36, 168.71, 168.66, 109.06, 108.71, 100.52, 72.71, 72.46, 70.43, 70.25, 69.53, 62.58, 61.04, 46.81, 31.35, 26.63, 26.10, 25.29, 24.38. HRMS-ESI (m/z) [M+H]+ calc'd for C₁₉H₃₀BN₂O₁₂S+, 521.1613, found 521.1608.

### 7-(But-2-yn-1-yl)-3-methyl-8-((R)-3-((R)-2-(6-methyl-4-oxo-1,3,6,2-dioxazaborocan-2-yl)aziridin-1-yl)piperidin-1-yl)-1-((4-methylquinazolin-2-yl)methyl)-3,7-dihydro-1H-purine-2,6-dione (46, from linagliptin)

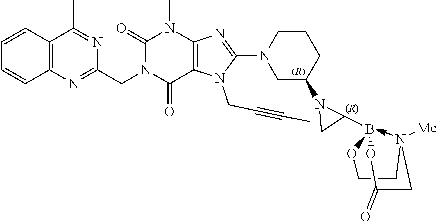

General procedure B with 3c (210 mg, 0.3 mmol), Linagliptin (170.7 mg, 0.36 mmol, 1.2 eq.) and Cs₂CO₃ (294.4 mg, 0.9 mmol, 3.0 eq.) to afford a white solid (127 mg, 66% yield). Rf=0.4 (dichloromethane:methanol=9:1). ¹H NMR (400 MHz, DMSO) δ 8.19-8.16 (m, 1H), 7.87-7.82 (m, 1H), 7.76-7.72 (m, 1H), 7.62-7.58 (m, 1H), 4.87-4.77 (m, 2H), 4.19-4.10 (m, 2H), 4.01-3.79 (m, 3H), 3.73-3.51 (m, 3H), 3.39-3.33 (m, 6H), 2.81 (d, J=1.5 Hz, 4H), 1.90 (d, J=10.4 Hz, 1H), 1.75-1.68 (m, 5H), 1.59-1.48 (m, 1H), 1.40 (ddd, J=11.2, 6.8, 3.8 Hz, 3H), 1.26 (t, J=7.0 Hz, 1H), 0.67 (dt, J=7.8, 4.0 Hz, 1H). ¹³C NMR (101 MHz, DMSO) δ 169.65, 169.62, 169.32, 169.19, 161.47, 161.44, 156.32, 156.24, 153.72, 153.66, 151.40, 149.51, 148.12, 148.01, 134.57, 128.34, 127.63, 126.22, 122.97, 103.85, 103.70, 81.72, 74.55, 74.05, 62.41, 46.03, 29.90, 29.84, 22.05, 3.58. HRMS-ESI (m/z) [M+H]+ calc'd for C₃₂H₃₇BN₉O₆ 654.2960; found 654.2980.

### 6-Methyl-2-((R)-1-((1R,2S)-2-phenylcyclopropyl)aziridin-2-yl)-1,3,6,2-dioxazaborocane-4,8-dione (1:1 isomers) (47)

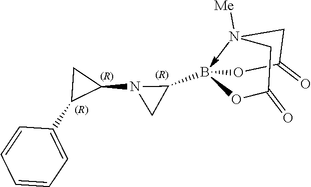

General procedure B with 3c (210 mg, 0.3 mmol), Tranylcypromine HCl (61.1 mg, 0.36 mmol, 1.2 eq.) and Cs₂CO₃ (490 mg, 1.5 mmol, 5.0 eq.) to afford a white solid (56 mg, 60% yield).

Rf=0.25 (dichloromethane:methanol=9:1). ¹H NMR (400 MHz, DMSO) δ 7.19 (dd, J=8.1, 6.9 Hz, 2H), 7.12-7.06 (m, 1H), 7.02-6.97 (m, 2H), 4.25 (dd, J=17.3, 10.2 Hz, 1H), 4.18-3.80 (m, 3H), 3.04 (d, J=12.3 Hz, 3H), 2.09 (dddd, J=58.9, 9.4, 5.9, 3.3 Hz, 1H), 1.59-1.37 (m, 3H), 1.30-1.07 (m, 1H), 0.96-0.76 (m, 2H). ¹¹B NMR (128 MHz, DMSO) δ 9.48. ¹³C NMR (101 MHz, DMSO) δ 170.06, 170.00, 168.94, 168.83, 142.56, 142.51, 128.68, 128.62, 126.06, 125.95, 125.80, 125.74, 62.55, 62.42, 62.13, 62.07, 53.12, 52.94, 46.61, 46.55, 30.21, 29.73, 24.08, 22.70, 16.93, 15.53. HRMS-ESI (m/z) [M+H]+ calc'd for C₁₆H₂₀BN₂O₄ 315.1509; found 315.1509.

### 6-Methyl-2-((R)-1-((1R,2R)-2-phenylcyclopropyl)aziridin-2-yl)-1,3,6,2-dioxazaborocane-4,8-dione (48)

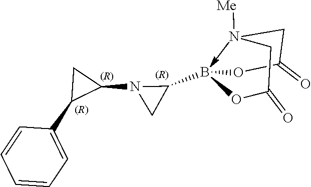

General procedure B with 3c (210 mg, 0.3 mmol), cis-Tranylcypromine HCl (61.1 mg, 0.36 mmol, 1.2 eq.) and Cs₂CO₃ (490 mg, 1.5 mmol, 5.0 eq.) to afford a white solid (58 mg, 60% yield). Rf=0.25 (dichloromethane:methanol=9:1). ¹H NMR (400 MHz, DMSO) δ 7.25-7.19 (m, 2H), 7.10 (dd, J=8.2, 6.5 Hz, 2H), 7.07-7.00 (m, 1H), 4.21 (dd, J=17.2, 9.2 Hz, 2H), 4.04-3.98 (m, 2H), 3.83 (d, J=16.7 Hz, 1H), 3.02 (s, 3H), 1.82 (dt, J=9.3, 7.1 Hz, 1H), 1.47 (td, J=7.2, 4.5 Hz, 1H), 1.22-1.13 (m, 2H), 1.07-0.98 (m, 2H), 0.79 (dd, J=7.4, 4.3 Hz, 1H). ¹¹B NMR (128 MHz, DMSO) δ 5.90. ¹³C NMR (101 MHz, DMSO) δ 170.19, 168.53, 139.81, 128.89, 127.79, 125.49, 62.37, 61.85, 49.76, 48.26, 46.52, 30.32, 22.15, 14.51. HRMS-ESI (m/z) [M+H]+ calc'd for C₁₆H₂₀BN₂O₄ 315.1509; found 315.1509.

### N-(2-(6-Methyl-4,8-dioxo-1,3,6,2-dioxazaborocan-2-yl)aziridin-1-yl)isonicotinamide (49)

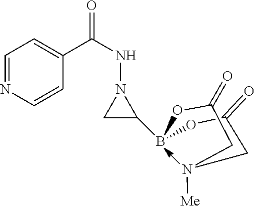

General procedure B with 3c (210 mg, 0.3 mmol), Isoniazid (49.5 mg, 0.36 mmol, 1.2 eq.) and Cs₂CO₃ (294 mg, 0.9 mmol, 3.0 eq.) to afford a white solid (38 mg, 40% yield). Rf=0.1 (dichloromethane:methanol=9:1). ¹H NMR (400 MHz, DMSO) δ 10.19 (s, 1H), 8.69 (d, J=5.0 Hz, 2H), 7.78-7.52 (m, 2H), 4.38 (dd, J=16.7, 11.9 Hz, 2H), 4.15 (d, J=16.0 Hz, 1H), 3.97 (d, J=17.3 Hz, 1H), 3.17 (s, 3H), 2.32 (d, J=8.9 Hz, 1H), 1.89 (d, J=6.0 Hz, 1H), 1.30 (dd, J=9.0, 6.0 Hz, 1H). ¹¹B NMR (128 MHz, DMSO) δ 12.87. ¹³C NMR (101 MHz, DMSO) δ 170.37, 168.60, 163.87, 150.59, 140.93, 121.62, 61.76, 61.52, 49.07, 45.55, 32.22. HRMS-ESI (m/z) [M+H]+ calc'd for C₁₃H₁₆BN₄O₅ 319.1214; found 319.1212.

### N-(2-(6-methyl-4,8-dioxo-1,3,6,2-dioxazaborocan-2-yl)aziridin-1-yl)isonicotinamide (50)

General procedure B with 3c (210 mg, 0.3 mmol), Isoniazid (49.5 mg, 0.36 mmol, 1.2 eq.) and Cs₂CO₃ (294 mg, 0.9 mmol, 3.0 eq.) to afford a white solid (38 mg, 40% yield). Rf=0.1 (dichloromethane:methanol=9:1). ¹H NMR (400 MHz, DMSO) δ 10.19 (s, 1H), 8.69 (d, J=5.0 Hz, 2H), 7.78-7.52 (m, 2H), 4.38 (dd, J=16.7, 11.9 Hz, 2H), 4.15 (d, J=16.0 Hz, 1H), 3.97 (d, J=17.3 Hz, 1H), 3.17 (s, 3H), 2.32 (d, J=8.9 Hz, 1H), 1.89 (d, J=6.0 Hz, 1H), 1.30 (dd, J=9.0, 6.0 Hz, 1H). ¹¹B NMR (128 MHz, DMSO) δ 12.87. ¹³C NMR (101 MHz, DMSO) δ 170.37, 168.60, 163.87, 150.59, 140.93, 121.62, 61.76, 61.52, 49.07, 45.55, 32.22. HRMS-ESI (m/z) [M+H]+ calc'd for C₁₃H₁₆BN₄O₅ 319.1214; found 319.1212.

### N-(2-(tert-Butylamino)-1-(6-methyl-4,8-dioxo-1,3,6,2-dioxazaborocan-2-yl)ethyl)-4-(5-(p-tolyl)-3-(trifluoromethyl)-1H-pyrazol-1-yl)benzenesulfonamide (52)

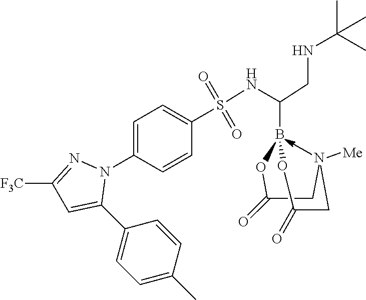

tert-Butylamine (0.05 mL, 0.51 mmol) was added in one portion to a stirred, room-temperature solution of aziridine 5 (100 mg, 0.17 mmol) in acetonitrile (3 mL). After 1 h the reaction was complete (Rf=0.3 in 7500 EtOAc/Hexane), and the volatiles were removed in vacuo. The crude residue was purified by flash column chromatography to afford 52 (96 mg, 850%) as a white solid. ¹H NMR (400 MHz, DMSO) δ 7.82-7.77 (m, 2H), 7.49-7.45 (m, 2H), 7.15-7.09 (m, 5H), 4.20 (d, J=17.2 Hz, 1H), 4.05 (d, J=16.5 Hz, 1H), 3.83 (dd, J=37.9, 16.8 Hz, 2H), 2.90 (s, 3H), 2.85 (dd, J=11.6, 2.9 Hz, 1H), 2.75 (dd, J=11.7, 4.6 Hz, 1H), 2.41 (s, 1H), 2.24 (s, 3H), 0.79 (s, 9H). ¹⁹F NMR (376 MHz, DMSO) δ −60.88. ¹³C NMR (101 MHz, DMSO) δ 169.68, 169.28, 145.76, 142.86, 142.49, 141.98, 140.06, 139.48, 129.86, 129.20, 128.61, 126.48, 125.79, 123.10, 120.43, 106.61, 62.97, 62.70, 45.96, 45.66, 30.65, 21.28. HRMS-ESI (m/z) [M+H]+ calc'd for C₂₈H₃₄BF₃N₅O₆S, 636.2275, found 636.2294.

### N-(2-Chloro-1-(6-methyl-4,8-dioxo-1,3,6,2-dioxazaborocan-2-yl)ethyl)-4-(5-(p-tolyl)-3-(trifluoromethyl)-1H-pyrazol-1-yl)benzenesulfonamide (53)

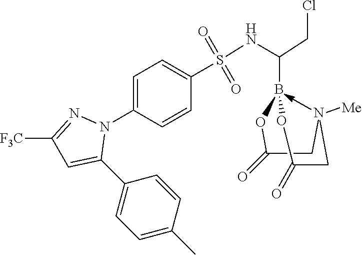

To a stirred solution of compound 5 (50 mg, 0.089 mmol, 1.0 eq.) in DCM, was added benzyl triethylammonium chloride (30 mg, 0.134 mmol, 1.5 eq.) under nitrogen atmosphere. The reaction mixture was cooled to 0° C. and added BF₃·Et₂O (13 μL, 0.105 mmol) dropwise and allowed to stir for 5 h at 0° C. After the complete consumption of starting material (monitored by TLC), a saturated NaHCO₃ solution was added and allowed to stir for 20 min at room temperature. The layers were separated, and the aqueous layer was further extracted with DCM and the combined organic layers were dried over anhydrous Na₂SO₄, filtered and the solvents were removed under vacuum. The obtained crude was purified by using flash column chromatography to afford compound 53 in 76% yield. ¹H NMR (400 MHz, CD₃CN) δ 7.91-7.83 (m, 2H), 7.54-7.46 (m, 2H), 7.27-7.13 (m, 4H), 6.92 (s, 1H), 6.08-6.01 (m, 1H), 4.00 (dd, J=17.0, 4.3 Hz, 2H), 3.88 (t, J=16.9 Hz, 2H), 3.23-3.11 (m, 3H), 2.99 (s, 3H), 2.34 (s, 3H). ¹¹B NMR (128 MHz, CD₃CN) δ 9.48. ¹⁹F NMR (376 MHz, CD₃CN) δ −62.82. ¹³C NMR (101 MHz, CD₃CN) δ 168.87, 168.27, 146.67, 143.84, 143.46, 140.87, 140.81, 130.45, 129.90, 128.95, 127.12, 126.71, 106.91, 63.43, 63.23, 46.90, 45.68, 21.30. HRMS-ESI (m/z) [M+H]+ calc'd for C₂₄H₂₄BClF₃N₄O₆S (M+H+): 599.1150; found: 599.1168.

### N-(2-Azido-1-(6-methyl-4,8-dioxo-1,3,6,2-dioxazaborocan-2-yl)ethyl)-4-(5-(p-tolyl)-3-(trifluoromethyl)-1H-pyrazol-1-yl)benzenesulfonamide (54)

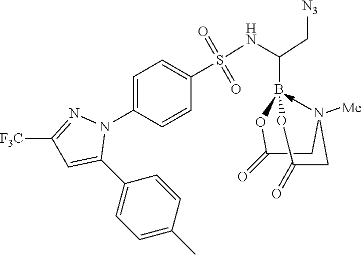

To a stirred solution of compound 5 (50 mg, 0.089 mmol, 1.0 eq.) in DMF, was added sodium azide (17 mg, 0.267 mmol, 3.0 eq.) under nitrogen atmosphere. The reaction mixture was heated to 75° C. and allowed to stir for 10 h at same temperature. After the complete consumption of starting material (monitored by TLC), the reaction mixture was allowed to cool to room temperature and diluted with cold water and ethyl acetate. The layers were separated, and the aqueous layer was further extracted with ethyl acetate. The combined organic layers were dried over anhydrous Na₂SO₄, filtered, and the solvents were removed under vacuum. The obtained crude was purified by using flash column chromatography to afford compounds 54 and 54a in 59% and 15% yields, respectively. ¹H NMR (400 MHz, CD₃CN) δ 7.92-7.82 (m, 2H), 7.53-7.45 (m, 2H), 7.24-7.12 (m, 4H), 6.92 (s, 1H), 6.03 (t, J=6.1 Hz, 1H), 4.06-3.81 (m, 4H), 3.25-3.11 (m, 3H), 2.99 (s, 3H), 2.34 (s, 3H). ¹¹B NMR (128 MHz, CD₃CN) δ 9.54. ¹⁹F NMR (376 MHz, CD₃CN) δ −62.84. ¹³C NMR (101 MHz, CD₃CN) δ 168.91, 168.32, 146.68, 144.23, 143.85, 143.45, 140.89, 140.82, 130.45, 129.91, 128.95, 127.12, 126.72, 123.87, 121.21, 106.92, 63.44, 63.24, 46.90, 45.68, 21.30. HRMS-ESI (m/z) [M+H]+ calc'd for C₂₄H₂₄BClF₃N₄O₆S (M+H+): 599.1150; found: 599.1168.

### 6-Methyl-2-(2-phenyl-1-((4-(5-(p-tolyl)-3-(trifluoromethyl)-1H-pyrazol-1-yl)phenyl)sulfonyl)-4,5-dihydro-1H-imidazol-5-yl)-1,3,6,2-dioxazaborocane-4,8-dione (55)

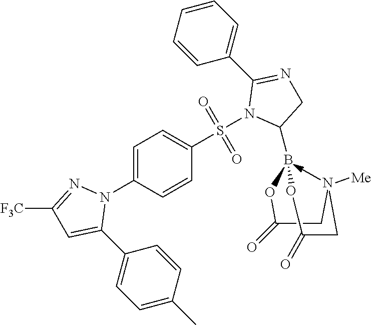

To a stirred solution of the corresponding aziridine 5 (120 mg, 0.21 mmol) in the benzo nitrile (3 mL) was added BF₃·Et₂O (0.04 mL, 0.3 mmol) at room temperature. After stirring at room temperature for 1 h, an aqueous saturated solution of sodium bicarbonate (5 mL) was added, and the mixture was stirred at room temperature for 5 min. Then, the aqueous phase was extracted with dichloromethane (3×10 mL), and the combined organic layers were dried over anhydrous Na₂SO₄, filtered, and concentrated in vacuo. Flash column chromatography on silica gel (Hexane:Ethyl acetate 20:80) to afford 55 (107 mg, 76%) as a white solid. ¹H NMR (400 MHz, DMSO) δ 7.73-7.65 (m, 2H), 7.64-7.58 (m, 2H), 7.55-7.51 (m, 2H), 7.47-7.43 (m, 1H), 7.35 (t, J=7.6 Hz, 2H), 7.19-7.15 (m, 3H), 7.10 (d, J=8.1 Hz, 2H), 4.37 (d, J=17.2 Hz, 1H), 4.25 (d, J=16.9 Hz, 1H), 4.12-4.01 (m, 3H), 3.66 (dd, J=16.0, 1.8 Hz, 1H), 3.17 (s, 3H), 2.81 (dd, J=15.9, 9.0 Hz, 1H), 2.25 (d, J=9.1 Hz, 4H). ¹⁹F NMR (377 MHz, DMSO) δ −60.92. ¹³C NMR (101 MHz, DMSO) δ 169.22, 168.58, 160.03, 146.00, 143.40, 139.71, 137.03, 131.66, 129.91, 129.79, 129.34, 129.27, 128.20, 127.09, 63.24, 62.46, 57.15, 46.44, 21.31. HRMS-ESI (m/z) [M+H]+ calc'd for C₂₂H₂₉BBrN₂O₆S, 539.1023, found 539.1017.

### N-(2-Bromo-1-(6-methyl-4,8-dioxo-1,3,6,2-dioxazaborocan-2-yl)ethyl)-4-(5-(p-tolyl)-3 (trifluoromethyl)-1H-pyrazol-1-yl)benzenesulfonamide (56)

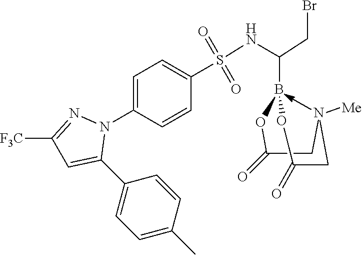

To a stirred solution of compound 5 (50 mg, 0.122 mmol, 1.0 eq.) in DCM, was added benzyl triethylammonium bromide (36 mg, 0.134 mmol, 1.1 eq.) under nitrogen atmosphere. The reaction mixture was cooled to 0° C. and BF₃·Et₂O (7 μL, 15 mmol) added dropwise and allowed to stir for 1 h at 0° C. After the complete consumption of starting material (monitored by TLC), saturated NaHCO₃ solution was added and allowed to stir for 20 min at room temperature. The layers were separated, and the aqueous layer was further extracted with DCM. The combined organic layers were dried over anhydrous Na₂SO₄, filtered, and the solvents were removed under vacuum. The obtained crude was purified by using flash column chromatography to afford compound 56 in 81% yield. ¹H NMR (400 MHz, CD₃CN) δ 7.93 (d, J=8.7 Hz, 2H), 7.48 (d, J=8.7 Hz, 2H), 7.23-7.13 (m, 4H), 6.93 (s, 1H), 5.86 (d, J=9.8 Hz, 1H), 4.00 (dd, J=17.0, 1.8 Hz, 2H), 3.86 (t, J=16.9 Hz, 2H), 3.65-3.56 (m, 1H), 3.38 (dd, J=10.9, 3.9 Hz, 1H), 3.24 (dd, J=10.9, 3.9 Hz, 1H), 3.01 (s, 3H), 2.34 (s, 3H). ¹¹B NMR (128 MHz, CD₃CN) δ 9.73. ¹⁹F NMR (376 MHz, CD₃CN) δ −62.84. ¹³C NMR (101 MHz, DMSO) δ 168.86, 168.23, 145.29, 142.79, 142.41, 142.26, 142.04, 141.66, 141.41, 139.08, 129.44, 128.72, 127.92, 125.98, 125.32, 125.28, 122.65, 119.97, 118.04, 106.06, 62.32, 62.24, 45.59, 36.57, 20.83. HRMS-ESI (m/z) [M+H]+ calc'd for C₂₄H₂₄BBrF₃N₄O₆S (M+H+): 643.0640; found: 643.0662.

### N-(1-(6-Methyl-4,8-dioxo-1,3,6,2-dioxazaborocan-2-yl)-2-(phenylthio)ethyl)-4-(5-(p-tolyl)-3-(trifluoromethyl)-1H-pyrazol-1-yl)benzenesulfonamide (57)

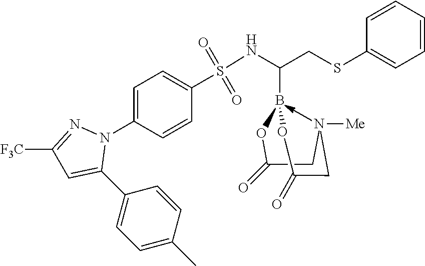

To a stirred solution of compound 56 (250 mg, 0.388 mmol, 1.0 eq.), was added sodium benzenethiolate (77 mg, 0.582 mmol, 1.5 eq.) and sodium iodide (88 mg, 0.582 mmol, 1.5 eq.) in acetone and the reaction mixture was heated to 55° C. The reaction mixture was stirred for 12 h. After completion of starting material (monitored by TLC), the reaction mixture was cooled to room temperature and the solvents were removed under reduced pressure. This crude product was purified by silica gel flash chromatography to afford compound 57 in 77% yield. ¹H NMR (400 MHz, CD₃CN) δ 7.84-7.76 (m, 2H), 7.33-7.26 (m, 2H), 7.20-7.09 (m, 6H), 7.09-7.02 (m, 3H), 6.90 (s, 1H), 5.82 (d, J=10.0 Hz, 1H), 4.03 (dd, J=17.0, 5.3 Hz, 2H), 3.89 (dd, J=17.0, 12.4 Hz, 2H), 3.45 (dt, J=10.1, 5.2 Hz, 1H), 3.05 (s, 3H), 2.92-2.79 (m, 2H), 2.29 (s, 3H). ¹¹B NMR (128 MHz, CD₃CN) δ 9.79. ¹⁹F NMR (376 MHz, CD₃CN) δ −62.80. ¹³C NMR (101 MHz, CD₃CN) δ 168.69, 168.63, 146.46, 144.14, 143.76, 143.38, 143.15, 142.76, 140.71, 137.95, 130.44, 129.88, 129.86, 129.75, 128.73, 126.75, 126.52, 123.89, 121.22, 107.03, 63.65, 63.50, 46.86, 37.03, 21.29. HRMS-ESI (m/z) [M+H]+ calc'd for (M+H+): 673.1568; found: 673.1614.

### S-(2-(6-Methyl-4,8-dioxo-1,3,6,2-dioxazaborocan-2-yl)-2-((4-(5-(p-tolyl)-3-(trifluoromethyl)-1H-pyrazol-1-yl)phenyl)sulfonamido)ethyl) ethanethioate (58)

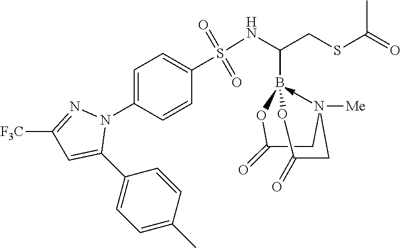

To a stirred solution of compound 56 (150 mg, 0.233 mmol, 1.0 eq.), was added potassium ethanethioate (40 mg, 0.350 mmol, 1.5 eq.) and sodium iodide (52 mg, 0.350 mmol, 1.5 eq.) in DMF and the reaction mixture was heated to 60° C. The reaction mixture was stirred for 12 h. After completion of starting material (monitored by TLC), the reaction mixture was cooled to room temperature and the solvents were removed under reduced pressure. The crude product was purified by silica gel flash chromatography to afford compound 58 in 71% yield. ¹H NMR (400 MHz, CD₃CN) δ 7.89-7.82 (m, 2H), 7.49-7.42 (m, 2H), 7.20 (s, 4H), 6.92 (s, 1H), 5.71 (d, J=9.8 Hz, 1H), 4.02 (dd, J=17.0, 5.0 Hz, 2H), 3.87 (t, J=16.9 Hz, 2H), 3.40 (ddd, J=9.8, 6.2, 5.0 Hz, 1H), 3.06 (s, 3H), 2.95 (dd, J=13.9, 5.0 Hz, 1H), 2.74 (dd, J=13.9, 6.2 Hz, 1H), 2.34 (s, 3H), 2.14 (s, 3H). ¹⁹F NMR (376 MHz, CD₃CN) δ −62.82. ¹³C NMR (101 MHz, CD₃CN) δ 196.23, 168.62, 168.57, 146.60, 144.57, 144.19, 143.81, 143.44, 143.32, 142.82, 140.71, 130.44, 129.95, 128.98, 126.89, 126.75, 123.86, 121.20, 106.96, 63.59, 63.42, 46.77, 32.00, 30.74, 21.33. HRMS-ESI (m/z) [M+H]+ calc'd for C₂₆H₂₇BF₃N₄O₇S₂(M+H+): 639.1361; found: 639.1399.

### 2-(6-Methyl-4,8-dioxo-1,3,6,2-dioxazaborocan-2-yl)-2-((4-(5-(p-tolyl)-3-(trifluoromethyl)-1H-pyrazol-1-yl)phenyl)sulfonamido)ethyl benzoate (59)

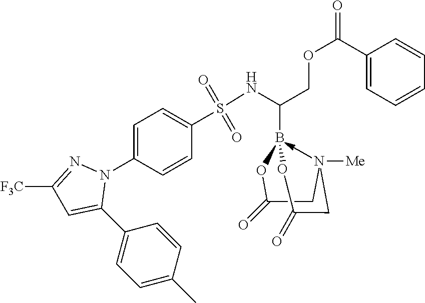

To a stirred solution of compound 56 (150 mg, 0.233 mmol, 1.0 eq.), was added sodium benzoate (50 mg, 0.350 mmol, 1.5 eq.) and sodium iodide (52 mg, 0.350 mmol, 1.5 eq.) in DMF and the reaction mixture was heated to 60° C. The reaction mixture was stirred for 12 h. After completion of starting material (monitored by TLC), the reaction mixture was cooled to room temperature and diluted with chilled water and ethyl acetate. The aqueous layer was further extracted with ethyl acetate (2×10 mL) and the combined organic layers were dried over anhydrous Na₂SO₄, and evaporated under reduced pressure. The crude product was purified by silica gel flash chromatography to afford compound 59 in 61% yield. ¹H NMR (400 MHz, CD₃CN) δ 8.02 (dt, J=7.0, 1.4 Hz, 2H), 7.89-7.81 (m, 2H), 7.62-7.55 (m, 1H), 7.45 (t, J=7.8 Hz, 2H), 7.41-7.32 (m, 2H), 7.21-7.12 (m, 4H), 6.91 (d, J=3.7 Hz, 1H), 6.03 (d, J=10.2 Hz, 1H), 4.15-3.99 (m, 3H), 3.96-3.83 (m, 3H), 3.52 (dt, J=10.3, 3.2 Hz, 1H), 3.11 (s, 3H), 2.28 (s, 3H). ¹¹B NMR (128 MHz, CD₃CN) δ 10.45. ¹⁹F NMR (377 MHz, CD₃CN) δ −62.85. ¹³C NMR (101 MHz, CD₃CN) δ 168.76, 168.68, 167.05, 146.63, 146.57, 144.22, 143.84, 143.30, 142.88, 142.83, 140.72, 134.07, 131.06, 130.65, 130.46, 129.97, 129.89, 129.35, 128.71, 126.91, 126.70, 123.87, 121.21, 107.00, 65.62, 63.52, 63.40, 47.02, 21.28. HRMS-ESI (m/z) [M+H]+ calc'd for C₃₁H₂₉BF₃N₄O₈S (M+H+): 685.1746; found: 685.1778.

### 5-(1-(6-methyl-4,8-dioxo-1,3,6,2-dioxazaborocan-2-yl)vinyl)-5H-thianthren-5-ium trifluoromethane sulfonate (60)

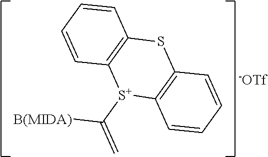

In an oven-dried 100 mL Schlenk vial equipped with a magnetic stir bar was charged with 3c (0.3 mmol, 1.0 eq.) and Cs₂CO₃ (0.52 eq.), followed by the solvent acetonitrile (0.1 M) were added and the mixture was stirred at 23° C. for 14 h. The reaction mixtures were filtered through a celite and washed with MeCN. The volatiles were removed in vacuo. Dichloromethane was added to the crude reaction product, the resulting slurry was filtered, and the solid was washed with a 3 mL DCM and then dried and afforded the product 60 in 80% yield as a white solid. ¹H NMR (400 MHz, DMSO) δ 8.25 (dd, J=7.9, 1.4 Hz, 2H), 8.16-8.01 (m, 2H), 8.01-7.72 (m, 4H), 6.66 (d, J=3.6 Hz, 1H), 5.51 (d, J=3.5 Hz, 1H), 4.37 (d, J=17.4 Hz, 2H), 3.99 (d, J=17.3 Hz, 2H), 2.54 (s, 3H). ¹⁹F NMR (376 MHz, DMSO) δ −77.69. ¹¹B NMR (128 MHz, DMSO) δ 7.60. ¹³C NMR (101 MHz, DMSO) δ 168.42, 158.67, 137.10, 135.83, 135.03, 130.81, 130.22, 122.73, 119.53, 116.83, 62.64, 47.61.

### (2-((4-methoxyphenyl)amino)-1-((4-(5-(p-tolyl)-3-(trifluoromethyl)-1H-pyrazol-1-yl)phenyl)sulfonamido)ethyl)boronic acid (62)

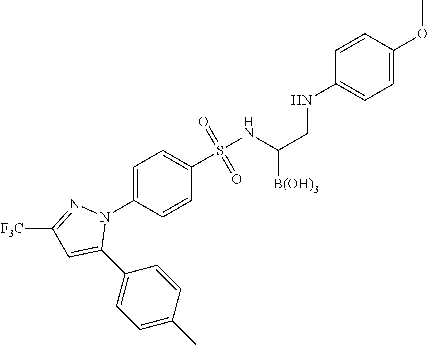

To an oven dried 25 mL round bottle flask with a magnetic stir bar was charged with 51 (0.2 mmol, 137 mg) in 5 mL of MeOH 3.0 N HCl (2.5 eq.) was then added dropwise to the solution at room temperature and stirred for 4 h. Upon concentration at <25° C., the resulting residue was dissolved in 1:1 MeCN:H₂O and lyophilized to afford the title compound 62 as a powder (80 mg, 70% yield, observed along with MIDA acid). ¹H NMR (400 MHz, DMSO) δ 7.95 (tt, J=6.5, 3.3 Hz, 2H), 7.67-7.60 (m, 2H), 7.45-7.41 (m, 1H), 7.25 (td, J=7.5, 3.5 Hz, 6H), 7.09-6.96 (m, 2H), 3.84-3.69 (m, 4H), 3.31-3.18 (m, 2H), 2.36 (d, J=3.3 Hz, 3H). ¹⁹F NMR (376 MHz, DMSO) δ −60.92. ¹¹B NMR (128 MHz, DMSO) δ 18.81. ¹³C NMR (101 MHz, DMSO) δ 145.81, 145.79, 142.27, 139.63, 129.93, 129.19, 128.60, 128.40, 126.77, 126.71, 125.67, 115.36, 115.06, 106.63, 55.77, 42.74, 21.27. HRMS-ESI (m/z) [M+H]+ calc'd for C₂₆H₂₇BF₃N₄O₅S, 575.1747, found 575.1743.

### N-(2-(tert-butylamino)-1-(potassiumtrifluoro-λ4-boraneyl)ethyl)-4-(5-(p-tolyl)-3-(trifluoromethyl)-1H-pyrazol-1-yl)benzenesulfonamide (63)

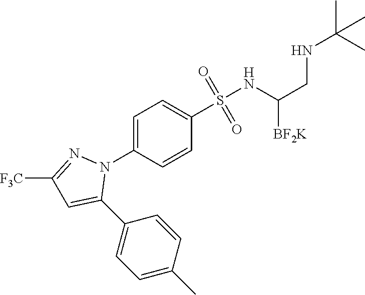

To a stirred solution of compound 52 (250 mg, 0.39 mmol, 1.0 eq.) in 3 mL of MeCN:MeOH (4:1), was added 4.5 M aqueous solution of KHF₂ (0.44 mL, 5.0 eq.) and allowed to stir for 16 h at room temperature. After completion of starting material, the volatiles were removed under reduced pressure. The mixture was dissolved in acetonitrile and stirred for 10-15 min and then filtered followed by washing the solid with additional acetonitrile two times. The combined filtrate was evaporated under reduced pressure and the obtained crude compound was triturated with Et₂O followed by hexanes. The white precipitate formed was filtered and dried to afford white solid 63 (164 mg, 71%). ¹H NMR (400 MHz, CD3CN) δ 7.84 (d, J=8.7 Hz, 2H), 7.48 (d, J=8.7 Hz, 2H), 7.22-7.12 (m, 5H), 6.91 (s, 1H), 3.11 (dd, J=14.8, 4.0 Hz, 1H), 2.95 (dd, J=14.8, 8.6 Hz, 1H), 2.46-2.36 (m, 1H), 2.33 (s, 3H), 1.33 (s, 9H) ppm. ¹¹B NMR (128 MHz, DMSO) δ 2.43 ppm. ¹³C NMR (101 MHz, CD3CN) δ 146.66, 143.94 (q, J=38.0 Hz), 143.50, 140.77, 140.66, 130.45, 129.90, 128.95, 127.09, 126.73, 123.87, 121.20, 106.96, 59.37, 44.69, 26.77, 21.32 ppm. HRMS-ESI (m/z) [M+H]+ calc'd for C₂₃H₂₇BF₆KN₄O₂S, 587.1484, found 587.1519.

### 1-(4-((2-(4-methoxyphenyl)-4-(4,4,5,5-tetramethyl-1,3,2-dioxaborolan-2-yl)pyrrolidin-1-yl)sulfonyl)phenyl)-5-(p-tolyl)-3-(trifluoromethyl)-1H-pyrazole (64)

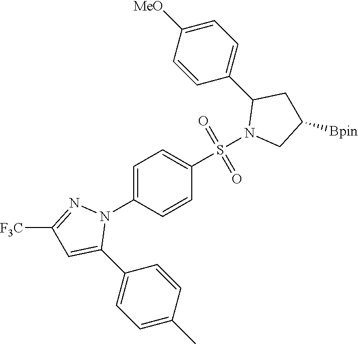

A 25 mL round-bottom flask was charged with compound 5 (281 mg, 0.5 mmol, 1.0 eq.), 1-methoxy-4-vinylbenzene (99 mg, 0.75 mmol, 1.5 eq.), NaI (149 mg, 1.0 mmol, 2.0 eq.), 4CzIPN (15.8 mg, 0.02 mmol, 4 mol %), and Ni(dtbbpy)Cl₂ (7.7 mg, 0.025 mmol, 8 mol %). The solids were dissolved in THF (5 mL, 0.08 M), and Et₃N (210 μL, 1.5 mmol, 3.0 eq.) was added. The reaction mixture was degassed for 10 min, sealed with a cone-lined cap, and stirred under blue LED irradiation (456 nm) at 70° C. for 48 h. After completion, the reaction was diluted with EtOAc (20 mL), quenched with saturated aqueous NH₄Cl (15 mL), and extracted with EtOAc (2×25 mL). The combined organic extracts were dried over Na₂SO₄, filtered, and concentrated. The crude residue was dissolved in CH₂Cl₂/MeOH (1:1, 20 mL), treated with pinacol (64 mg, 0.55 mmol, 1.1 eq.), and stirred at 45° C. for 12 h. After solvent removal under reduced pressure, the crude product was purified by Florisil silica gel flash chromatography to afford compound 64 (166 mg, 50% yield, 7:3 dr). ¹H NMR (400 MHz, CDCl₃) δ 7.73-7.52 (m, 2H), 7.36-7.27 (m, 2H), 7.13-7.03 (m, 4H), 7.00 (dd, J=8.3, 3.1 Hz, 2H), 6.76-6.65 (m, 3H), 4.81-4.46 (m, 1H), 3.69 (s, 4H), 3.46-3.13 (m, 1H), 2.30 (s, 4H), 1.79 (ddd, J=12.5, 5.8, 2.6 Hz, 1H), 1.27 (tt, J=11.4, 7.4 Hz, 1H), 1.13-1.06 (m, 12H). ¹⁹F NMR (377 MHz, CDCl₃) δ −62.40. ¹¹B NMR (128 MHz, CDCl₃) δ 32.68. ¹³C NMR (101 MHz, CDCl₃) δ 158.89, 145.27, 145.22, 142.13, 139.77, 139.74, 138.66, 138.10, 134.71, 134.01, 129.74, 129.72, 128.70, 128.44, 128.24, 127.79, 127.18, 125.70, 125.66, 125.48, 125.36, 113.74, 113.64, 83.74, 64.85, 55.30, 55.27, 52.13, 40.02, 24.74, 24.68, 21.32. HRMS-ESI (m/z) [M+Na] calc'd for C₃₄H₃₇BF₃N₃O₅SNa, 690.2397, found 690.2343.

### 5-(4-methoxyphenyl)-1-((4-(5-(p-tolyl)-3-(trifluoromethyl)-1H-pyrazol-1-yl)phenyl)sulfonyl)pyrrolidin-3-ol (65)

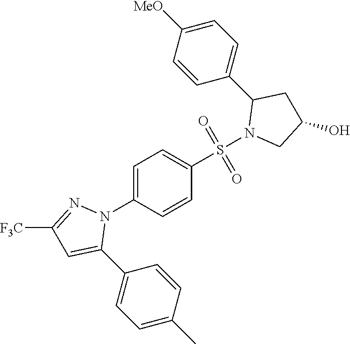 [SMILES: COc1ccc(C2C[C@H](O)CN2S(=O)(=O)c2ccc(-n3nc(C(F)(F)F)cc3-c3ccc(C)cc3)cc2)cc1]

To a solution of compound 64 (66.7 mg, 0.1 mmol, 1.0 eq.) in THF/H₂O (1:1, 4.0 mL) was added NaBO₃·4H₂O (77 mg, 0.5 mmol, 5.0 eq.). The mixture was stirred at room temperature for 3 h, diluted with H₂O, and extracted with EtOAc. The combined organic extracts were dried over Na₂SO₄, filtered, and concentrated under reduced pressure. The residue was purified by flash column chromatography to afford compound 65 as a white solid (44 mg, 80% yield, 7:3 dr). ¹H NMR (400 MHz, CDCl₃) δ 7.59-7.52 (m, 2H), 7.29 (dd, J=8.2, 6.3 Hz, 2H), 7.15 (d, J=8.3 Hz, 2H), 7.11-6.98 (m, 5H), 6.74-6.64 (m, 3H), 4.74-4.65 (m, 1H), 4.34-4.23 (m, 1H), 3.69 (d, J=1.7 Hz, 3H), 3.63-3.57 (m, 1H), 3.43 (dd, J=10.9, 4.0 Hz, 1H), 2.29 (s, 4H), 1.89 (dt, J=13.7, 5.3 Hz, 1H). ¹⁹F NMR (376 MHz, CDCl₃) δ −62.40. 13C NMR (101 MHz, CDCl₃) δ 158.98, 145.28, 142.40, 139.83, 137.85, 133.72, 129.75, 129.71, 128.70, 128.32, 127.95, 125.62, 125.41, 113.91, 113.86, 70.24, 62.15, 56.64, 55.27, 44.01, 21.32. HRMS-ESI (m/z) [M+Na] calc'd for C₂₈H₂₆F₃N₃O₄SNa, 580.1494, found 580.1454.

### (5-(4-methoxyphenyl)-1-((4-(5-(p-tolyl)-3-(trifluoromethyl)-1H-pyrazol-1-yl)phenyl)sulfonyl)pyrrolidin-3-yl)methanol (66)

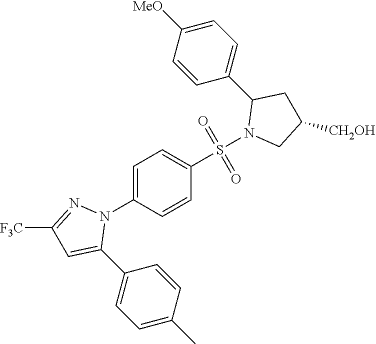 [SMILES: COc1ccc(C2C[C@H](CO)CN2S(=O)(=O)c2ccc(-n3nc(C(F)(F)F)cc3-c3ccc(C)cc3)cc2)cc1]

An oven-dried 10 mL vial with a magnetic stir bar was charged with compound 64 (66.7 mg, 0.1 mmol). The vial was sealed with a polypropylene open-top cap with PTFE/silicone septum, and evacuated and refilled with argon for three cycles, then CH₂Br₂ (35 μL, 0.4 mmol) and anhydrous THF (4 mL) was added. The mixture was cooled to −78° C., and then n-BuLi (0.16 mL, 0.39 mmol) was added dropwise to the solution for 5 min and stirred for 10 min. The solution was then warmed to room temperature and stirred for 21 h. A premixed solution of NaOH (2 M, aq.) and 35% H₂O₂ (2:1, 1.5 mL) was slowly added at 0° C. The mixture was stirred at room temperature for an additional 3 h. The reaction was quenched with 10 mL of water. Extract the resulting mixture twice with 10 mL of EtOAc. The combined organic layers were dried over anhydrous Na₂SO₄. The solvent was removed under reduced pressure. The residue was purified by flash column chromatography to afford compound 66 as a white solid (37 mg, 64%, 7:3 dr). ¹H NMR (400 MHz, CDCl₃) δ 7.56-7.49 (m, 2H), 7.32-7.26 (m, 2H), 7.11-7.04 (m, 4H), 7.00 (d, J=8.2 Hz, 2H), 6.73-6.65 (m, 3H), 4.55 (dd, J=8.9, 7.3 Hz, 1H), 3.77 (dd, J=10.8, 7.5 Hz, 1H), 3.69 (d, J=2.3 Hz, 3H), 3.58-3.42 (m, 2H), 3.29-3.22 (m, 1H), 2.32-2.23 (m, 4H), 2.17-2.04 (m, 1H), 1.63-1.58 (m, 1H). ¹⁹F NMR (377 MHz, CDCl₃) δ −62.39. 13C NMR (101 MHz, CDCl₃) δ 158.99, 145.28, 142.26, 139.81, 138.21, 133.70, 129.74, 128.70, 128.28, 127.83, 125.64, 125.39, 113.82, 63.88, 63.58, 55.27, 52.42, 40.65, 39.58, 21.32. HRMS-ESI (m/z) [M+Na] calc'd for C₂₉H₂₈F₃N₃O₄SNa, 594.1651, found 594.1613.

### 1-(4-((4-(3-chlorophenyl)-2-(4-methoxyphenyl)pyrrolidin-1-yl)sulfonyl)phenyl)-5-(p-tolyl)-3-(trifluoromethyl)-1H-pyrazole (67)

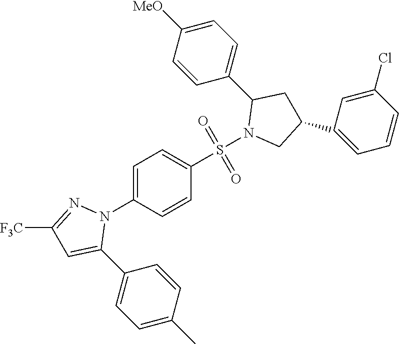 [SMILES: COc1ccc(C2C[C@H](c3cccc(Cl)c3)CN2S(=O)(=O)c2ccc(-n3nc(C(F)(F)F)cc3-c3ccc(C)cc3)cc2)cc1]

A 4 mL glass vial equipped with a magnetic stir bar was charged with [Ir(dF(CF₃)ppy)₂(dtbbpy)]PF₆ (1.1 mg, 1 mol %), 1-bromo-3-chlorobenzene (14.3 mg, 0.075 mmol), and compound 64 (66 mg, 0.1 mmol, 1.3 eq.) in DMF (1 mL). Morpholine (9 mg, 0.30 mmol, 1.5 eq.) was added. In a separate vial, NiCl₂·glyme (1.1 mg, 5 mol %) and dtbbpy (1.3 mg, 5 mol %) were dissolved in DMF (1 mL), sonicated for 30 s, and briefly heated to 100° C. until a clear green solution formed. The two solutions were combined and irradiated with blue LEDs (450 nm) for 2 h. The reaction mixture was poured into brine and extracted with cold EtOAc (3×10 mL). The combined organic layers were dried over Na₂SO₄, filtered, and concentrated. Purification by flash column chromatography afforded compound 67 as a white solid (34 mg, 72%, 6:4 dr). ¹H NMR (400 MHz, CDCl₃) δ 7.71-7.49 (m, 2H), 7.41-7.26 (m, 2H), 7.17-7.04 (m, 6H), 7.04-6.85 (m, 4H), 6.79-6.75 (m, 1H), 6.75-6.69 (m, 1H), 6.67 (d, J=2.8 Hz, 1H), 4.99-4.66 (m, 1H), 4.15-3.88 (m, 1H), 3.71 (dd, J=6.9, 1.1 Hz, 3H), 3.46-3.34 (m, 1H), 3.31-2.97 (m, 1H), 2.29 (s, 3H), 2.11-1.92 (m, 2H). ¹⁹F NMR (376 MHz, CDCl₃) δ −62.40. ¹³C NMR (101 MHz, CDCl₃) δ 158.97, 145.29, 142.58, 141.46, 139.84, 137.50, 134.59, 134.14, 130.04, 129.75, 129.73, 128.71, 128.42, 128.17, 127.93, 127.29, 127.24, 127.22, 125.67, 125.53, 125.40, 125.28, 125.06, 113.94, 113.91, 64.14, 62.66, 55.41, 55.33, 55.30, 54.75, 44.17, 43.23, 42.11, 41.18, 21.33. HRMS-ESI (m/z) [M+Na] calc'd for C₃₄H₂₉ClF₃N₃O₃SNa, 674.1468, found 674.1419.

### 3-(5-(4-methoxyphenyl)-1-((4-(5-(p-tolyl)-3-(trifluoromethyl)-1H-pyrazol-1-yl)phenyl)sulfonyl)pyrrolidin-3-yl)propanenitrile (68)

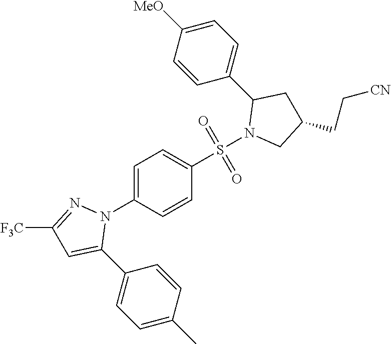 [SMILES: COc1ccc(C2C[C@H](CCC#N)CN2S(=O)(=O)c2ccc(-n3nc(C(F)(F)F)cc3-c3ccc(C)cc3)cc2)cc1]

A 5 mL glass vial equipped with a magnetic stir bar was charged with compound 64 (66.7 mg, 0.1 mmol), the photo catalyst Ir(dF(CF₃)ppy₂)(dtbpy)]PF₆ (2.2 mg, 2 mol %) and DMAP (18.3 mg, 0.15 mmol, 1.5 eq.). The vial was then sealed with a rubber septum and evacuated/backfilled with argon three times. The acrylonitrile (21 mg, 0.4 mmol, 4.0 eq.) was then added followed by 2 mL of a degassed acetone/methanol (1:1) mixture. This solution was then stirred while irradiated under blue LED (450 nm) for 16 hours at 30° C. The content of the vial was then concentrated and purified by flash column chromatography afforded compound 68 as a white solid (48 mg, 81%, 7:3 dr). ¹H NMR (400 MHz, CDCl₃) δ 7.63-7.48 (m, 2H), 7.36-7.26 (m, 2H), 7.14-6.97 (m, 6H), 6.76-6.63 (m, 3H), 4.82-4.53 (m, 1H), 3.69 (d, J=2.1 Hz, 4H), 3.13-2.91 (m, 1H), 2.44-2.16 (m, 6H), 2.10-1.86 (m, 1H), 1.74-1.45 (m, 3H). ¹⁹F NMR (377 MHz, CDCl₃) δ −62.40. 13C NMR (101 MHz, CDCl₃) δ 158.98, 145.29, 142.49, 139.86, 137.77, 133.92, 129.76, 129.74, 128.71, 128.31, 127.27, 125.64, 125.45, 118.79, 113.90, 62.45, 55.30, 55.28, 53.47, 41.20, 36.13, 28.20, 21.33. HRMS-ESI (m/z) [M+H]+ calc'd for C₃₁H₃₀F₃N₄O₃S, 595.1991, found 595.1944.

### X-Ray Crystallographic Analysis

CCDC 2414383 (3c), CCDC 2414412 (30), CCDC 2414411 (46), and CCDC 2414414 (60) contain the supplementary crystallo-graphic data. These data can be obtained via www.ccdc.cam.ac.uk/data_request/cif, or by emailing data_request@ccdc.cam.ac.uk.

### Crystallography Data for Compound 3c.

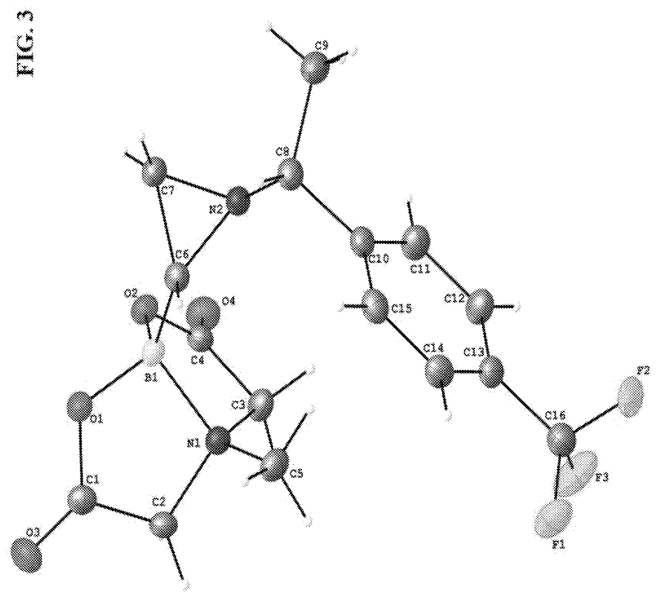

Boryl thianthrenium dication 3c was crystallized from acetonitrile. The X-ray structure of boryl thianthrenium dication 3 is shown in FIG. 3 and atoms are depicted with 50% probability ellipsoids. The crystallographic data for boryl thianthrenium dication 3c are summarized in the following tables.

TABLE 9
Crystal Data and structure refinement for 3c.

| Compound | 3c | Compound | 3c |
|---|---|---|---|
| Formula | C₂₃H₂₁BF₆N₂O₁₀S₄ | Z′ | 1 |
| Dcalc./g cm⁻³ | 1.642 | Wavelength/Å | 1.54184 |
| μ/mm⁻¹ | 3.800 | Radiation type | Cu K_{α} |
| Formula Weight | 738.47 | Θₘᵢₙ/° | 3.358 |
| Colour | colourless | Θₘₐₓ/° | 74.485 |
| Shape | block-shaped | Measured Refl's. | 29241 |
| Size/mm³ | 0.25 × 0.15 × 0.10 | Indep't Refl's | 6096 |
| T/K | 101(2) | Refl's I ≥ 2 σ(I) | 5926 |
| Crystal System | triclinic | Rᵢₙₜ | 0.0239 |
| Space Group | P-1 | Parameters | 438 |
| a/Å | 9.9502(2) | Restraints | 132 |
| b/Å | 11.4299(2) | Largest Peak | 1.145 |
| c/Å | 13.9995(3) | Deepest Hole | −0.745 |
| α/° | 77.086(2) | GooF | 1.026 |
| β/° | 74.258(2) | wR₂ (all data) | 0.0949 |
| γ/° | 86.353(2) | wR₂ | 0.0945 |
| V/Å³ | 1493.68(5) | R₁ (all data) | 0.0386 |
| Z | 2 | R₁ | 0.0380 |

TABLE 10
Structure Quality Indicators for 3c.

| | D min (CuKα) 0.80 | I/σ(I) | Rint 2.39% | Full |
|---|---|---|---|---|
| Reflections: | 2θ = 149.0° | 60.9 | m −4.80 | 135.4° 99.9 |
| Refinement: | Shift −0.001 | Max Peak 1.1 | Min Peak −0.8 | GooF 1.026 |

TABLE 11
Bond lengths [Å] and angles [°] for 3c.

| Atom | x | y | z | U_{eq} |
|---|---|---|---|---|
| S(1) | 3969.3(4) | 5956.4(4) | 3164.1(3) | 21.14(10) |
| S(2) | 1373.0(4) | 7000.5(4) | 2413.5(3) | 21.79(10) |
| O(1) | 5607.8(13) | 7929.0(12) | 586.4(9) | 23.8(3) |
| O(2) | 6277.1(15) | 9284.8(13) | −872.6(10) | 31.5(3) |
| O(3) | 6585.4(13) | 6648.8(11) | 1860.6(10) | 23.5(3) |
| O(4) | 8509.3(14) | 6155.7(13) | 2403.2(11) | 31.2(3) |
| N(1) | 6614.2(15) | 8822.8(13) | 1666.9(11) | 20.9(3) |
| C(1) | 2372.3(19) | 6123.9(17) | 4076.9(14) | 23.4(4) |
| C(2) | 1228.7(19) | 6619.2(17) | 3734.8(14) | 24.0(4) |
| C(3) | −28(2) | 6796.4(18) | 4413.2(15) | 28.1(4) |
| C(4) | −109(2) | 6477(2) | 5446.6(15) | 31.1(4) |
| C(5) | 1035(2) | 5996.4(19) | 5787.7(15) | 30.1(4) |
| C(6) | 2293(2) | 5805.5(17) | 5102.0(14) | 26.4(4) |
| C(7) | 3369.4(19) | 5244.4(17) | 2352.2(14) | 23.5(4) |
| C(8) | 2157.5(19) | 5663.6(17) | 2062.0(14) | 24.0(4) |
| C(9) | 1635(2) | 5093.9(18) | 1464.7(15) | 28.5(4) |
| C(10) | 2358(2) | 4107(2) | 1148.7(18) | 36.4(5) |
| C(11) | 3578(2) | 3710(2) | 1418.4(18) | 38.0(5) |
| C(12) | 4094(2) | 4274.8(18) | 2030.5(16) | 30.0(4) |
| C(13) | 4135.5(18) | 7514.2(16) | 2436.2(14) | 21.2(3) |
| C(14) | 2953.7(18) | 7913.7(17) | 1924.8(14) | 23.7(4) |
| C(15) | 6287.5(19) | 8910.5(17) | 2.4(14) | 23.7(4) |
| C(16) | 7033(2) | 9492.5(17) | 574.2(14) | 24.8(4) |
| C(17) | 7713.6(18) | 6903.9(17) | 2119.3(14) | 24.2(4) |
| C(18) | 7819.6(18) | 8232.6(17) | 2047.9(14) | 23.4(4) |
| C(19) | 5867(2) | 9666.2(17) | 2322.3(15) | 25.6(4) |
| B(1) | 5703(2) | 7683.5(18) | 1635.2(15) | 21.2(4) |
| S(1C) | 680.0(5) | 7966.0(4) | 9529.5(3) | 26.02(11) |
| F(5C) | 1363(2) | 5783.8(13) | 9273.0(12) | 59.0(4) |
| F(6C) | 986.1(15) | 6974.5(13) | 7966.0(9) | 44.6(3) |
| F(7C) | 2875.7(15) | 7146.4(18) | 8384.1(14) | 65.0(5) |
| O(2C) | 852.6(17) | 9102.9(13) | 8816.5(12) | 37.8(3) |
| O(3C) | 1463.6(17) | 7839.9(14) | 10274.7(11) | 35.5(3) |
| O(4C) | −733.4(15) | 7540.1(16) | 9928.2(12) | 40.5(4) |
| C(8C) | 1517(2) | 6904(2) | 8752.2(15) | 35.6(5) |
| S(9C) | 6043.5(8) | 7391.3(7) | 4938.1(5) | 24.18(17) |
| F(13C) | 4924(3) | 8564(2) | 6356.9(16) | 72.6(7) |
| F(14C) | 3617(2) | 7242(2) | 6240.5(16) | 71.7(7) |
| F(15C) | 3973(3) | 8911(3) | 5114(2) | 108.4(11) |
| O(10C) | 6508(2) | 6476.9(16) | 5667.9(14) | 34.6(4) |
| O(11C) | 5480(2) | 6958(3) | 4237.0(16) | 37.3(6) |
| O(12C) | 7001(2) | 8375.0(16) | 4460.4(13) | 35.7(4) |
| C(16C) | 4561(3) | 8068(3) | 5701(2) | 51.3(8) |
| C(1A) | 6117(4) | 8567(3) | 5383(3) | 35.6(18) |
| S(6) | 5584(4) | 7117(3) | 5271(3) | 26.6(9) |
| F(3) | 6305(7) | 8509(5) | 6296(4) | 49(2) |
| F(4) | 5146(6) | 9397(3) | 5254(5) | 43.0(19) |
| F(5) | 7296(5) | 8937(5) | 4691(5) | 42(2) |
| O(7) | 6747(5) | 6339(4) | 5394(5) | 34.6(4) |
| O(8) | 4330(5) | 6861(4) | 6086(4) | 36(2) |
| O(9) | 5371(7) | 7366(5) | 4265(4) | 26(3) |

TABLE 12
Anisotropic Displacement Parameters (×10⁴) for 3c.

| Atom | U₁₁ | U₂₂ | U₃₃ | U₂₃ | U₁₃ | U₁₂ |
|---|---|---|---|---|---|---|
| S(1) | 16.93(19) | 25.6(2) | 21.2(2) | −3.69(16) | −6.08(15) | −2.91(15) |
| S(2) | 16.3(2) | 27.4(2) | 22.9(2) | −5.82(16) | −6.36(15) | −2.09(16) |
| O(1) | 23.3(6) | 28.2(7) | 20.4(6) | −5.8(5) | −5.1(5) | −5.9(5) |
| O(2) | 37.1(8) | 35.4(7) | 23.1(7) | −3.3(6) | −11.0(6) | −4.8(6) |
| O(3) | 17.8(6) | 24.5(6) | 28.5(7) | −6.6(5) | −5.5(5) | −1.9(5) |
| O(4) | 21.7(6) | 31.3(7) | 39.1(8) | −2.9(6) | −9.6(6) | 2.1(5) |
| N(1) | 18.5(7) | 24.4(7) | 20.6(7) | −5.1(6) | −5.7(6) | −1.9(6) |
| C(1) | 19.8(8) | 26.0(9) | 23.7(9) | −5.6(7) | −3.6(7) | −5.1(7) |
| C(2) | 19.1(8) | 29.8(9) | 24.2(9) | −7.3(7) | −5.2(7) | −4.0(7) |
| C(3) | 19.3(9) | 36.1(10) | 29.5(10) | −8.7(8) | −5.2(7) | −3.5(7) |
| C(4) | 24.5(9) | 40.9(11) | 26.5(10) | −9.9(8) | −0.8(8) | −6.6(8) |
| C(5) | 30.0(10) | 37.6(11) | 22.2(9) | −6.4(8) | −3.7(8) | −9.5(8) |
| C(6) | 25.0(9) | 30.3(9) | 25.0(9) | −4.8(7) | −8.2(7) | −6.0(7) |
| C(7) | 21.9(8) | 26.5(9) | 23.1(9) | −5.5(7) | −6.3(7) | −4.5(7) |
| C(8) | 20.5(8) | 27.7(9) | 23.9(9) | −4.9(7) | −5.9(7) | −3.1(7) |
| C(9) | 25.1(9) | 34.1(10) | 29.1(10) | −9.1(8) | −9.4(8) | −3.4(8) |
| C(10) | 35.7(11) | 40.7(12) | 41.7(12) | −20.0(10) | −15.5(9) | −0.9(9) |
| C(11) | 38.1(12) | 37.2(11) | 46.0(13) | −21.1(10) | −14.9(10) | 5.9(9) |
| C(12) | 26.8(9) | 31.9(10) | 33.8(10) | −10.2(8) | −9.8(8) | 1.4(8) |
| C(13) | 17.7(8) | 23.9(8) | 22.8(8) | −3.8(7) | −7.3(7) | −2.6(6) |
| C(14) | 17.9(8) | 26.5(9) | 25.8(9) | −0.9(7) | −6.8(7) | −5.8(7) |
| C(15) | 21.1(8) | 26.8(9) | 22.9(9) | −5.6(7) | −4.9(7) | −1.0(7) |
| C(16) | 24.5(9) | 27.6(9) | 21.7(9) | −2.3(7) | −6.3(7) | −5.2(7) |
| C(17) | 18.0(8) | 28.9(9) | 23.9(9) | −4.4(7) | −2.5(7) | −3.5(7) |
| C(18) | 18.7(8) | 27.3(9) | 25.4(9) | −4.3(7) | −8.6(7) | −2.6(7) |
| C(19) | 24.2(9) | 27.3(9) | 27.7(9) | −10.5(7) | −7.0(7) | −0.8(7) |
| B(1) | 18.8(9) | 24.4(9) | 21.5(9) | −6.0(8) | −5.7(7) | −3.3(7) |
| S(1C) | 24.5(2) | 31.7(2) | 23.3(2) | −8.13(18) | −5.37(17) | −6.56(17) |
| F(5C) | 99.4(13) | 38.2(8) | 47.1(8) | −17.3(7) | −28.0(9) | 10.1(8) |
| F(6C) | 52.8(8) | 58.3(8) | 27.2(6) | −18.3(6) | −9.9(6) | −4.3(7) |
| F(7C) | 28.2(7) | 98.8(13) | 73.3(11) | −46.1(10) | −0.7(7) | 5.5(8) |
| O(2C) | 45.2(9) | 34.3(8) | 37.9(8) | −2.2(6) | −20.0(7) | −8.7(7) |
| O(3C) | 46.2(9) | 37.3(8) | 28.5(7) | −5.4(6) | −18.7(7) | −8.6(7) |
| O(4C) | 28.3(7) | 54.1(10) | 39.8(8) | −22.6(7) | 2.8(6) | −13.6(7) |
| C(8C) | 32.9(11) | 46.8(12) | 29.7(10) | −14.6(9) | −7.4(8) | 0.4(9) |
| S(9C) | 23.0(4) | 28.3(3) | 23.6(3) | −9.6(3) | −7.2(3) | 1.5(3) |
| F(13C) | 90.0(16) | 73.0(14) | 56.0(12) | −47.1(11) | 6.1(11) | −2.7(12) |
| F(14C) | 37.0(10) | 127(2) | 53.2(12) | −47.9(13) | 10.3(9) | −16.3(11) |
| F(15C) | 88.0(19) | 131(2) | 91.7(19) | −25.3(17) | −16.5(15) | 79.6(19) |
| O(10C) | 39.6(9) | 30.5(8) | 32.7(10) | 0.1(7) | −13.3(8) | −0.7(7) |
| O(11C) | 29.1(10) | 59.3(17) | 29.5(10) | −21.2(9) | −7.0(8) | −4.9(10) |
| O(12C) | 46.8(11) | 30.7(9) | 29.2(9) | −4.7(7) | −8.8(8) | −8.0(8) |
| C(16C) | 43.7(16) | 67(2) | 43.1(16) | −24.7(15) | −4.0(13) | 16.3(15) |
| C(1A) | 34(3) | 31(3) | 43(3) | −12(3) | −10(3) | −1(3) |
| S(6) | 25(2) | 27.6(18) | 30(2) | −9.5(15) | −8.9(15) | −2.6(14) |
| F(3) | 65(5) | 45(4) | 45(4) | −17(3) | −17(4) | −11(4) |
| F(4) | 39(4) | 30(3) | 59(4) | −9(3) | −12(3) | 5(3) |
| F(5) | 36(4) | 40(4) | 49(4) | −16(4) | −1(3) | −11(3) |
| O(7) | 39.6(9) | 30.5(8) | 32.7(10) | 0.1(7) | −13.3(8) | −0.7(7) |
| O(8) | 29(4) | 54(5) | 32(4) | −19(4) | −14(4) | 6(4) |
| O(9) | 35(5) | 26(5) | 21(4) | −7(3) | −14(4) | 1(4) |

The anisotropic displacement factor exponent takes the form: −2p²[h²a*² × U₁₁ + . . . + 2hka* × b* × U₁₂]

TABLE 13
Bond Lengths in Å for 3c

| Atom | Atom | Length/Å | Atom | Atom | Length/Å |
|---|---|---|---|---|---|
| S(1) | C(1) | 1.7786(19) | C(13) | C(14) | 1.532(2) |
| S(1) | C(7) | 1.7759(18) | C(13) | B(1) | 1.649(3) |
| S(1) | C(13) | 1.8361(18) | C(15) | C(16) | 1.502(3) |
| S(2) | C(2) | 1.7708(19) | C(17) | C(18) | 1.508(3) |
| S(2) | C(8) | 1.7783(19) | S(1C) | O(2C) | 1.4388(15) |
| S(2) | C(14) | 1.8268(18) | S(1C) | O(3C) | 1.4411(14) |
| O(1) | C(15) | 1.331(2) | S(1C) | O(4C) | 1.4373(15) |
| O(1) | B(1) | 1.460(2) | S(1C) | C(8C) | 1.822(2) |
| O(2) | C(15) | 1.207(2) | F(5C) | C(8C) | 1.320(3) |
| O(3) | C(17) | 1.336(2) | F(6C) | C(8C) | 1.330(2) |
| O(3) | B(1) | 1.456(2) | F(7C) | C(8C) | 1.333(2) |
| O(4) | C(17) | 1.204(2) | S(9C) | O(10C) | 1.4380(18) |
| N(1) | C(16) | 1.507(2) | S(9C) | O(11C) | 1.440(2) |
| N(1) | C(18) | 1.504(2) | S(9C) | O(12C) | 1.4400(19) |
| N(1) | C(19) | 1.503(2) | S(9C) | C(16C) | 1.812(3) |
| N(1) | B(1) | 1.649(2) | F(13C) | C(16C) | 1.317(3) |
| C(1) | C(2) | 1.392(3) | F(14C) | C(16C) | 1.323(3) |
| C(1) | C(6) | 1.381(3) | F(15C) | C(16C) | 1.335(3) |
| C(2) | C(3) | 1.384(3) | C(1A) | S(6) | 1.8237 |
| C(3) | C(4) | 1.392(3) | C(1A) | F(3) | 1.3286 |
| C(4) | C(5) | 1.387(3) | C(1A) | F(4) | 1.3291 |
| C(5) | C(6) | 1.394(3) | C(1A) | F(5) | 1.3246 |
| C(7) | C(8) | 1.398(3) | S(6) | O(7) | 1.4389 |
| C(7) | C(12) | 1.377(3) | S(6) | O(8) | 1.4379 |
| C(8) | C(9) | 1.384(3) | S(6) | O(9) | 1.4426 |
| C(9) | C(10) | 1.390(3) | F(4) | F(4)¹ | 1.454(8) |
| C(10) | C(11) | 1.387(3) | | | |
| C(11) | C(12) | 1.394(3) | | | |

¹1 − x, 2 − y, 1 − z

TABLE 14
Bond Angles in ° for 3c

| Atom | Atom | Atom | Angle/° |
|---|---|---|---|
| C(1) | S(1) | C(13) | 97.75(8) |
| C(7) | S(1) | C(1) | 100.63(9) |
| C(7) | S(1) | C(13) | 100.94(8) |
| C(2) | S(2) | C(8) | 99.81(9) |
| C(2) | S(2) | C(14) | 102.23(8) |
| C(8) | S(2) | C(14) | 96.50(9) |
| C(15) | O(1) | B(1) | 113.95(14) |
| C(17) | O(3) | B(1) | 114.08(14) |
| C(16) | N(1) | B(1) | 103.41(13) |
| C(18) | N(1) | C(16) | 113.62(14) |
| C(18) | N(1) | B(1) | 103.70(13) |
| C(19) | N(1) | C(16) | 109.24(14) |
| C(19) | N(1) | C(18) | 110.18(14) |
| C(19) | N(1) | B(1) | 116.61(14) |
| C(2) | C(1) | S(1) | 118.64(14) |
| C(6) | C(1) | S(1) | 120.24(15) |
| C(6) | C(1) | C(2) | 121.07(17) |
| C(1) | C(2) | S(2) | 119.52(14) |
| C(3) | C(2) | S(2) | 119.52(15) |
| C(3) | C(2) | C(1) | 120.95(18) |
| C(2) | C(3) | C(4) | 118.04(18) |
| C(5) | C(4) | C(3) | 121.04(18) |
| C(4) | C(5) | C(6) | 120.70(18) |
| C(1) | C(6) | C(5) | 118.19(18) |
| C(8) | C(7) | S(1) | 119.58(14) |
| C(12) | C(7) | S(1) | 119.45(15) |
| C(12) | C(7) | C(8) | 120.96(17) |
| C(7) | C(8) | S(2) | 118.12(14) |
| C(9) | C(8) | S(2) | 121.02(15) |
| C(9) | C(8) | C(7) | 120.74(18) |
| C(8) | C(9) | C(10) | 118.31(19) |
| C(11) | C(10) | C(9) | 120.80(19) |
| C(10) | C(11) | C(12) | 120.9(2) |
| C(7) | C(12) | C(11) | 118.29(19) |
| C(14) | C(13) | S(1) | 113.55(12) |
| C(14) | C(13) | B(1) | 113.39(15) |
| B(1) | C(13) | S(1) | 108.32(12) |
| C(13) | C(14) | S(2) | 116.30(13) |
| O(1) | C(15) | C(16) | 111.62(15) |
| O(2) | C(15) | O(1) | 123.42(17) |
| O(2) | C(15) | C(16) | 124.95(17) |
| C(15) | C(16) | N(1) | 106.97(14) |
| O(3) | C(17) | C(18) | 111.29(15) |
| O(4) | C(17) | O(3) | 123.70(17) |
| O(4) | C(17) | C(18) | 124.97(17) |
| N(1) | C(18) | C(17) | 106.95(14) |
| O(1) | B(1) | N(1) | 103.55(14) |
| O(1) | B(1) | C(13) | 110.76(14) |
| O(3) | B(1) | O(1) | 112.27(15) |
| O(3) | B(1) | N(1) | 103.42(13) |
| O(3) | B(1) | C(13) | 110.90(15) |
| N(1) | B(1) | C(13) | 115.61(14) |
| O(2C) | S(1C) | O(3C) | 114.49(9) |
| O(2C) | S(1C) | C(8C) | 103.54(10) |
| O(3C) | S(1C) | C(8C) | 103.68(10) |
| O(4C) | S(1C) | O(2C) | 115.04(10) |
| O(4C) | S(1C) | O(3C) | 114.74(10) |
| O(4C) | S(1C) | C(8C) | 103.17(9) |
| F(5C) | C(8C) | S(1C) | 112.00(14) |
| F(5C) | C(8C) | F(6C) | 107.01(17) |
| F(5C) | C(8C) | F(7C) | 108.9(2) |
| F(6C) | C(8C) | S(1C) | 111.59(15) |
| F(6C) | C(8C) | F(7C) | 107.55(17) |
| F(7C) | C(8C) | S(1C) | 109.68(15) |
| O(10C) | S(9C) | O(11C) | 115.25(15) |
| O(10C) | S(9C) | O(12C) | 114.38(12) |
| O(10C) | S(9C) | C(16C) | 103.89(13) |
| O(11C) | S(9C) | C(16C) | 104.29(14) |
| O(12C) | S(9C) | O(11C) | 113.57(14) |
| O(12C) | S(9C) | C(16C) | 103.58(13) |
| F(13C) | C(16C) | S(9C) | 111.7(2) |
| F(13C) | C(16C) | F(14C) | 106.5(2) |
| F(13C) | C(16C) | F(15C) | 108.3(3) |
| F(14C) | C(16C) | S(9C) | 110.4(2) |
| F(14C) | C(16C) | F(15C) | 109.1(3) |
| F(15C) | C(16C) | S(9C) | 110.8(2) |
| F(3) | C(1A) | S(6) | 111.1 |
| F(3) | C(1A) | F(4) | 107.4 |
| F(4) | C(1A) | S(6) | 110.8 |
| F(5) | C(1A) | S(6) | 111.3 |
| F(5) | C(1A) | F(3) | 108.4 |
| F(5) | C(1A) | F(4) | 107.8 |
| O(7) | S(6) | C(1A) | 104.0 |
| O(7) | S(6) | O(9) | 114.7 |
| O(8) | S(6) | C(1A) | 102.9 |
| O(8) | S(6) | O(7) | 115.0 |
| O(8) | S(6) | O(9) | 114.8 |
| O(9) | S(6) | C(1A) | 103.1 |
| C(1A) | F(4) | F(4)1 | 146.3(8) |

11 − x, 2 − y, 1 − z

TABLE 15
Torsion Angles in ° for 3c

| Atom | Atom | Atom | Atom | Angle/° |
|---|---|---|---|---|
| S(1) | C(1) | C(2) | S(2) | 2.9(2) |
| S(1) | C(1) | C(2) | C(3) | −178.39(15) |
| S(1) | C(1) | C(6) | C(5) | 177.54(14) |
| S(1) | C(7) | C(8) | S(2) | 6.6(2) |
| S(1) | C(7) | C(8) | C(9) | −177.28(15) |
| S(1) | C(7) | C(12) | C(11) | 178.11(17) |
| S(1) | C(13) | C(14) | S(2) | 17.90(19) |
| S(1) | C(13) | B(1) | O(1) | 114.48(14) |
| S(1) | C(13) | B(1) | O(3) | −10.87(17) |
| S(1) | C(13) | B(1) | N(1) | −128.16(13) |
| S(2) | C(2) | C(3) | C(4) | 179.44(15) |
| S(2) | C(8) | C(9) | C(10) | 174.99(16) |
| O(1) | C(15) | C(16) | N(1) | −6.1(2) |
| O(2) | C(15) | C(16) | N(1) | 172.73(18) |
| O(3) | C(17) | C(18) | N(1) | −1.9(2) |
| O(4) | C(17) | C(18) | N(1) | −179.66(17) |
| C(1) | S(1) | C(7) | C(8) | 44.00(17) |
| C(1) | S(1) | C(7) | C(12) | −135.00(16) |
| C(1) | S(1) | C(13) | C(14) | −62.88(14) |
| C(1) | S(1) | C(13) | B(1) | 170.22(12) |
| C(1) | C(2) | C(3) | C(4) | 0.7(3) |
| C(2) | S(2) | C(8) | C(7) | −52.53(16) |
| C(2) | S(2) | C(8) | C(9) | 131.40(16) |
| C(2) | S(2) | C(14) | C(13) | 37.54(16) |
| C(2) | C(1) | C(6) | C(5) | −0.2(3) |
| C(2) | C(3) | C(4) | C(5) | 0.0(3) |
| C(3) | C(4) | C(5) | C(6) | −0.9(3) |
| C(4) | C(5) | C(6) | C(1) | 0.9(3) |
| C(6) | C(1) | C(2) | S(2) | −179.38(14) |
| C(6) | C(1) | C(2) | C(3) | −0.7(3) |
| C(7) | S(1) | C(1) | C(2) | −49.30(17) |
| C(7) | S(1) | C(1) | C(6) | 132.94(16) |
| C(7) | S(1) | C(13) | C(14) | 39.60(15) |
| C(7) | S(1) | C(13) | B(1) | −87.31(13) |
| C(7) | C(8) | C(9) | C(10) | −1.0(3) |
| C(8) | S(2) | C(2) | C(1) | 47.45(17) |
| C(8) | S(2) | C(2) | C(3) | −131.30(16) |
| C(8) | S(2) | C(14) | C(13) | −64.01(15) |
| C(8) | C(7) | C(12) | C(11) | −0.9(3) |
| C(8) | C(9) | C(10) | C(11) | −0.5(3) |
| C(9) | C(10) | C(11) | C(12) | 1.3(4) |
| C(10) | C(11) | C(12) | C(7) | −0.6(3) |
| C(12) | C(7) | C(8) | S(2) | −174.38(15) |
| C(12) | C(7) | C(8) | C(9) | 1.7(3) |
| C(13) | S(1) | C(1) | C(2) | 53.44(16) |
| C(13) | S(1) | C(1) | C(6) | −124.32(16) |
| C(13) | S(1) | C(7) | C(8) | −56.14(16) |
| C(13) | S(1) | C(7) | C(12) | 124.86(16) |
| C(14) | S(2) | C(2) | C(1) | −51.47(17) |
| C(14) | S(2) | C(2) | C(3) | 129.78(16) |
| C(14) | S(2) | C(8) | C(7) | 51.12(16) |
| C(14) | S(2) | C(8) | C(9) | −124.95(16) |
| C(14) | C(13) | B(1) | O(1) | −12.5(2) |
| C(14) | C(13) | B(1) | O(3) | −137.86(16) |
| C(14) | C(13) | B(1) | N(1) | 104.84(17) |
| C(15) | O(1) | B(1) | O(3) | −108.59(17) |
| C(15) | O(1) | B(1) | N(1) | 2.30(19) |
| C(15) | O(1) | B(1) | C(13) | 126.83(16) |
| C(16) | N(1) | C(18) | C(17) | −105.96(16) |
| C(16) | N(1) | B(1) | O(1) | −5.71(17) |
| C(16) | N(1) | B(1) | O(3) | 111.57(15) |
| C(16) | N(1) | B(1) | C(13) | −127.02(16) |
| C(17) | O(3) | B(1) | O(1) | 117.68(16) |
| C(17) | O(3) | B(1) | N(1) | 6.70(19) |
| C(17) | O(3) | B(1) | C(13) | −117.82(16) |
| C(18) | N(1) | C(16) | C(15) | 118.64(16) |
| C(18) | N(1) | B(1) | O(1) | −124.53(14) |
| C(18) | N(1) | B(1) | O(3) | −7.26(17) |
| C(18) | N(1) | B(1) | C(13) | 114.15(16) |
| C(19) | N(1) | C(16) | C(15) | −117.89(16) |
| C(19) | N(1) | C(18) | C(17) | 131.08(15) |
| C(19) | N(1) | B(1) | O(1) | 114.18(16) |
| C(19) | N(1) | B(1) | O(3) | −128.55(15) |
| C(19) | N(1) | B(1) | C(13) | −7.1(2) |
| B(1) | O(1) | C(15) | O(2) | −176.69(18) |
| B(1) | O(1) | C(15) | C(16) | 2.2(2) |
| B(1) | O(3) | C(17) | O(4) | 174.36(18) |
| B(1) | O(3) | C(17) | C(18) | −3.4(2) |
| B(1) | N(1) | C(16) | C(15) | 6.92(18) |
| B(1) | N(1) | C(18) | C(17) | 5.58(17) |
| B(1) | C(13) | C(14) | S(2) | 142.10(13) |
| O(2C) | S(1C) | C(8C) | F(5C) | −175.06(15) |
| O(2C) | S(1C) | C(8C) | F(6C) | −55.12(17) |
| O(2C) | S(1C) | C(8C) | F(7C) | 63.95(18) |
| O(3C) | S(1C) | C(8C) | F(5C) | 65.11(17) |
| O(3C) | S(1C) | C(8C) | F(6C) | −174.95(14) |
| O(3C) | S(1C) | C(8C) | F(7C) | −55.88(18) |
| O(4C) | S(1C) | C(8C) | F(5C) | −54.84(18) |
| O(4C) | S(1C) | C(8C) | F(6C) | 65.10(17) |
| O(4C) | S(1C) | C(8C) | F(7C) | −175.83(16) |
| O(10C) | S(9C) | C(16C) | F(13C) | 62.0(2) |
| O(10C) | S(9C) | C(16C) | F(14C) | −56.4(2) |
| O(10C) | S(9C) | C(16C) | F(15C) | −177.3(3) |
| O(11C) | S(9C) | C(16C) | F(13C) | −177.0(2) |
| O(11C) | S(9C) | C(16C) | F(14C) | 64.7(2) |
| O(11C) | S(9C) | C(16C) | F(15C) | −56.2(3) |
| O(12C) | S(9C) | C(16C) | F(13C) | −57.9(2) |
| O(12C) | S(9C) | C(16C) | F(14C) | −176.2(2) |
| O(12C) | S(9C) | C(16C) | F(15C) | 62.9(3) |
| S(6) | C(1A) | F(4) | F(4)1 | −132.0(14) |
| F(3) | C(1A) | S(6) | O(7) | −62.5 |
| F(3) | C(1A) | S(6) | O(8) | 57.8 |
| F(3) | C(1A) | S(6) | O(9) | 177.5 |
| F(3) | C(1A) | F(4) | F(4)1 | 106.5(14) |
| F(4) | C(1A) | S(6) | O(7) | 178.2 |
| F(4) | C(1A) | S(6) | O(8) | −61.5 |
| F(4) | C(1A) | S(6) | O(9) | 58.2 |
| F(5) | C(1A) | S(6) | O(7) | 58.3 |
| F(5) | C(1A) | S(6) | O(8) | 178.6 |
| F(5) | C(1A) | S(6) | O(9) | −61.7 |
| F(5) | C(1A) | F(4) | F(4)1 | −10.1(14) |

11 − x, 2 − y, 1 − z

TABLE 16
Hydrogen Fractional Atomic Coordinates (×10⁴) and Equivalent Isotropic
Displacement Parameters (Å² × 10³) for 3c.

| Atom | x | y | z | U_{eq} |
|---|---|---|---|---|
| H(3) | −811.68 | 7126.16 | 4180.26 | 34 |
| H(4) | −961.31 | 6590.62 | 5925.94 | 37 |
| H(5) | 960.31 | 5794.94 | 6496.23 | 36 |
| H(6) | 3074.24 | 5465.62 | 5333.48 | 32 |
| H(9) | 803.6 | 5370.18 | 1275.53 | 34 |
| H(10) | 2012.22 | 3699.3 | 743.02 | 44 |
| H(11) | 4067.56 | 3044.63 | 1183.04 | 46 |
| H(12) | 4924.67 | 3997.87 | 2220.67 | 36 |
| H(13) | 4089.88 | 8038.14 | 2928.64 | 25 |
| H(14A) | 3318.9 | 7924.49 | 1190.89 | 28 |
| H(14B | 2692.78 | 8748.04 | 1990.42 | 28 |
| H(16A) | 6760.81 | 10348.17 | 521.76 | 30 |
| H(16B) | 8055.99 | 9444.87 | 292.24 | 30 |
| H(18A) | 7769.39 | 8392.04 | 2723.39 | 28 |
| H(18B | 8716.23 | 8547.55 | 1572.59 | 28 |
| H(19A) | 6493.65 | 10322.66 | 2260.43 | 38 |
| H(19B) | 5579.76 | 9230.58 | 3032.34 | 38 |
| H(19C) | 5040.26 | 9995.52 | 2101.59 | 38 |

U_{eg} is defined as ⅓ of the trace of the orthogonalised Uᵢⱼ.

TABLE 17
Atomic Occupancies for all atoms that
are not fully occupied in 3c.

| Atom | Occupancy |
|---|---|
| S(9C) | 0.8485(19) |
| F(13C) | 0.8485(19) |
| F(14C) | 0.8485(19) |
| F(15C) | 0.8485(19) |
| O(10C) | 0.8485(19) |
| O(11C) | 0.8485(19) |
| O(12C) | 0.8485(19) |
| C(16C) | 0.8485(19) |
| C(1A) | 0.1515(19) |
| S(6) | 0.1515(19) |
| F(3) | 0.1515(19) |
| F(4) | 0.1515(19) |
| F(5) | 0.1515(19) |
| O(7) | 0.1515(19) |
| O(8) | 0.1515(19) |
| O(9) | 0.1515(19) |

TABLE 18
Solvent masking (PLATON/SQUEEZE) information for 3c

| No | x | y | z | V | e | Content |
|---|---|---|---|---|---|---|
| 1 | 0.000 | 0.000 | 0.500 | 175.4 | 49.3 | 2 acetonitrile |

### Crystallography Data for Compound 45.

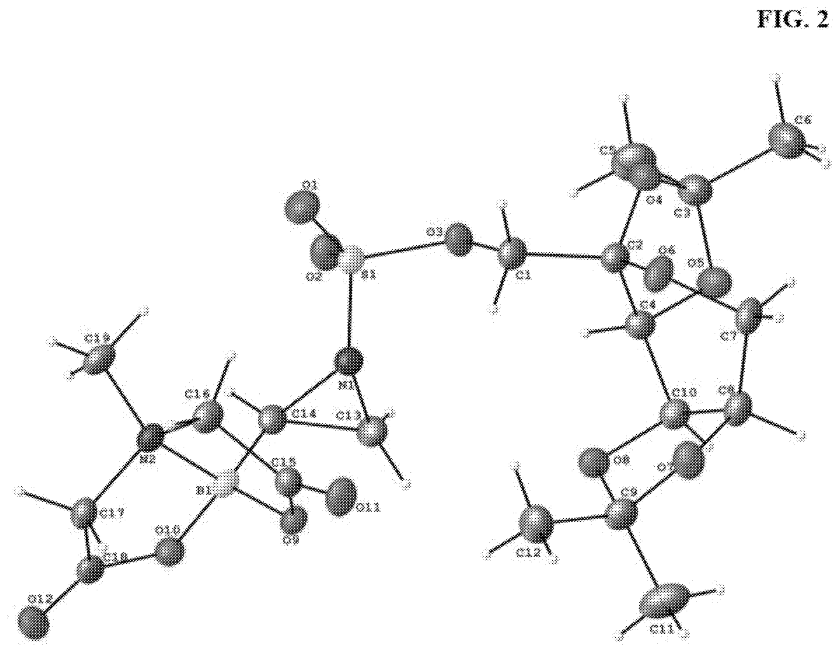

Compound 45 was crystallized from dichloromethane/Et₂O. The X-ray structure of compound 45 is shown in FIG. 2. The crystallographic data compound 45 are summarized in the following tables.

TABLE 19
Crystallography Data for Compound 45.

| Compound | 45 |
|---|---|
| Formula | C₁₉H₂₉BN₂O₁₂S |
| Dcalc./g cm⁻³ | 1.440 |
| 1/mm⁻¹ | 1.788 |
| Formula Weight | 520.31 |
| Colour | colourless |
| Shape | plate-shaped |
| Size/mm³ | 0.16 × 0.07 × 0.01 |
| T/K | 100.01(10) |
| Crystal System | monoclinic |
| Flack Parameter | 0.013(11) |
| Hooft Parameter | 0.020(5) |
| Space Group | PZ₁ |
| a/Å | 10.02940(10) |
| b/Å | 6.24760(10) |
| c/Å | 19.1570(3) |
| α/° | 90 |
| β/° | 90.7440(10) |
| γ/° | 90 |
| V/Å³ | 1200.27(3) |
| Z | 2 |
| Z′ | 1 |
| Wavelength/Å | 1.54184 |
| Radiation type | Cu K_{α} |
| Θmin/° | 2.307 |
| Θmax/° | 74.468 |
| Measured Refl's. | 23814 |
| Indep't Refl's | 4898 |
| Refl's I ≥ 2 σ(I) | 4763 |
| Rint | 0.0366 |
| Parameters | 321 |
| Restraints | 1 |
| Largest Peak | 0.241 |
| Deepest Hole | −0.312 |
| GooF | 1.055 |
| wR2 (all data) | 0.0757 |
| wR2 | 0.0751 |
| R1 (all data) | 0.0304 |
| R1 | 0.0294 |

TABLE 20
Structure Quality Indicators

| | D min (CuKα) 0.80 | I/σ(I) | Rint 3.66% | Full | |
|---|---|---|---|---|---|
| Reflections: | 2θ = 148.9° | 36.2 | m −4.80 | 135.4° 100 | |
| Refinement: | Shift 0.000 | Max Peak 0.2 | Min Peak −0.3 | GooF | Hooft |
| | | | | 1.055 | .020(5) |

TABLE 21
Bond lengths [Å] and angles [°]

| Atom | x | y | z | Ueq |
|---|---|---|---|---|
| S(1) | 3763.0(4) | 3129.6(9) | 3084.9(3) | 19.99(13) |
| O(1) | 3373.8(18) | 1055(3) | 2852.3(10) | 30.7(4) |
| O(2) | 2869.5(15) | 4303(3) | 3512.3(9) | 27.4(4) |
| O(3) | 5086.5(14) | 3035(3) | 3527.8(8) | 23.6(3) |
| O(4) | 7392.1(16) | 2077(3) | 4339.8(9) | 25.6(4) |
| O(5) | 8071.0(17) | 5527(3) | 4488.7(8) | 25.4(4) |
| O(6) | 8562.1(15) | 2145(3) | 3305.4(9) | 24.0(3) |
| O(7) | 9623.2(16) | 5311(3) | 2373.9(9) | 25.3(4) |
| O(8) | 7697.5(15) | 6919(3) | 2674.3(8) | 22.3(3) |
| O(9) | 4597.7(14) | 5740(3) | 934.1(8) | 19.1(3) |
| O(10) | 2447.2(15) | 7624(2) | 938.6(8) | 20.6(3) |
| O(11) | 5984.9(14) | 3312(3) | 477.8(8) | 26.0(4) |
| O(12) | 1033.9(14) | 8275(3) | 48.6(9) | 28.0(4) |
| N(1) | 4251.5(18) | 4429(3) | 2388.3(10) | 19.6(4) |
| N(2) | 2560.2(17) | 3762(3) | 846.8(10) | 18.2(4) |
| C(1) | 6299(2) | 2204(4) | 3213.9(12) | 21.9(5) |
| C(2) | 7461.4(19) | 2978(4) | 3667.6(11) | 20.8(4) |
| C(3) | 7572(2) | 3720(4) | 4860.8(13) | 28.4(5) |
| C(4) | 7524(2) | 5401(4) | 3804.8(12) | 20.2(4) |
| C(5) | 6242(3) | 4205(6) | 5197.2(15) | 38.2(6) |
| C(6) | 8625(3) | 3014(6) | 5385.4(15) | 41.2(7) |
| C(7) | 9794(2) | 3270(4) | 3425.6(12) | 24.7(5) |
| C(8) | 9711(2) | 5481(4) | 3119.3(12) | 22.3(5) |
| C(9) | 8644(2) | 6800(4) | 2124.4(12) | 23.5(5) |
| C(10) | 8414(2) | 6672(4) | 3320.8(12) | 20.3(4) |
| C(11) | 9279(3) | 8949(5) | 1987.4(16) | 38.4(7) |
| C(12) | 7952(3) | 5855(5) | 1492.9(13) | 32.0(6) |
| C(13) | 4352(2) | 6780(4) | 2461.3(13) | 23.2(5) |
| C(14) | 3220(2) | 5858(4) | 2049.5(12) | 20.0(4) |
| C(15) | 4902(2) | 3817(4) | 692.6(11) | 20.0(5) |
| C(16) | 3714(2) | 2316(4) | 721.2(13) | 21.8(5) |
| C(17) | 2018(2) | 4746(4) | 186.2(12) | 22.3(5) |
| C(18) | 1757(2) | 7067(4) | 364.8(12) | 21.6(5) |
| C(19) | 1469(2) | 2696(4) | 1239.9(12) | 23.0(5) |
| B(1) | 3235(2) | 5851(4) | 1223.7(13) | 18.4(5) |

Fractional Åtomic Coordinates (×10⁴) and Equivalent Isotropic Displacement Parameters (Å² × 10³) for 45. U_{eq} is defined as ⅓ of the trace of the orthogonalised Uᵢⱼ.

TABLE 22
Ånisotropic Displacement Parameters (×10⁴) for 45.

| Atom | U₁₁ | U₂₂ | U₃₃ | U₂₃ | U₁₃ | U₁₂ |
|---|---|---|---|---|---|---|
| S(1) | 14.0(2) | 21.9(3) | 24.0(2) | 2.3(2) | 0.09(17) | 0.1(2) |
| O(1) | 27.0(9) | 24.9(10) | 40.0(10) | 3.0(7) | −3.0(7) | −3.6(7) |
| O(2) | 16.9(7) | 38.4(11) | 27.0(8) | 0.0(8) | 3.9(6) | 2.7(7) |
| O(3) | 13.7(6) | 33.1(9) | 24.0(7) | 3.1(8) | 0.5(5) | 2.7(7) |
| O(4) | 26.4(8) | 23.6(9) | 26.7(8) | 5.0(7) | −3.4(6) | −0.3(7) |
| O(5) | 28.9(8) | 26.3(9) | 21.0(8) | 0.1(7) | −0.3(6) | −3.1(7) |
| O(6) | 14.3(7) | 20.7(8) | 37.1(9) | −6.1(7) | 1.2(6) | 1.2(6) |
| O(7) | 19.4(7) | 32.7(10) | 23.8(8) | −4.7(7) | 1.7(6) | 3.6(7) |
| O(8) | 16.7(7) | 27.8(9) | 22.5(8) | 3.6(7) | 3.4(6) | 1.8(6) |
| O(9) | 13.5(7) | 20.6(8) | 23.4(7) | 0.3(6) | 1.1(5) | −1.8(6) |
| O(10) | 17.1(7) | 18.7(9) | 26.1(7) | 1.4(6) | 0.4(6) | 0.8(6) |
| O(11) | 14.4(6) | 34.2(10) | 29.5(8) | −5.2(8) | 4.2(6) | 2.1(7) |
| O(12) | 16.0(6) | 34.5(10) | 33.6(8) | 9.1(8) | −0.7(6) | 4.4(8) |
| N(1) | 15.8(8) | 19.1(10) | 23.8(9) | 1.4(8) | 0.5(7) | 1.1(7) |
| N(2) | 13.6(8) | 18.9(10) | 22.2(9) | −1.1(7) | 2.3(6) | −1.5(7) |
| C(1) | 14.6(10) | 23.0(11) | 28.2(11) | −0.7(10) | 1.0(8) | 2.4(9) |
| C(2) | 15.2(9) | 21.0(11) | 26.1(10) | 1.2(10) | 0.5(7) | 0.8(9) |
| C(3) | 30.2(12) | 29.3(14) | 25.5(12) | 4.2(10) | −2.4(9) | −3.3(10) |
| C(4) | 18.5(10) | 20.2(12) | 21.9(10) | 0.2(9) | 1.4(8) | 1.8(8) |
| C(5) | 39.3(14) | 45.1(18) | 30.4(13) | 0.9(13) | 9.1(11) | −3.3(13) |
| C(6) | 43.4(14) | 45.7(17) | 34.1(13) | 10.9(14) | −13.1(11) | −8.8(15) |
| C(7) | 13.5(8) | 25.9(12) | 34.8(11) | −4.7(11) | −1.4(8) | 0.5(10) |
| C(8) | 15.4(9) | 25.9(12) | 25.7(11) | −5.1(10) | 1.2(8) | −1.3(9) |
| C(9) | 20.6(10) | 26.2(13) | 23.9(11) | −1.4(10) | 4.9(9) | −0.4(9) |
| C(10) | 18.9(10) | 20.1(11) | 22.1(11) | −2.2(9) | 1.9(8) | 0.3(9) |
| C(11) | 46.9(16) | 32.0(15) | 36.5(14) | −2.7(12) | 16.6(12) | −8.5(12) |
| C(12) | 28.6(12) | 42.4(16) | 25.0(12) | −0.9(11) | −1.9(9) | −2.9(11) |
| C(13) | 24.6(11) | 19.5(12) | 25.3(11) | −1.3(9) | −3.5(9) | −1.8(9) |
| C(14) | 15.7(9) | 17.2(11) | 27.3(11) | 0.2(9) | −0.2(8) | 2.7(8) |
| C(15) | 15.6(9) | 24.4(12) | 20.0(10) | 0.6(8) | −0.4(8) | 0.3(8) |
| C(16) | 15.2(10) | 20.9(11) | 29.5(11) | −2.8(9) | 4.4(8) | 2.1(8) |
| C(17) | 15.7(9) | 27.3(12) | 23.7(11) | 0.4(9) | −1.7(8) | −3.9(9) |
| C(18) | 11.8(9) | 26.9(12) | 26.3(11) | 5.7(10) | 2.8(8) | −0.9(9) |
| C(19) | 17.0(9) | 23.1(13) | 29.0(11) | −0.2(9) | 5.8(8) | −4.1(8) |
| B(1) | 12.4(10) | 16.9(12) | 26.0(12) | 0.2(10) | 1.9(8) | −1.2(9) |

TABLE 23
Bond Lengths in Å for 45.

| Atom | Atom | Length/Å |
|---|---|---|
| S(1) | O(1) | 1.423(2) |
| S(1) | O(2) | 1.4248(17) |
| S(1) | O(3) | 1.5672(15) |
| S(1) | N(1) | 1.6421(19) |
| O(3) | C(1) | 1.459(2) |
| O(4) | C(2) | 1.408(3) |
| O(4) | C(3) | 1.442(3) |
| O(5) | C(3) | 1.429(3) |
| O(5) | C(4) | 1.416(3) |
| O(6) | C(2) | 1.411(3) |
| O(6) | C(7) | 1.437(3) |
| O(7) | C(8) | 1.433(3) |
| O(7) | C(9) | 1.430(3) |
| O(8) | C(9) | 1.429(3) |
| O(8) | C(10) | 1.432(3) |
| O(9) | C(15) | 1.325(3) |
| O(9) | B(1) | 1.483(3) |
| O(10) | C(18) | 1.338(3) |
| O(10) | B(1) | 1.462(3) |
| O(11) | C(15) | 1.208(3) |
| O(12) | C(18) | 1.205(3) |
| N(1) | C(13) | 1.479(3) |
| N(1) | C(14) | 1.508(3) |
| N(2) | C(16) | 1.491(3) |
| N(2) | C(17) | 1.502(3) |
| N(2) | C(19) | 1.493(3) |
| N(2) | B(1) | 1.634(3) |
| C(1) | C(2) | 1.524(3) |
| C(2) | C(4) | 1.537(3) |
| C(3) | C(5) | 1.520(4) |
| C(3) | C(6) | 1.514(4) |
| C(4) | C(10) | 1.520(3) |
| C(7) | C(8) | 1.503(4) |
| C(8) | C(10) | 1.552(3) |
| C(9) | C(11) | 1.510(4) |
| C(9) | C(12) | 1.507(3) |
| C(13) | C(14) | 1.490(3) |
| C(14) | B(1) | 1.582(3) |
| C(15) | C(16) | 1.517(3) |
| C(17) | C(18) | 1.513(4) |

TABLE 24
Bond Ångles in ° for SX_45.

| Atom | Atom | Atom | Angle/° |
|---|---|---|---|
| O(1) | S(1) | O(2) | 118.46(11) |
| O(1) | S(1) | O(3) | 111.22(11) |
| O(1) | S(1) | N(1) | 106.20(11) |
| O(2) | S(1) | O(3) | 104.07(10) |
| O(2) | S(1) | N(1) | 114.15(11) |
| O(3) | S(1) | N(1) | 101.49(9) |
| C(1) | O(3) | S(1) | 119.66(14) |
| C(2) | O(4) | C(3) | 109.93(19) |
| C(4) | O(5) | C(3) | 106.48(19) |
| C(2) | O(6) | C(7) | 114.66(18) |
| C(9) | O(7) | C(8) | 108.53(17) |
| C(9) | O(8) | C(10) | 107.51(16) |
| C(15) | O(9) | B(1) | 112.98(17) |
| C(18) | O(10) | B(1) | 112.38(18) |
| C(13) | N(1) | S(1) | 115.77(16) |
| C(13) | N(1) | C(14) | 59.85(15) |
| C(14) | N(1) | S(1) | 115.61(14) |
| C(16) | N(2) | C(17) | 112.65(18) |
| C(16) | N(2) | C(19) | 112.73(18) |
| C(16) | N(2) | B(1) | 103.75(16) |
| C(17) | N(2) | B(1) | 100.88(17) |
| C(19) | N(2) | C(17) | 110.37(17) |
| C(19) | N(2) | B(1) | 115.83(17) |
| O(3) | C(1) | C(2) | 106.71(18) |
| O(4) | C(2) | O(6) | 110.51(19) |
| O(4) | C(2) | C(1) | 110.36(19) |
| O(4) | C(2) | C(4) | 103.88(18) |
| O(6) | C(2) | C(1) | 101.54(18) |
| O(6) | C(2) | C(4) | 114.63(19) |
| C(1) | C(2) | C(4) | 116.1(2) |
| O(4) | C(3) | C(5) | 109.4(2) |
| O(4) | C(3) | C(6) | 109.4(2) |
| O(5) | C(3) | O(4) | 105.01(18) |
| O(5) | C(3) | C(5) | 111.6(2) |
| O(5) | C(3) | C(6) | 108.4(2) |
| C(6) | C(3) | C(5) | 112.6(2) |
| O(5) | C(4) | C(2) | 103.16(19) |
| O(5) | C(4) | C(10) | 108.17(19) |
| C(10) | C(4) | C(2) | 115.67(19) |
| O(6) | C(7) | C(8) | 110.11(18) |
| O(7) | C(8) | C(7) | 108.9(2) |
| O(7) | C(8) | C(10) | 104.04(18) |
| C(7) | C(8) | C(10) | 112.72(18) |
| O(7) | C(9) | C(11) | 110.3(2) |
| O(7) | C(9) | C(12) | 108.7(2) |
| O(8) | C(9) | O(7) | 104.31(18) |
| O(8) | C(9) | C(11) | 111.6(2) |
| O(8) | C(9) | C(12) | 107.95(19) |
| C(12) | C(9) | C(11) | 113.6(2) |
| O(8) | C(10) | C(4) | 106.95(17) |
| O(8) | C(10) | C(8) | 104.43(17) |
| C(4) | C(10) | C(8) | 113.70(19) |
| N(1) | C(13) | C(14) | 61.02(15) |
| N(1) | C(14) | B(1) | 114.41(18) |
| C(13) | C(14) | N(1) | 59.13(14) |
| C(13) | C(14) | B(1) | 120.88(19) |
| O(9) | C(15) | C(16) | 111.32(18) |
| O(11) | C(15) | O(9) | 124.6(2) |
| O(11) | C(15) | C(16) | 124.1(2) |
| N(2) | C(16) | C(15) | 104.04(19) |
| N(2) | C(17) | C(18) | 105.27(18) |
| O(10) | C(18) | C(17) | 110.25(19) |
| O(12) | C(18) | O(10) | 123.5(2) |
| O(12) | C(18) | C(17) | 126.3(2) |
| O(9) | B(1) | N(2) | 100.13(17) |
| O(9) | B(1) | C(14) | 113.26(18) |
| O(10) | B(1) | O(9) | 113.06(18) |
| O(10) | B(1) | N(2) | 102.80(17) |
| O(10) | B(1) | C(14) | 111.04(19) |
| C(14) | B(1) | N(2) | 115.77(18) |

TABLE 25
Torsion Ångles in ° for 45.

| Atom | Atom | Atom | Atom | Angle/° |
|---|---|---|---|---|
| S(1) | O(3) | C(1) | C(2) | 161.83(17) |
| S(1) | N(1) | C(13) | C(14) | −105.94(16) |
| S(1) | N(1) | C(14) | C(13) | 106.20(19) |
| S(1) | N(1) | C(14) | B(1) | −141.13(16) |
| O(1) | S(1) | O(3) | C(1) | 60.0(2) |
| O(1) | S(1) | N(1) | C(13) | 163.85(16) |
| O(1) | S(1) | N(1) | C(14) | 96.63(18) |
| O(2) | S(1) | O(3) | C(1) | −171.41(18 |
| O(2) | S(1) | N(1) | C(13) | 31.47(19) |
| O(2) | S(1) | N(1) | C(14) | −35.8(2) |
| O(3) | S(1) | N(1) | C(13) | −79.81(18) |
| O(3) | S(1) | N(1) | C(14) | −147.03(16) |
| O(3) | C(1) | C(2) | O(4) | 64.5(2) |
| O(3) | C(1) | C(2) | O(6) | −178.25(18) |
| O(3) | C(1) | C(2) | C(4) | −53.3(2) |
| O(4) | C(2) | C(4) | O(5) | 25.2(2) |
| O(4) | C(2) | C(4) | C(10) | 143.09(18) |
| O(5) | C(4) | C(10) | O(8) | −167.49(18) |
| O(5) | C(4) | C(10) | C(8) | 77.8(2) |
| O(6) | C(2) | C(4) | O(5) | −95.5(2) |
| O(6) | C(2) | C(4) | C(10) | 22.4(3) |
| O(6) | C(7) | C(8) | O(7) | −66.9(2) |
| O(6) | C(7) | C(8) | C(10) | 48.0(2) |
| O(7) | C(8) | C(10) | O(8) | 3.7(2) |
| O(7) | C(8) | C(10) | C(4) | 119.9(2) |
| O(9) | C(15) | C(16) | N(2) | 13.9(2) |
| O(11) | C(15) | C(16) | N(2) | −166.3(2) |
| N(1) | S(1) | O(3) | C(1) | −52.6(2) |
| N(1) | C(13) | C(14) | B(1) | −101.7(2) |
| N(1) | C(14) | B(1) | O(9) | −37.8(3) |
| N(1) | C(14) | B(1) | O(10) | −166.31(18) |
| N(1) | C(14) | B(1) | N(2) | 77.0(2) |
| N(2) | C(17) | C(18) | O(10) | 19.2(2) |
| N(2) | C(17) | C(18) | O(12) | −160.4(2) |
| C(1) | C(2) | C(4) | O(5) | 146.52(18) |
| C(1) | C(2) | C(4) | C(10) | −95.6(2) |
| C(2) | O(4) | C(3) | O(5) | −13.7(2) |
| C(2) | O(4) | C(3) | C(5) | 106.3(2) |
| C(2) | O(4) | C(3) | C(6) | −129.9(2) |
| C(2) | O(6) | C(7) | C(8) | −67.2(2) |
| C(2) | C(4) | C(10) | O(8) | 77.5(2) |
| C(2) | C(4) | C(10) | C(8) | −37.3(3) |
| C(3) | O(4) | C(2) | O(6) | 116.4(2) |
| C(3) | O(4) | C(2) | C(1) | −132.1(2) |
| C(3) | O(4) | C(2) | C(4) | −7.0(2) |
| C(3) | O(5) | C(4) | C(2) | −34.4(2) |
| C(3) | O(5) | C(4) | C(10) | −157.38(19) |
| C(4) | O(5) | C(3) | O(4) | 30.6(2) |
| C(4) | O(5) | C(3) | C(5) | −87.9(2) |
| C(4) | O(5) | C(3) | C(6) | 147.4(2) |
| C(7) | O(6) | C(2) | O(4) | −87.0(2) |
| C(7) | O(6) | C(2) | C(1) | 155.9(2) |
| C(7) | O(6) | C(2) | C(4) | 30.0(3) |
| C(7) | C(8) | C(10) | O(8) | −114.1(2) |
| C(7) | C(8) | C(10) | C(4) | 2.1(3) |
| C(8) | O(7) | C(9) | O(8) | −31.4(2) |
| C(8) | O(7) | C(9) | C(11) | 88.5(2) |
| C(8) | O(7) | C(9) | C(12) | −146.4(2) |
| C(9) | O(7) | C(8) | C(7) | 137.34(18) |
| C(9) | O(7) | C(8) | C(10) | 16.9(2) |
| C(9) | O(8) | C(10) | C(4) | −143.80(19) |
| C(9) | O(8) | C(10) | C(8) | −23.0(2) |
| C(10) | O(8) | C(9) | O(7) | 33.8(2) |
| C(10) | O(8) | C(9) | C(11) | −85.3(3) |
| C(10) | O(8) | C(9) | C(12) | 149.3(2) |
| C(13) | N(1) | C(14) | B(1) | 112.7(2) |
| C(13) | C(14) | B(1) | O(9) | 29.5(3) |
| C(13) | C(14) | B(1) | O(10) | −99.0(2) |
| C(13) | C(14) | B(1) | N(2) | 144.4(2) |
| C(15) | O(9) | B(1) | O(10) | −128.7(2) |
| C(15) | O(9) | B(1) | N(2) | −20.0(2) |
| C(15) | O(9) | B(1) | C(14) | 103.9(2) |
| C(16) | N(2) | C(17) | C(18) | −137.20(18) |
| C(16) | N(2) | B(1) | O(9) | 27.0(2) |
| C(16) | N(2) | B(1) | O(10) | 143.69(17) |
| C(16) | N(2) | B(1) | C(14) | −95.1(2) |
| C(17) | N(2) | C(16) | C(15) | 83.5(2) |
| C(17) | N(2) | B(1) | O(9) | −89.75(18) |
| C(17) | N(2) | B(1) | O(10) | 26.90(19) |
| C(17) | N(2) | B(1) | C(14) | 148.12(18) |
| C(18) | O(10) | B(1) | O(9) | 90.1(2) |
| C(18) | O(10) | B(1) | N(2) | −17.0(2) |
| C(18) | O(10) | B(1) | C(14) | −141.36(18) |
| C(19) | N(2) | C(16) | C(15) | −150.78(18) |
| C(19) | N(2) | C(17) | C(18) | 95.8(2) |
| C(19) | N(2) | B(1) | O(9) | 151.12(17) |
| C(19) | N(2) | B(1) | O(10) | −92.2(2) |
| C(19) | N(2) | B(1) | C(14) | 29.0(3) |
| B(1) | O(9) | C(15) | O(11) | −174.6(2) |
| B(1) | O(9) | C(15) | C(16) | 5.2(3) |
| B(1) | O(10) | C(18) | O(12) | 179.4(2) |
| B(1) | O(10) | C(18) | C(17) | −0.3(2) |
| B(1) | N(2) | C(16) | C(15) | −24.7(2) |
| B(1) | N(2) | C(17) | C(18) | −27.17(19) |

TABLE 26
Hydrogen Fractional Åtomic Coordinates (×10⁴) and Equivalent Isotropic
Displacement Parameters (Å² × 10³) for 45.

| Atom | x | y | z | Ueq |
|---|---|---|---|---|
| H(1 Å) | 6386.12 | 2744.75 | 2730.89 | 26 |
| H(1B) | 6277.35 | 620.25 | 3200.49 | 26 |
| H(4) | 6603.41 | 6015.74 | 3796.67 | 24 |
| H(5 Å) | 6343.09 | 5427.51 | 5514.12 | 57 |
| H(5B) | 5944.77 | 2951.97 | 5460.6 | 57 |
| H(5C) | 5579.22 | 4549.26 | 4833.71 | 57 |
| H(6 Å) | 8731.02 | 4113.54 | 5746.75 | 62 |
| H(6B) | 9474.3 | 2806.53 | 5147.84 | 62 |
| H(6C) | 8349.59 | 1665.13 | 5601.32 | 62 |
| H(7 Å) | 10535.04 | 2473.88 | 3209.07 | 30 |
| H(7B) | 9977.29 | 3367.02 | 3933.59 | 30 |
| H(8) | 10511.36 | 6339.68 | 3260.39 | 27 |
| H(10) | 8629.47 | 8102.52 | 3527.93 | 24 |
| H(11 Å) | 8590.24 | 9974.12 | 1841.7 | 58 |
| H(11B) | 9937.69 | 8804.14 | 1616.97 | 58 |
| H(11C) | 9721.04 | 9462.99 | 2414.76 | 58 |
| H(12 Å) | 7621.56 | 4422 | 1606.49 | 48 |
| H(12B) | 8582.96 | 5756.51 | 1107.91 | 48 |
| H(12C) | 7201.45 | 6771.55 | 1353.93 | 48 |
| H(13 Å) | 5064.01 | 7519.23 | 2201.71 | 28 |
| H(13B) | 4151.79 | 7409.2 | 2922.59 | 28 |
| H(14) | 2323.62 | 5898.79 | 2272.19 | 24 |
| H(16 Å) | 3599.17 | 1530.92 | 275.51 | 26 |
| H(16B) | 3821.33 | 1268.62 | 1105.78 | 26 |
| H(17 Å) | 1183.77 | 4024.98 | 36.31 | 27 |
| H(17B) | 2674.8 | 4633.16 | −193.61 | 27 |
| H(19 Å) | 1067.27 | 1569.57 | 949.92 | 35 |
| H(19B) | 788.01 | 3754.85 | 1358.6 | 35 |
| H(19C) | 1836.55 | 2062.83 | 1669.16 | 35 |

U_{eq} is defined as ⅓ of the trace of the orthogonalised Uᵢⱼ.

### Crystallography Data for Compound 30.

Compound 30 was crystallized from acetonitrile. The X-ray structure of compound 30 is shown in FIG. 3. The crystallographic data for compound 30 are summarized in the following tables.

TABLE 27
Crystal data and structure refinement for 30.

| Compound | 30 | |
|---|---|---|
| Formula | C16H18BF3N2O4 | |
| Dcalc./g cm⁻³ | 1.451 | |
| □/mm⁻¹ | 1.074 | |
| Formula Weight | 370.13 | |
| Color | yellow | |
| Shape | block-shaped | |
| Size/mm³ | 0.20 × 0.10 × 0.06 | |
| T/K | 104 | (6) |
| Crystal System | triclinic | |
| Flack Parameter | −0.03 | (4) |
| Hooft Parameter | −0.02 | (3) |
| Space Group | P1 | |
| a/Å | 7.56920 | (10) |
| b/Å | 7.59130 | (10) |
| c/Å | 14.9391 | (2) |
| α/° | 95.8240 | (10) |
| β/° | 96.5830 | (10) |
| γ/° | 92.281 | (2) |
| V/Å³ | 847.19 | (2) |

| | |
|---|---|
| Z | 2 |
| Z′ | 2 |
| Wavelength/Å | 1.54184 |
| Radiation type | Cu K□ |
| Θmin/° | 2.995 |
| Θmax/° | 74.455 |
| Measured Refl's. | 29818 |
| Indep't Refl's | 6144 |
| Refl's I ≥ 2 σ(I) | 6035 |
| Rint | 0.0305 |
| Parameters | 498 |
| Restraints | 199 |
| Largest Peak | 0.186 |
| Deepest Hole | −0.180 |
| GooF | 1.036 |
| wR₂ (all data) | 0.0660 |
| wR₂ | 0.0657 |
| R₁ (all data) | 0.0255 |
| R₁ | 0.0250 |

TABLE 28
Structure Quality Indicators

| Reflections: | D min (CuKα) 0.80 | I/σ(I) 55.4 | Rint 3.05% | Full 135.4° 99.8 | |
|---|---|---|---|---|---|
| | 2θ = 148.9° | | M = 4.85 | 99% to 148.9 | |
| Refinement: | Shift 0.000 | Max Peak 0.2 | Min Peak −0.2 | GooF | Hooft |
| | | | | 1.036 | .02(3) |

TABLE 29
Bond lengths [Å] and angles [°].

| Atom | x | y | z | Ueq |
|---|---|---|---|---|
| F1B | 131.2(17) | −534.6(16) | 6692.2(10) | 33.2(3) |
| F2B | −853.4(19) | 377(2) | 5427.5(10) | 40.5(3) |
| F3B | −1816.4(18) | 1438.5(17) | 6650.5(12) | 39.8(4) |
| O1B | 5336.4(17) | 8221.2(18) | 9992.4(9) | 20.5(3) |
| O2B | 3304.0(17) | 9821.4(17) | 9039.2(9) | 19.2(3) |
| O3B | 5045.4(19) | 7637(2) | 11411.9(10) | 26.3(3) |
| O4B | 530.6(18) | 10757.7(19) | 8836.2(10) | 25.9(3) |
| N1B | 2574(2) | 6766(2) | 9218.7(11) | 18.2(3) |
| N2B | 4638(2) | 7949(2) | 7359.9(11) | 19.8(3) |
| C1B | 4454(2) | 7605(2) | 10628.2(14) | 20.3(4) |
| C2B | 2620(2) | 6846(3) | 10228.8(13) | 19.4(4) |
| C3B | 994(2) | 7617(3) | 8791.1(14) | 20.6(4) |
| C4B | 1541(2) | 9584(3) | 8891.3(13) | 18.7(4) |
| C5B | 2702(3) | 4902(3) | 8820.6(14) | 23.2(4) |
| C6B | 5374(2) | 7649(3) | 8300.7(13) | 19.1(4) |
| C7B | 6173(3) | 9059(3) | 7812.6(13) | 21.6(4) |
| C8B | 5110(3) | 6590(3) | 6653.3(14) | 24.0(4) |
| C9B | 5196(3) | 7423(3) | 5771.0(15) | 34.5(5) |
| C10B | 3717(3) | 5067(3) | 6556.1(13) | 21.4(4) |
| C11B | 1928(3) | 5407(3) | 6328.2(14) | 23.4(4) |
| C12B | 622(3) | 4058(3) | 6261.8(14) | 22.7(4) |
| C13B | 1091(3) | 2358(3) | 6427.4(13) | 19.9(4) |
| C14B | 2860(3) | 2001(3) | 6659.9(14) | 22.8(4) |
| C15B | 4170(3) | 3371(3) | 6722.0(14) | 22.9(4) |
| C16B | −344(3) | 925(3) | 6315.0(15) | 24.1(4) |
| B1B | 4250(3) | 8148(3) | 9104.4(15) | 18.6(4) |
| O1 | 8716.9(18) | 4826.8(17) | 5.5(10) | 20.9(3) |
| O2 | 10770.8(16) | 3224.9(17) | 946.5(10) | 19.8(3) |
| O3 | 7489(2) | 3888(2) | −1410.8(10) | 27.1(3) |
| O4 | 11813.9(19) | 547.3(19) | 1136.0(11) | 26.6(3) |
| N1 | 7631(2) | 2412(2) | 789.8(11) | 17.8(3) |
| N2 | 9648(2) | 5270(2) | 2634.0(11) | 19.4(3) |
| C1 | 7808(2) | 3651(3) | −626.3(14) | 20.3(4) |
| C2 | 7248(2) | 2008(3) | −219.4(13) | 20.2(4) |
| C3 | 8693(3) | 1031(3) | 1211.7(14) | 22.0(4) |
| C4 | 10610(2) | 1539(3) | 1092.5(13) | 19.9(4) |
| C5 | 5954(2) | 2710(3) | 1202.5(14) | 23.5(4) |
| C6 | 8938(2) | 5614(2) | 1698.6(14) | 19.0(4) |
| C7 | 10590(3) | 6588(3) | 2189.7(13) | 21.7(4) |
| C8 | 8638(3) | 6069(3) | 3352.5(14) | 22.0(4) |
| C9 | 9914(3) | 6526(3) | 4217.8(15) | 29.9(5) |
| C10 | 7142(3) | 4765(3) | 3474.5(13) | 20.4(4) |
| C11 | 7540(3) | 3111(3) | 3760.7(15) | 25.2(4) |
| C12 | 6194(3) | 1873(3) | 3843.2(15) | 25.6(4) |
| C13 | 4417(3) | 2271(3) | 3631.9(14) | 22.1(4) |
| C14 | 4005(3) | 3909(3) | 3354.5(14) | 22.8(4) |
| C15 | 5367(3) | 5151(3) | 3279.2(14) | 22.3(4) |
| B1 | 9066(3) | 4137(3) | 892.6(15) | 18.2(4) |
| F1 | 1429(4) | 1132(5) | 3249(3) | 36.9(6) |
| F2 | 2665(5) | 891(7) | 4594.4(16) | 56.7(12) |
| F3 | 3421(3) | −755(3) | 3472(3) | 43.4(8) |
| C16 | 3002(5) | 898(5) | 3732(3) | 26.5(6) |
| F1 Å | 1690(30) | 930(40) | 3082(16) | 36.9(6) |
| F2 Å | 2070(20) | 1760(30) | 4464(11) | 44(4) |
| F3 Å | 3460(20) | −440(30) | 3910(20) | 47(4) |
| C16 Å | 2920(30) | 1120(30) | 3783(19) | 26.5(6) |

Fractional Åtomic Coordinates (×10⁴) and Equivalent Isotropic Displacement Parameters (Å² × 10³) for 30. U_{eq} is defined as ⅓ of the trace of the orthogonalized Uᵢⱼ.

TABLE 30
Anisotropic Displacement Parameters (×104) for 30.

| Atom | U₁₁ | U₂₂ | U₃₃ | U₂₃ | U₁₃ | U₁₂ |
|---|---|---|---|---|---|---|
| F1B | 32.5(7) | 22.1(6) | 45.6(8) | 9.1(6) | 3.6(6) | −0.8(5) |
| F2B | 44.0(8) | 42.4(8) | 30.5(7) | 0.1(6) | −4.0(6) | −20.0(6) |
| F3B | 27.5(6) | 28.2(7) | 67.9(10) | 7.2(7) | 21.6(6) | 1.1(5) |
| O1B | 18.0(6) | 24.1(7) | 19.3(7) | 3.5(5) | 1.6(5) | −2.4(5) |
| O2B | 18.4(6) | 17.2(6) | 22.0(7) | 2.3(5) | 3.2(5) | −1.6(5) |
| O3B | 24.8(7) | 34.0(8) | 20.1(8) | 6.4(6) | −0.5(6) | 3.0(6) |
| O4B | 24.2(7) | 24.9(7) | 29.2(8) | 5.1(6) | 2.8(6) | 5.8(6) |
| NIB | 17.9(7) | 17.7(7) | 19.1(8) | 1.7(6) | 3.2(6) | 0.0(6) |
| N2B | 20.1(8) | 20.6(8) | 18.0(8) | 1.6(6) | 1.3(6) | −3.7(6) |
| C1B | 21.0(9) | 18.2(9) | 22.4(10) | 3.4(7) | 4.0(7) | 3.4(7) |
| C2B | 20.3(9) | 21.9(9) | 16.7(9) | 3.5(7) | 4.0(7) | 1.7(7) |
| C3B | 17.3(8) | 21.4(9) | 22.9(10) | 4.6(8) | 0.1(7) | −1.6(7) |
| C4B | 19.5(9) | 21.4(9) | 15.4(9) | 2.9(7) | 2.6(7) | 0.0(7) |
| C5B | 26.0(10) | 18.4(9) | 25.2(10) | −0.3(8) | 7.2(8) | −1.8(7) |
| C6B | 17.5(8) | 20.1(9) | 19.3(9) | 2.6(7) | 1.0(7) | −1.4(7) |
| C7B | 20.8(9) | 24.3(10) | 19.0(9) | 1.6(8) | 3.1(7) | −5.5(7) |
| C8B | 22.8(9) | 26.6(10) | 21.6(10) | −1.9(8) | 4.0(8) | −4.4(8) |
| C9B | 42.9(13) | 37.6(13) | 21.5(11) | −1.9(9) | 7.4(9) | −14.8(10) |
| C10B | 23.4(9) | 23.5(9) | 16.5(9) | −1.9(8) | 3.6(7) | −1.1(8) |
| C11B | 26.2(10) | 21.1(9) | 22.6(10) | 3.8(8) | 0.3(8) | 1.1(8) |
| C12B | 20.7(9) | 23.9(10) | 22.7(10) | 1.8(8) | −0.3(8) | 2.1(7) |
| C13B | 22.8(9) | 20.3(9) | 16.5(9) | 0.1(7) | 3.7(7) | 0.0(7) |
| C14B | 25.5(10) | 20.8(9) | 22.2(10) | 0.3(8) | 3.9(8) | 4.1(8) |
| C15B | 19.3(9) | 27.5(10) | 21.1(10) | −1.4(8) | 2.7(7) | 2.3(7) |
| C16B | 23.6(9) | 22.8(10) | 26.5(11) | 3.5(8) | 4.5(8) | 2.7(8) |
| B1B | 16.9(9) | 17.2(10) | 21.2(11) | 2.7(8) | 1.4(8) | −3.4(8) |
| O1 | 21.9(6) | 20.2(6) | 20.0(7) | 2.3(5) | 1.1(5) | −2.9(5) |
| O2 | 16.4(6) | 19.9(6) | 22.5(7) | 0.7(5) | 2.3(5) | −1.0(5) |
| O3 | 31.3(8) | 28.0(7) | 21.1(8) | 4.3(6) | −2.5(6) | 3.5(6) |
| O4 | 22.5(7) | 25.1(7) | 31.5(8) | 1.5(6) | 0.0(6) | 4.8(6) |
| N1 | 15.5(7) | 19.2(7) | 18.3(8) | 0.6(6) | 2.1(6) | −0.1(6) |
| N2 | 18.6(7) | 21.7(8) | 17.5(8) | 1.7(7) | 2.2(6) | −2.4(6) |
| C1 | 16.4(8) | 21.9(9) | 21.8(10) | 0.0(8) | 0.6(7) | 2.6(7) |
| C2 | 18.5(9) | 22.3(9) | 18.1(10) | −1.8(7) | −0.7(7) | −1.5(7) |
| C3 | 20.2(9) | 20.6(9) | 25.6(10) | 6.4(8) | 1.0(8) | −1.0(7) |
| C4 | 20.3(9) | 21.3(9) | 16.8(9) | 1.3(7) | −1.2(7) | −1.3(7) |
| C5 | 18.2(9) | 25.1(10) | 26.9(10) | −1.3(8) | 6.6(8) | −2.1(7) |
| C6 | 18.7(9) | 19.0(9) | 19.3(9) | 3.0(7) | 1.1(7) | 0.1(7) |
| C7 | 22.1(9) | 23.0(9) | 19.3(9) | 0.8(8) | 3.1(7) | −4.8(7) |
| C8 | 24.5(10) | 22.2(10) | 19.3(10) | 0.5(8) | 4.6(8) | −1.0(7) |
| C9 | 30.5(11) | 35.5(12) | 22.1(11) | −1.5(9) | 4.3(9) | −10.6(9) |
| C10 | 22.0(9) | 22.9(9) | 16.3(9) | 0.7(7) | 4.1(7) | −1.1(7) |
| C11 | 19.5(9) | 29.0(10) | 27.5(11) | 5.4(8) | 3.0(8) | 1.3(8) |
| C12 | 23.1(10) | 24.5(10) | 29.6(11) | 7.9(8) | 0.9(8) | −0.8(8) |
| C13 | 20.8(9) | 26.9(10) | 18.7(9) | 1.9(8) | 4.3(7) | −2.0(8) |
| C14 | 18.0(8) | 29.1(10) | 21.5(10) | 0.5(8) | 3.9(7) | 3.4(8) |
| C15 | 26.2(10) | 22.2(9) | 19.0(9) | 1.0(8) | 4.9(8) | 4.3(8) |
| B1 | 15.6(9) | 19.2(10) | 19.6(10) | 2.9(8) | 1.9(8) | −2.7(8) |
| F1 | 19.9(11) | 37.9(12) | 51.7(16) | 6.7(10) | −0.9(9) | −4.2(8) |
| F2 | 64.6(18) | 78(2) | 24.3(10) | 1.2(11) | 13.7(10) | −44.4(18) |
| F3 | 28.3(9) | 24.4(9) | 76(2) | −1.8(11) | 7.4(12) | −3.7(7) |
| C16 | 24.8(11) | 31.3(16) | 22.9(12) | 2.4(11) | 2.6(8) | −1.0(10) |
| F1A | 19.9(11) | 37.9(12) | 51.7(16) | 6.7(10) | −0.9(9) | −4.2(8) |
| F2A | 45(7) | 59(9) | 29(6) | 8(6) | 15(5) | −23(6) |
| F3A | 38(6) | 29(7) | 75(11) | 26(7) | −5(7) | −14(5) |
| C16A | 24.8(11) | 31.3(16) | 22.9(12) | 2.4(11) | 2.6(8) | −1.0(10) |

The anisotropic displacement factor exponent takes the form: −2π²[h²a*² × U₁₁ + . . . + 2hka* × b* × U₁₂]

TABLE 31
Bond Lengths in Å for 30.

| Atom | Atom | Length/Å |
|---|---|---|
| F1B | C16B | 1.337(3) |
| F2B | C16B | 1.356(3) |
| F3B | C16B | 1.330(2) |
| O1B | C1B | 1.333(2) |
| O1B | B1B | 1.473(3) |
| O2B | C4B | 1.330(2) |
| O2B | B1B | 1.489(3) |
| O3B | C1B | 1.202(2) |
| O4B | C4B | 1.200(2) |
| N1B | C2B | 1.500(2) |
| N1B | C3B | 1.492(2) |
| N1B | C5B | 1.489(2) |
| N1B | B1B | 1.649(3) |
| N2B | C6B | 1.494(3) |
| N2B | C7B | 1.464(2) |
| N2B | C8B | 1.484(2) |
| C1B | C2B | 1.514(3) |
| C3B | C4B | 1.521(3) |
| C6B | C7B | 1.501(3) |
| C6B | B1B | 1.574(3) |
| C8B | C9B | 1.525(3) |
| C8B | C10B | 1.518(3) |
| C10B | C11B | 1.399(3) |
| C10B | C15B | 1.384(3) |
| C11B | C12B | 1.383(3) |
| C12B | C13B | 1.391(3) |
| C13B | C14B | 1.388(3) |
| C13B | C16B | 1.489(3) |
| C14B | C15B | 1.397(3) |
| O1 | C1 | 1.339(2) |
| O1 | B1 | 1.474(3) |
| O2 | C4 | 1.323(2) |
| O2 | B1 | 1.486(2) |
| O3 | C1 | 1.202(3) |
| O4 | C4 | 1.205(2) |
| N1 | C2 | 1.500(2) |
| N1 | C3 | 1.493(3) |
| N1 | C5 | 1.489(2) |
| N1 | B1 | 1.651(2) |
| N2 | C6 | 1.491(3) |
| N2 | C7 | 1.461(3) |
| N2 | C8 | 1.483(2) |
| C1 | C2 | 1.508(3) |
| C3 | C4 | 1.521(3) |
| C6 | C7 | 1.501(2) |
| C6 | B1 | 1.574(3) |
| C8 | C9 | 1.523(3) |
| C8 | C10 | 1.513(3) |
| C10 | C11 | 1.400(3) |
| C10 | C15 | 1.391(3) |
| C11 | C12 | 1.383(3) |
| C12 | C13 | 1.398(3) |
| C13 | C14 | 1.386(3) |
| C13 | C16 | 1.495(4) |
| C13 | C16Å | 1.46(2) |
| C14 | C15 | 1.391(3) |
| F1 | C16 | 1.347(4) |
| F2 | C16 | 1.343(4) |
| F3 | C16 | 1.337(4) |
| F1Å | C16Å | 1.31(2) |
| F2Å | C16Å | 1.32(2) |
| F3Å | C16Å | 1.30(2) |

TABLE 32
Bond Ångles in ° for 30.

| Atom | Atom | Atom | Angle/° |
|---|---|---|---|
| C1B | O1B | B1B | 113.12(15) |
| C4B | O2B | B1B | 113.95(14) |
| C2B | N1B | B1B | 102.42(14) |
| C3B | N1B | C2B | 112.31(14) |
| C3B | N1B | B1B | 103.24(15) |
| C5B | N1B | C2B | 110.22(16) |
| C5B | N1B | C3B | 112.42(15) |
| C5B | N1B | B1B | 115.72(15) |
| C7B | N2B | C6B | 60.94(12) |
| C7B | N2B | C8B | 113.25(15) |
| C8B | N2B | C6B | 113.68(16) |
| O1B | C1B | C2B | 110.94(16) |
| O3B | C1B | O1B | 124.38(18) |
| O3B | C1B | C2B | 124.68(19) |
| N1B | C2B | C1B | 106.51(15) |
| N1B | C3B | C4B | 104.62(15) |
| O2B | C4B | C3B | 110.34(16) |
| O4B | C4B | O2B | 124.60(18) |
| O4B | C4B | C3B | 125.06(17) |
| N2B | C6B | C7B | 58.54(12) |
| N2B | C6B | B1B | 119.13(16) |
| C7B | C6B | B1B | 120.94(17) |
| N2B | C7B | C6B | 60.52(12) |
| N2B | C8B | C9B | 109.31(18) |
| N2B | C8B | C10B | 107.61(16) |
| C10B | C8B | C9B | 112.39(17) |
| C11B | C10B | C8B | 118.97(18) |
| C15B | C10B | C8B | 121.51(18) |
| C15B | C10B | C11B | 119.47(18) |
| C12B | C11B | C10B | 120.34(19) |
| C11B | C12B | C13B | 119.73(19) |
| C12B | C13B | C16B | 118.18(18) |
| C14B | C13B | C12B | 120.64(18) |
| C14B | C13B | C16B | 121.15(18) |
| C13B | C14B | C15B | 119.17(19) |
| C10B | C15B | C14B | 120.64(18) |
| F1B | C16B | F2B | 105.40(16) |
| F1B | C16B | C13B | 113.95(17) |
| F2B | C16B | C13B | 111.32(18) |
| F3B | C16B | F1B | 106.97(18) |
| F3B | C16B | F2B | 105.53(18) |
| F3B | C16B | C13B | 113.03(16) |
| O1B | B1B | O2B | 109.72(15) |
| O1B | B1B | N1B | 102.37(16) |
| O1B | B1B | C6B | 111.82(16) |
| O2B | B1B | N1B | 100.32(14) |
| O2B | B1B | C6B | 114.33(17) |
| C6B | B1B | N1B | 117.12(15) |
| C1 | O1 | B1 | 112.89(15) |
| C4 | O2 | B1 | 114.12(15) |
| C2 | N1 | B1 | 102.14(14) |
| C3 | N1 | C2 | 112.15(15) |
| C3 | N1 | B1 | 103.12(14) |
| C5 | N1 | C2 | 110.71(15) |
| C5 | N1 | C3 | 112.30(16) |
| C5 | N1 | B1 | 115.85(14) |
| C7 | N2 | C6 | 61.13(12) |
| C7 | N2 | C8 | 113.15(15) |
| C8 | N2 | C6 | 114.28(15) |
| O1 | C1 | C2 | 110.87(17) |
| O3 | C1 | O1 | 124.02(19) |
| O3 | C1 | C2 | 125.11(17) |
| N1 | C2 | C1 | 106.86(14) |
| N1 | C3 | C4 | 104.42(16) |
| O2 | C4 | C3 | 110.48(16) |
| O4 | C4 | O2 | 124.89(18) |
| O4 | C4 | C3 | 124.62(18) |
| N2 | C6 | C7 | 58.47(12) |
| N2 | C6 | B1 | 118.73(16) |
| C7 | C6 | B1 | 120.52(16) |
| N2 | C7 | C6 | 60.40(12) |
| N2 | C8 | C9 | 108.69(16) |
| N2 | C8 | C10 | 108.44(15) |
| C10 | C8 | C9 | 112.35(18) |
| C11 | C10 | C8 | 119.74(18) |
| C15 | C10 | C8 | 121.31(19) |
| C15 | C10 | C11 | 118.91(18) |
| C12 | C11 | C10 | 120.72(19) |
| C11 | C12 | C13 | 119.7(2) |
| C12 | C13 | C16 | 118.0(2) |
| C12 | C13 | C16 Å | 123.3(12) |
| C14 | C13 | C12 | 120.19(19) |
| C14 | C13 | C16 | 121.8(2) |
| C14 | C13 | C16 Å | 116.1(11) |
| C13 | C14 | C15 | 119.73(18) |
| C10 | C15 | C14 | 120.78(19) |
| O1 | B1 | O2 | 109.85(16) |
| O1 | B1 | N1 | 102.42(14) |
| O1 | B1 | C6 | 111.80(16) |
| O2 | B1 | N1 | 100.27(14) |
| O2 | B1 | C6 | 114.40(16) |
| C6 | B1 | N1 | 116.95(16) |
| F1 | C16 | C13 | 113.2(3) |
| F2 | C16 | C13 | 112.2(3) |
| F2 | C16 | F1 | 105.8(3) |
| F3 | C16 | C13 | 113.5(3) |
| F3 | C16 | F1 | 105.9(3) |
| F3 | C16 | F2 | 105.5(3) |
| F1 Å | C16 Å | C13 | 112(2) |
| F1 Å | C16 Å | F2 Å | 104(2) |
| F2 Å | C16 Å | C13 | 113.4(18) |
| F3 Å | C16 Å | C13 | 109.6(19) |
| F3 Å | C16 Å | F1 Å | 107(2) |
| F3 Å | C16 Å | F2 Å | 110(2) |

TABLE 33
Torsion Ångles in for 30.

| Atom | Atom | Atom | Atom | Angle/° |
|---|---|---|---|---|
| O1B | C1B | C2B | N1B | 9.9(2) |
| O3B | C1B | C2B | N1B | −169.48(17) |
| N1B | C3B | C4B | O2B | 19.6(2) |
| N1B | C3B | C4B | O4B | −161.04(19) |
| N2B | C6B | B1B | O1B | −164.87(15) |
| N2B | C6B | B1B | O2B | −39.4(2) |
| N2B | C6B | B1B | N1B | 77.5(2) |
| N2B | C8B | C10B | C11B | 58.2(2) |
| N2B | C8B | C10B | C15B | −119.3(2) |
| C1B | O1B | B1B | O2B | 89.38(19) |
| C1B | O1B | B1B | N1B | −16.49(19) |
| C1B | O1B | B1B | C6B | −142.67(16) |
| C2B | N1B | C3B | C4B | 83.12(18) |
| C2B | N1B | B1B | O1B | 20.93(17) |
| C2B | N1B | B1B | O2B | −92.09(16) |
| C2B | N1B | B1B | C6B | 143.60(17) |
| C3B | N1B | C2B | C1B | −128.67(16) |
| C3B | N1B | B1B | O1B | 137.75(15) |
| C3B | N1B | B1B | O2B | 24.73(17) |
| C3B | N1B | B1B | C6B | −99.58(19) |
| C4B | O2B | B1B | O1B | −121.25(17) |
| C4B | O2B | B1B | N1B | −14.0(2) |
| C4B | O2B | B1B | C6B | 112.21(18) |
| C5B | N1B | C2B | C1B | 105.14(17) |
| C5B | N1B | C3B | C4B | −151.89(16) |
| C5B | N1B | B1B | O1B | −99.00(18) |
| C5B | N1B | B1B | O2B | 147.98(16) |
| C5B | N1B | B1B | C6B | 23.7(2) |
| C6B | N2B | C8B | C9B | −150.69(17) |
| C6B | N2B | C8B | C10B | 86.99(19) |
| C7B | N2B | C6B | B1B | 110.43(19) |
| C7B | N2B | C8B | C9B | −83.6(2) |
| C7B | N2B | C8B | C10B | 154.11(17) |
| C7B | C6B | B1B | O1B | −96.1(2) |
| C7B | C6B | B1B | O2B | 29.3(2) |
| C7B | C6B | B1B | N1B | 146.21(17) |
| C8B | N2B | C6B | C7B | 104.45(17) |
| C8B | N2B | C6B | B1B | −145.12(17) |
| C8B | N2B | C7B | C6B | −105.15(18) |
| C8B | C10B | C11B | C12B | −178.02(19) |
| C8B | C10B | C15B | C14B | 177.73(18) |
| C9B | C8B | C10B | C11B | −62.2(2) |
| C9B | C8B | C10B | C15B | 120.3(2) |
| C10B | C11B | C12B | C13B | 0.3(3) |
| C11B | C10B | C15B | C14B | 0.3(3) |
| C11B | C12B | C13B | C14B | 0.1(3) |
| C11B | C12B | C13B | C16B | −177.71(19) |
| C12B | C13B | C14B | C15B | −0.3(3) |
| C12B | C13B | C16B | F1B | −164.56(17) |
| C12B | C13B | C16B | F2B | 76.4(2) |
| C12B | C13B | C16B | F3B | −42.1(3) |
| C13B | C14B | C15B | C10B | 0.1(3) |
| C14B | C13B | C16B | F1B | 17.7(3) |
| C14B | C13B | C16B | F2B | −101.3(2) |
| C14B | C13B | C16B | F3B | 140.1(2) |
| C15B | C10B | C11B | C12B | −0.5(3) |
| C16B | C13B | C14B | C15B | 177.42(19) |
| B1B | O1B | C1B | O3B | −175.39(18) |
| B1B | O1B | C1B | C2B | 5.2(2) |
| B1B | O2B | C4B | O4B | 178.33(19) |
| B1B | O2B | C4B | C3B | −2.4(2) |
| B1B | N1B | C2B | C1B | −18.55(18) |
| B1B | N1B | C3B | C4B | −26.49(18) |
| B1B | C6B | C7B | N2B | −107.37(19) |
| O1 | C1 | C2 | N1 | 10.0(2) |
| O3 | C1 | C2 | N1 | −170.02(17) |
| N1 | C3 | C4 | O2 | 20.1(2) |
| N1 | C3 | C4 | O4 | −160.76(18) |
| N2 | C6 | B1 | O1 | −166.27(15) |
| N2 | C6 | B1 | O2 | −40.6(2) |
| N2 | C6 | B1 | N1 | 76.1(2) |
| N2 | C8 | C10 | C11 | 62.3(2) |
| N2 | C8 | C10 | C15 | −115.5(2) |
| C1 | O1 | B1 | O2 | 88.97(18) |
| C1 | O1 | B1 | N1 | −16.90(19) |
| C1 | O1 | B1 | C6 | −142.91(16) |
| C2 | N1 | C3 | C4 | 82.56(17) |
| C2 | N1 | B1 | O1 | 21.32(17) |
| C2 | N1 | B1 | O2 | −91.84(16) |
| C2 | N1 | B1 | C6 | 143.90(17) |
| C3 | N1 | C2 | C1 | −128.62(16) |
| C3 | N1 | B1 | O1 | 137.82(15) |
| C3 | N1 | B1 | O2 | 24.66(17) |
| C3 | N1 | B1 | C6 | −99.60(19) |
| C4 | O2 | B1 | O1 | −121.02(17) |
| C4 | O2 | B1 | N1 | −13.70(19) |
| C4 | O2 | B1 | C6 | 112.31(19) |
| C5 | N1 | C2 | C1 | 105.08(17) |
| C5 | N1 | C3 | C4 | −152.01(15) |
| C5 | N1 | B1 | O1 | −99.10(18) |
| C5 | N1 | B1 | O2 | 147.74(16) |
| C5 | N1 | B1 | C6 | 23.5(2) |
| C6 | N2 | C8 | C9 | −149.48(17) |
| C6 | N2 | C8 | C10 | 88.1(2) |
| C7 | N2 | C6 | B1 | 110.06(19) |
| C7 | N2 | C8 | C9 | −82.0(2) |
| C7 | N2 | C8 | C10 | 155.58(16) |
| C7 | C6 | B1 | O1 | −97.9(2) |
| C7 | C6 | B1 | O2 | 27.7(3) |
| C7 | C6 | B1 | N1 | 144.48(18) |
| C8 | N2 | C6 | C7 | 104.11(17) |
| C8 | N2 | C6 | B1 | −145.83(17) |
| C8 | N2 | C7 | C6 | −105.96(17) |
| C8 | C10 | C11 | C12 | −177.50(19) |
| C8 | C10 | C15 | C14 | 177.04(18) |
| C9 | C8 | C10 | C11 | −57.8(2) |
| C9 | C8 | C10 | C15 | 124.3(2) |
| C10 | C11 | C12 | C13 | 0.5(3) |
| C11 | C10 | C15 | C14 | −0.8(3) |
| C11 | C12 | C13 | C14 | −1.0(3) |
| C11 | C12 | C13 | C16 | −179.9(2) |
| C11 | C12 | C13 | C16 Å | −173.7(13) |
| C12 | C13 | C14 | C15 | 0.6(3) |
| C12 | C13 | C16 | F1 | −159.5(3) |
| C12 | C13 | C16 | F2 | 80.7(4) |
| C12 | C13 | C16 | F3 | −38.7(4) |
| C12 | C13 | C16 Å | F1 Å | −134.6(19) |
| C12 | C13 | C16 Å | F2 Å | 107.8(19) |
| C12 | C13 | C16 Å | F3 Å | −16(3) |
| C13 | C14 | C15 | C10 | 0.4(3) |
| C14 | C13 | C16 | F1 | 21.6(4) |
| C14 | C13 | C16 | F2 | −98.1(4) |
| C14 | C13 | C16 | F3 | 142.4(3) |
| C14 | C13 | C16 Å | F1 Å | 52(2) |
| C14 | C13 | C16 Å | F2 Å | −65(2) |
| C14 | C13 | C16 Å | F3 Å | 171.1(18) |
| C15 | C10 | C11 | C12 | 0.4(3) |
| B1 | O1 | C1 | O3 | −174.51(18) |
| B1 | O1 | C1 | C2 | 5.5(2) |
| B1 | O2 | C4 | O4 | 178.00(18) |
| B1 | O2 | C4 | C3 | −2.8(2) |
| B1 | N1 | C2 | C1 | −18.85(18) |
| B1 | N1 | C3 | C4 | −26.60(18) |
| B1 | C6 | C7 | N2 | −107.0(2) |
| C16 | C13 | C14 | C15 | 179.4(2) |
| C16 Å | C13 | C14 | C15 | 173.8(12) |

TABLE 34
Hydrogen Fractional Åtomic Coordinates (×10⁴) and Equivalent Isotropic
Displacement Parameters (Å² × 10³) for 30.

| Atom | x | y | z | Ueq |
|---|---|---|---|---|
| H2B Å | 2408.8 | 5645.79 | 10412.18 | 23 |
| H2BB | 1691.51 | 7614.17 | 10440.63 | 23 |
| H3B Å | −62.28 | 7398.64 | 9106.31 | 25 |
| H3BB | 714.8 | 7155.86 | 8144.17 | 25 |
| H5B Å | 1685.69 | 4175.33 | 8955.02 | 35 |
| H5BB | 3811.45 | 4435.48 | 9082.32 | 35 |
| H5BC | 2692.35 | 4869.47 | 8162.61 | 35 |
| H6B | 6077.05 | 6568.63 | 8351.9 | 23 |
| H7B Å | 5976.56 | 10310.4 | 8016.92 | 26 |
| H7BB | 7345.9 | 8856.27 | 7598.27 | 26 |
| H8B | 6302.89 | 6147.96 | 6854.02 | 29 |
| H9B Å | 4039.27 | 7886.87 | 5579.88 | 52 |
| H9BB | 5490.92 | 6523.22 | 5300.56 | 52 |
| H9BC | 6114.13 | 8392.63 | 5865.49 | 52 |
| H11B | 1608.2 | 6570.2 | 6218.53 | 28 |
| H12B | −591.83 | 4291.86 | 6103.77 | 27 |
| H14B | 3175.71 | 839.24 | 6775.24 | 27 |
| H15B | 5383.63 | 3137.68 | 6879.68 | 27 |
| H2 Å | 5962.99 | 1707.32 | −396.79 | 24 |
| H2B | 7927.19 | 992.05 | −432.86 | 24 |
| H3 Å | 8329.25 | −164.72 | 900.63 | 26 |
| H3B | 8540.99 | 1042.6 | 1861.68 | 26 |
| H5 Å | 5159.98 | 1641.56 | 1066.19 | 35 |
| H5B | 5366.33 | 3710.59 | 952.36 | 35 |
| H5C | 6231.49 | 2974.92 | 1860.65 | 35 |
| H6 | 7845.97 | 6313.39 | 1649.13 | 23 |
| H7 Å | 11746.1 | 6278.56 | 1983.19 | 26 |
| H7B | 10508.97 | 7853.04 | 2410.37 | 26 |
| H8 | 8118.79 | 7180.84 | 3158.57 | 26 |
| H9 Å | 10504.99 | 5459.09 | 4381.98 | 45 |
| H9B | 9247.54 | 6982.06 | 4709.18 | 45 |
| H9C | 10810.26 | 7430.82 | 4118.84 | 45 |
| H11 | 8747.72 | 2836.76 | 3899.88 | 30 |
| H12 | 6476.02 | 756.92 | 4042.46 | 31 |
| H14 | 2796.7 | 4182.45 | 3216.26 | 27 |
| H15 | 5081.8 | 6274.93 | 3092.24 | 27 |

TABLE 35
Åtomic Occupancies for all atoms that are not fully occupied in 30.

| Atom | Occupancy |
|---|---|
| F1 | 0.867(11) |
| F2 | 0.867(11) |
| F3 | 0.867(11) |
| C16 | 0.867(11) |
| F1 Å | 0.133(11) |
| F2 Å | 0.133(11) |
| F3 Å | 0.133(11) |
| C16 Å | 0.133(11) |

### Crystallography Data for Compound 60.

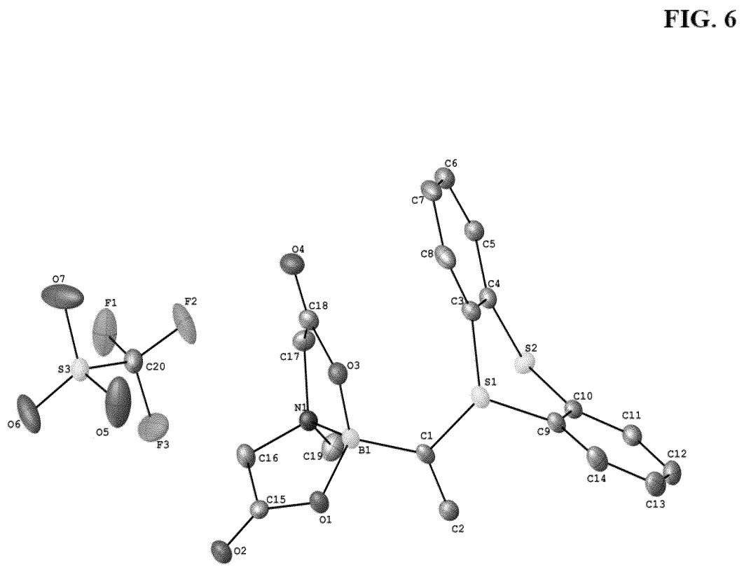

Compound 60 was crystallized from acetonitrile. The X-ray structure of 60 is shown in FIG. 6 and the atoms are depicted with 50 probability ellipsoids. The crystallographic data are summarized in the following tables.

TABLE 36
Crystal Data and structure refinement for 60.

| Compound | 60 | |
|---|---|---|
| Formula | C₂₀H₁₇BF₃NO₇S₃ | |
| D_{calc.}/g cm⁻³ | 1.640 | |
| m/mm⁻¹ | 3.710 | |
| Formula Weight | 547.34 | |
| Colour | colourless | |
| Shape | block-shaped | |
| Size/mm³ | 0.44 × 0.29 × 0.15 | |
| T/K | 100.0 | (3) |
| Crystal System | monoclinic | |
| Space Group | P2₁/n | |
| a/Å | 12.75819 | (5) |
| b/Å | 16.13758 | (7) |
| c/Å | 43.24849 | (18) |
| a/° | 90 | |
| b/° | 95.3159 | (4) |
| g/° | 90 | |
| V/Å³ | 8865.97 | (6) |

| | |
|---|---|
| Z | 16 |
| Z′ | 4 |
| Wavelength/Å | 1.54184 |
| Radiation type | Cu K_{α} |
| Qₘᵢₙ/° | 2.924 |
| Qₘₐₓ/° | 74.499 |
| Measured Refl's. | 231518 |
| Indep't Refl's | 18116 |
| Refl's I ≥ 2 s(I) | 16879 |
| Rᵢₙₜ | 0.0392 |
| Parameters | 1376 |
| Restraints | 706 |
| Largest Peak | 0.506 |
| Deepest Hole | −0.402 |
| GooF | 1.077 |
| wR₂ (all data) | 0.1113 |
| wR₂ | 0.1100 |
| R₁ (all data) | 0.0399 |
| R₁ | 0.0382 |

TABLE 37
Structure Quality Indicators for 60

| | | | | |
|---|---|---|---|---|
| Reflections: | D min (CuKα) 0.80 | I/σ(I) 67.8 | Rint 3.92% | Full 135.4° |
| | 2θ = 149.0° | | M = 13.00 | 99.9 |
| Refinement: | Shift −0.003 | Max Peak 0.5 | Min Peak −0.4 | GooF 1.077 |

TABLE 38
Reflection Statistics for 60.

| | | | |
|---|---|---|---|
| Total reflections (after | 235447 | Unique reflections | 18116 |
| filtering) | | | |
| Completeness | 0.999 | Mean I/s | 37.53 |
| hklₘₐₓ collected | (15, 20, 54) | hklₘᵢₙ collected | (−15, −18, −54) |
| hklₘₐₓ used | (15, 20, 54) | hklₘᵢₙ used | (−15, 0, 0) |
| Lim dₘₐₓ collected | 100.0 | Lim dₘᵢₙ collected | 0.77 |
| dₘₐₓ used | 16.14 | dₘᵢₙ used | 0.8 |
| Friedel pairs | 23609 | Friedel pairs merged | 1 |
| Inconsistent equivalents | 8 | Rᵢₙₜ | 0.0392 |
| R_{sigma} | 0.0147 | Intensity transformed | 0 |
| Omitted reflections | 0 | Omitted by user (OMIT | 111 |
| | | hkl) | |
| Multiplicity | (11120, 11709, 8789, | Maximum multiplicity | 34 |
| | 6892, 5524, 4689, | | |
| | 3696, 2685, 1731, | | |
| | 1097, 709, 380, 200, | | |
| | 98, 41, 18, 5) | | |
| Removed systematic | 3818 | Filtered off | 0 |
| absences | | (Shel/OMIT) | |

TABLE 39
Fractional Atomic Coordinates (×10⁴) and Equivalent Isotropic
Displacement Parameters (Å² × 10³) for 60.

| Atom | x | y | z | U_{eq} |
|---|---|---|---|---|
| S(1) | 2263.4(3) | 8957.8(2) | 4657.1(2) | 15.05(9) |
| S(2) | 657.2(3) | 10326.8(2) | 4306.1(2) | 15.99(9) |
| O(1) | 2746.5(8) | 7224.1(7) | 4060.5(2) | 17.6(2) |
| O(2) | 2917.3(9) | 6140.6(7) | 3744.8(3) | 22.6(2) |
| O(3) | 1476.7(8) | 7268.9(7) | 4445.9(2) | 16.3(2) |
| O(4) | −45.5(9) | 6727.0(7) | 4578.0(3) | 23.5(2) |
| N(1) | 918.7(10) | 7584.3(8) | 3911.0(3) | 14.0(2) |
| C(1) | 2273.8(11) | 8631.7(10) | 4257.7(3) | 15.0(3) |
| C(2) | 2712.0(12) | 9128.3(10) | 4061.0(4) | 19.4(3) |
| C(3) | 909.7(12) | 9002.4(9) | 4717.1(3) | 15.8(3) |
| C(4) | 229.6(12) | 9565.5(9) | 4556.3(3) | 15.2(3) |
| C(5) | −844.2(12) | 9519.4(10) | 4593.9(4) | 18.7(3) |
| C(6) | −1210.8(14) | 8922.3(10) | 4789.3(4) | 23.0(3) |
| C(7) | −514.4(14) | 8391.7(10) | 4960.1(4) | 24.3(4) |
| C(8) | 553.8(14) | 8437.3(10) | 4926.4(4) | 21.2(3) |
| C(9) | 2585.9(12) | 10019.7(10) | 4648.7(3) | 16.4(3) |
| C(10) | 1902.2(12) | 10584.7(10) | 4490.5(3) | 15.0(3) |
| C(11) | 2229.3(13) | 11406.3(10) | 4471.6(4) | 18.4(3) |
| C(12) | 3206.9(14) | 11644.8(11) | 4608.3(4) | 23.1(3) |
| C(13) | 3870.2(13) | 11082.2(11) | 4772.5(4) | 24.0(4) |
| C(14) | 3560.3(13) | 10261.7(11) | 4793.6(4) | 22.2(3) |
| C(15) | 2388.3(12) | 6668.7(9) | 3847.4(3) | 15.5(3) |
| C(16) | 1218.1(13) | 6799.6(10) | 3758.0(4) | 19.9(3) |
| C(17) | −5.6(12) | 7471.6(10) | 4093.6(4) | 19.5(3) |
| C(18) | 440.3(12) | 7095.5(10) | 4398.5(4) | 17.8(3) |
| C(19) | 719.6(13) | 8260.9(10) | 3675.3(4) | 22.5(3) |
| B(1) | 1898.3(13) | 7695.5(10) | 4183.0(4) | 14.1(3) |
| S(1B) | 2779.7(3) | 3922.8(2) | 2851.4(2) | 15.13(8) |
| S(2B) | 4353.6(3) | 5318.4(2) | 3203.6(2) | 17.82(9) |
| O(1B) | 2291.1(8) | 2183.5(7) | 3448.5(3) | 18.6(2) |
| O(2B) | 2119.6(9) | 1113.3(7) | 3770.2(3) | 23.5(3) |
| O(3B) | 3552.9(8) | 2224.3(7) | 3060.8(2) | 17.0(2) |
| O(4B) | 5067.1(9) | 1676.0(8) | 2926.5(3) | 23.6(2) |
| N(1B) | 4119.0(10) | 2543.1(8) | 3594.7(3) | 14.2(2) |
| C(1B) | 2761.9(11) | 3589.7(10) | 3249.6(3) | 15.1(3) |
| C(2B) | 2318.2(12) | 4080.0(10) | 3447.3(4) | 20.4(3) |
| C(3B) | 4136.4(12) | 3981.4(10) | 2796.9(3) | 15.8(3) |
| C(4B) | 4801.0(12) | 4558.9(9) | 2955.8(3) | 15.7(3) |
| C(5B) | 5875.7(12) | 4524.9(10) | 2920.5(4) | 19.4(3) |
| C(6B) | 6260.6(13) | 3927.1(10) | 2729.9(4) | 21.9(3) |
| C(7B) | 5584.2(14) | 3379.0(10) | 2562.1(4) | 22.6(3) |
| C(8B) | 4513.8(13) | 3411.2(10) | 2592.8(4) | 19.5(3) |
| C(9B) | 2434.0(12) | 4978.9(10) | 2861.0(4) | 17.1(3) |
| C(10B) | 3102.4(12) | 5555.3(10) | 3019.9(3) | 16.9(3) |
| C(11B) | 2750.1(13) | 6369.6(10) | 3041.1(4) | 20.3(3) |
| C(12B) | 1766.4(14) | 6593.0(11) | 2904.6(4) | 25.0(4) |
| C(13B) | 1119.6(13) | 6021.8(12) | 2739.2(4) | 26.1(4) |
| C(14B) | 1453.1(13) | 5205.6(11) | 2717.9(4) | 22.8(3) |
| C(15B) | 2649.6(12) | 1637.0(9) | 3663.8(3) | 16.1(3) |
| C(16B) | 3824.9(13) | 1762.7(10) | 3750.4(4) | 21.0(3) |
| C(17B) | 5042.2(12) | 2426.2(10) | 3410.7(4) | 20.7(3) |
| C(18B) | 4585.6(12) | 2047.7(10) | 3106.6(4) | 17.9(3) |
| C(19B) | 4326.1(13) | 3224.2(10) | 3828.7(4) | 23.5(3) |
| B(1B) | 3136.6(13) | 2653.7(11) | 3323.8(4) | 14.9(3) |
| S(1D) | 2059.8(3) | 8838.3(2) | 7183.1(2) | 15.42(8) |
| S(2D) | 596.0(3) | 10253.8(2) | 6804.0(2) | 16.60(9) |
| O(1D) | 2593.6(8) | 6990.7(7) | 6640.3(3) | 18.2(2) |
| O(2D) | 3076.0(9) | 6228.1(7) | 6246.3(3) | 23.5(2) |
| O(3D) | 1217.4(8) | 7202.1(7) | 6981.4(2) | 16.6(2) |
| O(4D) | −250.9(9) | 6502.5(7) | 7063.9(3) | 22.1(2) |
| N(1D) | 875.5(9) | 7434.2(8) | 6421.8(3) | 13.8(2) |
| C(1D) | 2164.1(11) | 8471.0(9) | 6792.0(3) | 15.3(3) |
| C(2D) | 2670.6(13) | 8932.4(10) | 6600.5(4) | 20.8(3) |
| C(3D) | 687.7(12) | 8924.5(10) | 7215.4(4) | 17.3(3) |
| C(4D) | 77.8(12) | 9516.3(9) | 7048.1(3) | 15.9(3) |
| C(5D) | −1008.8(13) | 9517.6(10) | 7069.7(4) | 21.3(3) |
| C(6D) | −1458.5(14) | 8928.3(11) | 7250.7(4) | 25.6(4) |
| C(7D) | −835.2(15) | 8353.9(11) | 7421.7(4) | 27.4(4) |
| C(8D) | 245.5(14) | 8358.9(10) | 7409.6(4) | 23.2(3) |
| C(9D) | 2450.3(12) | 9885.7(9) | 7172.2(3) | 15.9(3) |
| C(10D) | 1828.3(12) | 10473.4(10) | 7003.4(3) | 15.3(3) |
| C(11D) | 2211.3(13) | 11280.5(10) | 6985.1(4) | 17.9(3) |
| C(12D) | 3183.3(14) | 11480.9(11) | 7134.6(4) | 21.9(3) |
| C(13D) | 3784.5(13) | 10898.8(11) | 7309.7(4) | 23.4(3) |
| C(14D) | 3416.8(13) | 10090.7(11) | 7330.1(4) | 20.7(3) |
| C(15D) | 2465.8(12) | 6692.9(9) | 6351.6(4) | 16.1(3) |
| C(16D) | 1488.8(12) | 7065.1(11) | 6178.3(4) | 20.9(3) |
| C(17D) | 111.4(12) | 6819.7(10) | 6539.4(4) | 19.5(3) |
| C(18D) | 312.6(12) | 6819.8(10) | 6890.4(4) | 16.8(3) |
| C(19D) | 295.1(13) | 8195.4(10) | 6310.8(4) | 24.9(4) |
| B(1D) | 1750.9(13) | 7539.2(11) | 6723.8(4) | 14.7(3) |
| S(1F) | 2953.2(3) | 3801.2(2) | 5324.2(2) | 14.88(8) |
| S(2F) | 4380.7(3) | 5238.6(2) | 5706.3(2) | 17.71(9) |
| O(1F) | 2390.9(8) | 1950.1(7) | 5864.0(3) | 17.5(2) |
| O(2F) | 1895.7(9) | 1198.4(7) | 6259.4(3) | 23.4(2) |
| O(3F) | 3772.3(8) | 2162.7(7) | 5525.3(2) | 16.2(2) |
| O(4F) | 5230.2(9) | 1448.3(7) | 5444.1(3) | 22.2(2) |
| N(1F) | 4107.0(9) | 2391.1(8) | 6084.5(3) | 13.7(2) |
| C(1F) | 2830.3(11) | 3431.1(9) | 5713.6(3) | 14.8(3) |
| C(2F) | 2313.9(13) | 3890.1(10) | 5903.7(4) | 20.7(3) |
| C(3F) | 4326.0(12) | 3898.4(9) | 5299.4(3) | 16.1(3) |
| C(4F) | 4919.8(12) | 4500.3(9) | 5466.4(4) | 16.1(3) |
| C(5F) | 6008.8(13) | 4510.8(10) | 5449.0(4) | 21.0(3) |
| C(6F) | 6474.3(14) | 3925.1(11) | 5270.8(4) | 25.1(4) |
| C(7F) | 5868.6(14) | 3341.5(11) | 5099.0(4) | 25.1(4) |
| C(8F) | 4786.1(14) | 3334.4(10) | 5109.2(4) | 21.4(3) |
| C(9F) | 2545.9(12) | 4843.7(9) | 5333.3(3) | 15.8(3) |
| C(10F) | 3149.1(12) | 5439.9(10) | 5503.2(3) | 16.3(3) |
| C(11F) | 2742.3(13) | 6241.0(10) | 5519.5(4) | 19.6(3) |
| C(12F) | 1768.9(14) | 6424.8(11) | 5368.1(4) | 24.0(4) |
| C(13F) | 1189.3(13) | 5832.9(12) | 5191.3(4) | 25.7(4) |
| C(14F) | 1578.2(13) | 5033.9(11) | 5173.1(4) | 22.0(3) |
| C(15F) | 2511.7(12) | 1660.4(9) | 6154.0(4) | 16.2(3) |
| C(16F) | 3483.7(12) | 2033.0(10) | 6328.4(4) | 20.2(3) |
| C(17F) | 4864.2(12) | 1770.7(10) | 5968.6(4) | 18.7(3) |
| C(18F) | 4669.7(12) | 1770.9(10) | 5616.7(4) | 16.6(3) |
| C(19F) | 4694.4(13) | 3149.0(10) | 6196.3(4) | 23.3(3) |
| B(1F) | 3238.2(13) | 2499.2(11) | 5782.1(4) | 14.6(3) |
| S(3) | 1515.4(3) | 3600.7(2) | 4353.8(2) | 19.40(9) |
| C(20) | 983.3(13) | 4617.7(10) | 4239.0(4) | 22.3(3) |
| F(1) | 96(3) | 4551.2(19) | 4082.8(11) | 44.0(10) |
| F(2) | 915(4) | 5082(2) | 4486.6(7) | 39.6(9) |
| F(3) | 1684(3) | 4979.5(15) | 4071.9(10) | 41.3(9) |
| O(5) | 2528(3) | 3754(2) | 4534.8(13) | 51.6(13) |
| O(6) | 1631(4) | 3162(2) | 4078.0(7) | 37.0(10) |
| O(7) | 767(4) | 3254(3) | 4547.3(15) | 58.0(15) |
| F(1A) | −98(2) | 4655(3) | 4231.9(11) | 39.7(9) |
| F(2A) | 1317(4) | 5248(2) | 4410.8(13) | 50.4(13) |
| F(3A) | 1103(4) | 4843.9(18) | 3939.8(8) | 40.9(12) |
| O(5A) | 2588(2) | 3749(2) | 4315.4(15) | 45.3(13) |
| O(6A) | 996(5) | 3106(2) | 4104.4(10) | 46.1(13) |
| O(7A) | 1186(4) | 3500(3) | 4645.4(8) | 42.3(12) |
| S(3B) | 3503.7(3) | −1438.8(3) | 3136.8(2) | 21.87(10) |
| C(20B) | 3989.6(13) | −400.3(11) | 3237.8(4) | 24.3(3) |
| F(1B) | 4872.8(15) | −430.5(10) | 3409.6(6) | 43.4(5) |
| F(2B) | 4124.7(19) | 10.3(11) | 2979.1(4) | 47.8(5) |
| F(3B) | 3284.1(13) | −7.7(10) | 3382.7(5) | 41.0(5) |
| O(5B) | 2566(2) | −1326.5(14) | 2933.0(6) | 59.3(8) |
| O(6B) | 3322.2(19) | −1812.8(11) | 3429.2(4) | 34.5(5) |
| O(7B) | 4346(2) | −1840.9(13) | 2992.6(7) | 59.7(8) |
| F(1C) | 5051(3) | −251(3) | 3220.0(14) | 41.5(13) |
| F(2C) | 3537(4) | 288(3) | 3122.9(15) | 52.3(18) |
| F(3C) | 4032(5) | −198(3) | 3562.1(9) | 47.8(16) |
| O(5C) | 2464(4) | −1295(4) | 3224.5(18) | 52.1(19) |
| O(6C) | 4182(7) | −1887(3) | 3344.0(18) | 70(3) |
| O(7C) | 3646(6) | −1384(4) | 2822.5(11) | 51.5(19) |
| S(3D) | 1691.9(3) | 3574.8(2) | 6808.8(2) | 17.45(9) |
| F(1D) | 1523.5(9) | 5169.2(7) | 6924.4(3) | 35.4(3) |
| F(2D) | 1436.3(11) | 4873.8(7) | 6440.7(3) | 42.2(3) |
| F(3D) | 122.3(8) | 4624.6(7) | 6699.9(3) | 31.3(2) |
| O(5D) | 1198.0(11) | 3077.0(8) | 6558.3(3) | 28.2(3) |
| O(6D) | 1360.5(13) | 3415.4(9) | 7109.2(3) | 37.9(3) |
| O(7D) | 2806.2(10) | 3674.6(9) | 6792.2(4) | 37.7(3) |
| C(20D) | 1166.0(13) | 4609.2(10) | 6715.3(4) | 18.8(3) |
| S(3F) | 3249.7(3) | −1444.6(2) | 5682.5(2) | 20.46(9) |
| F(1F) | 3420.2(10) | 136.8(8) | 5546.6(3) | 46.3(3) |
| F(2F) | 3508.6(13) | −116.2(8) | 6031.0(3) | 53.8(4) |
| F(3F) | 4818.2(8) | −391.3(7) | 5776.5(3) | 34.8(3) |
| O(5F) | 3736.3(11) | −1918.4(8) | 5937.9(3) | 31.8(3) |
| O(6F) | 3555.6(16) | −1625.1(11) | 5383.4(4) | 56.5(5) |
| O(7F) | 2132.3(11) | −1336.1(10) | 5702.2(4) | 46.7(4) |
| C(20F) | 3781.0(13) | −407.0(10) | 5760.3(4) | 21.2(3) |

U_{eq} is defined as ⅓ of the trace of the orthogonalised Uᵢⱼ

TABLE 40
Anisotropic Displacement Parameters (×10⁴) for 60

| Atom | U₁₁ | U₂₂ | U₃₃ | U₂₃ | U₁₃ | U₁₂ |
|---|---|---|---|---|---|---|
| S(1) | 16.18(17) | 15.27(17) | 13.21(17) | −0.84(12) | −1.28(13) | 4.56(13) |
| S(2) | 13.68(17) | 16.96(18) | 16.74(18) | 4.73(13) | −1.75(13) | 0.61(13) |
| O(1) | 14.3(5) | 18.8(5) | 19.4(5) | −3.7(4) | 0.3(4) | 3.4(4) |
| O(2) | 23.4(6) | 20.3(6) | 24.8(6) | −4.9(5) | 6.5(5) | 3.5(5) |
| O(3) | 18.3(5) | 16.2(5) | 14.2(5) | 1.2(4) | −0.1(4) | 2.7(4) |
| O(4) | 25.0(6) | 24.5(6) | 22.1(6) | 2.9(5) | 8.6(5) | 1.4(5) |
| N(1) | 13.0(6) | 15.8(6) | 12.9(6) | 0.4(5) | −1.0(5) | 1.9(5) |
| C(1) | 11.5(7) | 19.2(7) | 13.9(7) | −3.5(5) | −0.2(5) | 4.4(5) |
| C(2) | 17.3(7) | 20.9(8) | 20.3(7) | −3.6(6) | 3.8(6) | 0.2(6) |
| C(3) | 17.5(7) | 16.5(7) | 13.8(7) | −1.0(6) | 2.6(5) | 2.6(6) |
| C(4) | 18.4(7) | 13.5(7) | 13.7(7) | −0.4(5) | 2.1(5) | 1.4(6) |
| C(5) | 17.7(7) | 18.7(7) | 20.2(7) | −2.2(6) | 4.0(6) | 1.4(6) |
| C(6) | 24.5(8) | 21.0(8) | 24.7(8) | −4.7(6) | 9.7(7) | −1.8(6) |
| C(7) | 34.5(9) | 17.5(8) | 23.7(8) | −0.7(6) | 16.8(7) | −0.4(7) |
| C(8) | 32.4(9) | 16.1(7) | 16.1(7) | 2.0(6) | 7.8(6) | 5.9(6) |
| C(9) | 14.9(7) | 19.0(7) | 15.2(7) | −4.5(6) | 0.8(5) | 3.0(6) |
| C(10) | 15.3(7) | 17.7(7) | 12.3(6) | −2.3(5) | 2.5(5) | −0.7(6) |
| C(11) | 21.8(8) | 18.0(8) | 15.9(7) | −0.8(6) | 4.3(6) | 0.4(6) |
| C(12) | 26.6(8) | 21.9(8) | 21.4(8) | −7.7(6) | 4.5(6) | −6.0(7) |
| C(13) | 17.8(8) | 30.8(9) | 23.0(8) | −10.8(7) | −1.2(6) | −2.6(7) |
| C(14) | 17.9(8) | 27.5(9) | 20.5(8) | −7.9(6) | −2.0(6) | 4.5(6) |
| C(15) | 17.4(7) | 14.8(7) | 14.8(7) | 1.2(6) | 4.2(5) | −1.4(6) |
| C(16) | 21.2(8) | 18.2(8) | 20.2(7) | −4.6(6) | 1.0(6) | 1.6(6) |
| C(17) | 14.1(7) | 23.4(8) | 20.9(8) | 0.9(6) | 1.7(6) | 0.3(6) |
| C(18) | 16.2(7) | 18.6(7) | 18.8(7) | −1.3(6) | 2.5(6) | 3.8(6) |
| C(19) | 24.8(8) | 21.0(8) | 20.3(8) | 6.1(6) | −5.2(6) | −0.6(6) |
| B(1) | 12.6(7) | 14.8(8) | 14.5(7) | −1.6(6) | −1.4(6) | 3.0(6) |
| S(1B) | 14.54(17) | 16.98(18) | 13.41(17) | 1.21(13) | −1.17(13) | −4.05(13) |
| S(2B) | 15.36(18) | 18.37(18) | 19.04(18) | −6.01(14) | −2.02(14) | −0.45(13) |
| O(1B) | 13.7(5) | 20.7(5) | 21.2(5) | 5.1(4) | 0.3(4) | −3.1(4) |
| O(2B) | 25.7(6) | 20.5(6) | 25.4(6) | 3.1(5) | 8.3(5) | −4.3(5) |
| O(3B) | 17.8(5) | 17.6(5) | 15.1(5) | −1.5(4) | −0.5(4) | −2.3(4) |
| O(4B) | 25.1(6) | 25.6(6) | 21.4(6) | −2.4(5) | 8.6(5) | 0.4(5) |
| N(1B) | 13.1(6) | 16.0(6) | 13.1(6) | −0.4(5) | −1.5(5) | −1.4(5) |
| C(1B) | 10.6(6) | 19.8(7) | 14.6(7) | 3.2(6) | 0.2(5) | −3.5(5) |
| C(2B) | 18.2(7) | 22.8(8) | 20.6(8) | 4.9(6) | 4.3(6) | 1.4(6) |
| C(3B) | 15.8(7) | 18.1(7) | 13.7(7) | 0.5(6) | 1.8(5) | −3.0(6) |
| C(4B) | 17.0(7) | 14.9(7) | 15.2(7) | 0.1(5) | 1.6(5) | −1.8(6) |
| C(5B) | 17.0(7) | 19.7(8) | 21.6(8) | 1.7(6) | 2.3(6) | −3.6(6) |
| C(6B) | 21.0(8) | 22.2(8) | 23.6(8) | 4.9(6) | 7.9(6) | 1.4(6) |
| C(7B) | 29.3(9) | 20.1(8) | 20.5(8) | 1.5(6) | 13.4(6) | 0.8(7) |
| C(8B) | 28.4(8) | 16.5(7) | 14.3(7) | −1.4(6) | 5.2(6) | −4.4(6) |
| C(9B) | 14.7(7) | 20.1(8) | 16.4(7) | 4.1(6) | 1.6(5) | −1.6(6) |
| C(10B) | 16.8(7) | 20.0(8) | 14.2(7) | 2.1(6) | 2.5(5) | 1.5(6) |
| C(11B) | 26.0(8) | 18.7(8) | 16.9(7) | 1.6(6) | 5.8(6) | 1.4(6) |
| C(12B) | 28.6(9) | 25.5(8) | 21.9(8) | 10.8(7) | 7.9(7) | 8.8(7) |
| C(13B) | 19.3(8) | 34.0(10) | 25.1(8) | 14.9(7) | 2.3(6) | 5.1(7) |
| C(14B) | 17.4(8) | 30.2(9) | 20.4(8) | 10.1(7) | 0.1(6) | −1.6(6) |
| C(15B) | 18.9(7) | 14.7(7) | 15.4(7) | −1.9(6) | 4.7(6) | 0.7(6) |
| C(16B) | 21.7(8) | 20.5(8) | 20.3(8) | 4.6(6) | −0.1(6) | −1.6(6) |
| C(17B) | 14.5(7) | 24.8(8) | 23.0(8) | −1.2(6) | 1.7(6) | −0.7(6) |
| C(18B) | 15.3(7) | 19.9(8) | 18.6(7) | 1.5(6) | 2.8(6) | −2.8(6) |
| C(19B) | 25.0(8) | 21.4(8) | 22.6(8) | −6.5(6) | −6.7(6) | 0.9(6) |
| B(1B) | 11.7(7) | 17.5(8) | 15.2(7) | 1.5(6) | −1.1(6) | −2.3(6) |
| S(1D) | 17.45(18) | 13.99(17) | 14.37(17) | 0.53(13) | −0.96(13) | 3.71(13) |
| S(2D) | 15.00(17) | 15.62(18) | 18.43(18) | 5.02(13) | −2.47(13) | 0.02(13) |
| O(1D) | 14.4(5) | 18.6(5) | 21.1(5) | −3.5(4) | −0.8(4) | 3.9(4) |
| O(2D) | 22.8(6) | 22.7(6) | 26.0(6) | −2.7(5) | 7.6(5) | 4.3(5) |
| O(3D) | 17.9(5) | 15.7(5) | 15.7(5) | 0.9(4) | −1.0(4) | −0.6(4) |
| O(4D) | 20.8(6) | 25.3(6) | 20.6(6) | 5.4(5) | 4.9(4) | −0.4(5) |
| N(1D) | 11.0(6) | 16.0(6) | 14.3(6) | 1.6(5) | 0.1(5) | 0.5(5) |
| C(1D) | 12.2(7) | 16.4(7) | 17.1(7) | −3.0(6) | 0.2(5) | 3.6(5) |
| C(2D) | 19.7(8) | 20.9(8) | 22.7(8) | −3.5(6) | 6.0(6) | −1.3(6) |
| C(3D) | 20.4(7) | 15.7(7) | 16.2(7) | 0.1(6) | 4.1(6) | 3.2(6) |
| C(4D) | 17.9(7) | 13.8(7) | 16.2(7) | −0.8(5) | 2.7(6) | 0.4(6) |
| C(5D) | 18.7(8) | 20.2(8) | 25.1(8) | −3.0(6) | 3.6(6) | 1.3(6) |
| C(6D) | 21.9(8) | 25.3(9) | 31.5(9) | −8.4(7) | 12.4(7) | −4.5(7) |
| C(7D) | 38.0(10) | 19.2(8) | 28.0(9) | −2.0(7) | 19.6(8) | −3.6(7) |
| C(8D) | 33.9(9) | 16.5(7) | 20.6(8) | 1.4(6) | 10.0(7) | 4.7(7) |
| C(9D) | 16.2(7) | 15.6(7) | 15.9(7) | −1.9(6) | 1.9(5) | 0.3(6) |
| C(10D) | 16.2(7) | 17.6(7) | 12.3(7) | −0.7(5) | 1.9(5) | 0.1(6) |
| C(11D) | 23.0(8) | 16.1(7) | 15.0(7) | −0.1(6) | 4.0(6) | −1.0(6) |
| C(12D) | 25.2(8) | 22.6(8) | 18.3(7) | −6.1(6) | 4.7(6) | −8.1(6) |
| C(13D) | 18.8(8) | 31.1(9) | 19.9(8) | −8.0(7) | −0.2(6) | −5.4(7) |
| C(14D) | 17.7(7) | 25.6(8) | 18.1(7) | −3.9(6) | −2.0(6) | 1.7(6) |
| C(15D) | 16.9(7) | 14.3(7) | 17.6(7) | −0.2(6) | 5.0(6) | −2.6(6) |
| C(16D) | 18.6(7) | 26.0(8) | 18.2(7) | −2.7(6) | 2.7(6) | 0.2(6) |
| C(17D) | 16.0(7) | 22.9(8) | 19.7(7) | 2.9(6) | 1.3(6) | −4.5(6) |
| C(18D) | 13.4(7) | 18.2(7) | 18.9(7) | 1.6(6) | 1.9(6) | 3.2(6) |
| C(19D) | 22.6(8) | 20.7(8) | 29.9(9) | 4.8(7) | −6.0(7) | 4.0(6) |
| B(1D) | 13.7(7) | 15.4(8) | 14.5(8) | −0.3(6) | −0.9(6) | 2.1(6) |
| S(1F) | 15.48(17) | 14.87(17) | 13.85(17) | −0.30(12) | −1.05(13) | −3.44(13) |
| S(2F) | 16.23(18) | 16.56(18) | 19.57(18) | −5.78(13) | −2.53(14) | −0.36(13) |
| O(1F) | 13.3(5) | 18.4(5) | 20.3(5) | 3.1(4) | −0.5(4) | −3.6(4) |
| O(2F) | 23.9(6) | 22.0(6) | 25.6(6) | 2.3(5) | 8.4(5) | −4.2(5) |
| O(3F) | 17.1(5) | 15.4(5) | 15.5(5) | −0.2(4) | −1.1(4) | 1.0(4) |
| O(4F) | 21.2(6) | 25.4(6) | 20.8(6) | −4.2(5) | 5.8(4) | 1.7(5) |
| N(1F) | 11.1(6) | 16.4(6) | 13.5(6) | −1.0(5) | 0.1(4) | 0.4(5) |
| C(1F) | 11.4(6) | 16.3(7) | 16.4(7) | 3.1(5) | 0.1(5) | −2.9(5) |
| C(2F) | 20.1(8) | 20.4(8) | 22.6(8) | 3.8(6) | 6.8(6) | 2.2(6) |
| C(3F) | 17.2(7) | 15.7(7) | 15.5(7) | −0.1(6) | 2.7(6) | −2.5(6) |
| C(4F) | 16.8(7) | 14.9(7) | 16.7(7) | 0.3(6) | 2.1(5) | −1.1(6) |
| C(5F) | 17.5(8) | 20.0(8) | 25.6(8) | 2.2(6) | 2.1(6) | −3.0(6) |
| C(6F) | 20.1(8) | 24.5(8) | 32.0(9) | 8.0(7) | 10.3(7) | 2.9(6) |
| C(7F) | 33.5(9) | 19.0(8) | 25.5(8) | 2.1(6) | 16.2(7) | 2.0(7) |
| C(8F) | 30.0(9) | 17.5(7) | 17.7(7) | −1.5(6) | 7.7(6) | −3.6(6) |
| C(9F) | 15.9(7) | 15.2(7) | 16.3(7) | 3.1(5) | 2.2(5) | 0.5(6) |
| C(10F) | 16.7(7) | 18.3(7) | 14.1(7) | 1.4(6) | 2.3(5) | 0.7(6) |
| C(11F) | 25.7(8) | 16.1(7) | 18.1(7) | 1.9(6) | 7.4(6) | 2.5(6) |
| C(12F) | 28.4(9) | 23.8(8) | 20.6(8) | 8.4(6) | 7.4(7) | 9.6(7) |
| C(13F) | 19.7(8) | 35.3(10) | 22.3(8) | 11.9(7) | 2.3(6) | 7.2(7) |
| C(14F) | 17.3(7) | 28.6(9) | 19.4(8) | 5.1(6) | −1.5(6) | −0.4(6) |
| C(15F) | 17.8(7) | 14.2(7) | 17.5(7) | 0.2(6) | 5.7(6) | 3.2(6) |
| C(16F) | 19.1(7) | 25.2(8) | 16.5(7) | 1.5(6) | 2.6(6) | 0.7(6) |
| C(17F) | 15.5(7) | 20.9(8) | 19.5(7) | −2.0(6) | 0.9(6) | 4.3(6) |
| C(18F) | 13.5(7) | 18.2(7) | 18.3(7) | −0.9(6) | 2.7(6) | −2.1(6) |
| C(19F) | 20.1(8) | 19.7(8) | 28.5(8) | −4.9(6) | −5.8(6) | −3.8(6) |
| B(1F) | 12.4(7) | 16.2(8) | 14.9(8) | 0.2(6) | 0.3(6) | −2.1(6) |
| S(3) | 22.6(2) | 16.27(18) | 19.42(19) | −2.39(14) | 2.34(15) | −1.32(14) |
| C(20) | 29.1(9) | 18.6(8) | 19.8(8) | −2.9(6) | 5.0(6) | −3.2(6) |
| F(1) | 42.7(18) | 25.3(12) | 58(2) | −2.4(15) | −27.8(17) | 5.6(12) |
| F(2) | 69(3) | 23.0(16) | 26.5(13) | −8.0(11) | 0.8(13) | 16.9(15) |
| F(3) | 47.5(18) | 20.9(11) | 59(2) | 15.6(12) | 24.1(16) | 2.7(11) |
| O(5) | 48(2) | 29.8(16) | 70(3) | −6.5(17) | −30(2) | 8.7(13) |
| O(6) | 70(3) | 21.3(14) | 19.5(13) | −2.8(10) | 2.9(16) | 12.0(17) |
| O(7) | 64(3) | 37(2) | 82(4) | 31(2) | 52(3) | 23(2) |
| F(1A) | 26.6(13) | 39.8(18) | 53(2) | 22.9(17) | 3.3(14) | 7.6(11) |
| F(2A) | 64(3) | 17.5(16) | 64(3) | −16.0(17) | −27(2) | 5.5(16) |
| F(3A) | 71(3) | 23.6(13) | 32.5(16) | 13.8(11) | 28.5(17) | 19.7(15) |
| O(5A) | 20.7(15) | 27.1(16) | 89(4) | 12.4(19) | 10.8(18) | 3.2(12) |
| O(6A) | 77(3) | 16.4(14) | 38(2) | −4.2(13) | −35(2) | 1.4(19) |
| O(7A) | 63(3) | 45(3) | 20.1(16) | 16.0(15) | 11.9(16) | 26(2) |
| S(3B) | 24.0(2) | 24.9(2) | 16.50(19) | 0.91(15) | 0.47(15) | 0.51(15) |
| C(20B) | 27.5(9) | 21.7(8) | 23.9(8) | 6.0(6) | 3.6(7) | 5.4(7) |
| F(1B) | 35.4(10) | 25.4(8) | 64.2(14) | 4.4(9) | −23.1(10) | −7.6(7) |
| F(2B) | 88.8(16) | 26.1(9) | 29.1(8) | 7.8(7) | 8.5(9) | −17.7(9) |
| F(3B) | 40.3(9) | 21.5(8) | 63.7(12) | −14.4(8) | 17.9(9) | 1.1(7) |
| O(5B) | 64.6(16) | 36.5(12) | 67.3(17) | 5.2(11) | −44.3(14) | −10.9(11) |
| O(6B) | 60.5(14) | 23.6(9) | 20.5(9) | −1.6(7) | 9.4(8) | −12.7(9) |
| O(7B) | 65.3(16) | 28.9(11) | 94(2) | −24.0(12) | 57.5(15) | −15.5(11) |
| F(1C) | 28(2) | 39(3) | 58(3) | −24(3) | 4(2) | −4.4(19) |
| F(2C) | 50(3) | 16(2) | 85(4) | 17(2) | −26(3) | 1(2) |
| F(3C) | 90(4) | 24(2) | 33(2) | −11.5(18) | 22(3) | −25(2) |
| O(5C) | 44(3) | 29(3) | 89(5) | −19(3) | 34(3) | −15(2) |
| O(6C) | 109(6) | 16(3) | 71(5) | 1(3) | −66(5) | 3(3) |
| O(7C) | 72(4) | 61(4) | 24(3) | −23(3) | 13(3) | −38(4) |
| S(3D) | 17.95(18) | 15.61(18) | 18.28(18) | −2.26(13) | −1.12(14) | 1.87(13) |
| F(1D) | 37.6(6) | 22.3(5) | 44.4(7) | −16.2(5) | −6.8(5) | 4.3(4) |
| F(2D) | 71.5(9) | 23.3(5) | 36.5(6) | 9.8(5) | 30.1(6) | 11.0(5) |
| F(3D) | 19.4(5) | 26.4(5) | 47.4(7) | 4.6(5) | −0.8(4) | 4.6(4) |
| O(5D) | 36.5(7) | 17.9(6) | 28.5(6) | −4.5(5) | −6.7(5) | −1.1(5) |
| O(6D) | 57.8(9) | 34.8(7) | 22.5(6) | 9.1(6) | 10.6(6) | 17.8(7) |
| O(7D) | 18.4(6) | 27.9(7) | 66.6(10) | −11.7(7) | 3.1(6) | 1.8(5) |
| C(20D) | 20.3(8) | 17.2(7) | 19.3(7) | −2.1(6) | 3.7(6) | −0.2(6) |
| S(3F) | 23.8(2) | 18.99(19) | 17.76(19) | 2.13(14) | −2.44(14) | −4.87(14) |
| F(1F) | 37.8(7) | 32.0(6) | 66.5(9) | 29.0(6) | −8.4(6) | −6.2(5) |
| F(2F) | 87.4(11) | 25.3(6) | 55.9(8) | −15.3(6) | 44.7(8) | −16.0(6) |
| F(3F) | 19.7(5) | 27.2(6) | 56.7(7) | −0.2(5) | 0.3(5) | −4.5(4) |
| O(5F) | 37.1(7) | 19.2(6) | 36.9(7) | 6.4(5) | −9.2(6) | −0.7(5) |
| O(6F) | 92.5(14) | 50.7(10) | 29.2(8) | −16.5(7) | 21.4(8) | −33.5(10) |
| O(7F) | 23.1(7) | 36.6(8) | 79.3(12) | 22.8(8) | −1.5(7) | −4.1(6) |
| C(20F) | 22.1(8) | 17.0(8) | 25.0(8) | 2.9(6) | 5.3(6) | 0.1(6) |

The anisotropic displacement factor exponent takes the form: −2π²[h²a*² × U₁₁ + . . . + 2hka* × b* × U₁₂]

TABLE 41
Bond Lengths in Å for 60

| Atom | Atom | Length/Å |
|---|---|---|
| S(1) | C(1) | 1.8070(15) |
| S(1) | C(3) | 1.7714(16) |
| S(1) | C(9) | 1.7635(16) |
| S(2) | C(4) | 1.7572(15) |
| S(2) | C(10) | 1.7600(15) |
| O(1) | C(15) | 1.3357(19) |
| O(1) | B(1) | 1.4616(19) |
| O(2) | C(15) | 1.1976(19) |
| O(3) | C(18) | 1.3485(19) |
| O(3) | B(1) | 1.473(2) |
| O(4) | C(18) | 1.196(2) |
| N(1) | C(16) | 1.4949(19) |
| N(1) | C(17) | 1.4898(19) |
| N(1) | C(19) | 1.4992(19) |
| N(1) | B(1) | 1.645(2) |
| C(1) | C(2) | 1.329(2) |
| C(1) | B(1) | 1.609(2) |
| C(3) | C(4) | 1.397(2) |
| C(3) | C(8) | 1.390(2) |
| C(4) | C(5) | 1.396(2) |
| C(5) | C(6) | 1.391(2) |
| C(6) | C(7) | 1.395(3) |
| C(7) | C(8) | 1.386(2) |
| C(9) | C(10) | 1.396(2) |
| C(9) | C(14) | 1.395(2) |
| C(10) | C(11) | 1.395(2) |
| C(11) | C(12) | 1.384(2) |
| C(12) | C(13) | 1.390(3) |
| C(13) | C(14) | 1.387(3) |
| C(15) | C(16) | 1.522(2) |
| C(17) | C(18) | 1.514(2) |
| S(1B) | C(1B) | 1.8063(15) |
| S(1B) | C(3B) | 1.7709(15) |
| S(1B) | C(9B) | 1.7619(16) |
| S(2B) | C(4B) | 1.7578(16) |
| S(2B) | C(10B) | 1.7581(16) |
| O(1B) | C(15B) | 1.3323(19) |
| O(1B) | B(1B) | 1.4621(19) |
| O(2B) | C(15B) | 1.200(2) |
| O(3B) | C(18B) | 1.3447(19) |
| O(3B) | B(1B) | 1.472(2) |
| O(4B) | C(18B) | 1.197(2) |
| N(1B) | C(16B) | 1.4922(19) |
| N(1B) | C(17B) | 1.4934(19) |
| N(1B) | C(19B) | 1.5007(19) |
| N(1B) | B(1B) | 1.644(2) |
| C(1B) | C(2B) | 1.329(2) |
| C(1B) | B(1B) | 1.608(2) |
| C(3B) | C(4B) | 1.397(2) |
| C(3B) | C(8B) | 1.391(2) |
| C(4B) | C(5B) | 1.395(2) |
| C(5B) | C(6B) | 1.388(2) |
| C(6B) | C(7B) | 1.392(2) |
| C(7B) | C(8B) | 1.385(2) |
| C(9B) | C(10B) | 1.399(2) |
| C(9B) | C(14B) | 1.393(2) |
| C(10B) | C(11B) | 1.395(2) |
| C(11B) | C(12B) | 1.384(2) |
| C(12B) | C(13B) | 1.390(3) |
| C(13B) | C(14B) | 1.390(3) |
| C(15B) | C(16B) | 1.525(2) |
| C(17B) | C(18B) | 1.516(2) |
| S(1D) | C(1D) | 1.8086(15) |
| S(1D) | C(3D) | 1.7745(16) |
| S(1D) | C(9D) | 1.7640(16) |
| S(2D) | C(4D) | 1.7599(16) |
| S(2D) | C(10D) | 1.7577(16) |
| O(1D) | C(15D) | 1.3337(19) |
| O(1D) | B(1D) | 1.4635(19) |
| O(2D) | C(15D) | 1.201(2) |
| O(3D) | C(18D) | 1.3356(19) |
| O(3D) | B(1D) | 1.463(2) |
| O(4D) | C(18D) | 1.201(2) |
| N(1D) | C(16D) | 1.4930(19) |
| N(1D) | C(17D) | 1.5112(19) |
| N(1D) | C(19D) | 1.4907(19) |
| N(1D) | B(1D) | 1.647(2) |
| C(1D) | C(2D) | 1.326(2) |
| C(1D) | B(1D) | 1.612(2) |
| C(3D) | C(4D) | 1.392(2) |
| C(3D) | C(8D) | 1.394(2) |
| C(4D) | C(5D) | 1.398(2) |
| C(5D) | C(6D) | 1.389(2) |
| C(6D) | C(7D) | 1.389(3) |
| C(7D) | C(8D) | 1.385(3) |
| C(9D) | C(10D) | 1.398(2) |
| C(9D) | C(14D) | 1.393(2) |
| C(10D) | C(11D) | 1.396(2) |
| C(11D) | C(12D) | 1.383(2) |
| C(12D) | C(13D) | 1.392(3) |
| C(13D) | C(14D) | 1.391(2) |
| C(15D) | C(16D) | 1.518(2) |
| C(17D) | C(18D) | 1.516(2) |
| S(1F) | C(1F) | 1.8075(15) |
| S(1F) | C(3F) | 1.7716(16) |
| S(1F) | C(9F) | 1.7623(16) |
| S(2F) | C(4F) | 1.7609(16) |
| S(2F) | C(10F) | 1.7579(16) |
| O(1F) | C(15F) | 1.3338(19) |
| O(1F) | B(1F) | 1.4664(19) |
| O(2F) | C(15F) | 1.203(2) |
| O(3F) | C(18F) | 1.3353(19) |
| O(3F) | B(1F) | 1.4604(19) |
| O(4F) | C(18F) | 1.1995(19) |
| N(1F) | C(16F) | 1.4947(19) |
| N(1F) | C(17F) | 1.5089(19) |
| N(1F) | C(19F) | 1.4914(19) |
| N(1F) | B(1F) | 1.644(2) |
| C(1F) | C(2F) | 1.326(2) |
| C(1F) | B(1F) | 1.610(2) |
| C(3F) | C(4F) | 1.392(2) |
| C(3F) | C(8F) | 1.392(2) |
| C(4F) | C(5F) | 1.399(2) |
| C(5F) | C(6F) | 1.387(2) |
| C(6F) | C(7F) | 1.389(3) |
| C(7F) | C(8F) | 1.386(2) |
| C(9F) | C(10F) | 1.397(2) |
| C(9F) | C(14F) | 1.393(2) |
| C(10F) | C(11F) | 1.397(2) |
| C(11F) | C(12F) | 1.381(2) |
| C(12F) | C(13F) | 1.392(3) |
| C(13F) | C(14F) | 1.386(3) |
| C(15F) | C(16F) | 1.515(2) |
| C(17F) | C(18F) | 1.519(2) |
| S(3) | C(20) | 1.8271(18) |
| S(3) | O(5) | 1.468(3) |
| S(3) | O(6) | 1.407(3) |
| S(3) | O(7) | 1.440(3) |
| S(3) | O(5A) | 1.414(3) |
| S(3) | O(6A) | 1.452(3) |
| S(3) | O(7A) | 1.375(4) |
| C(20) | F(1) | 1.268(3) |
| C(20) | F(2) | 1.316(3) |
| C(20) | F(3) | 1.335(3) |
| C(20) | F(1A) | 1.379(3) |
| C(20) | F(2A) | 1.308(4) |
| C(20) | F(3A) | 1.367(3) |
| S(3B) | C(20B) | 1.8258(19) |
| S(3B) | O(5B) | 1.430(2) |
| S(3B) | O(6B) | 1.4395(17) |
| S(3B) | O(7B) | 1.446(2) |
| S(3B) | O(5C) | 1.432(5) |
| S(3B) | O(6C) | 1.390(5) |
| S(3B) | O(7C) | 1.391(4) |
| C(20B) | F(1B) | 1.292(2) |
| C(20B) | F(2B) | 1.325(2) |
| C(20B) | F(3B) | 1.307(2) |
| C(20B) | F(1C) | 1.384(4) |
| C(20B) | F(2C) | 1.326(4) |
| C(20B) | F(3C) | 1.436(4) |
| S(3D) | O(5D) | 1.4455(12) |
| S(3D) | O(6D) | 1.4266(14) |
| S(3D) | O(7D) | 1.4390(14) |
| S(3D) | C(20D) | 1.8302(17) |
| F(1D) | C(20D) | 1.3290(19) |
| F(2D) | C(20D) | 1.3367(19) |
| F(3D) | C(20D) | 1.3273(19) |
| S(3F) | O(5F) | 1.4362(13) |
| S(3F) | O(6F) | 1.4156(15) |
| S(3F) | O(7F) | 1.4466(15) |
| S(3F) | C(20F) | 1.8260(17) |
| F(1F) | C(20F) | 1.325(2) |
| F(2F) | C(20F) | 1.337(2) |
| F(3F) | C(20F) | 1.319(2) |

TABLE 42
Bond Angles in ° for 60.

| Atom | Atom | Atom | Angle/° |
|---|---|---|---|
| C(3) | S(1) | C(1) | 104.20(7) |
| C(9) | S(1) | C(1) | 103.94(7) |
| C(9) | S(1) | C(3) | 101.31(7) |
| C(4) | S(2) | C(10) | 101.83(7) |
| C(15) | O(1) | B(1) | 112.45(12) |
| C(18) | O(3) | B(1) | 113.75(12) |
| C(16) | N(1) | C(19) | 110.50(12) |
| C(16) | N(1) | B(1) | 101.57(11) |
| C(17) | N(1) | C(16) | 112.24(12) |
| C(17) | N(1) | C(19) | 110.89(12) |
| C(17) | N(1) | B(1) | 102.75(11) |
| C(19) | N(1) | B(1) | 118.45(12) |
| C(2) | C(1) | S(1) | 118.49(12) |
| C(2) | C(1) | B(1) | 124.94(14) |
| B(1) | C(1) | S(1) | 115.93(11) |
| C(4) | C(3) | S(1) | 121.52(12) |
| C(8) | C(3) | S(1) | 116.76(12) |
| C(8) | C(3) | C(4) | 121.70(15) |
| C(3) | C(4) | S(2) | 123.20(12) |
| C(5) | C(4) | S(2) | 118.22(12) |
| C(5) | C(4) | C(3) | 118.58(14) |
| C(6) | C(5) | C(4) | 119.76(15) |
| C(5) | C(6) | C(7) | 120.89(16) |
| C(8) | C(7) | C(6) | 119.74(15) |
| C(7) | C(8) | C(3) | 119.13(15) |
| C(10) | C(9) | S(1) | 120.55(12) |
| C(14) | C(9) | S(1) | 117.56(12) |
| C(14) | C(9) | C(10) | 121.83(15) |
| C(9) | C(10) | S(2) | 124.34(12) |
| C(11) | C(10) | S(2) | 117.43(12) |
| C(11) | C(10) | C(9) | 118.22(14) |
| C(12) | C(11) | C(10) | 120.12(15) |
| C(11) | C(12) | C(13) | 121.21(16) |
| C(14) | C(13) | C(12) | 119.55(15) |
| C(13) | C(14) | C(9) | 119.02(16) |
| O(1) | C(15) | C(16) | 110.31(12) |
| O(2) | C(15) | O(1) | 124.39(14) |
| O(2) | C(15) | C(16) | 125.30(14) |
| N(1) | C(16) | C(15) | 106.86(12) |
| N(1) | C(17) | C(18) | 104.98(12) |
| O(3) | C(18) | C(17) | 109.47(13) |
| O(4) | C(18) | O(3) | 124.36(14) |
| O(4) | C(18) | C(17) | 126.11(15) |
| O(1) | B(1) | O(3) | 111.84(12) |
| O(1) | B(1) | N(1) | 102.90(11) |
| O(1) | B(1) | C(1) | 110.18(12) |
| O(3) | B(1) | N(1) | 101.15(11) |
| O(3) | B(1) | C(1) | 114.02(12) |
| C(1) | B(1) | N(1) | 116.01(12) |
| C(3B) | S(1B) | C(1B) | 103.98(7) |
| C(9B) | S(1B) | C(1B) | 103.89(7) |
| C(9B) | S(1B) | C(3B) | 101.62(7) |
| C(4B) | S(2B) | C(10B) | 102.04(7) |
| C(15B) | O(1B) | B(1B) | 112.57(12) |
| C(18B) | O(3B) | B(1B) | 113.86(12) |
| C(16B) | N(1B) | C(17B) | 112.18(12) |
| C(16B) | N(1B) | C(19B) | 110.48(12) |
| C(16B) | N(1B) | B(1B) | 101.89(11) |
| C(17B) | N(1B) | C(19B) | 110.71(12) |
| C(17B) | N(1B) | B(1B) | 102.75(11) |
| C(19B) | N(1B) | B(1B) | 118.41(12) |
| C(2B) | C(1B) | S(1B) | 118.67(12) |
| C(2B) | C(1B) | B(1B) | 124.56(14) |
| B(1B) | C(1B) | S(1B) | 116.12(11) |
| C(4B) | C(3B) | S(1B) | 121.75(12) |
| C(8B) | C(3B) | S(1B) | 116.68(12) |
| C(8B) | C(3B) | C(4B) | 121.55(14) |
| C(3B) | C(4B) | S(2B) | 123.26(12) |
| C(5B) | C(4B) | S(2B) | 118.18(12) |
| C(5B) | C(4B) | C(3B) | 118.55(14) |
| C(6B) | C(5B) | C(4B) | 119.86(15) |
| C(5B) | C(6B) | C(7B) | 121.00(15) |
| C(8B) | C(7B) | C(6B) | 119.68(15) |
| C(7B) | C(8B) | C(3B) | 119.20(15) |
| C(10B) | C(9B) | S(1B) | 120.82(12) |
| C(14B) | C(9B) | S(1B) | 117.41(13) |
| C(14B) | C(9B) | C(10B) | 121.70(15) |
| C(9B) | C(10B) | S(2B) | 124.34(12) |
| C(11B) | C(10B) | S(2B) | 117.38(12) |
| C(11B) | C(10B) | C(9B) | 118.26(15) |
| C(12B) | C(11B) | C(10B) | 120.15(16) |
| C(11B) | C(12B) | C(13B) | 121.22(16) |
| C(14B) | C(13B) | C(12B) | 119.45(16) |
| C(13B) | C(14B) | C(9B) | 119.18(16) |
| O(1B) | C(15B) | C(16B) | 110.47(13) |
| O(2B) | C(15B) | O(1B) | 124.39(15) |
| O(2B) | C(15B) | C(16B) | 125.13(14) |
| N(1B) | C(16B) | C(15B) | 106.50(12) |
| N(1B) | C(17B) | C(18B) | 104.74(12) |
| O(3B) | C(18B) | C(17B) | 109.57(13) |
| O(4B) | C(18B) | O(3B) | 124.41(15) |
| O(4B) | C(18B) | C(17B) | 125.96(15) |
| O(1B) | B(1B) | O(3B) | 111.82(13) |
| O(1B) | B(1B) | N(1B) | 102.75(11) |
| O(1B) | B(1B) | C(1B) | 110.20(12) |
| O(3B) | B(1B) | N(1B) | 101.17(11) |
| O(3B) | B(1B) | C(1B) | 114.19(13) |
| C(1B) | B(1B) | N(1B) | 115.93(12) |
| C(3D) | S(1D) | C(1D) | 104.95(7) |
| C(9D) | S(1D) | C(1D) | 104.11(7) |
| C(9D) | S(1D) | C(3D) | 102.13(7) |
| C(10D) | S(2D) | C(4D) | 102.17(7) |
| C(15D) | O(1D) | B(1D) | 114.83(12) |
| C(18D) | O(3D) | B(1D) | 113.43(12) |
| C(16D) | N(1D) | C(17D) | 111.84(12) |
| C(16D) | N(1D) | B(1D) | 103.84(11) |
| C(17D) | N(1D) | B(1D) | 102.24(11) |
| C(19D) | N(1D) | C(16D) | 112.25(12) |
| C(19D) | N(1D) | C(17D) | 109.41(12) |
| C(19D) | N(1D) | B(1D) | 116.80(12) |
| C(2D) | C(1D) | S(1D) | 118.85(12) |
| C(2D) | C(1D) | B(1D) | 125.44(14) |
| B(1D) | C(1D) | S(1D) | 115.21(11) |
| C(4D) | C(3D) | S(1D) | 121.40(12) |
| C(4D) | C(3D) | C(8D) | 121.63(15) |
| C(8D) | C(3D) | S(1D) | 116.95(12) |
| C(3D) | C(4D) | S(2D) | 123.57(12) |
| C(3D) | C(4D) | C(5D) | 118.46(15) |
| C(5D) | C(4D) | S(2D) | 117.96(12) |
| C(6D) | C(5D) | C(4D) | 120.02(16) |
| C(7D) | C(6D) | C(5D) | 120.73(16) |
| C(8D) | C(7D) | C(6D) | 119.93(16) |
| C(7D) | C(8D) | C(3D) | 119.10(16) |
| C(10D) | C(9D) | S(1D) | 121.05(12) |
| C(14D) | C(9D) | S(1D) | 117.00(12) |
| C(14D) | C(9D) | C(10D) | 121.92(15) |
| C(9D) | C(10D) | S(2D) | 123.92(12) |
| C(11D) | C(10D) | S(2D) | 117.53(12) |
| C(11D) | C(10D) | C(9D) | 118.54(14) |
| C(12D) | C(11D) | C(10D) | 119.68(15) |
| C(11D) | C(12D) | C(13D) | 121.46(15) |
| C(12D) | C(13D) | C(14D) | 119.68(15) |
| C(13D) | C(14D) | C(9D) | 118.67(15) |
| O(1D) | C(15D) | C(16D) | 110.09(13) |
| O(2D) | C(15D) | O(1D) | 123.55(15) |
| O(2D) | C(15D) | C(16D) | 126.27(15) |
| N(1D) | C(16D) | C(15D) | 105.64(12) |
| N(1D) | C(17D) | C(18D) | 106.39(12) |
| O(3D) | C(18D) | C(17D) | 110.90(13) |
| O(4D) | C(18D) | O(3D) | 124.32(14) |
| O(4D) | C(18D) | C(17D) | 124.76(14) |
| O(1D) | B(1D) | N(1D) | 101.66(11) |
| O(1D) | B(1D) | C(1D) | 111.97(13) |
| O(3D) | B(1D) | O(1D) | 111.54(13) |
| O(3D) | B(1D) | N(1D) | 103.68(11) |
| O(3D) | B(1D) | C(1D) | 112.01(13) |
| C(1D) | B(1D) | N(1D) | 115.32(12) |
| C(3F) | S(1F) | C(1F) | 104.91(7) |
| C(9F) | S(1F) | C(1F) | 104.08(7) |
| C(9F) | S(1F) | C(3F) | 102.24(7) |
| C(10F) | S(2F) | C(4F) | 102.16(7) |
| C(15F) | O(1F) | B(1F) | 114.54(12) |
| C(18F) | O(3F) | B(1F) | 113.49(12) |
| C(16F) | N(1F) | C(17F) | 112.13(12) |
| C(16F) | N(1F) | B(1F) | 103.82(11) |
| C(17F) | N(1F) | B(1F) | 102.20(11) |
| C(19F) | N(1F) | C(16F) | 111.87(12) |
| C(19F) | N(1F) | C(17F) | 109.51(12) |
| C(19F) | N(1F) | B(1F) | 116.91(12) |
| C(2F) | C(1F) | S(1F) | 118.95(12) |
| C(2F) | C(1F) | B(1F) | 125.34(14) |
| B(1F) | C(1F) | S(1F) | 115.18(11) |
| C(4F) | C(3F) | S(1F) | 121.59(12) |
| C(4F) | C(3F) | C(8F) | 121.58(15) |
| C(8F) | C(3F) | S(1F) | 116.82(12) |
| C(3F) | C(4F) | S(2F) | 123.67(12) |
| C(3F) | C(4F) | C(5F) | 118.42(14) |
| C(5F) | C(4F) | S(2F) | 117.89(12) |
| C(6F) | C(5F) | C(4F) | 120.02(15) |
| C(5F) | C(6F) | C(7F) | 120.89(16) |
| C(8F) | C(7F) | C(6F) | 119.69(16) |
| C(7F) | C(8F) | C(3F) | 119.29(15) |
| C(10F) | C(9F) | S(1F) | 121.33(12) |
| C(14F) | C(9F) | S(1F) | 116.67(12) |
| C(14F) | C(9F) | C(10F) | 121.96(15) |
| C(9F) | C(10F) | S(2F) | 123.96(12) |
| C(11F) | C(10F) | S(2F) | 117.69(12) |
| C(11F) | C(10F) | C(9F) | 118.33(14) |
| C(12F) | C(11F) | C(10F) | 119.77(16) |
| C(11F) | C(12F) | C(13F) | 121.42(16) |
| C(14F) | C(13F) | C(12F) | 119.64(15) |
| C(13F) | C(14F) | C(9F) | 118.81(16) |
| O(1F) | C(15F) | C(16F) | 110.31(13) |
| O(2F) | C(15F) | O(1F) | 123.43(15) |
| O(2F) | C(15F) | C(16F) | 126.18(15) |
| N(1F) | C(16F) | C(15F) | 105.46(12) |
| N(1F) | C(17F) | C(18F) | 106.41(12) |
| O(3F) | C(18F) | C(17F) | 110.65(12) |
| O(4F) | C(18F) | O(3F) | 124.43(14) |
| O(4F) | C(18F) | C(17F) | 124.89(14) |
| O(1F) | B(1F) | N(1F) | 101.63(11) |
| O(1F) | B(1F) | C(1F) | 112.08(12) |
| O(3F) | B(1F) | O(1F) | 111.42(13) |
| O(3F) | B(1F) | N(1F) | 103.76(11) |
| O(3F) | B(1F) | C(1F) | 111.91(13) |
| C(1F) | B(1F) | N(1F) | 115.36(12) |
| O(5) | S(3) | C(20) | 106.25(14) |
| O(6) | S(3) | C(20) | 106.71(14) |
| O(6) | S(3) | O(5) | 112.4(2) |
| O(6) | S(3) | O(7) | 115.1(3) |
| O(7) | S(3) | C(20) | 104.91(18) |
| O(7) | S(3) | O(5) | 110.7(3) |
| O(5A) | S(3) | C(20) | 98.91(15) |
| O(5A) | S(3) | O(6A) | 112.7(3) |
| O(6A) | S(3) | C(20) | 99.18(16) |
| O(7A) | S(3) | C(20) | 102.6(2) |
| O(7A) | S(3) | O(5A) | 120.6(3) |
| O(7A) | S(3) | O(6A) | 117.3(3) |
| F(1) | C(20) | S(3) | 111.08(17) |
| F(1) | C(20) | F(2) | 111.0(3) |
| F(1) | C(20) | F(3) | 111.0(2) |
| F(2) | C(20) | S(3) | 109.9(2) |
| F(2) | C(20) | F(3) | 106.8(2) |
| F(3) | C(20) | S(3) | 106.83(16) |
| F(1A) | C(20) | S(3) | 113.04(18) |
| F(2A) | C(20) | S(3) | 116.8(2) |
| F(2A) | C(20) | F(1A) | 104.6(3) |
| F(2A) | C(20) | F(3A) | 105.7(3) |
| F(3A) | C(20) | S(3) | 115.21(15) |
| F(3A) | C(20) | F(1A) | 99.6(2) |
| O(5B) | S(3B) | C(20B) | 106.09(11) |
| O(5B) | S(3B) | O(6B) | 113.66(16) |
| O(5B) | S(3B) | O(7B) | 113.84(18) |
| O(6B) | S(3B) | C(20B) | 104.67(9) |
| O(6B) | S(3B) | O(7B) | 112.17(15) |
| O(7B) | S(3B) | C(20B) | 105.39(10) |
| O(5C) | S(3B) | C(20B) | 95.2(2) |
| O(6C) | S(3B) | C(20B) | 98.4(2) |
| O(6C) | S(3B) | O(5C) | 116.8(6) |
| O(6C) | S(3B) | O(7C) | 122.2(5) |
| O(7C) | S(3B) | C(20B) | 95.9(3) |
| O(7C) | S(3B) | O(5C) | 117.2(5) |
| F(1B) | C(20B) | S(3B) | 111.21(13) |
| F(1B) | C(20B) | F(2B) | 109.25(19) |
| F(1B) | C(20B) | F(3B) | 110.19(19) |
| F(2B) | C(20B) | S(3B) | 108.96(13) |
| F(3B) | C(20B) | S(3B) | 109.02(13) |
| F(3B) | C(20B) | F(2B) | 108.15(17) |
| F(1C) | C(20B) | S(3B) | 117.3(2) |
| F(1C) | C(20B) | F(3C) | 93.8(3) |
| F(2C) | C(20B) | S(3B) | 123.5(2) |
| F(2C) | C(20B) | F(1C) | 103.1(4) |
| F(2C) | C(20B) | F(3C) | 98.7(4) |
| F(3C) | C(20B) | S(3B) | 115.04(19) |
| O(5D) | S(3D) | C(20D) | 102.46(7) |
| O(6D) | S(3D) | O(5D) | 115.91(9) |
| O(6D) | S(3D) | O(7D) | 116.30(10) |
| O(6D) | S(3D) | C(20D) | 103.43(8) |
| O(7D) | S(3D) | O(5D) | 112.89(9) |
| O(7D) | S(3D) | C(20D) | 103.33(8) |
| F(1D) | C(20D) | S(3D) | 111.97(11) |
| F(1D) | C(20D) | F(2D) | 106.65(14) |
| F(2D) | C(20D) | S(3D) | 111.61(11) |
| F(3D) | C(20D) | S(3D) | 111.95(11) |
| F(3D) | C(20D) | F(1D) | 107.51(13) |
| F(3D) | C(20D) | F(2D) | 106.84(14) |
| O(5F) | S(3F) | O(7F) | 112.17(9) |
| O(5F) | S(3F) | C(20F) | 102.70(8) |
| O(6F) | S(3F) | O(5F) | 117.19(11) |
| O(6F) | S(3F) | O(7F) | 115.80(12) |
| O(6F) | S(3F) | C(20F) | 103.17(9) |
| O(7F) | S(3F) | C(20F) | 103.26(9) |
| F(1F) | C(20F) | S(3F) | 112.31(12) |
| F(1F) | C(20F) | F(2F) | 106.04(15) |
| F(2F) | C(20F) | S(3F) | 111.16(11) |
| F(3F) | C(20F) | S(3F) | 112.39(11) |
| F(3F) | C(20F) | F(1F) | 107.85(14) |
| F(3F) | C(20F) | F(2F) | 106.72(15) |

TABLE 43
Torsion Angles in ° for 60.

| Atom | Atom | Atom | Atom | Angle/° |
|---|---|---|---|---|
| S(1) | C(1) | B(1) | O(1) | −119.71(12) |
| S(1) | C(1) | B(1) | O(3) | 7.00(16) |
| S(1) | C(1) | B(1) | N(1) | 123.94(12) |
| S(1) | C(3) | C(4) | S(2) | −5.10(19) |
| S(1) | C(3) | C(4) | C(5) | 174.43(12) |
| S(1) | C(3) | C(8) | C(7) | −173.92(12) |
| S(1) | C(9) | C(10) | S(2) | 3.49(19) |
| S(1) | C(9) | C(10) | C(11) | −175.34(11) |
| S(1) | C(9) | C(14) | C(13) | 175.50(13) |
| S(2) | C(4) | C(5) | C(6) | 179.75(12) |
| S(2) | C(10) | C(11) | C(12) | −179.11(12) |
| O(1) | C(15) | C(16) | N(1) | 7.61(17) |
| O(2) | C(15) | C(16) | N(1) | −173.01(15) |
| N(1) | C(17) | C(18) | O(3) | 22.08(16) |
| N(1) | C(17) | C(18) | O(4) | −160.54(15) |
| C(1) | S(1) | C(3) | C(4) | −64.53(14) |
| C(1) | S(1) | C(3) | C(8) | 114.04(13) |
| C(1) | S(1) | C(9) | C(10) | 65.91(14) |
| C(1) | S(1) | C(9) | C(14) | −111.42(13) |
| C(2) | C(1) | B(1) | O(1) | 50.93(19) |
| C(2) | C(1) | B(1) | O(3) | 177.64(14) |
| C(2) | C(1) | B(1) | N(1) | −65.42(19) |
| C(3) | S(1) | C(1) | C(2) | 119.97(13) |
| C(3) | S(1) | C(1) | B(1) | −68.75(12) |
| C(3) | S(1) | C(9) | C(10) | −41.99(14) |
| C(3) | S(1) | C(9) | C(14) | 140.67(13) |
| C(3) | C(4) | C(5) | C(6) | 0.2(2) |
| C(4) | S(2) | C(10) | C(9) | 35.42(14) |
| C(4) | S(2) | C(10) | C(11) | −145.74(12) |
| C(4) | C(3) | C(8) | C(7) | 4.6(2) |
| C(4) | C(5) | C(6) | C(7) | 3.0(2) |
| C(5) | C(6) | C(7) | C(8) | −2.5(3) |
| C(6) | C(7) | C(8) | C(3) | −1.3(2) |
| C(8) | C(3) | C(4) | S(2) | 176.40(12) |
| C(8) | C(3) | C(4) | C(5) | −4.1(2) |
| C(9) | S(1) | C(1) | C(2) | 14.24(14) |
| C(9) | S(1) | C(1) | B(1) | −174.49(10) |
| C(9) | S(1) | C(3) | C(4) | 43.17(14) |
| C(9) | S(1) | C(3) | C(8) | −138.26(13) |
| C(9) | C(10) | C(11) | C(12) | −0.2(2) |
| C(10) | S(2) | C(4) | C(3) | −34.25(14) |
| C(10) | S(2) | C(4) | C(5) | 146.22(12) |
| C(10) | C(9) | C(14) | C(13) | −1.8(2) |
| C(10) | C(11) | C(12) | C(13) | −1.6(2) |
| C(11) | C(12) | C(13) | C(14) | 1.6(3) |
| C(12) | C(13) | C(14) | C(9) | 0.0(2) |
| C(14) | C(9) | C(10) | S(2) | −179.29(12) |
| C(14) | C(9) | C(10) | C(11) | 1.9(2) |
| C(15) | O(1) | B(1) | O(3) | 86.73(15) |
| C(15) | O(1) | B(1) | N(1) | −21.06(15) |
| C(15) | O(1) | B(1) | C(1) | −145.36(12) |
| C(16) | N(1) | C(17) | C(18) | 80.82(15) |
| C(16) | N(1) | B(1) | O(1) | 23.72(14) |
| C(16) | N(1) | B(1) | O(3) | −92.01(12) |
| C(16) | N(1) | B(1) | C(1) | 144.09(13) |
| C(17) | N(1) | C(16) | C(15) | −127.94(13) |
| C(17) | N(1) | B(1) | O(1) | 139.99(12) |
| C(17) | N(1) | B(1) | O(3) | 24.26(14) |
| C(17) | N(1) | B(1) | C(1) | −99.65(14) |
| C(18) | O(3) | B(1) | O(1) | −120.83(13) |
| C(18) | O(3) | B(1) | N(1) | −11.93(15) |
| C(18) | O(3) | B(1) | C(1) | 113.33(14) |
| C(19) | N(1) | C(16) | C(15) | 107.71(14) |
| C(19) | N(1) | C(17) | C(18) | −155.05(12) |
| C(19) | N(1) | B(1) | O(1) | −97.44(15) |
| C(19) | N(1) | B(1) | O(3) | 146.83(13) |
| C(19) | N(1) | B(1) | C(1) | 22.92(19) |
| B(1) | O(1) | C(15) | O(2) | −169.75(15) |
| B(1) | O(1) | C(15) | C(16) | 9.64(17) |
| B(1) | O(3) | C(18) | O(4) | 177.29(15) |
| B(1) | O(3) | C(18) | C(17) | −5.27(17) |
| B(1) | N(1) | C(16) | C(15) | −18.85(15) |
| B(1) | N(1) | C(17) | C(18) | −27.53(15) |
| S(1B) | C(1B) | B(1B) | O(1B) | −120.59(12) |
| S(1B) | C(1B) | B(1B) | O(3B) | 6.24(16) |
| S(1B) | C(1B) | B(1B) | N(1B) | 123.28(12) |
| S(1B) | C(3B) | C(4B) | S(2B) | −4.1(2) |
| S(1B) | C(3B) | C(4B) | C(5B) | 174.84(12) |
| S(1B) | C(3B) | C(8B) | C(7B) | −174.29(12) |
| S(1B) | C(9B) | C(10B) | S(2B) | 3.7(2) |
| S(1B) | C(9B) | C(10B) | C(11B) | −174.83(12) |
| S(1B) | C(9B) | C(14B) | C(13B) | 175.49(12) |
| S(2B) | C(4B) | C(5B) | C(6B) | 179.19(12) |
| S(2B) | C(10B) | C(11B) | C(12B) | −179.21(12) |
| O(1B) | C(15B) | C(16B) | N(1B) | 8.31(17) |
| O(2B) | C(15B) | C(16B) | N(1B) | −172.70(15) |
| N(1B) | C(17B) | C(18B) | O(3B) | 22.16(17) |
| N(1B) | C(17B) | C(18B) | O(4B) | −160.62(15) |
| C(1B) | S(1B) | C(3B) | C(4B) | −65.88(14) |
| C(1B) | S(1B) | C(3B) | C(8B) | 112.73(13) |
| C(1B) | S(1B) | C(9B) | C(10B) | 66.49(14) |
| C(1B) | S(1B) | C(9B) | C(14B) | −110.45(13) |
| C(2B) | C(1B) | B(1B) | O(1B) | 50.0(2) |
| C(2B) | C(1B) | B(1B) | O(3B) | 176.84(14) |
| C(2B) | C(1B) | B(1B) | N(1B) | −66.1(2) |
| C(3B) | S(1B) | C(1B) | C(2B) | 119.37(13) |
| C(3B) | S(1B) | C(1B) | B(1B) | −69.45(12) |
| C(3B) | S(1B) | C(9B) | C(10B) | −41.27(14) |
| C(3B) | S(1B) | C(9B) | C(14B) | 141.79(13) |
| C(3B) | C(4B) | C(5B) | C(6B) | 0.2(2) |
| C(4B) | S(2B) | C(10B) | C(9B) | 34.76(15) |
| C(4B) | S(2B) | C(10B) | C(11B) | −146.73(12) |
| C(4B) | C(3B) | C(8B) | C(7B) | 4.3(2) |
| C(4B) | C(5B) | C(6B) | C(7B) | 2.7(2) |
| C(5B) | C(6B) | C(7B) | C(8B) | −2.1(2) |
| C(6B) | C(7B) | C(8B) | C(3B) | −1.4(2) |
| C(8B) | C(3B) | C(4B) | S(2B) | 177.33(12) |
| C(8B) | C(3B) | C(4B) | C(5B) | −3.7(2) |
| C(9B) | S(1B) | C(1B) | C(2B) | 13.39(14) |
| C(9B) | S(1B) | C(1B) | B(1B) | −175.43(11) |
| C(9B) | S(1B) | C(3B) | C(4B) | 41.81(14) |
| C(9B) | S(1B) | C(3B) | C(8B) | −139.59(13) |
| C(9B) | C(10B) | C(11B) | C(12B) | −0.6(2) |
| C(10B) | S(2B) | C(4B) | C(3B) | −34.23(15) |
| C(10B) | S(2B) | C(4B) | C(5B) | 146.79(13) |
| C(10B) | C(9B) | C(14B) | C(13B) | −1.4(2) |
| C(10B) | C(11B) | C(12B) | C(13B) | −1.3(2) |
| C(11B) | C(12B) | C(13B) | C(14B) | 1.9(3) |
| C(12B) | C(13B) | C(14B) | C(9B) | −0.5(2) |
| C(14B) | C(9B) | C(10B) | S(2B) | −179.53(12) |
| C(14B) | C(9B) | C(10B) | C(11B) | 2.0(2) |
| C(15B) | O(1B) | B(1B) | O(3B) | 87.37(15) |
| C(15B) | O(1B) | B(1B) | N(1B) | −20.36(16) |
| C(15B) | O(1B) | B(1B) | C(1B) | −144.49(13) |
| C(16B) | N(1B) | C(17B) | C(18B) | 81.18(15) |
| C(16B) | N(1B) | B(1B) | O(1B) | 23.57(14) |
| C(16B) | N(1B) | B(1B) | O(3B) | −92.10(13) |
| C(16B) | N(1B) | B(1B) | C(1B) | 143.82(13) |
| C(17B) | N(1B) | C(16B) | C(15B) | −128.37(13) |
| C(17B) | N(1B) | B(1B) | O(1B) | 139.88(12) |
| C(17B) | N(1B) | B(1B) | O(3B) | 24.21(14) |
| C(17B) | N(1B) | B(1B) | C(1B) | −99.87(14) |
| C(18B) | O(3B) | B(1B) | O(1B) | −120.56(14) |
| C(18B) | O(3B) | B(1B) | N(1B) | −11.81(15) |
| C(18B) | O(3B) | B(1B) | C(1B) | 113.45(14) |
| C(19B) | N(1B) | C(16B) | C(15B) | 107.58(14) |
| C(19B) | N(1B) | C(17B) | C(18B) | −154.89(13) |
| C(19B) | N(1B) | B(1B) | O(1B) | −97.80(15) |
| C(19B) | N(1B) | B(1B) | O(3B) | 146.54(13) |
| C(19B) | N(1B) | B(1B) | C(1B) | 22.45(19) |
| B(1B) | O(1B) | C(15B) | O(2B) | −170.24(15) |
| B(1B) | O(1B) | C(15B) | C(16B) | 8.76(17) |
| B(1B) | O(3B) | C(18B) | O(4B) | 177.28(15) |
| B(1B) | O(3B) | C(18B) | C(17B) | −5.45(17) |
| B(1B) | N(1B) | C(16B) | C(15B) | −19.13(15) |
| B(1B) | N(1B) | C(17B) | C(18B) | −27.51(15) |
| S(1D) | C(1D) | B(1D) | O(1D) | — |
| | | | | 117.61(12) |
| S(1D) | C(1D) | B(1D) | O(3D) | 8.55(16) |
| S(1D) | C(1D) | B(1D) | N(1D) | 126.80(11) |
| S(1D) | C(3D) | C(4D) | S(2D) | −2.6(2) |
| S(1D) | C(3D) | C(4D) | C(5D) | 176.12(12) |
| S(1D) | C(3D) | C(8D) | C(7D) | −174.41(13) |
| S(1D) | C(9D) | C(10D) | S(2D) | 3.05(19) |
| S(1D) | C(9D) | C(10D) | C(11D) | −175.53(11) |
| S(1D) | C(9D) | C(14D) | C(13D) | 175.73(12) |
| S(2D) | C(4D) | C(5D) | C(6D) | 177.70(13) |
| S(2D) | C(10D) | C(11D) | C(12D) | −179.15(12) |
| O(1D) | C(15D) | C(16D) | N(1D) | −15.83(17) |
| O(2D) | C(15D) | C(16D) | N(1D) | 167.46(15) |
| N(1D) | C(17D) | C(18D) | O(3D) | −13.53(17) |
| N(1D) | C(17D) | C(18D) | O(4D) | 168.12(14) |
| C(1D) | S(1D) | C(3D) | C(4D) | −67.94(14) |
| C(1D) | S(1D) | C(3D) | C(8D) | 110.43(13) |
| C(1D) | S(1D) | C(9D) | C(10D) | 68.51(14) |
| C(1D) | S(1D) | C(9D) | C(14D) | −109.41(13) |
| C(2D) | C(1D) | B(1D) | O(1D) | 54.1(2) |
| C(2D) | C(1D) | B(1D) | O(3D) | −179.74(15) |
| C(2D) | C(1D) | B(1D) | N(1D) | −61.5(2) |
| C(3D) | S(1D) | C(1D) | C(2D) | 119.93(13) |
| C(3D) | S(1D) | C(1D) | B(1D) | −67.78(12) |
| C(3D) | S(1D) | C(9D) | C(10D) | −40.53(14) |
| C(3D) | S(1D) | C(9D) | C(14D) | 141.56(13) |
| C(3D) | C(4D) | C(5D) | C(6D) | −1.1(2) |
| C(4D) | S(2D) | C(10D) | C(9D) | 35.18(15) |
| C(4D) | S(2D) | C(10D) | C(11D) | −146.23(12) |
| C(4D) | C(3D) | C(8D) | C(7D) | 4.0(2) |
| C(4D) | C(5D) | C(6D) | C(7D) | 2.6(3) |
| C(5D) | C(6D) | C(7D) | C(8D) | −0.8(3) |
| C(6D) | C(7D) | C(8D) | C(3D) | −2.4(3) |
| C(8D) | C(3D) | C(4D) | S(2D) | 179.08(12) |
| C(8D) | C(3D) | C(4D) | C(5D) | −2.2(2) |
| C(9D) | S(1D) | C(1D) | C(2D) | 13.00(15) |
| C(9D) | S(1D) | C(1D) | B(1D) | −174.71(11) |
| C(9D) | S(1D) | C(3D) | C(4D) | 40.45(15) |
| C(9D) | S(1D) | C(3D) | C(8D) | −141.18(13) |
| C(9D) | C(10D) | C(11D) | C(12D) | −0.5(2) |
| C(10D) | S(2D) | C(4D) | C(3D) | −35.28(15) |
| C(10D) | S(2D) | C(4D) | C(5D) | 145.97(13) |
| C(10D) | C(9D) | C(14D) | C(13D) | −2.2(2) |
| C(10D) | C(11D) | C(12D) | C(13D) | −1.4(2) |
| C(11D) | C(12D) | C(13D) | C(14D) | 1.5(2) |
| C(12D) | C(13D) | C(14D) | C(9D) | 0.2(2) |
| C(14D) | C(9D) | C(10D) | S(2D) | −179.14(12) |
| C(14D) | C(9D) | C(10D) | C(11D) | 2.3(2) |
| C(15D) | O(1D) | B(1D) | O(3D) | 118.25(14) |
| C(15D) | O(1D) | B(1D) | N(1D) | 8.31(16) |
| C(15D) | O(1D) | B(1D) | C(1D) | −115.33(14) |
| C(16D) | N(1D) | C(17D) | C(18D) | 128.17(13) |
| C(16D) | N(1D) | B(1D) | O(1D) | −17.15(15) |
| C(16D) | N(1D) | B(1D) | O(3D) | −133.00(12) |
| C(16D) | N(1D) | B(1D) | C(1D) | 104.19(14) |
| C(17D) | N(1D) | C(16D) | C(15D) | −89.99(14) |
| C(17D) | N(1D) | B(1D) | O(1D) | 99.31(13) |
| C(17D) | N(1D) | B(1D) | O(3D) | −16.54(14) |
| C(17D) | N(1D) | B(1D) | C(1D) | −139.34(13) |
| C(18D) | O(3D) | B(1D) | O(1D) | −99.21(14) |
| C(18D) | O(3D) | B(1D) | N(1D) | 9.42(16) |
| C(18D) | O(3D) | B(1D) | C(1D) | 134.39(13) |
| C(19D) | N(1D) | C(16D) | C(15D) | 146.59(13) |
| C(19D) | N(1D) | C(17D) | C(18D) | −106.82(14) |
| C(19D) | N(1D) | B(1D) | O(1D) | −141.30(13) |
| C(19D) | N(1D) | B(1D) | O(3D) | 102.85(14) |
| C(19D) | N(1D) | B(1D) | C(1D) | −19.96(18) |
| B(1D) | O(1D) | C(15D) | O(2D) | −179.20(15) |
| B(1D) | O(1D) | C(15D) | C(16D) | 3.98(18) |
| B(1D) | O(3D) | C(18D) | O(4D) | −179.73(15) |
| B(1D) | O(3D) | C(18D) | C(17D) | 1.90(17) |
| B(1D) | N(1D) | C(16D) | C(15D) | 19.53(15) |
| B(1D) | N(1D) | C(17D) | C(18D) | 17.64(15) |
| S(1F) | C(1F) | B(1F) | O(1F) | −118.05(12) |
| S(1F) | C(1F) | B(1F) | O(3F) | 7.97(16) |
| S(1F) | C(1F) | B(1F) | N(1F) | 126.29(11) |
| S(1F) | C(3F) | C(4F) | S(2F) | −2.1(2) |
| S(1F) | C(3F) | C(4F) | C(5F) | 176.47(12) |
| S(1F) | C(3F) | C(8F) | C(7F) | −175.21(13) |
| S(1F) | C(9F) | C(10F) | S(2F) | 3.21(19) |
| S(1F) | C(9F) | C(10F) | C(11F) | −175.25(12) |
| S(1F) | C(9F) | C(14F) | C(13F) | 175.53(12) |
| S(2F) | C(4F) | C(5F) | C(6F) | 177.99(13) |
| S(2F) | C(10F) | C(11F) | C(12F) | −178.89(12) |
| O(1F) | C(15F) | C(16F) | N(1F) | −16.05(17) |
| O(2F) | C(15F) | C(16F) | N(1F) | 167.18(15) |
| N(1F) | C(17F) | C(18F) | O(3F) | −13.38(17) |
| N(1F) | C(17F) | C(18F) | O(4F) | 168.18(15) |
| C(1F) | S(1F) | C(3F) | C(4F) | −68.79(14) |
| C(1F) | S(1F) | C(3F) | C(8F) | 110.09(13) |
| C(1F) | S(1F) | C(9F) | C(10F) | 68.93(14) |
| C(1F) | S(1F) | C(9F) | C(14F) | −108.69(13) |
| C(2F) | C(1F) | B(1F) | O(1F) | 53.5(2) |
| C(2F) | C(1F) | B(1F) | O(3F) | 179.55(15) |
| C(2F) | C(1F) | B(1F) | N(1F) | −62.1(2) |
| C(3F) | S(1F) | C(1F) | C(2F) | 119.33(13) |
| C(3F) | S(1F) | C(1F) | B(1F) | −68.52(12) |
| C(3F) | S(1F) | C(9F) | C(10F) | −40.09(14) |
| C(3F) | S(1F) | C(9F) | C(14F) | 142.29(13) |
| C(3F) | C(4F) | C(5F) | C(6F) | −0.6(2) |
| C(4F) | S(2F) | C(10F) | C(9F) | 34.65(15) |
| C(4F) | S(2F) | C(10F) | C(11F) | −146.88(12) |
| C(4F) | C(3F) | C(8F) | C(7F) | 3.7(2) |
| C(4F) | C(5F) | C(6F) | C(7F) | 2.3(3) |
| C(5F) | C(6F) | C(7F) | C(8F) | −1.0(3) |
| C(6F) | C(7F) | C(8F) | C(3F) | −1.9(2) |
| C(8F) | C(3F) | C(4F) | S(2F) | 179.09(12) |
| C(8F) | C(3F) | C(4F) | C(5F) | −2.4(2) |
| C(9F) | S(1F) | C(1F) | C(2F) | 12.29(15) |
| C(9F) | S(1F) | C(1F) | B(1F) | −175.56(11) |
| C(9F) | S(1F) | C(3F) | C(4F) | 39.60(14) |
| C(9F) | S(1F) | C(3F) | C(8F) | −141.53(13) |
| C(9F) | C(10F) | C(11F) | C(12F) | −0.3(2) |
| C(10F) | S(2F) | C(4F) | C(3F) | −35.14(15) |
| C(10F) | S(2F) | C(4F) | C(5F) | 146.30(13) |
| C(10F) | C(9F) | C(14F) | C(13F) | −2.1(2) |
| C(10F) | C(11F) | C(12F) | C(13F) | −1.7(2) |
| C(11F) | C(12F) | C(13F) | C(14F) | 1.9(3) |
| C(12F) | C(13F) | C(14F) | C(9F) | 0.0(2) |
| C(14F) | C(9F) | C(10F) | S(2F) | −179.29(12) |
| C(14F) | C(9F) | C(10F) | C(11F) | 2.2(2) |
| C(15F) | O(1F) | B(1F) | O(3F) | 119.07(14) |
| C(15F) | O(1F) | B(1F) | N(1F) | 9.09(16) |
| C(15F) | O(1F) | B(1F) | C(1F) | −114.64(14) |
| C(16F) | N(1F) | C(17F) | C(18F) | 128.43(13) |
| C(16F) | N(1F) | B(1F) | O(1F) | −18.01(14) |
| C(16F) | N(1F) | B(1F) | O(3F) | −133.75(12) |
| C(16F) | N(1F) | B(1F) | C(1F) | 103.48(14) |
| C(17F) | N(1F) | C(16F) | C(15F) | −89.38(14) |
| C(17F) | N(1F) | B(1F) | O(1F) | 98.75(13) |
| C(17F) | N(1F) | B(1F) | O(3F) | −16.99(14) |
| C(17F) | N(1F) | B(1F) | C(1F) | −139.76(13) |
| C(18F) | O(3F) | B(1F) | O(1F) | −98.61(14) |
| C(18F) | O(3F) | B(1F) | N(1F) | 10.00(16) |
| C(18F) | O(3F) | B(1F) | C(1F) | 135.01(13) |
| C(19F) | N(1F) | C(16F) | C(15F) | 147.13(13) |
| C(19F) | N(1F) | C(17F) | C(18F) | −106.77(14) |
| C(19F) | N(1F) | B(1F) | O(1F) | −141.71(13) |
| C(19F) | N(1F) | B(1F) | O(3F) | 102.54(14) |
| C(19F) | N(1F) | B(1F) | C(1F) | −20.23(18) |
| B(1F) | O(1F) | C(15F) | O(2F) | −179.52(15) |
| B(1F) | O(1F) | C(15F) | C(16F) | 3.61(17) |
| B(1F) | O(3F) | C(18F) | O(4F) | 179.88(15) |
| B(1F) | O(3F) | C(18F) | C(17F) | 1.43(17) |
| B(1F) | N(1F) | C(16F) | C(15F) | 20.19(15) |
| B(1F) | N(1F) | C(17F) | C(18F) | 17.83(15) |
| O(5) | S(3) | C(20) | F(1) | −179.3(3) |
| O(5) | S(3) | C(20) | F(2) | −56.0(3) |
| O(5) | S(3) | C(20) | F(3) | 59.5(3) |
| O(6) | S(3) | C(20) | F(1) | 60.6(3) |
| O(6) | S(3) | C(20) | F(2) | −176.2(3) |
| O(6) | S(3) | C(20) | F(3) | −60.6(2) |
| O(7) | S(3) | C(20) | F(1) | −62.0(3) |
| O(7) | S(3) | C(20) | F(2) | 61.3(3) |
| O(7) | S(3) | C(20) | F(3) | 176.8(3) |
| O(5A) | S(3) | C(20) | F(1A) | 175.8(3) |
| O(5A) | S(3) | C(20) | F(2A) | −62.8(3) |
| O(5A) | S(3) | C(20) | F(3A) | 62.2(3) |
| O(6A) | S(3) | C(20) | F(1A) | 60.9(3) |
| O(6A) | S(3) | C(20) | F(2A) | −177.7(3) |
| O(6A) | S(3) | C(20) | F(3A) | −52.7(3) |
| O(7A) | S(3) | C(20) | F(1A) | −60.0(3) |
| O(7A) | S(3) | C(20) | F(2A) | 61.4(3) |
| O(7A) | S(3) | C(20) | F(3A) | −173.6(3) |
| O(5B) | S(3B) | C(20B) | F(1B) | −176.6(2) |
| O(5B) | S(3B) | C(20B) | F(2B) | −56.1(2) |
| O(5B) | S(3B) | C(20B) | F(3B) | 61.7(2) |
| O(6B) | S(3B) | C(20B) | F(1B) | 62.95(19) |
| O(6B) | S(3B) | C(20B) | F(2B) | −176.57(17) |
| O(6B) | S(3B) | C(20B) | F(3B) | −58.74(17) |
| O(7B) | S(3B) | C(20B) | F(1B) | −55.5(2) |
| O(7B) | S(3B) | C(20B) | F(2B) | 65.0(2) |
| O(7B) | S(3B) | C(20B) | F(3B) | −177.21(19) |
| O(5C) | S(3B) | C(20B) | F(1C) | 173.9(5) |
| O(5C) | S(3B) | C(20B) | F(2C) | −55.7(5) |
| O(5C) | S(3B) | C(20B) | F(3C) | 65.0(4) |
| O(6C) | S(3B) | C(20B) | F(1C) | 55.8(5) |
| O(6C) | S(3B) | C(20B) | F(2C) | −173.8(6) |
| O(6C) | S(3B) | C(20B) | F(3C) | −53.1(5) |
| O(7C) | S(3B) | C(20B) | F(1C) | −68.1(5) |
| O(7C) | S(3B) | C(20B) | F(2C) | 62.4(5) |
| O(7C) | S(3B) | C(20B) | F(3C) | −176.9(4) |
| O(5D) | S(3D) | C(20D) | F(1D) | 179.30(12) |
| O(5D) | S(3D) | C(20D) | F(2D) | −61.22(14) |
| O(5D) | S(3D) | C(20D) | F(3D) | 58.48(13) |
| O(6D) | S(3D) | C(20D) | F(1D) | 58.45(14) |
| O(6D) | S(3D) | C(20D) | F(2D) | 177.93(13) |
| O(6D) | S(3D) | C(20D) | F(3D) | −62.37(14) |
| O(7D) | S(3D) | C(20D) | F(1D) | −63.20(14) |
| O(7D) | S(3D) | C(20D) | F(2D) | 56.28(14) |
| O(7D) | S(3D) | C(20D) | F(3D) | 175.98(12) |
| O(5F) | S(3F) | C(20F) | F(1F) | −179.92(13) |
| O(5F) | S(3F) | C(20F) | F(2F) | −61.29(15) |
| O(5F) | S(3F) | C(20F) | F(3F) | 58.25(14) |
| O(6F) | S(3F) | C(20F) | F(1F) | 57.81(16) |
| O(6F) | S(3F) | C(20F) | F(2F) | 176.44(15) |
| O(6F) | S(3F) | C(20F) | F(3F) | −64.02(16) |
| O(7F) | S(3F) | C(20F) | F(1F) | −63.14(15) |
| O(7F) | S(3F) | C(20F) | F(2F) | 55.49(15) |
| O(7F) | S(3F) | C(20F) | F(3F) | 175.03(13) |

TABLE 44
Hydrogen Fractional Atomic Coordinates (×10⁴) and Equivalent Isotropic
Displacement Parameters (Å² × 10³) for 60.

| Atom | x | y | z | U_{eq} |
|---|---|---|---|---|
| H(2A) | 2823.79 | 8936.5 | 3858.99 | 23 |
| H(2B) | 2913.44 | 9675.13 | 4122.39 | 23 |
| H(5) | −1322.57 | 9894.66 | 4486.51 | 22 |
| H(6) | −1945.22 | 8875.04 | 4806.61 | 28 |
| H(7) | −771.43 | 8000.79 | 5098.87 | 29 |
| H(8) | 1036.55 | 8087.06 | 5044.78 | 25 |
| H(11) | 1780.36 | 11803.09 | 4364.71 | 22 |
| H(12) | 3428.68 | 12203.03 | 4589.5 | 28 |
| H(13) | 4531.02 | 11258.53 | 4869.56 | 29 |
| H(14) | 4005.1 | 9870.35 | 4905.04 | 27 |
| H(16A) | 1076.61 | 6845.46 | 3529.64 | 24 |
| H(16B) | 808.14 | 6327.94 | 3830.02 | 24 |
| H(17A) | −530.15 | 7096.44 | 3984.05 | 23 |
| H(17B) | −346.64 | 8010.37 | 4128.46 | 23 |
| H(19A) | 1335.76 | 8322.76 | 3557.77 | 34 |
| H(19B) | 589.96 | 8782.77 | 3781.26 | 34 |
| H(19C) | 103.06 | 8119.63 | 3532.91 | 34 |
| H(2BA) | 2203.39 | 3882.65 | 3648.31 | 24 |
| H(2BB) | 2115.93 | 4627.8 | 3387.5 | 24 |
| H(5B) | 6343.34 | 4910.03 | 3026.75 | 23 |
| H(6B) | 6996.74 | 3891.44 | 2713.76 | 26 |
| H(7B) | 5855.39 | 2984.85 | 2427.13 | 27 |
| H(8B) | 4043.08 | 3048.36 | 2476.04 | 23 |
| H(11B) | 3186.18 | 6771.96 | 3149.52 | 24 |
| H(12B) | 1528.95 | 7146.76 | 2924.28 | 30 |
| H(13B) | 455.24 | 6187.99 | 2641.55 | 31 |
| H(14B) | 1017.22 | 4807.33 | 2607.16 | 27 |
| H(16C) | 3974.01 | 1811.55 | 3978.38 | 25 |
| H(16D) | 4229.49 | 1288.64 | 3677.83 | 25 |
| H(17C) | 5566.87 | 2050.33 | 3519.81 | 25 |
| H(17D) | 5384.64 | 2963.52 | 3374.42 | 25 |
| H(19D) | 3716.12 | 3286.22 | 3948.79 | 35 |
| H(19E) | 4448.14 | 3744.85 | 3720.99 | 35 |
| H(19F) | 4949.21 | 3086.41 | 3969 | 35 |
| H(2DA) | 2816.84 | 8717.75 | 6404.53 | 25 |
| H(2DB) | 2887.28 | 9477.81 | 6659.23 | 25 |
| H(5D) | −1439.81 | 9921.77 | 6960.49 | 26 |
| H(6D) | −2200.45 | 8917.94 | 7257.6 | 31 |
| H(7D) | −1150.13 | 7958.04 | 7546.78 | 33 |
| H(8D) | 679.84 | 7982.07 | 7531.95 | 28 |
| H(11D) | 1806.02 | 11690.08 | 6870.45 | 21 |
| H(12D) | 3446.43 | 12028.01 | 7117.35 | 26 |
| H(13D) | 4442.84 | 11052.42 | 7414.69 | 28 |
| H(14D) | 3816.95 | 9686.95 | 7449.41 | 25 |
| H(16E) | 1683.56 | 7496.35 | 6031.2 | 25 |
| H(16F) | 1071.67 | 6631.94 | 6060.75 | 25 |
| H(17E) | 230.65 | 6260.24 | 6455.51 | 23 |
| H(17F) | −622.95 | 6987.33 | 6475.03 | 23 |
| H(19G) | 792.54 | 8599.69 | 6239.32 | 37 |
| H(19H) | −60.71 | 8434.73 | 6481.18 | 37 |
| H(19I) | −228.25 | 8052.11 | 6138.79 | 37 |
| H(2FA) | 2157.48 | 3672.6 | 6098.33 | 25 |
| H(2FB) | 2100.55 | 4436.46 | 5845.31 | 25 |
| H(5F) | 6429.95 | 4919.06 | 5559.2 | 25 |
| H(6F) | 7217.34 | 3923.19 | 5266.13 | 30 |
| H(7F) | 6194.84 | 2949.13 | 4975.16 | 30 |
| H(8F) | 4362.57 | 2948.91 | 4987.7 | 26 |
| H(11F) | 3133.81 | 6657.9 | 5634.22 | 24 |
| H(12F) | 1488.87 | 6966.65 | 5384.9 | 29 |
| H(13F) | 530.98 | 5975.78 | 5083.81 | 31 |
| H(14F) | 1191.62 | 4623.44 | 5053.4 | 26 |
| H(16G) | 3286.29 | 2470.18 | 6472.76 | 24 |
| H(16H) | 3894.79 | 1602.03 | 6448.93 | 24 |
| H(17G) | 4735.71 | 1212.57 | 6052.3 | 22 |
| H(17H) | 5599.96 | 1932.23 | 6034.12 | 22 |
| H(19J) | 4198.19 | 3561.55 | 6262.79 | 35 |
| H(19K) | 5068.2 | 3378.58 | 6027.8 | 35 |
| H(19L) | 5202.93 | 3004.81 | 6371.94 | 35 |

U_{eq} is defined as ⅓ of the trace of the orthogonalised Uᵢⱼ

TABLE 45
Atomic Occupancies for all atoms that are not fully occupied in 60.

| Atom | Occupancy |
|---|---|
| F(1) | 0.521(6) |
| F(2) | 0.521(6) |
| F(3) | 0.521(6) |
| O(5) | 0.521(6) |
| O(6) | 0.521(6) |
| O(7) | 0.521(6) |
| F(1A) | 0.479(6) |
| F(2A) | 0.479(6) |
| F(3A) | 0.479(6) |
| O(5A) | 0.479(6) |
| O(6A) | 0.479(6) |
| O(7A) | 0.479(6) |
| F(1B) | 0.734(3) |
| F(2B) | 0.734(3) |
| F(3B) | 0.734(3) |
| O(5B) | 0.734(3) |
| O(6B) | 0.734(3) |
| O(7B) | 0.734(3) |
| F(1C) | 0.266(3) |
| F(2C) | 0.266(3) |
| F(3C) | 0.266(3) |
| O(5C) | 0.266(3) |
| O(6C) | 0.266(3) |
| O(7C) | 0.266(3) |

Further benefits of Applicants' invention will be apparent to one skilled in the art from reading this patent application.

It is understood that the foregoing detailed description and accompanying examples are merely illustrative and are not to be taken as limitations upon the scope of the present disclosure, which is defined by the appended claims and their equivalents. Various changes and modifications to the described embodiments will be apparent to those skilled in the art. Such changes and modifications, including without limitation those relating to the chemical structures, substituents, derivatives, syntheses, compositions, or methods, or any combination of such changes and modifications of use of the present disclosure, may be made without departing from the spirit and scope thereof.

1. A compound of formula (I), 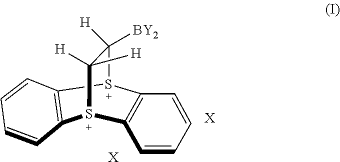
where each Y is a ligand; or wherein two Y combine to form a bidentate ligand; and each X is independently a negatively charged ion.

2. The compound of claim 1, wherein
Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-NR³—C₁₋₁₂ alkylenyl-C(O)O—;
R² is C₁₋₈ alkyl, C(O)—C₁₋₈ alkyl, or C(O)—C₁₋₈ alkylenyl-N(R³)₂; and
R³ is hydrogen or C₁₋₄ alkyl.

3. The compound of claim 1, wherein two Y are combined to form:

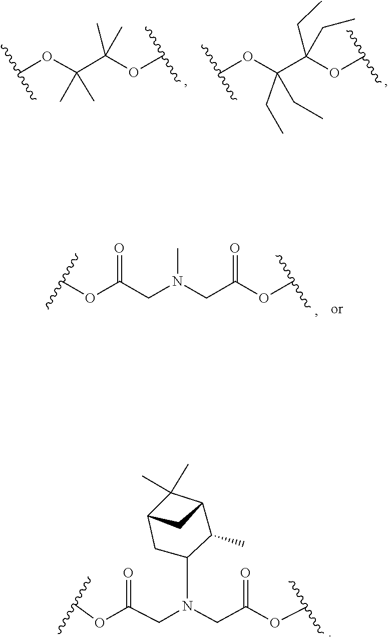

4. The compound of claim 1, which is

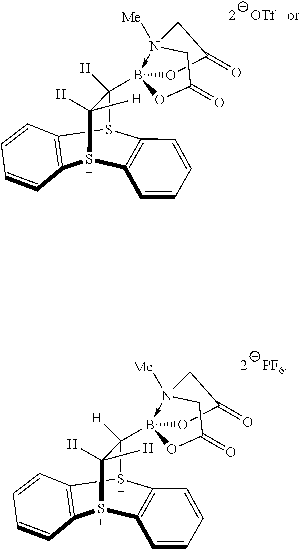

5. The compound of claim 1, which is

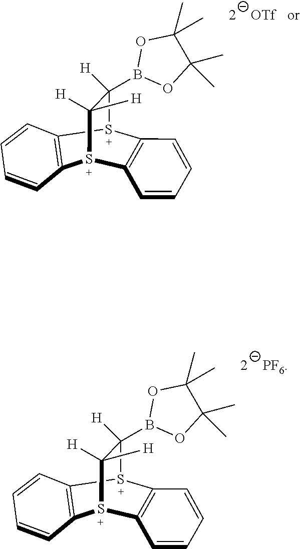

6. The compound of claim 1, which is

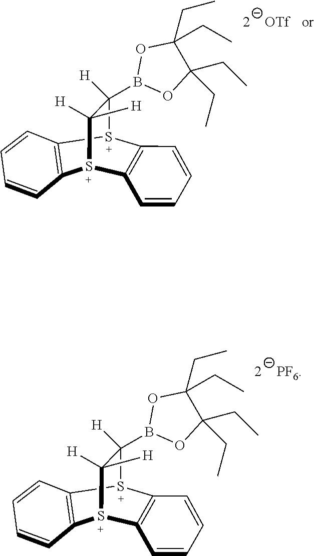

7. A composition comprising the compound of claim 1 and a solvent.

8. A method of preparing a boryl thianthrenium salt comprising treating thianthrene 5-oxide or thianthrene with an alkenyl boronate 1: 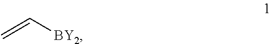
where each Y is a ligand; or wherein two Y combine to form a bidentate ligand.

9. The method of claim 8, wherein in the alkenyl boronate 1,
Y is OR²; or two Y combine to form —O—C₁₋₁₂ alkylenyl-O—, —OC(O)—C₁₋₁₂ alkylenyl-C(O)O—, or —OC(O)—C₁₋₁₂ alkylenyl-N³—C₁₋₁₂ alkylenyl-C(O)O—;
R² is C₁₋₈ alkyl, C(O)—C₁₋₈ alkyl, or C(O)—C₁₋₈ alkyl-N(R³)₂; and
R³ is hydrogen or C₁₋₄ alkyl.

10. The method of claim 8, wherein BY² is:

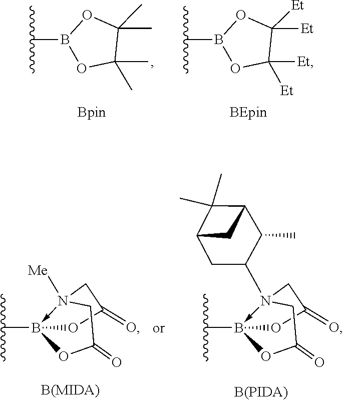

11. The method of claim 8, wherein the boryl thianthrenium salt is of formula (I), 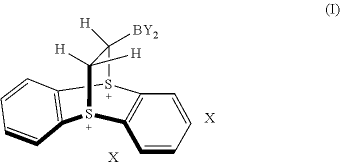
where each Y is a ligand; or wherein two Y combine to form a bidentate ligand; and each X is independently a negatively charged ion.

12. The method of claim 8, comprising treating thianthrene 5-oxide with the alkenyl boronate 1 in the presence of an acid.

13. The method of claim 12, wherein treating thianthrene 5-oxide with the alkenyl boronate 1 is in the presence of an acylating agent.

14. The method of claim 8, comprising treating thianthrene with the alkenyl boronate 1 in an electrochemical reaction.

15. A method of synthesizing an organoboron compound comprising contacting 3c or 3d 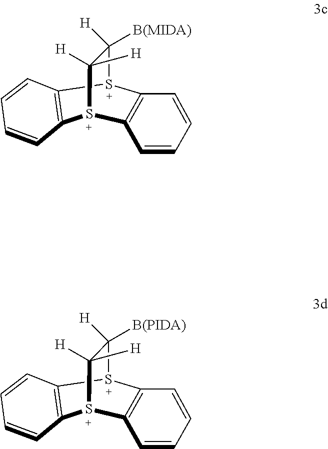
with a compound comprising —NH₂.

16. The method of claim 15, wherein the compound comprising —NH₂ is an amine, a sulfonamide, or a sulfamide.

17. The method of claim 16, comprising forming an aziridinyl borate.

18. The method of claim 17, wherein contacting 3c or 3d with the compound comprising —NH₂ is done in the presence of a base.

19. The method of claim 18, wherein the base is potassium carbonate, cesium carbonate, sodium bicarbonate, potassium phosphate, or sodium tert-butoxide.

20. The method of claim 16, further comprising opening an aziridine ring of the aziridinyl borate with a nucleophile.
